(19) United States
(12) Patent Application Publication
(10) Pub. No.: US 2016/0004814 A1
(43) Pub. Date: Jan. 7, 2016

(54) METHODS AND COMPOSITIONS RELATED TO REGULATION OF NUCLEIC ACIDS

(71) Applicant: University of Washington through its Center for Commercialization, Seattle, WA (US)

(72) Inventor: John A Stamatoyannopoulos, Seattle, WA (US)

(21) Appl. No.: 14/426,291

(22) PCT Filed: Sep. 5, 2013
(86) PCT No.: PCT/US13/58339

§ 371 Date: Mar. 5, 2015

Related U.S. Application Data
(60) Provisional application No. 61/697,200, filed on Sep. 5, 2012.

(51) Int. Cl. G06F 19/18; G06F 19/24; C40B 30/02; G06F 19/22

(52) U.S. Cl. CPC G06F 19/18; G06F 19/22; G06F 19/24; C40B 30/02

(57) ABSTRACT

Described herein are methods and compositions for analyzing regulatory regions within polynucleotides, particularly within genomic DNA. The methods provided herein include cleaving the polynucleotides with a cleaving agent such as DNase1 and using the cleavage patterns for such applications as identifying regulatory states of a cellular or polynucleotide sample; identifying novel regulatory elements; generating maps of binding patterns of regulatory factors along a polynucleotide; generating maps of regulatory networks; and identifying topologic features of a polynucleotide sample, particularly samples of polynucleotides bound to proteins. The methods provided herein may also be used in a myriad of other applications including predicting risks of diseases or disorders, diagnostics, drug screening, and therapeutic development.

### CROSS-REFERENCE

This application claims the benefit of U.S. Provisional Application No. 61/697,200, filed Sep. 5, 2012, which is incorporated herein by reference in its entirety.

### STATEMENT AS TO FEDERALLY SPONSORED RESEARCH

This disclosure was made, in part, with the support of the United States government under Grant numbers U54HG004592, U01ES01156, P30DK056465, R01HL088456, R24HD000836-47, FDK095678A, HG004563, GM076036, RO1MH084676, DGE-0718124, HHSN261200800001E and RC2HG005654 from the National Institutes of Health and the National Science Foundation.

### BACKGROUND

Transcriptional regulatory factors play a large role in regulating genes in a myriad of different cellular contexts. Regulatory elements may interact in a complex manner, forming extended networks across multiple regulatory genes. The extended networks may enable simultaneous integration of multiple internal and external cues so that signals can be conveyed to specific targets, such as effector genes along the genome.

Sequence-specific transcription factors bind to specific elements within DNA including a large variety of different cis-regulatory elements (e.g., enhancers, promoters, silencers, insulators, locus control regions, etc.). Sequence-specific transcription factors often bind in place of nucleosomes. The binding of transcription factors to DNA may create focal alterations in chromatin structure. The focal alterations can result in heightened nuclease accessibility, particularly to DNaseI, thereby generating DNaseI hypersensitive sites (DHS).

DNaseI footprinting can involve cleaving protein-bound DNA with DNaseI. DNaseI cleaves phosphodiester bonds between adjacent nucleotides; and cleavage of a sample of genomic DNA generally occurs at DHS. Bound factors such as transcription factors can prevent DNA cleavage, leaving footprints that demarcate transcription factor occupancy. DNaseI hypersensitivity overlies cis-regulatory elements directly and is maximal over the core region of regulatory factor occupancy.

Despite their central biological roles, both the structure of core human regulatory networks and their component subnetworks are largely undefined. There is a need in the art for methods and compositions that enable assaying of human regulatory networks for useful applications such as detecting or predicting diseases such as cancer.

### SUMMARY

Described herein are methods and compositions for analyzing polynucleotides, particularly polynucleotides associated with proteins, in order to (1) identify regulatory states of a cellular or polynucleotide sample; (2) generate maps of binding patterns of regulatory factors on a polynucleotide, particularly genomic DNA; (3) identify occupancy of transcription factor recognition sequences; (4) detect expression potential of a target polynucleotide within a polynucleotide sample, such as by using a stereotyped footprint of about 50 base pairs in length; (5) detect topologic features of protein-polynucleotide interfaces; (6) identify regulatory factors, including transcription factor binding sequences with highly cell-specific occupancy patterns; (7) distinguish direct versus indirect binding of a polypeptide to a polynucleotide; (8) generate integrated regulatory networks of a cell or organism; (9) generate an ordered regulatory hierarchy of polynucleotides; (10) diagnose, detect, or predict the risk of a disease, disorder or trait; (11) determine proliferative potential of a cell; (12) generate a map of variants of a set of nucleotides within regulatory regions of polynucleotides; (13) determine whether genetic variations within a target polynucleotide are associated with a function phenotype; (14) identify a cell type responsible for a particular disease or disorder; and (5) identify regulatory regions within genes. This disclosure also provides methods of screening agents that reverse a phenotype, as well as methods of treating subjects, particularly after analyzing the cleavage pattern or frequency of polynucleotide samples of the subject. This disclosure also provides methods of associating transcription factors with disease, differentiating between causes of gestational versus adult-onset diseases, identifying regulators of differentiation, and identifying genes such as oncogenes, tumor suppressor genes, or oncofetal genes. Often, the polynucleotides analyzed herein are genomic DNA, but they may also include other types of polynucleotides such as mitochondrial DNA, exosomal polynucleotides, RNA, cell-free DNA or RNA, etc. The methods provided herein often involve cleaving polynucleotides with a cleavage agent, such as a DNase (more specifically, DNaseI). They may also involve employing algorithms and transmitting data over a network.

In some aspects, this disclosure provides methods for identifying a regulatory state of a cell derived from a subject comprising: (a) obtaining a polynucleotide sample derived from the cell, wherein the polynucleotide sample comprises greater than 60% of the total number of polynucleotides within a polynucleotide compartment within the cell (or greater than about 50%, 55%, 60%, 65%, 70%, 75%, 80%, 85%, 90%, or 95% of the total number of polynucleotides within a polynucleotide compartment within the cell); b) cleaving the polynucleotide sample with a polynucleotide cleaving agent in order to obtain a library of polynucleotide fragments representing regions of the polynucleotide that are engaged with at least one other biomolecule; c) analyzing the library of polynucleotide fragments in order to obtain data reflecting a frequency of cleavage events for greater than 50% of the nucleotide sites in the polynucleotide sample, (or for greater than about 50%, 55%, 60%, 65%, 70%, 75%, 80%, 85%, 90%, or 95% of the nucleotide sites in the polynucleotide sample); and/or d) identifying a regulatory state of the cell by applying an algorithm to the data of step (c). In some embodiments of these aspects, the regulatory state may be a state of on- or off-gene activity. The algorithm may be generated by comparing sequence and cleavage data of reference polynucleotides with sequence and cleavage data from databases of known transcription factors, wherein the reference polynucleotides are obtained from greater than ten different cell types or cell states, or combination thereof. In some embodiments of these aspects, the reference polynucleotides are obtained from greater than 15, 20, 25, or 30 different cell types or cell states. In some embodiments of these aspects, the reference polynucleotides comprise polynucleotide cleavage (e.g., DNaseI cleavage) data. In some embodiments of these aspects, the polynucleotide sample comprises genomic DNA; in some embodiments, the polynucleotide compartment is a cellular nucleus or mitochondrion. In some embodiments of these aspects, the method further comprises identifying sequences of the library of polynucleotide fragments, wherein the algorithm correlates the sequence information with the data present in databases of known transcription factors. In some embodiments of these aspects, the identifying the sequences comprises performing a sequencing reaction, an amplification reaction, or a gene array assay. In some embodiments of these aspects, the polynucleotide cleaving agent is a DNA cleaving agent; in some embodiments the DNA cleaving agent is DNaseI. In some embodiments of these aspects, the cleavage data of the reference polynucleotides comprises DNaseI cleavage data. In some embodiments of these aspects, greater than 50% of DNaseI cleavage sites within the DNaseI cleavage data of the reference polynucleotides are localized to DNaseI-hypersensitivity regions. In some embodiments, the cell is a human cell. In some embodiments of these aspects, the method further comprises treating the subject based on the regulatory state identified in step (d). In some embodiments of these aspects, the regulatory state is a state of On- or Off-activity of genes regulated by greater than 50% of the regulatory elements present in the library of polynucleotide fragments. In some embodiments of these aspects, the method further comprises transmitting information related to the regulatory state of the cell over a network. In some embodiments of these aspects, the library of polynucleotide fragments comprises greater than 1 million polynucleotide fragments. In some embodiments of these aspects, the at least one other biomolecule is a polypeptide.

In some aspects, provided herein are methods for generating a map of one or more binding patterns of a plurality of binding proteins to one or more protein binding sequences within a plurality of regulatory regions of a plurality of polynucleotide fragments, comprising: (a) determining a frequency of polynucleotide cleavage events throughout a length of the plurality of polynucleotide fragments, wherein each of the plurality of polynucleotide fragments is generated by digesting a polynucleotide with a polynucleotide cleaving agent in the presence of the plurality of binding proteins; (b) detecting whether the determined frequency of polynucleotide cleavage is different; (c) if the determined frequency of polynucleotide cleavage is relatively different, identifying sequences of a set of nucleotides within the plurality of polynucleotide fragments; (d) identifying at least one protein binding sequence within the sequences of the set of nucleotides; (e) identifying at least one regulatory region within the plurality of polynucleotide fragments; (f) using at least one polynucleotide information database, correlating the identified protein binding sequence with the identified regulatory region to generate one or more binding patterns of at least one binding protein among the plurality of binding proteins; and (g) annotating the generated patterns using information from the polynucleotide information database to generate the map. In some embodiments of these aspects, the polynucleotide fragments are derived from greater than ten different cell types. In some embodiments of these aspects, the polynucleotide fragments are derived from greater than 20 different cell types, or greater than 30 different cell types. In some embodiments of these aspects, the identifying a sequence of a set of nucleotides within the plurality of polynucleotide fragments comprises sequencing. In some embodiments of these aspects, the polynucleotide is derived from genomic DNA of an organism. In some embodiments of these aspects, the identified regulatory regions comprise footprints. In some embodiments of these aspects, the one or more binding patterns are generated using at least one pattern detection algorithm selected from the group consisting of: a hotspot algorithm; a footprint occupancy score algorithm; a false discovery rate algorithm; and a multiset union algorithm. In some embodiments of these aspects, the method is performed using one or more processors or computers. In some embodiments of these aspects, the polynucleotide information database comprises data from greater than 40 cell or tissue types. In some embodiments of these aspects, polynucleotide information database comprises transcription factor binding sequences present within greater than 60% of an entire genome. In some embodiments of these aspects, polynucleotide cleaving agent is an enzyme (e.g., DNaseI). In some embodiments of these aspects, the different level of polynucleotide cleavage is greater than two standard deviations within a Z score.

In some aspects, provided herein are methods for identifying occupancy at transcription factor recognition sequences within a polynucleotide sample comprising: (a) obtaining a library of polynucleotide fragments produced by cleavage of the polynucleotide sample at cleavage sites, wherein the polynucleotide sample is derived from at least ten different cell types or cell states and wherein greater than 50% of the polynucleotide cleavage sites localize to regions of relatively high cleavage along the length of the polynucleotide; (b) performing sequencing reactions on the library of polynucleotide fragments and identifying a plurality of polynucleotide footprints; (c) correlating the polynucleotide footprints with a database comprising known regulatory factor recognition sequences; (d) enumerating the number of polynucleotide cleavages within core recognition sequences within the regulatory factor recognition sequences; and (e) quantifying the occupancy at transcription factor recognition sequences within polynucleotide hypersensitivity regions by computing a footprint occupancy score based on the values obtained in step d. In some embodiments of these aspects, the cleavage is performed with DNaseI. In some embodiments of these aspects, the method further comprises assembling the polynucleotide footprint information by cell type and identifying patterns of polynucleotide footprints across cell-types.

In some aspects, the methods provided herein include a method of detecting expression potential of a target polynucleotide within a polynucleotide sample comprising: (a) cleaving a polynucleotide sample with a polynucleotide cleaving agent, thereby generating a plurality of cleaved polynucleotide fragments; (b) analyzing the cleaved polynucleotide fragments in order to determine the presence of a stereotyped footprint that is about 50 basepairs in length, wherein the stereotyped footprint comprises sequences for GC-box binding proteins; (c) determining whether the stereotyped footprint is located in proximity to a known site of transcription origination for the target polynucleotide; and (d) correlating the presence of the stereotyped footprint with the expression potential of the target polynucleotide. In some embodiments of these aspects, the known site of transcription origination is a Transcription Start Site (TSS). In some embodiments of these aspects, the method further comprises using a computer or processor to analyze the cleaved polynucleotide fragments. In some embodiments of these aspects, the method is repeated more than ten times with more than ten genes of interest either simultaneously or consecutively. In some embodiments of these aspects, the stereotyped footprint that is about 50 base pairs in length is present in greater than 100 regulatory regions within the polynucleotide sample, or greater than 200 regulatory regions, or greater than 300 regulatory regions. In some embodiments of these aspects, the analyzing the cleaved polynucleotide fragments comprises identifying a sequence of the polynucleotide fragments by conducting a sequencing reaction, a microarray assay, or an amplification reaction. In some embodiments of these aspects, the stereotyped footprint is flanked by regions of uniformly elevated polynucleotide cleavage. In some embodiments of these aspects, the regions of uniformly elevated polynucleotide cleavage each comprise about 15 base pairs. In some embodiments of these aspects, the polynucleotide cleaving agent is an enzyme. In some embodiments of these aspects, the polynucleotide is DNA (e.g., genomic DNA). In some embodiments of these aspects, the polynucleotide cleaving agent is an enzyme such as DNaseI. In some embodiments of these aspects, the polynucleotide is obtained from a subject having a disease or disorder, at risk of having a disease or disorder, or suspected of having a disease or disorder and further comprising correlating the presence of the stereotyped footprint with such disease or disorder. In some embodiments of these aspects, the polynucleotide is obtained from a cellular sample and the presence of the stereotyped footprint is used to determine whether the cellular sample comprises pluripotent cells, multipotent cells, differentiated cells, stem cells, terminally differentiated cells, self-renewing cells, or proliferating cells. In some embodiments of these aspects, the polynucleotide is obtained from a cellular sample and the presence of the stereotyped footprint is used to determine (a) whether the cellular sample comprises cells infected with a pathogen; or (b) whether the cellular sample comprises cells at a specific point in cell cycle. In some embodiments of these aspects, the polynucleotide is obtained from a cellular sample and the presence of the stereotyped footprint is used to determine (1) future gene activity in the cellular sample; or (2) past gene activity in the cellular sample.

In some aspects, provided herein are methods for detecting topologic features of a protein-polynucleotide interface comprising: (a) cleaving a polynucleotide with a polynucleotide cleaving agent, thereby generating a plurality of cleaved polynucleotide fragments; (b) analyzing the cleaved polynucleotide fragments in order to determine regions of relatively high polynucleotide cleavage rates or relatively low polynucleotide cleavage rates; and (c) using the regions obtained in step (b) to predict the topologic features of the protein-polynucleotide interfaces. In some embodiments of these aspects, the analyzing of the cleaved polynucleotide fragments comprises employing a computer or processor to perform the analysis. In some embodiments of these aspects, the polynucleotide cleaving agent is DNaseI. In some embodiments of these aspects, the relatively high polynucleotide cleavage rates are relatively high compared to a set value. In some embodiments of these aspects, the set value is the average frequency of cleavage sites per nucleotide within a region proximal to the polynucleotide cleavage site. In some embodiments of these aspects, the regions of relatively low numbers of cleavage sites indicate that nucleotides within the regions are in contact with proteins In some embodiments of these aspects, the regions of relatively high numbers of cleavage sites indicate that nucleotides within the regions are exposed. In some embodiments of these aspects, the exposed nucleotides are located within a central pocket of a leucine zipper of a protein. In some embodiments of these aspects, the topological features are predicted with a high resolution. In some embodiments of these aspects, the topological features are predicted with greater than 75% accuracy.

In some aspects, provided herein are methods for identifying regulatory factors comprising: (a) obtaining polynucleotides from at least two cellular samples, wherein each sample comprises a functionally distinct cell type; (b) cleaving the polynucleotides with a polynucleotide cleaving agent, thereby generating a plurality of cleaved polynucleotide fragments; (c) identifying polynucleotide footprints within the cleaved polynucleotide fragments; (d) obtaining a database of transcription factor binding sequences; (e) for each cell type and transcription factor binding sequence, enumerating the number of sequence instances encompassed within each polynucleotide footprint and normalizing this value with the total number of polynucleotide footprints in that cell type; and (f) identifying transcription factor binding sequences with highly cell-specific occupancy patterns. In some embodiments of these aspects, at least a plurality of the transcription factor sequences are localized to distal regulatory regions from respective target genes. In some embodiments of these aspects, the distal regulatory regions are greater than 300 base pairs from the respective target genes. In some embodiments of these aspects, the distal regulatory regions are greater than 400, 500, 700, or 800 base pairs from the respective target genes. In some embodiments of these aspects, the at least two cellular samples are human cellular samples.

In some aspects, provided herein are methods of distinguishing direct versus indirect binding of a polypeptide to genomic DNA comprising: (a) obtaining sequencing data for the genomic DNA, wherein the sequencing data is obtained from sequencing DNA bound to transcription factors isolated by chromatin immunoprecipitation; (b) obtaining DNaseI footprinting data for the genomic DNA; (c) comparing the sequencing data from step (a) with the DNaseI footprinting data; and (d) using a computer or processor to determine whether the sequencing data from step (a) comprises (i) a footprinted sequence, indicating that the transcription factor is directly bound to the genomic DNA; or (ii) no footprinted sequence, indicating that the transcription factor is not directly bound to the genomic DNA. In some embodiments of these aspects, the sequencing is performed by high-throughput sequencing.

In some aspects, provided herein are methods for generating a map of a regulatory network of a cell or organism, comprising: (a) obtaining a library of polynucleotide fragments, wherein the polynucleotide fragments are produced by cleaving a polynucleotide from the cell or organism with a polynucleotide cleaving agent; (b) identifying sequences of the library of polynucleotide fragments by performing an assay; (c) identifying proximal regulatory regions of at least ten polynucleotides, each encoding a different transcription factor, by aligning the sequences of the library of polynucleotide fragments; (d) detecting at least one transcription factor binding sequence within the proximal regulatory region of the polynucleotide encoding each of the transcription factors; (e) identifying recognition sequences for each of the at least ten transcription factors within the remaining polynucleotide fragments within the library of polynucleotide fragments sequence by using information from at least one transcription factor binding sequence database; and (f) using the information from steps (b)-(e) to generate a map of the regulatory network for the cell or organism. In some embodiments of these aspects, the polynucleotide fragments are derived from at least three different cell-types of the same organism. In some embodiments of these aspects, the at least ten polynucleotides of step c is at least 20 polynucleotides. In some embodiments of these aspects, the one or more second polynucleotides are target genes regulated by the first polynucleotides. In some embodiments of these aspects, the proximal regulatory region of the polynucleotide encoding the first transcription factor is within 10 kilobases of a transcriptional start site (TSS) of the polynucleotide encoding the first transcription factor. In some embodiments of these aspects, the identified regulatory regions comprise footprints. In some embodiments of these aspects, the method further comprises analyzing the recognition sequences using at least one algorithm selected from the group consisting of: a normalized network degree algorithm, a network cluster algorithm; and a feed-forward loop algorithm. In some embodiments of these aspects, the method is performed under the control of one or more computers or processors. In some embodiments of these aspects, the recognition sequences is generated so as to determine whether occupancy of at least one identified transcription factor binding sequence by at least one of the plurality of transcription factors controls cell behavior.

In some aspects, provided herein are methods of identifying a first gene that regulates at least a second gene within a sample of polynucleotides: (a) digesting the sample of polynucleotides with a polynucleotide cleaving agent in order to obtain a library of polynucleotide fragments; (b) determining a frequency of polynucleotide cleavage events within about a 30 kb region upstream or downstream of a transcription start site for the target gene; c) if the determined frequency of polynucleotide cleavage events is different, sequencing a set of nucleotides within the plurality of polynucleotide fragments; d) identifying at least one transcription factor binding sequence within the sequenced set of nucleotides using at least one transcription factor binding sequence database; and e) analyzing the regulatory region with an algorithm that creates an ordered regulatory hierarchy of the first and second genes. In some embodiments of these aspects, the algorithm is a feed-forward loop algorithm. In some embodiments of these aspects, the sample of polynucleotides is derived from a normal cell type. In some embodiments of these aspects, the method further comprises repeating steps a)-e) with a polynucleotide sample derived from a malignant cell-type. In some embodiments of these aspects, the method further comprises comparing the first and second genes from the normal cell type with the first and second regulatory genes from the malignant cell-type in order to identify which gene is the driver gene. In some embodiments of these aspects, the driver gene is a driver of cancer or of differentiation. In some embodiments of these aspects, the driver gene is an oncogene or a tumor suppressor gene.

In some aspects, provided herein are methods of diagnosing or predicting the risk of disease in a subject comprising: (a) obtaining a polynucleotide sample derived from the subject, wherein the polynucleotide sample comprises polynucleotides and polynucleotide-binding proteins; b) assaying the polynucleotide sample for the presence or absence of at least two regions of engagement between the polynucleotides and the polynucleotide-binding proteins; and c) diagnosing a disease or predicting the risk of disease in the subject based on the presence or absence of the at least two regions of engagement between the polynucleotides and the polynucleotide-binding proteins. In some embodiments of these aspects, the disease is selected from the group consisting of: cancer, autoimmune disease, neurodegenerative disease, or a metabolic disorder. In some embodiments of these aspects, the polynucleotide-binding proteins are transcription factors. In some embodiments of these aspects, the at least two regions of engagement between the polynucleotides and the polynucleotide-binding proteins are greater than five (5) regions of engagement. In some embodiments of these aspects, the assaying the polynucleotide sample comprises cleaving the polynucleotide with a cleaving agent. In some embodiments of these aspects, the assaying the polynucleotide sample comprises determining the relative frequencies of cleavage along the polynucleotide. In some embodiments of these aspects, the polynucleotide is DNA (e.g., genomic DNA). In some embodiments of these aspects, the method further comprises treating the subject based on the diagnosing the disease or predicting the risk of the disease performed in step (c). In some embodiments of these aspects, the treating comprises reducing gene activity (e.g., by use of a drug or RNAi); in other embodiments, the treating comprises enhancing gene activity (e.g., by use of a drug or gene therapy).

In some aspects, provided herein are methods of identifying an agent that reverses a phenotype comprising: a) contacting polynucleotides with a set of molecules, wherein the polynucleotides have a known cleavage pattern when cleaved with a polynucleotide cleavage agent; b) cleaving the polynucleotides with the polynucleotide cleavage agent in order to obtain a library of polynucleotide fragments; c) analyzing the library of polynucleotide fragments in order to identify a test cleavage pattern; d) comparing the test cleavage pattern with the known cleavage pattern in order to identify test cleavage patterns with cleavage patterns that differ from the known cleavage pattern; and e) identifying molecules within the set of molecules that contacted the polynucleotides with the cleavage pattern that differ from the known cleavage pattern.

In some aspects, provided herein are methods of determining proliferative potential of a cell comprising: a) obtaining a library of polynucleotide fragments, wherein the polynucleotide fragments are generated by digesting polynucleotides of the cell with a polynucleotide cleaving agent; b) identifying regions of cleaving agent hypersensitivity within the library of polynucleotide fragments; and c) determining a relative evolutionary mutation rate within the cleaving agent hypersensitive regions, wherein a high relative evolutionary mutation rate correlates with increased proliferative potential and a low relative mutation rate correlates with decreased proliferative potential. In some embodiments of these aspects, the high relative evolutionary mutation rate is at least two-fold higher than the evolutionary mutation rate in an analogous cleaving agent hypersensitive region in a control cell. In some embodiments of these aspects, the low relative evolutionary mutation rate is at least two-fold lower than the mutation rate in an analogous cleaving agent hypersensitive region in a control cell. In some embodiments of these aspects, the cell is an immortal cell, cancerous cell or stem cell and the relative mutation rate is high. In some embodiments of these aspects, the cell is a differentiated, non-dividing cell and the relative mutation rate is low. In some embodiments of these aspects, the evolutionary mutation rate relates to the relative number of genetic variations within the cleaving agent hypersensitivity region. In some embodiments of these aspects, the genetic variations are single nucleotide polymorphisms. In some embodiments of these aspects, the cleaving agent is DNaseI.

In some aspects, provided herein are methods for generating a map of one or more variants of a set of nucleotides within one or more regulatory regions of a plurality of polynucleotide fragments, comprising: a) determining a frequency of polynucleotide cleavage events throughout a length of the plurality of polynucleotide fragments, wherein the plurality of polynucleotide fragments are generated by digesting, with a polynucleotide cleaving agent, a first polynucleotide in the presence of the plurality of binding proteins; b) detecting whether the determined frequency of polynucleotide cleavage events is different; c) if detected that the determined frequency of polynucleotide cleavage events is different, identifying sequences of a set of nucleotides within the plurality of polynucleotide fragments; d) identifying at least one regulatory region within the plurality of polynucleotide fragments; e) identifying at least one variant of the set of nucleotides within the regulatory region of the plurality of polynucleotide fragments; f) repeating steps (a)-(e) using a second polynucleotide that differs from the first polynucleotide; g) using at least one polynucleotide information database, correlating the variants identified for the first polynucleotide with the variants identified for the second nucleotide so as to generate one or more patterns of variants; and h) annotating the generated patterns using information from the polynucleotide information database to generate the map. In some embodiments of these aspects, further comprising analyzing the generated patterns to identify at least one polynucleotide target of the regulatory region of the first polynucleotide. In some embodiments of these aspects, the method further comprises correlating the variants identified for the first polynucleotide and the variants identified for the second polynucleotide so as to determine a relationship between a polynucleotide target of the first polynucleotide and a polynucleotide target of the second polynucleotide. In some embodiments of these aspects, the determined relationship confers association with a phenotype. In some embodiments of these aspects, the phenotype is selected from the group consisting of: a disease; a state of pathogenesis; a stage of development; a type of tissue; and a type of cell. In some embodiments of these aspects, the first and second polynucleotides are derived from genomic DNA of at least one human cell type. In some embodiments of these aspects, at least one of the identified regulatory regions is a DNA hypersensitivity site. In some embodiments of these aspects, at least one of the identified regulatory regions is a protein binding sequence. In some embodiments of these aspects, the map is generated using an algorithm selected from the group consisting of: a set of genome wide association study algorithms; a gene ontology algorithm; a clustering analysis algorithm; a linear regression analysis algorithm; and a uniform processing algorithm. In some embodiments of these aspects, the method is performed under the control of one or more processors or computers.

In some aspects provided herein, the methods comprise methods of determining whether an allele of a gene of a heterozygous subject is associated with a functional disease phenotype comprising: a) obtaining a polynucleotide sample from the heterozygous subject, wherein the heterozygous subject has a risk allele and a non-risk allele; b) cleaving the polynucleotide sample in order to generate a library of polynucleotide fragments; c) obtaining sequence reads of the polynucleotide fragments; d) using the sequences of step c, identifying the sequence reads within the region encompassing the risk allele and non-risk allele and counting the number of sequence reads for each allele; e) using the numbers from step d, determining a ratio of the risk-allele sequence reads to the non-risk-allele sequence; and f) identifying the risk allele as functional if the ratio of step e is greater than 1:1. In some embodiments of these aspects, the risk allele is a single nucleotide polymorphism. In some embodiments of these aspects, the disease is cancer, diabetes, aging-related disorders, autoimmune disorder, metabolic disorder, neurodegenerative disease, or an inflammatory disorder. In some embodiments of these aspects, the polynucleotide is a fetal polynucleotide. In some embodiments of these aspects, the method further comprises distinguishing a homozygous allele from a heterozygous allele by comparing the polynucleotide fragment pattern to either: (a) known polynucleotide fragment patterns for homozygous alleles; or (b) known polynucleotide fragment patterns for heterozygous alleles.

In some aspects, provided herein are methods of identifying a cell type associated with a disease caused by a genetic variation comprising: a) cleaving a polynucleotide sample in order to obtain a library of polynucleotide fragments, wherein the polynucleotide sample comprises polynucleotides derived from different cell types; b) analyzing the library of polynucleotide fragments in order to obtain a cleavage pattern; c) determining whether the genetic variation perturbs the cleavage pattern across the different cell types; and d) analyzing the library of polynucleotide fragments in order to identify cell types associated with the cleavage patterns identified in step (c), thereby identifying the cell type associated with the disease. In some embodiments, the different cell types are at least 10 different cell types.

In some aspects, provided herein are methods of identifying a regulatory region of a gene comprising: (a) identifying a plurality of DNaseI hypersensitivity sites (DHS) within a gene wherein at least one of the DHS includes a promoter of the gene; (b) computing a pattern of DHS across greater than 10 cell types, wherein the pattern reflect the presence or absence of DHS; (c) computing the pattern of at least one non-promoter DHS within 500 kilobases of the promoter; and (d) correlating the patterns from step (b) and step (c) in order to identify DHS with synchronous patterns across greater than 10 cell types, thereby identifying a distal regulatory region of the gene.

### INCORPORATION BY REFERENCE

All publications, patents, and patent applications mentioned in this specification are herein incorporated by reference in their entireties to the same extent as if each individual publication, patent, or patent application was specifically and individually indicated to be incorporated by reference in their entities.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative cases, in which the principles of the disclosure are utilized, and the accompanying drawings of which:

FIG. 1: Parallel profiling of genomic regulatory factor occupancy across 41 cell types.

FIG. 2: Identification and distribution of DNaseI footprints.

FIG. 3: Distribution of DNaseI footprints.

FIG. 4: Motif density in DNaseI footprints.

FIG. 5: Validation of footprints as potential sites of protein occupancy in vitro.

FIG. 6: DNaseI footprints mark sites of functional in vivo protein occupancy.

FIG. 7: DNaseI footprints mark sites of in vivo protein occupancy.

FIG. 8: Stereotyped cleavage patterns for different TFs.

FIG. 9: Footprint structure parallels transcription factor structure and is imprinted on the human genome.

FIG. 10: A highly stereotyped chromatin structural motif marks sites of transcription initiation in human promoters.

FIG. 11: General transcriptional activators occupy the PIC footprint.

FIG. 12: Distribution of indirect binding by transcription factor.

FIG. 13: Distribution of direct and indirect transcription factor binding.

FIG. 14: Distinguishing direct and indirect binding of transcription factors.

FIG. 15: De novo motif discovery expands the human regulatory lexicon.

FIG. 16: De novo motif discovery in footprints.

FIG. 17: Multi-lineage DNaseI footprinting reveals cell-selective gene regulators.

FIG. 18: Construction of comprehensive transcriptional regulatory networks.

FIG. 19: Cell-specific versus shared regulatory interactions in TF networks of 41 diverse cell types.

FIG. 20: Transcriptional regulatory networks show marked cell-type specificity.

FIG. 21: Functionally related cell types share similar core transcriptional regulatory networks.

FIG. 22: Cell-selective behaviors of widely expressed TFs.

FIG. 23: Conserved architecture of human TF regulatory networks.

FIG. 24: General features of the DHS landscape.

FIG. 25: Three examples of DHSs overlapping microRNA promoters.

FIG. 26: Examples of DHSs in repetitive elements.

FIG. 27: Number of cell types per DHS overlapping four categories of repeat classes.

FIG. 28: Transcription factor drivers of chromatin accessibility.

FIG. 29: Quantifying the impact of transcription factors on chromatin accessibility.

FIG. 30: The occupancies of different transcription factors within accessible chromatin.

FIG. 31: Identification and directional classification of novel promoters.

FIG. 32: Chromatin accessibility and DNA methylation patterns.

FIG. 33: Relationship between TF transcript levels and overall methylation at cognate recognition sequences of the same TFs.

FIG. 34: Cell-specific enhancers (red arrows) in the IFNG locus. Enhancers of the IFNG gene are marked by DHSs in the hTH1 (T lymphocyte) cell-type, consistent with the functioning of lymphocytes in producing the gene product interferon gamma.

FIG. 35: Enrichments of 5C interactions, ChIA-PET interactions, and gene ontology classes revealed by signal-vector correlation.

FIG. 36: Genome-wide map of distal DHS-to-promoter connectivity.

FIG. 37: Statistical significances of co-occurrences of motifs and families and classes of motifs within connected (r>0.8) distal/promoter DHS pairs genome-wide.

FIG. 38: Stereotyped regulation of chromatin accessibility.

FIG. 39: Clustering of ˜290,000 DHSs by cross-cell-type patterns using a self-organizing map (SOM), which learns patterns in the data and organizes DHSs into stereotyped groups analogous to those shown in FIG. 38a-e.

FIG. 40: Color-coded key to the signal height vectors used as input for the SOM of FIG. 39.

FIG. 41: The number of instances of each pattern discovered by the SOM illustrated in FIG. 39 heat map.

FIG. 42: Genetic variation in regulatory DNA linked to mutation rate.

FIG. 43: Diseases and traits studied by GWAS and distribution of GWAS variants.

FIG. 44: Disease-associated variation is concentrated in DNaseI hypersensitive sites.

FIG. 45: Multiple distinct genomic disease associations repeatedly localize within relevant cell-selective DHSs.

FIG. 46: Localization of GWAS SNPs in DHSs of fetal and adult tissue classes.

FIG. 47: Enrichment of GWAS SNPs for DHSs by disease/trait.

FIG. 48: Regulatory GWAS variants are linked to distant target genes.

FIG. 49: Candidate regulatory roles for GWAS SNPs.

FIG. 50: GWAS variants in DHSs localize within physiologically relevant TF binding sites.

FIG. 51: Allelic imbalance distribution.

FIG. 52: Common disease-associated variants cluster in regulatory pathways.

FIG. 53: Common disease networks. GWAS SNPs from related diseases repeatedly perturb recognition sequences of common transcription factors.

FIG. 54: Identification of pathogenic cell types. GWAS SNPs are systematically enriched in the regulatory DNA of disease-specific cell types throughout the full range of significance.

FIG. 55: Flow chart depicting acquisition of a sample from a subject.

FIG. 56A-B: Flow chart depicting a control assembly.

FIG. 57: Diagram depicting a kit.

### DETAILED DESCRIPTION

The methods and compositions described herein may be used to determine the pattern of proteins binding at sites within a nucleic acid. The methods and compositions may further be used to correlate the protein-binding pattern to expression of genes within a nucleic acid sample or across multiple samples of nucleic acids. The methods and compositions may be used to construct a regulatory network within a nucleic acid sample or across multiple samples of nucleic acids. The methods and compositions may be used to determine the state of development, pluripotency, differentiation and/or immortalization of a nucleic acid sample; establish the temporal state of a nucleic acid sample; identify the physiologic and/or pathologic condition of the nucleic acid sample. In some cases, a nucleic acid sample may be treated with a footprinting method. The footprinting method may include DNaseI mapping and/or digital genomic footprinting.

Identification of Occupancy Events within Regulatory Regions.

This disclosure provides compositions and methods for predicting gene activation, transcription initiation, protein binding patterns, protein binding sites and chromatin structure. In some cases, the methods and compositions provided herein can be used to detect temporal information about gene expression (e.g., past, future or present gene expression or activity). For example, the information may describe a gene activation event that occurred in the past. In some cases, the information may describe a gene activation event in the present. In some cases, the information may predict gene activation. The methods and compositions described herein may be used to describe a physiologic state or a pathologic state. In some cases, the pathologic state may include the diagnosis and/or prognosis of a disease.

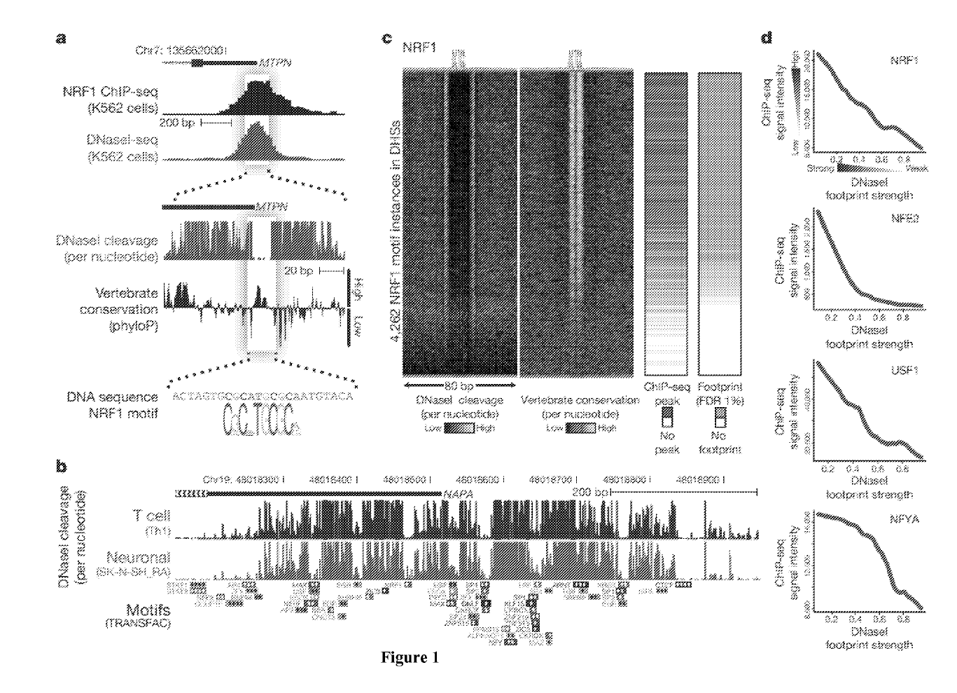

In some cases, this disclosure provides compositions and methods for digestion of a sample containing a nucleic acid (e.g., genomic DNA) with a cleavage agent. The cleavage agent may cleave the nucleic acid (e.g., genomic DNA) to create footprints (e.g., FIG. 1). In some cases, the footprints may be created at sites where the nucleic acid (e.g., genomic DNA) is bound by a factor. In some cases, the factor may be a protein. In some cases, the protein may be a binding protein. In some cases, the binding protein may be a transcription factor. In some cases, the footprints may be created at sites where the shape of the nucleic acid (e.g., genomic DNA) is such that a cleavage agent may have increased access to the backbone. In some cases, the footprints may be created at sites where the shape of the nucleic acid (e.g., genomic DNA) is such that a cleavage agent may have decreased access to the backbone.

Using the methods described herein, millions of sites where transcription factors bind a nucleic acid (e.g., genomic DNA) can be identified. In some cases, the binding of a transcription factor to a nucleic acid may be an occupancy event. In some cases, an occupancy event may occur within a regulatory region. These occupancy events may represent differential binding of a plurality of transcription factors to numerous distinct elements. In some cases, the number of distinct elements engaged or bound by transcription factors is greater than 10, 50, 500, 1000, 2500, 5000, 7500, 10000, 25000, 50000, or 100000. The distinct elements can be short sequence elements within a longer nucleic acid sequence. Differential binding of transcription factors to sequence elements can comprise a genomic sequence compartment that may encode a repertoire of conserved recognition sequences for binding proteins (e.g., DNA binding proteins). The genomic sequence compartment may include sites previously known as well as tens, hundreds, thousands, or even millions of novel sites that may have not yet been identified until use of the methods described herein. In some cases, the methods may be used to determine a cis-regulatory lexicon which may contain elements with evolutionary, structural and functional profiles.

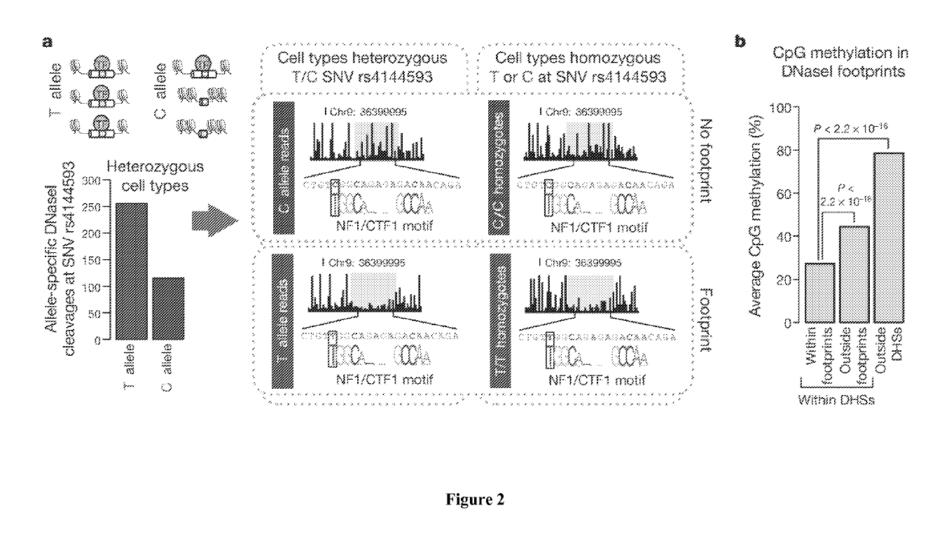

The ability to resolve the sequence of footprints may depend on the depth and level of sequencing at sites of cleavage (e.g., by DNaseI). The methods provided herein describe sequencing of unique footprints at DHSs across multiple cell types (e.g., FIG. 2). In some cases, genetic variants that may affect allelic chromatin states may be identified. In some cases, the genetic variants may alter binding of proteins to the DNA sequence. In some cases, the genetic variants may be located in footprints that may not be subject to modifications (e.g., DNA methylation). In some cases, the identification of variants may affect the correlation of genetic variants within footprints.

The methods provided herein may be used to identify binding proteins (e.g., DNA-binding proteins) which recognize novel nucleic acid (e.g., DNA) sequences. In some cases, the identification of binding proteins and recognition sequences can be performed in vivo. In some cases, the identification of binding proteins and recognition sequences can be performed in vitro. In some cases, the identification of binding proteins and recognition sequences may be performed in a sample taken from a single organism. In some cases, the identification of binding proteins and recognition sequences may be performed in a sample taken from a different organism. In some cases, the identification of binding proteins and recognition sequences may be analyzed across samples taken from at least one organism. For example, the analysis may determine that the identification of binding proteins and recognition sequences may have evolutionary functional signatures.

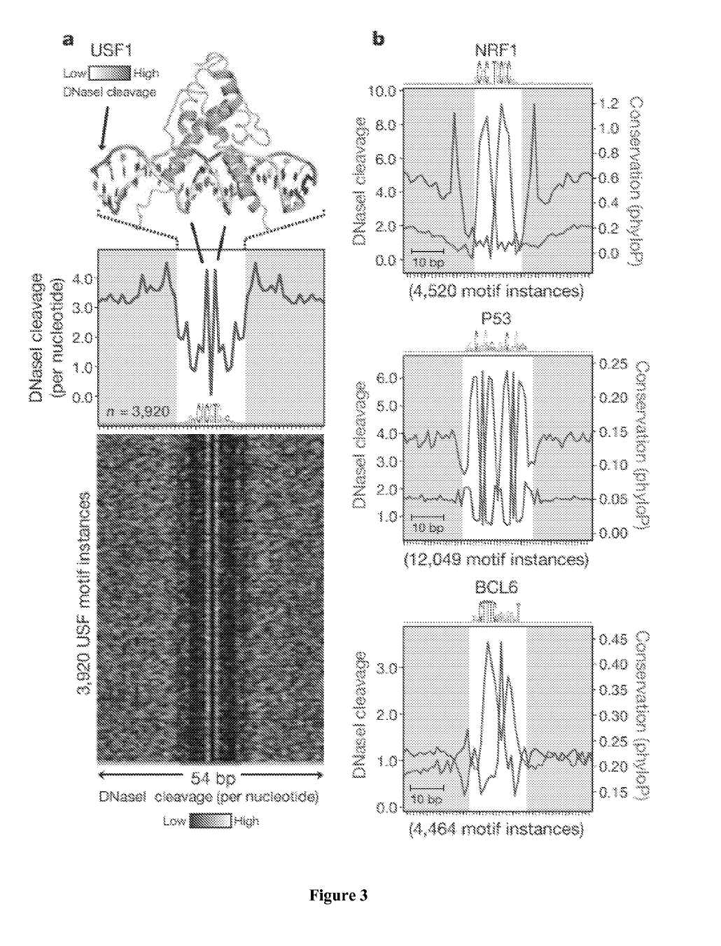

The methods provided herein may be used to determine high-resolution patterns of cleavage events across a nucleic acid. In some cases, the cleavage events may be performed by an enzyme (e.g., DNaseI). In some cases, the interfaces and structures of protein-DNA interactions may be determined using crystallographic topography interfaces (e.g., FIG. 3). The crystallographic topography interfaces may be compared across a plurality of species, to identify evolutionary conservation. The patterns of cleavage events may be compared across species, tissue, cell and/or sample types to demonstrate evolutionary conservation of genetic variants at the nucleotide-level.

Regulatory regions in the nucleic acid (e.g, genomic DNA) sequence may control the expression of at least one gene. Regulatory regions are sites at which at least one protein binds to the nucleic acid and upon binding of a protein to the nucleic acid, may elicit an effect upon gene expression. In some cases, the regulatory regions can be promoters.

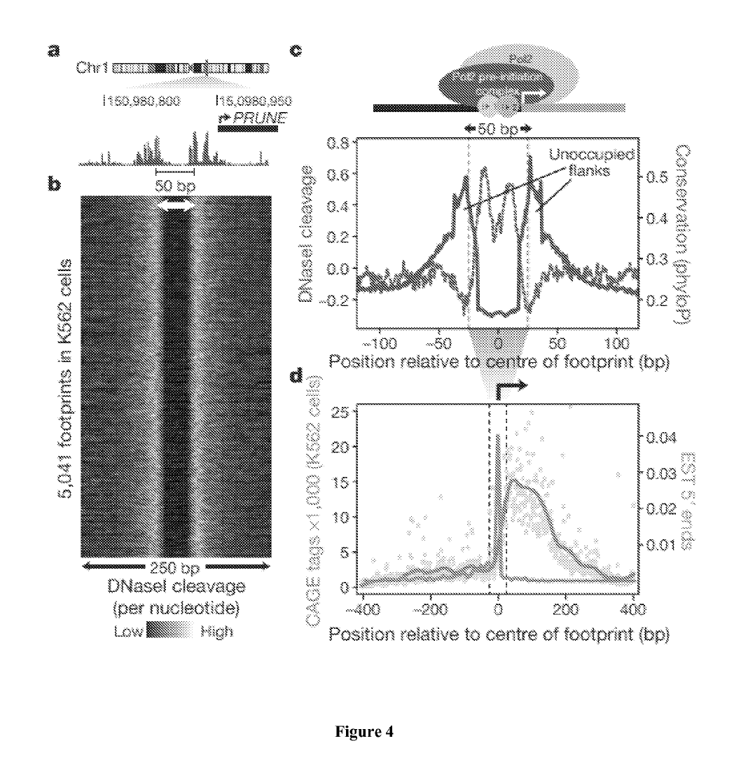

Using the methods described herein, a footprint (e.g., 50-base-pair) located in a regulatory region can be located. The footprint (e.g., about 50 base pairs) may precisely define the site of transcript origination within a promoter and can be identified. In some cases, a plurality of footprints (e.g., about 50 base pairs) in a plurality of promoters may be identified across a genome (e.g., FIG. 4). The sequence of the footprint may vary depending on the promoter in which the footprint is located however the pattern of proteins bound at the footprint may be common across at least one gene and at least one organism.

The methods further provide for the identification of novel regulatory factor recognition motifs. In some cases, the novel regulatory factor recognition motifs may be conserved in sequence and/or function across multiple genes, cell and/or tissue types within one species. In some cases, the recognition motifs may be conserved in sequence and/or function across multiple genes, cell and/or tissue types across a plurality of species. In some cases, the novel regulatory factor recognition motifs may not be conserved in sequence and/or function across multiple genes, cell and/or tissue types within one species. In some cases, the novel regulatory factor recognition motifs may not be conserved in sequence and/or function across multiple genes, cell and/or tissue types across a plurality of species. The novel regulatory factor recognition motifs may have cell-selective patterns of occupancy by one, or more than one, unique binding protein. The novel regulatory factor recognition motifs may not have cell-selective patterns of occupancy by one, or more than one, unique binding protein. In some cases, the novel regulatory factor recognition motifs may be arranged in a table, for example, a motif table.

The novel regulatory factor recognition motifs may have a pattern of occupancy for at least one gene in at least one cell type. For example, binding proteins located at recognition motifs may exhibit a pattern of occupancy. In some cases, the novel regulatory factor recognition motifs may have a pattern of occupancy for at least one gene in at least one cell type may be the same across a plurality of cell types. In some cases, the pattern of occupancy for at least one gene may also vary across a plurality of cell types, tissue types and/or organisms. In some cases, the pattern of occupancy for at least one gene may not vary across a plurality of cell types, tissue types and/or organisms. In some cases, the bound proteins and/or pattern of occupancy may regulate development, differentiation and/or pluripotency. In some cases, the motifs and/or the binding proteins exhibiting a pattern of occupancy may regulate differentiation. In some cases, the motifs and/or the binding proteins may be identified. In some cases, a map of the motifs and/or the binding proteins which may regulate differentiation may be generated.

Identification of a Regulatory Network.

Sequence-specific transcription factors (TFs) may control cell behavior. In some cases, the TFs may control behavior of a gene. TFs can bind to a region of a nucleic acid (e.g., genomic DNA). In some cases, the region may be a regulatory region. In some cases, the regulatory region may be a promoter, an enhancer, and/or a transcription start site. In some cases, the bound TF can regulate hundreds to thousands of downstream genes. For example, the TF may regulate expression of other TFs, and/or expression of itself. When bound to the target nucleic acid sequence, TFs may be identified using a footprinting method. In some cases, the footprinting method may be the DNaseI footprinting method. In some cases, the method of digital genomic footprinting may be used. For example, digital genomic footprinting may identify millions of DNase1 footprints across the genome in a plurality of cell types. The digital genomic footprinting method may further be used to identify cell- and/or lineage-selective transcriptional regulators.

Maps of DNase1 footprints may be assembled to depict a regulatory network (e.g., transcription factor network). Such maps of regulatory networks may provide a description of the circuitry, dynamics, and/or organizing principles of a regulatory network. For example, the maps may be generated from a library of polynucleotide fragments which, in some cases, may contain footprints. In some cases, the maps may include footprints across the entire genome. For example, the maps may be generated by aligning at least one library of polynucleotide fragments with at least one different library of polynucleotide fragments. In some cases, the polynucleotide fragment may be sequenced. In some cases, the aligning may be aligning the sequence of at least one polynucleotide with the sequence of at least one different polynucleotide. In some cases, the aligning may not include sequencing of at least one polynucleotide fragment. For example, the aligned libraries may include information that can be analyzed to determining a regulatory network. In some cases, the regulatory network can illustrate connections between hundreds of sequence-specific TFs. In some cases, the regulatory network can be used to analyze the dynamics of these connections across a plurality of cell and tissue types.

In some cases, a regulatory network map for a cell type and a regulatory map for a different cell type may be generated. For example a regulatory map for a first cell type and a regulatory map for a second cell type may be compared. In some cases, the comparison may generate a different regulatory map that integrates the regulatory network map from the first cell type with the second cell type. In some cases, an integrated regulatory map may be generated. For example, the integrated regulatory map may also be generated from a plurality of cell types, tissues, organs and/or organisms.

Among a complement of TFs expressed in a given cell type, a core transcriptional regulatory network may be identified. The core transcriptional regulatory network may be used to integrate complex cellular signals. The methods described herein provide for an accurate and scalable approach to identify transcriptional regulatory networks. In some cases, the method may be suitable for the collection of information from a plurality of experiments, from a plurality of cell types and/or from a plurality of TFs. In some cases, the methods can be used with a large number of TFs and/or cellular states.

Identification of the cross-regulation of hundreds of sequence-specific TFs, across genes within the same cell and tissue type or across a plurality of cell and tissue types, may be performed using the methods described herein. Iterating or repeating this paradigm across diverse cell types may provide a system for analysis of TF network dynamics in an organism.

In some cases, the methods described herein may be combined with DNaseI footprinting to determine if any regulatory interactions are present between a plurality of TFs. In some cases, mutual cross-regulation of target genes among at least one group of TFs may define a regulatory subnetwork which may contribute to the control of cell identity and function (e.g., pluripotency, development, and/or differentiation).

In some cases, such cross-regulation may comprise a part of a regulatory network wherein the regulatory network may control cellular identity and/or function. In such networks, TFs comprise the network nodes. In some cases, the cross-regulation of one TF by another may occur through the interactions or network edges. In some cases, the methods described herein may be used to determine the structure of a plurality of core regulatory networks and their component subnetworks.

Using the methods described herein, cell-selective TF networks can be determined. In some cases the methods can be used to analyze the activities of multiple TFs within the same cellular environment. In some cases, the cell-selective TF networks may comprise a plurality of factors which may include previously unidentified regulators. In some cases, the previously unidentified regulators may control cellular identity.

In some cases, networks may be constructed de novo. In some cases, the networks may be constructed in the native cellular context. The construction of networks in the native cellular context may use a plurality of approaches (e.g., a high-throughput approach). In some cases, the approach may be based on gene expression data. The approaches may be used to identify cis-regulatory element binding partners. In some cases, the systematic analysis of TF footprints in the regulatory regions of each TF gene may generate a comprehensive and/or unbiased map of the complex network of regulatory interactions between TFs.

This disclosure provides methods for identifying a regulatory state of a cell derived from a subject. The methods may include: obtaining a polynucleotide sample derived from the cell, wherein the polynucleotide sample comprises greater than 60% of the total number of polynucleotides within a polynucleotide compartment within the cell (or greater than about 50%, 55%, 60%, 65%, 70%, 75%, 80%, 85%, 90%, or 95% of the total number of polynucleotides within a polynucleotide compartment within the cell); b) cleaving the polynucleotide sample with a polynucleotide cleaving agent in order to obtain a library of polynucleotide fragments representing regions of the polynucleotide that are engaged with at least one other biomolecule; c) analyzing the library of polynucleotide fragments in order to obtain data reflecting a frequency of cleavage events for greater than 50% of the nucleotide sites in the polynucleotide sample, (or for greater than about 50%, 55%, 60%, 65%, 70%, 75%, 80%, 85%, 90%, or 95% of the nucleotide sites in the polynucleotide sample); and/or d) identifying a regulatory state of the cell by applying an algorithm to the data of step (c). In some cases, the regulatory state may be a state of on- or off-gene activity. The algorithm may be generated by comparing sequence and cleavage data of reference polynucleotides with sequence and cleavage data from databases of known transcription factors, wherein the reference polynucleotides are obtained from greater than ten different cell types or cell states, or combination thereof. In some cases, the reference polynucleotides comprise polynucleotide cleavage (e.g., DNaseI cleavage) data.

Determination of Relationships Between Chromatin and Regulatory Factors.

Regions of regulatory nucleic acid (e.g., genomic DNA) sequences may include DHSs. The methods described herein can be used to generate a map of DHSs that may be identified through genome-wide profiling in a plurality of cell and tissue types. In some cases, the methods can be used to identify hundreds, thousands, or millions of DHSs (e.g., greater than 100, 500, 1×10³, 1×10⁴, 5×10⁴, 1×10⁵, 5×10⁵, 1×10⁶, 2×10⁶, 3×10⁶, 4×10⁶, 5×10⁶, 6×10⁶, 7×10⁶, 8×10⁶, 9×10⁶, 1×10⁷, 2×10⁷, 3×10⁷, 4×10⁷, 5×10⁷, 6×10⁷, 7×10⁷, 8×10⁷, 9×10⁷ or 1×10⁸DHS).

In some cases, the regulatory regions and DHSs may be associated with cis-regulatory elements (e.g., enhancers, promoters, insulators, silencers and/or locus control regions). The identified DHSs may include experimentally validated cis-regulatory sequences as well as recently identified novel elements. In some cases, the cis-regulatory sequences may be regulated in a cell-selective manner. In some cases, the methods may be used to analyze cell-selective gene regulation. In some cases, the cell-selective gene regulation can be used for identification of systematic long-distance regulatory patterns within a nucleic acid (e.g., genomic DNA).

The methods may be further used to connect distal DHSs to a promoter that may be affected by the DHSs. In some cases, the connected DHSs may reveal a correlation between different classes of distal DHSs and/or types of promoters. In some cases, DHSs may be located within at least one regulatory region or within close proximity to at least one regulatory region. In some cases, DHSs within regulatory regions or within close proximity to regulatory regions may be related to co-activated elements (e.g., greater than 100, 1×10³, 5×10³, 1×10⁴, 5×10⁴, 1×10⁵, 5×10⁵, 1×10⁶ co-activated elements) and may predict cell-type specific behavior. For example, the DHS compartments in pluripotent and immortalized cells may exhibit higher mutation rates than DHS compartments in highly differentiated cells.

In some cases, the elements (e.g., cis-regulatory sequences) identified using the methods described herein may be annotated using a plurality of databases. In some cases, annotating these elements may generate a map of novel relationships between chromatin accessibility, transcription, DNA methylation and/or regulatory factor occupancy patterns. In some cases, the methods may be used to uncover previously undescribed phenomena. For example, in some cases, the methods may be used to correlate a DHS landscape to a functional evolutionary constraint. For example, the methods may be used to identify stereotyping of DHS activation and mutation rate variation in normal versus immortal cells.

Identification of DHSs and Gene Targets Associated with Diseases and/or Traits.

Disease- and trait-associated genetic variants may be identified with genome-wide association studies (GWAS). In some cases, disease- and trait-associated variants that may be identified from GWAS studies may lie within non-coding nucleic acid (e.g., genomic DNA) sequence. The variants may span diverse diseases and quantitative phenotypes. In some cases, the variants may be associated with a phenotype. In some cases, the phenotype may be a disease. For example, variants associated with a phenotype (e.g., a disease) may be arranged into networks. In some cases, the networks may be disease networks, for example, that may provide information about the variants and related diseases. In some cases, variants may be enriched within expression quantitative trait loci (eQTL).

The disclosure provides methods for the identification of disease- and/or trait-associated variants which may lie in non-coding nucleic acid sequences. In some cases, the non-coding nucleic acid sequences may be located within transcriptional regulatory mechanisms. For example, variants within non-coding nucleic acid sequences may affect a gene. In some cases, the effect upon a gene may be connected to a transcriptional regulatory mechanism.

Variants may affect the nucleic acid sequence of regulatory regions. The regulatory regions may be marked by DHSs. In some cases, the regulatory regions may be promoters and/or enhancers. In some cases, the variants located in regulatory regions may be active during fetal development. In some cases, the variants located in regulatory regions may be silent during fetal development. In some cases, the variants located in regulatory regions may be enriched for gestational exposure-related phenotypes. In some cases, the variants located in regulatory regions may be not be enriched for gestational exposure-related phenotypes.

In some cases, genome-wide cleavage (e.g., DNaseI) mapping in a plurality of cell and tissue samples may be performed. The cell and tissue samples may include several classes of cell types (e.g., cultured primary cells with limited proliferative potential; cultured immortalized, malignancy-derived or pluripotent cell lines; terminally differentiated cells, self-renewing cells, primary hematopoietic cells; purified differentiated hematopoietic cells; cells infected with a pathogen (e.g., virus) and/or a variety of multipotent progenitor and pluripotent cells). In some cases, genome-wide DNaseI mapping may be performed using a plurality of post-conception fetal tissue samples.

Maps may be generated which depict the regulation of distant gene targets for hundreds of DHSs (e.g., target genes located greater than 10 bp, 20 bp, 40 bp, 50 bp, 100 bp, 500 bp, 1000 bp, 2000 bp, or 5000 bp from a regulatory DHS). In some cases, the distant gene targets for the DHSs may be correlated with the phenotype of the nucleic acid from which the sample was derived. In some cases, the maps may identify disease-associated variants. For example, disease-associated variants may disrupt transcription factor recognition sequences, alter allelic chromatin states, and/or form regulatory networks which differ from those in the non-diseased state. In some cases, the method may be used to determine the tissue-selective enrichment of disease-associated variants within DHSs. For example, the method may be used for the identification of pathogenic cell types (e.g., Crohn's disease, multiple sclerosis, and/or an electrocardiogram trait).

The disclosure further provides for a method of data analysis. In some cases, a uniform processing algorithm may be used to identify DHSs and the surrounding boundaries of DNaseI accessibility (e.g., the nucleosome-free region harboring regulatory factors). In some cases, greater than 100, 500, 1×10³, 5×10³, 1×10⁴, 2×10⁴, 3×10⁴, 5×10⁴, 6×10⁴, 7×10⁴, 8×10⁴, 9×10⁴, 1×10⁵, 2×10⁵, 3×10⁵, 4×10⁵, 5×10⁵, 6×10⁵, 7×10⁵, 8×10⁵, 9×10⁵, 1×10⁶, 2×10⁶, 3×10⁶, 4×10⁶, 5×10⁶, 6×10⁶, 7×10⁶, 8×10⁶, 9×10⁶, 1×10⁷, 2×10⁷, 3×10⁷, 5×10⁷, 7×10⁷, or 1×10⁸ DHSs per cell type may be identified.

In some cases, millions of distinct DHS positions at unique nucleotides along the genome may be detected in one or more cell or tissue types. For example, DHS along the genome may interact with a gene in one or more cell or tissue types. In some cases, the interaction of DHs with a gene may be depicted in a map. In some cases, the map may be organized into a table.

Samples.

In the disclosure provided herein, samples can include any biological material which may contain nucleic acid. Samples may originate from a variety of sources. In some cases, the sources may be humans, non-human mammals, mammals, animals, rodents, amphibians, fish, reptiles, microbes, bacteria, plants, fungus, yeast and/or viruses.

Nucleic acid samples provided in this disclosure can be derived from an organism. In some cases, an entire organism may be used. In some cases, portion of an organism may be used. For example, a portion of an organism may include an organ, a piece of tissue comprising multiple tissues, a piece of tissue comprising a single tissue, a plurality of cells of mixed tissue sources, a plurality of cells of a single tissue source, a single cell of a single tissue source, cell-free nucleic acid from a plurality of cells of mixed tissue source, cell-free nucleic acid from a plurality of cells of a single tissue source and cell-free nucleic acid from a single cell of a single tissue source and/or body fluids. In some cases, the portion of an organism is a compartment such as mitochondrion, nucleus, or other compartment described herein. In some cases, the portion of an organism is cell-free nucleic acids present in a fluid, e.g., circulating cell-free nucleic acids. For example, the cell-free nucleic acids may be fetal nucleic acids circulating in a a fluid (e.g., blood) of a mother.

In some cases, the tissue can be derived from any of the germ layers. In some cases, the germ layers may be neural crest, endoderm, ectoderm and/or mesoderm. The germ layers may give rise to any of the following tissues, connective tissue, skeletal muscle tissue, smooth muscle tissue, nervous system tissue, epithelial tissue, ectodermal tissue, endodermal tissue, mesodermal tissue, endothelial tissue, cardiac muscle tissue, brain tissue, spinal cord tissue, cranial nerve tissue, spinal nerve tissue, neuron tissue, skin tissue, respiratory tissue, reproductive tissue and/or digestive tissue. In some cases, the organ can be derived from any of the germ layers. In some cases, the germ layers may give rise to any of the following organs, adrenal glands, anus, appendix, bladder, bones, brain, bronchi, ears, esophagus, eyes, gall bladder, genitals, heart, hypothalamus, kidney, larynx, liver, lungs, large intestine, lymph nodes, meninges, mouth, nose, pancreas, parathyroid glands, pituitary gland, rectum, salivary glands, skin, skeletal muscles, small intestine, spinal cord, spleen, stomach, thymus gland, thyroid, tongue, trachea, ureters and/or urethra. In some cases, the organ may contain a neoplasm. In some cases, the neoplasm may be a tumor. In some cases, the tumor may be cancer.

In some cases, the cell can be derived from any tissue. In some cases, the cell may include exocrine secretory epithelial cells, hormone secreting cells, keratinizing epithelial cells, wet stratified barrier epithelial cells, sensory transducer cells, autonomic neuron cells, sense organ and peripheral neuron supporting cells, central nervous system neurons, glial cells, lens cells, metabolism and storage cells, kidney cells, extracellular matrix cells, contractile cells, blood and immune system cells, germ cells, nurse cells and/or interstitial cells.

In some cases, body fluids may be suspensions of biological particles in a liquid. For example, a body fluid may be blood. In some cases, blood may include plasma and/or cells (e.g., red blood cells, white blood cells, circulating rare cells) and/or platelets. In some cases, a blood sample contains blood that has been depleted of one or more cell types. In some cases, a blood sample contains blood that has been enriched for one or more cell types. In some cases, a blood sample contains a heterogeneous, homogenous or near-homogenous mix of cells. Body fluids can include, for example, whole blood, fractionated blood, serum, plasma, sweat, tears, ear flow, sputum, lymph, bone marrow suspension, lymph, urine, saliva, semen, vaginal flow, feces, transcervical lavage, cerebrospinal fluid, brain fluid, ascites, breast milk, vitreous humor, aqueous humor, sebum, endolympth, peritoneal fluid, pleural fluid, cerumen, epicardial fluid, and secretions of the respiratory, intestinal and/or genitourinary tracts. In some cases, body fluids can be in contact with various organs (e.g. lung) that contain mixtures of cells.

In some cases, body fluids can contain at least one cell. Cells may include, for example, cells of a malignant phenotype; fetal cells (e.g., fetal cells in maternal peripheral blood); tumor cells, (e.g., tumor cells which have been shed from tumor into blood and/or other bodily fluids); cancerous cells; immortal cells; stem cells; cells infected with a virus, (e.g., cells infected by HIV); cells transfected with a gene of interest; aberrant subtypes of T-cells and/or B-cells present in the peripheral blood of subjects afflicted with autoreactive disorders. In some cases, the cell may be one of the following, erythrocytes, white blood cells, leukocytes, lymphocytes, B cells, T cells, mast cells, monocytes, macrophages, neutrophils, eosinophils, dendritic cells, stem cells, erythroid cells, cancer cells, tumor cells or cell isolated from any tissue originating from the endoderm, mesoderm, ectoderm and/or neural crest tissues. Cells may be from a primary source and/or from a secondary source (e.g, a cell line). The body fluids may also contain polynucleotides, e.g., cell-free fetal polynucleotides or DNA circulating in maternal blood.

In some cases, the nucleic acids within a sample are bound to one or more proteins. Cells or nucleic acids may be treated with an agent to enhance binding of proteins. In some cases, the agent may be a chemical agent, a source of temperature change, a source of sound energy, a source of optical energy, a source of light energy, and/or a source of heat energy. In some cases, chemical agent may be a fixative. The nucleic acid may not be treated with an agent to enhance binding of proteins.

In some cases, the nucleic acids within a sample may be located within a region of a cell or a cellular compartment. In some cases, the region or compartment of a cell may include a membrane, an organelle and/or the cytosol. For example, the membranes may include, but are not limited to, nuclear membrane, plasma membrane, endoplasmic reticulum membrane, cell wall, cell membrane and/or mitochondrial membrane. In some cases, the membranes may include a complete membrane or a fragment of a membrane. For example, the organelles may include, but are not limited to, the nucleolus, nucleus, chloroplast, plastid, endoplasmic reticulum, rough endoplasmic reticulum, smooth endoplasmic reticulum, centrosome, golgi apparatus, mitochondria, vacuole, acrosome, autophagosome, centriole, cilium, eyespot apparatus, glycosome, glyoxysome, hydrogenosome, lysosome, melanosome, mitosome, myofibril, parenthesome, peroxisome, proteasome, ribosome, vesicle, carboxysome, chlorosome, flagellum, magenetosome, nucleoid, plasmid, thylakoid, mesosomes, cytoskeleton, and/or vesicles. In some cases, the organelles may include a complete membrane or a fragment of a membrane. For example, the cytosol may be encapsulated by the plasma membrane, cell membrane and/or the cell wall.

In some cases, the sample comprises biomolecules such as proteins. The proteins may be, but are not limited to, nuclear proteins, cytoplasmic proteins, extracellular proteins, membrane bound proteins. In some cases, nuclear proteins may be transcription factors, polymerases, nucleosomes, receptors, and/or segments of proteins. In some cases, cytoplasmic proteins may be transcription factors, polymerases, receptors, and/or segments of proteins. In some cases, extracellular proteins may be transcription factors, polymerases, receptors, and/or segments of proteins. In some cases, membrane bound proteins may be transcription factors, polymerases, receptors, and/or segments of proteins.

In some cases, the sample comprises regulatory proteins. In some cases, the regulatory proteins may be transcription factors, polymerases, nucleosomes, receptors and/or segments of proteins. The samples may be treated with an agent that causes modifications to the regulatory proteins. In some cases, the modifications may include, but are not limited to, myristoylation, pamitoylation, isoprenylation, glypiation, lipoylation, favinylation, heme C modified, phosphopantetheinylation, retinylidene Schiff base modified, diphthamide modified, ethanolamine phosphoglycerol modified, hypusine modified, acylation modified, formylation modified, alkylation modified, amide modified, butyrylation modified, gamma-carboxylation modified, glycosylation modified, malonylation modified, hydroxylation modified, iodination modified, nucleotide addition modified, oxidation modified, phosphate ester modified, propionylation modified, proglutamate modified, S-glutathionylation modified, S-nitrosylation modified, succinylation modified, sulfonation modified, selenoylation modified, glycation modified, biotinylation modified, pegylation modified, ISGylation modified, SUMOylation modified, ubiquitination modified, Neddylation modified, Pupylation modified, citrullination modified, deamidation modified, elimyation modified, carbamylation modified, disulfide bridge modified, methylation modified, and/or lysine modified. In some cases, the modifications may occur at one site on the protein. In some cases, the modifications may occur at more than one site on the protein.

In some cases, the sample comprises proteins which may be homologs. In some cases, the homologs may consist of one subunit. In some cases, the homologs may consist of more than one subunit. In some cases, the sample comprises proteins which may be heterologs. In some cases, the heterologs may consist of one subunit. In some cases, the heterologs may consist of more than one subunit.

In some cases, the sample comprises nucleic acids that are not bound to protein. The nucleic acids may be treated with an agent to reduce protein binding, remove bound proteins and/or prevent protein binding. In some cases, the agent may be a chemical agent, a source of temperature change, a source of sound energy, a source of optical energy, a source of light energy, and/or a source of heat energy. In some cases, the chemical agent may be an enzyme. In some cases, the enzyme may cleave the bonds between amino acids of a protein.

Samples comprising nucleic acids may comprise deoxyribonucleic acid (DNA), genomic DNA, mitochondrial DNA, complementary DNA, synthetic DNA, plasmid DNA, viral DNA, linear DNA, circular DNA, double-stranded DNA, single-stranded DNA, digested DNA, fragmented DNA, ribonucleic acid (RNA), small interfering RNA, messenger RNA, transfer RNA, micro RNA, duplex RNA, double-stranded RNA and/or single-stranded RNA.

In some cases, nucleic acid (e.g., genomic DNA) may be the entire genome of a species, such as viruses, yeast, bacteria, animals, and plants. The nucleic acid (e.g., genomic DNA) may be from still higher life forms (e.g., human genomic DNA). In some cases, the nucleic acid (e.g., genomic DNA) may comprise one or more chromatid fibers, or at least 25%, 50%, 75%, 80%, 90%, 95%, or 98% of the nucleic acid (e.g., genomic DNA) of the species or of an organism or cell.

In some cases, the sample may be a biological sample. In some cases, the biological sample may include cell cultures, tissue sections, frozen sections, biopsy samples and autopsy samples. In some cases, the biological sample may be obtained for histologic purposes.

The sample can be a clinical sample, an environmental sample or a research sample. Clinical samples can include nasopharyngeal wash, blood, plasma, cell-free plasma, buffy coat, saliva, urine, stool, sputum, mucous, wound swab, tissue biopsy, milk, a fluid aspirate, a swab (e.g., a nasopharyngeal swab), and/or tissue, among others. Environmental samples can include water, soil, aerosol, and/or air, among others. Research samples can include cultured cells, primary cells, bacteria, spores, viruses, small organisms, any of the clinical samples listed above. Additional samples can include foodstuffs, weapons components, biodefense samples to be tested for bio-threat agents, suspected contaminants, and so on.

Samples can be collected for diagnostic purposes (e.g., the quantitative measurement of a clinical analyte such as an infectious agent) or for monitoring purposes (e.g., to monitor the course of a disease or disorder). For example, samples of polynucleotides may be collected or obtained from a subject having a disease or disorder, at risk of having a disease or disorder, or suspected of having a disease or disorder.

Sample Acquisition and Processing.

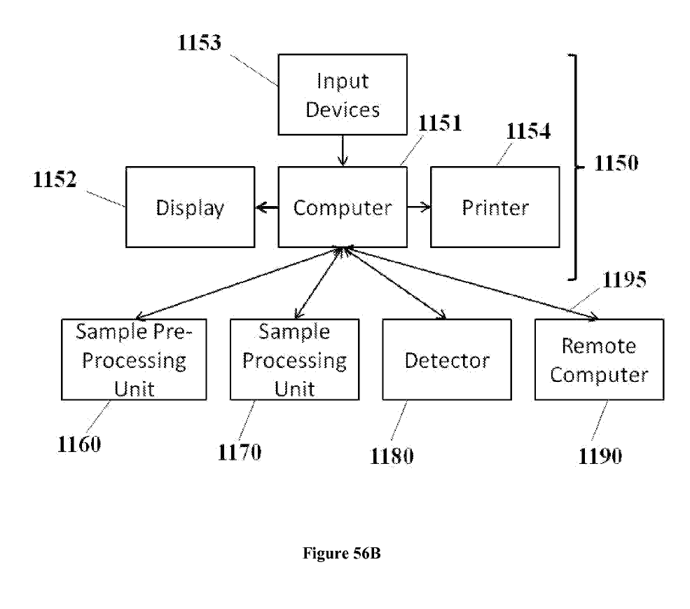

Often, a sample provided herein is collected from a patient or subject 100 at a particular location as depicted in FIG. 56. Examples of a location for sample collection include but are not limited to: a laboratory, a CLIA laboratory, a diagnostic laboratory, a hospital, an ambulance, or an accident site. The sample may be collected using a sample collector, such as a swab, a sample card, a specimen drawing needle, a pipette, a syringe, and/or by any other suitable method. Furthermore, pre-collected samples can be stored in wells such as a single well or an array of wells in a plate, can be dried and/or frozen, can be put into an aerosol form, or can take the form of a culture or tissue sample prepared on a slide.

In some cases, the location where the sample is collected is the same location where the sample is processed. In some cases, the sample is collected at a particular location and is processed at a different location. Processing of a sample may include such techniques as isolating polynucleotides (e.g., genomic DNA, mitochondrial DNA, etc.) 120. In some cases, the polynucleotides (also referred to herein as nucleic acids) are contained within a cell prior to isolation; in some cases, the polynucleotides may be extracellular or located in exosomes prior to isolation. In some cases, the nucleic acids may be released from a cell prior to isolation or during isolation.

The polynucleotides isolated from a cell may be cleaved 140 using a method of nucleic acid cleavage, for example but not limited to, any method described herein (e.g., DNaseI cleavage). The nucleic acids may be cleaved into various nucleic acid lengths. In some cases, the cleaved polynucleotides may be pooled into a library. In some cases, the cleaved polynucleotides may be distributed across more than one library.

The cleaved polynucleotides may be analyzed using, for example but not limited to, at least one method or composition described herein. In some cases, the analysis may include determining a cleavage pattern of the polynucleotides 160, or a relative cleavage frequency. In some cases, the analysis may include further analysis of a cleavage pattern of the nucleic acids 160.

The analyzed cleavage pattern may be used to, for example but not limited to, detect information about a disease, disorder or trait of the subject or patient 190. In some cases, the at least one data point may be to prognose a disease, disorder or trait of the sample 180. In some cases, the at least one data point may be to diagnose a disease, disorder or trait of the sample 170.

Kits.

The methods and compositions described herein may include a kit 203 which may be used, but is not limited to use, with the methods and compositions described herein. The kit 203 may contain one or more of the following, instructions 201, reagents 205 and/or a device for use with the sample 200. In some cases, the reagents may contain one or more of the following, buffers, chemicals, enzymes, nucleotides, labels, and/or solutions. The kit may be in a container 202. The kit may also have containers for biological samples.

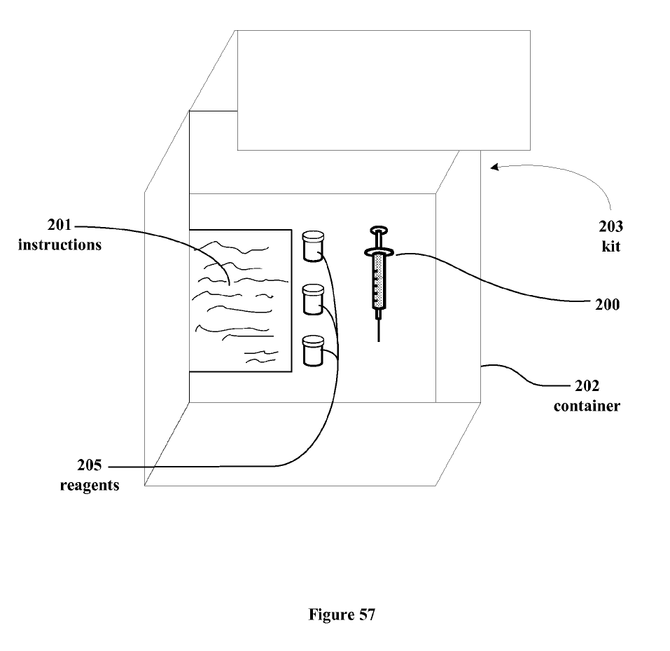

In an exemplary case, the kit may be used for obtaining a sample from an organism. For example, the kit 203, as depicted in FIG. 57, may comprise a container 202, a means for obtaining a sample 200, reagents for storing the sample 205, and instructions for use. In some cases, obtaining a sample from an organism may include extracting at least one nucleic acid from the sample obtained from an organism. For example, the kit 203 may contain at least one buffer, reagent, container and sample transfer device for extracting at least one nucleic acid. In some cases, the kit 203 may contain a material for analyzing at least one nucleic acid in a sample. For example, the material may include at least one control and reagent. The kit may contain polynucleotide cleavage agents (e.g., DNaseI, etc.) as well as buffers and reagents associated with carrying out polynucleotide cleavage reactions.

In another exemplary case, the kit 203 may be used for the identification of nucleic acids. For example, the kit may include reagents 205 may include materials for performing at least one of the methods and compositions described herein. For example, the reagents 205 may include a computer program for analyzing the data generated by the identification of nucleic acids. In some cases, the kit 203 may further comprise software or a license to obtain and use software for analysis of the data provided using the methods and compositions described herein.

In another exemplary case, the kit 203 may contain a reagent 205 that may be used to store and/or transport the biological sample to a testing facility. For example, the testing facility may be a different location in the same facility in which the sample was obtained or the testing facility may be a different facility from the facility in which the sample was obtained. In some cases, the testing facility may be located in the same zip code as the facility in which the sample was obtained. In some cases, the testing facility may be located in a different zip code as the facility in which the sample was obtained. In some cases, the testing facility may be located in a different country as the facility in which the sample was obtained.

Methods.

The methods described herein may be used to determine the protein-binding pattern at specific sites within a nucleic acid; correlate the protein-binding pattern to gene expression within a single sample of a nucleic acid or across multiple samples of nucleic acids; construct a regulatory network within a single sample of a nucleic acid or across multiple samples of nucleic acids; determine the state of development, pluripotency, differentiation and/or immortalization of a nucleic acid sample; establish the past, current and previous states of a nucleic acid sample; and/or identify the physiologic or pathologic condition of the nucleic acid sample. In some cases, a nucleic acid sample may be treated with a footprinting method. The footprinting method may include DNaseI mapping, digital genomic footprinting and/or other methods.

DNaseI Mapping.

DNaseI mapping may be used to determine the accessibility of a nucleic acid to an endonuclease wherein the accessibility may be associated with the occupation of a segment of the nucleic acid by a protein. In some cases, the nucleic acid may be nucleic acid (e.g., genomic DNA). In some cases, the protein may be a nucleic acid binding protein. In some cases, the protein may be a histone. In some cases, the protein may be a transcription factor.

DNaseI mapping may be performed on a sample and the method may comprise a nuclear extraction, a nuclear permeabilization and/or a digestion step. The digestion step may include digestion of the sample with DNaseI. In some cases, the digested sample may be treated using methods known to those of skill in the art to isolate DNaseI digested nucleic acid fragments.

In some cases, as the time of digestion with DNaseI increases, DNaseI hypersensitive sites may be detected. In some cases, as the units of DNaseI used for digestion increase, DNaseI hypersensitive sites may be detected. In either case, as the number of DNaseI hypersensitivity sites increases, the amount of nonspecific background nucleic acid cleavage may decrease.

In some cases, real-time PCR-based methods for interrogating DNaseI sensitivity at specific genomic positions may be used to monitor specific and nonspecific DNaseI digestion samples. To monitor DNaseI digestion quantitatively, and to select an optimum sample for evaluation using additional methods (e.g., DNaseI-array), several aliquots from the same sample may be prepared. In some cases, the amount of DNaseI digestion at known DNaseI hypersensitive sites may be determined. In some cases, the amount of DNaseI digestion at known DNaseI hypersensitive sites may be compared to a reference sequence. In some cases, the DNaseI digestion conditions may be selected for the highest average cleavage within DNaseI hypersensitive sites with no copy number loss as the reference.

A control may be used for the DNaseI mapping method. In some cases, the control may undergo the same steps of the method as the sample. The control sample may be treated to remove bound proteins. In some cases, the control may be portioned into aliquots and each aliquot may be digested with various concentrations of DNaseI to generate samples containing random fragment lengths.

DNaseI fragments may be isolated from the processed samples. In some cases, the DNaseI fragments may be chromatin-specific. In some cases, the DNaseI fragments may be chromatin-nonspecific. For example, the isolation step may include a size fractionation of the sample and the control. In some cases, the size fractionation may be performed using a sucrose step gradient. In some cases, the sucrose step gradient may generate fractions. In some cases, the sizes of the fragments in each fraction may be determined using methods known to those of skill in the art. In some cases, the fractions containing fragments of a desired size may be pooled.

In some cases, the DNaseI fragments may be analyzed using a microarray. In some cases, the microarray may be custom. In some cases, the microarray may be commercially designed. For example, a custom DNA microarray comprising hundreds of thousands of probes may be used. In some cases, the probes may be 50 base pairs in length (e.g., 50-mers). In some cases, the probes may be less than or equal to 200-mers, 150-mers, 125-mers, 100-mers, 70-mers, 60-mers, 50-mers, 40-mers, 30-mers, 20-mers, 10-mers or 5-mers.

In some cases, the custom DNA microarray may be organized such that the probes are tiled. In some cases, the tiling may allow for overlap of a probe wherein the length of overlap is a percentage of the total probe length. In some cases, the percentage of overlap may be 20%. In some cases, the percentage of overlap may be less than or equal to 99%, 90%, 80%, 70%, 60%, 50%, 40%, 30%, 20%, 10% or 5%.

In some cases, the overlap may occur across regions identified within a database. In some cases, the regions may be non-RepeatMasked regions. In some cases, the non-RepeatMasked regions may contain genomic segments defined within the ENCODE database. In some cases, the non-RepeatMasked regions may contain 44 genomic segments. In some cases, the regions may contain greater than or equal to 1, 5, 10, 20, 30, 40, 50, 60, 70, 80, 90, 100, 150, 200, 250, 300, 350, 400, 500, 750, 1000, 5000 or 1×10³ genomic segments.

Digested nucleic acid fragments (e.g., genomic DNA digested with DNaseI) may be labeled prior to hybridization on the DNA microarray. In some cases, a sample containing nucleic acid (e.g., genomic DNA) fragments may be mixed with a tag. In some cases, the tag may be an oligonucleotide. In some cases, the oligonucleotide may be conjugated to a fluorescent moiety. For example, useful moieties may include, without limitation, radionuclides, fluorescent dyes (e.g., fluorescein, fluorescein isothiocyanate (FITC), Oregon Green™, rhodamine, Texas red, tetrarhodimine isothiocynate (TRITC), Cy3, Cy5, etc.), fluorescent markers (e.g., green fluorescent protein (GFP), phycoerythrin (PE), etc.), autoquenched fluorescent compounds that are activated by tumor-associated proteases, enzymes (e.g., luciferase, horseradish peroxidase, alkaline phosphatase, etc.), nanoparticles, biotin, and/or digoxigenin. In some cases, the tags may emit in a spectrum detectable as a color in an image. The colors may include red, blue, yellow, green, purple, and/or orange.

In some cases, the sample can be mixed with a control sample. In some cases, the control sample can be bacterial DNA. In some cases, the mixed sample can be contacted with primers. The primers may be annealed to the nucleotides in the mixed sample. In some cases, the fragments may be mixed with oligonucleotides. The oligonucleotides may be control oligonucleotides.

In some cases, the mixed sample and oligonucleotides may be concentrated using methods known to those of skill in the art. In some cases, the concentrated mixed sample may be combined with labeled specific oligonucleotides. For example, the sample may be heated and hybridized to the microarray slide. The microarray slide may be analyzed and results determined using methods known to those of skill in the art.

Digital Genomic Footprinting.

The digital genomic footprinting (DGF) method can be used to annotate the genomes of diverse organisms. The data that can be acquired using DGF may be used in conjunction with sequencing data. The data that can be acquired using DGF may not be used in conjunction with sequencing data. In some cases, DGF can be applied to generate a gene-by-gene map. In some cases, DGF can be applied to determine a lexicon of major regulatory motifs.

The disclosure provides a method for determining a protein-binding pattern of a nucleic acid. In some cases, the nucleic acid is genomic DNA. In some cases, the nucleic acid (e.g., genomic DNA) is of known or unknown sequence. The method comprises the following steps: (1) digesting the nucleic acid (e.g., genomic DNA) in the presence of its binding proteins with a nucleic acid-cleaving agent to generate a plurality of nucleic acid fragments; (2) determining the nucleotide sequence of at least some of the plurality of nucleic acid fragments, the nucleotides at the ends of the nucleic acid fragments indicating the nucleic acid cleavage sites in the nucleic acid (e.g., genomic DNA); and (3) determining the frequency of nucleic acid cleavage throughout the length of the nucleic acid (e.g., genomic DNA) sequence, a segment of the nucleic acid (e.g., genomic DNA) sequence having lower than average frequency indicating a protein-binding site, thereby determining a protein-binding pattern of the nucleic acid (e.g., genomic DNA). The cleavage fragments may be sequenced at random and may constitute a large percentage of all fragments. Often, the protein-binding sites may be determined as a segment of the nucleic acid (e.g., genomic DNA) sequence not only having lower than average frequency but also having higher than average frequency in the immediate flanking regions.

The method can be performed by digesting the nucleic acid (e.g., genomic DNA) in vivo as the nucleic acid remains in the cell. In some cases, the nucleic acid may be in the nucleus of the cell. In some cases, the nucleic acid may not be in the nucleus of the cell. In some cases, such as in the case of a prokaryotic cell, the digestion step can be performed when the entire cell is permeated with the DNA-cleaving agent. In some cases, the genome is a partial genome or whole genome or chromosome. In some cases, the partial genome can be analyzed by array capture or solution hybridization. In some cases, the partial genome to be digested for digital genomic footprinting is at least 1, 10, 100, 10², 10³, 10⁴, and/or 10⁵ kilobases in length. In some cases, the digital genomic footprints throughout a nucleic acid (e.g., genomic DNA) of at least those lengths may be described by the methods and compositions provided herein. In some cases, the genome is haploid or diploid.

In some cases, the plurality of DNA fragments are no more than 500 nucleotides in length, no more than 300 nucleotides in length, 200 nucleotides in length or 100 nucleotides in length. In other cases, the segment of the nucleic acid (e.g., genomic DNA) is 50 nucleotides in length. For example, the plurality of DNA fragments may comprise at least 10⁷ fragments, and the nucleotide sequence of at least 10⁶ fragments is determined in step (2). In some cases, the fragments can be between 25 to 500 nucleotides in length, 25 to 100 nucleotides in length, 40 to 400 nucleotides in length, or from 50 to 500 nucleotides in length.

The number of base pairs/fragment to be sequenced may be related to the size of the genome. In some cases, about 10, 20, 30, or 40 base pairs may be sequenced. For example, a large genome, such as the human, may require at least 20, 25 base pair, or more preferably at least 27 or still more preferably at least 36 base pairs to be sequenced (e.g., 27 to 40 basepairs).

The method of DGF can be used to combine digestion (e.g., DNaseI) of a nucleic acid (e.g., intact nuclei and/or nuclei-free nucleic acids), with massively parallel sequencing to determine nucleotide-level patterns of protein binding to a nucleic acid. DGF can be used for partial or complete genome-scale detection of the occupancy of nucleic acid sites by DNA-binding proteins over hundreds of loci or across the entire genome. Detection of individual binding events may depend on the depth of sequence coverage at a given position, the DGF method can use the concentration of cleavages within DNaseI hypersensitive regions.

The Digital Genomic Footprinting method can be performed as follows using any combination of the following steps in any order or using subsets of the following steps: 1) First the nucleic acids in a sample may be digested using a nucleic acid cleavage agent (e.g., nuclease or nuclease/reaction conditions) which preferably makes single stranded nicks with each cut (e.g, DNaseI digestion methods disclosed herein). The digestion may be performed on nuclei or on whole cells, preferably, isolated nuclei. Permeabilization of nuclei or whole cells is preferred to increase access of the nucleic acid.

The number of cells depends on the methods used. For example, cells (e.g., millions) may be used. In some cases, 5×10⁶ cells may be used. In some cases, 2×10⁵ cells may be used. For example, the number of cells used may be greater than or equal to 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸ and/or 1×10⁹ cells. In some cases, microfluidic methods may be used in combination with the method described herein. For example, less than or equal to 1×10¹, 5×10¹, 1×10², 5×10², 1×10³, 5×10³, 1×10⁴, 5×10⁴, 1×10⁵, 5×10⁵, 1×10⁶, 5×10⁶ and/or 1×10⁷ cells may be used with microfluidics. Theoretically, the process can be performed on as few cells as needed to provide the contemplated number of nucleotide cleavages/nucleotide in a footprint.

2.) The nucleic acid may be purified; and

3.) The relative digestion may be quantified. Samples that show either comparatively inadequate digestion within known DNaseI hypersensitive sites (DHSs) or that show comparatively excess digestion within the reference regions may be discarded. This step can be accomplished by examining the digestion in known DHSs vs. reference non-DHS regions using an analytical method (e.g., real-time PCR).

4.) The DNA may be fractionated by size to isolate the small (<500 bp) DNaseI double-hit fragments (DDHFs). Size fractionation may be performed using sucrose gradient ultracentrifugation.

5.) The DDHFs may be assembled into sequencing libraries. Libraries may be single-end (e.g., one end of each fragment may be sequenced) or paired-end (e.g., both ends may be sequenced). For example, single end sequencing may be used.

6.) Enrichment of the samples may be ascertained by trial DNA sequencing. In this step, sample sequences are obtained and their enrichment may be calculated. The amount of sequence obtained is instrument dependent, but preferably, for the human genome, at least 1 or 5 million sequence reads that map uniquely to the genome may be used to calculate the sample enrichment. Smaller numbers can also be used, and correspondingly lower numbers may be required for smaller genomes. The enrichment can be calculated by identifying statistically significant sequence tag clusters, and then computing the proportion of all uniquely mapping tags that fall within clusters. In a preferred embodiment, identification of significant clusters may be performed using a scan statistic algorithm to delineate DNaseI hotspots. The percent of tags in hotspots (PTIH) may be calculated. For example, samples with PTIH<40% are considered to have low enrichment and may not be optimal candidates for digital genomic footprinting. For example, samples with PTIH>50% may be used as templates for deep sequencing.

7.) Suitably enriched samples may be subjected to deep sequencing. The number of reads required varies by organism, and may be related to the number of DNaseI hypersensitive sites within the genome, or, in the case of organisms that lack DNaseI hypersensitive sites such as bacteria, the total size of the genome. For the human genome, more than 200 million uniquely mapping reads are preferably required, and complete footprinting of all DHSs may not be obtained until many more hundreds of millions or even billions of reads are obtained.

8.) The reads may be processed to determine the total cleavages that have been observed for nucleotides within the genome. These may be visualized using a bar plot, with the vertical axis denoting the number of cleavages mapped to each nucleotide at the particular sequencing depth of the data set.

9.) In an optional, though desirable, step, per-nucleotide nuclease cleavage may be corrected for the intrinsic sequence preferences of the nuclease used (e.g. DNaseI). Though commonly regarded as a non-specific endonuclease, DNaseI exhibits some sequence preference that may vary widely over different combinations of nucleotides. The enzyme engages 6 by of DNA (3 on each side of the cleavage site). The cleavage may be corrected using an empirical model derived from treating naked DNA with DNaseI, sequencing the cleavage sites, and then computing the relative cleavage rates of either tetranucleotide or hexanucleotide combinations straddling the cleavage sites. The observed genomic cleavages performed in the context of chromatin may then be attenuated or accentuated, as dictated by the intrinsic cleavage propensity of the surrounding 4 (+/−2) or 6 (+/−3) nucleotides.

10.) DNaseI footprints within the per-nucleotide cleavage data may be identified. A number of algorithms may be employed, including segmentation approaches such as hidden Markov models; classification approaches such as support vector machines; or heuristics based on the expected distribution of cleavages surrounding protein binding sites. In some cases, DNaseI footprints are calculated using a footprint discovery statistic. For example, a footprint discovery statistic described herein serves as a quantitative measure of occupancy. Footprints may optimally be assigned a statistical significance, and thresholding applied to identify only those footprints that meet a certain significance cutoff. Significance may be expressed as a False Discovery Rate (FDR).

In some cases, the average occupancy of a given footprint site by a given regulatory factor can be expressed as the footprint discovery statistic, which may be used in place of other measures of occupancy such as chromatin immunoprecipitation.

In some cases, identification of the regulatory factors binding at a specific location can be achieved using matching known sequence binding motifs (or their position weight matrices) with the footprint sequences, using any of a variety of established algorithms such as FIMO.

In some cases, the footprints may be analyzed to derive, de novo, the cis-regulatory lexicon of an organism. This is accomplished by performing de novo sequence motif discovery on the footprint sequences. A number of algorithms may be employed, though in practice an algorithm will need to be able to scale to millions of sites. For example, algorithms that may be used for de novo motif discovery are provided herein.

In some cases, sequence variants within footprints may be identified by examining the individual sequence reads overlying the footprint. Homozygous variants and heterozygous variants that differ from the reference sequence can be recognized. For example, the variant may be an allele. In some cases, the allele may be a homozygous allele. In some cases, the allele may be a heterozygous allele.

In some cases, allelic variation in actuation of the footprint, or actuation of the composite regulatory element of which the footprint is a part, may also be recognized when heterozygous sequence variants are available. This may be accomplished by determining the presence of statistically significant deviation from a 1:1 ratio of each allele.

In some cases, functional variants that impact regulatory factor binding may be identified. Alternatively, such variants may be identified by combining sequence variants associated with disease or phenotypic traits with the footprint or motif information obtained.

Mapping Footprints.

Maps of nucleic acid (e.g., genomic DNA) footprints may be used to reveal the distribution of footprints throughout the genome. In some cases, footprints may be generated by treating a nucleic acid with a cleavage agent. In some cases, the cleavage agent may be DNaseI. For example, footprints may be located throughout the genome and in some cases, may be located in, but not limited to, intergenic regions, introns, exons, promoters, upstream of transcriptional start sites, and/or in 5′ and 3′ untranslated regions.

Footprints (e.g., DNaseI) may be resolved from a large genome (e.g., human) if the density and concentration of cleavages (e.g., DNaseI) occurs within a small fraction of the genome. In some cases, a small fraction may be within, and including, the range of 1-3%. In some cases, the range may be within the range of, and including, 0.01-0.1%, 0.1-1%, 0.5-5%, 1-10%, 5-50%, 10-100%. In some cases, the concentration of cleavages occurs within less than 10%, 5%, 4%, 3%, 2%, 1%, 0.9%, 0.8%, 0.7%, 0.6%, 0.5%, 0.4%, 0.3%, 0.2%, 0.1%, 0.05%, 0.02%, or 0.01% of the genome. In some cases, the concentration of cleavages occurs within greater than 1%, 2%, 4%, 6%, 8%, 10%, 15%, 20%, or 25% of the genome. For example, cleavage samples (e.g., libraries) may have cleavage sites that are localized to DNaseI-hypersensitive regions. In some cases, the percentage of DNaseI cleavage sites that are localized to DNaseI-hypersensitive regions may be between, and including, 53-81%. In some cases, the percentage of DNaseI cleavage sites that are localized to DNaseI-hypersensitive regions may be within the range of 0.01-0.1%, 0.1-1%, 0.5-5%, 1-10%, 5-50%, 10-100%. In some cases, the percentage of DNaseI cleavage sites that are localized to DNaseI-hypersensitive regions may be greater than about 30%, 40%, 45%, 46%, 47%, 48%, 49%, 50%, 51%, 52%, 53%, 54%, 55%, 56%, 57%, 59%, 59%, 60%, 65%, 70%, 75%, 80%, 85%, or 90%.

In some cases, the signal-to-noise ratio may be higher than from samples using small genomes (e.g., yeast). In some cases, the signal to noise ratio is greater than 10 times higher, when compared with samples using small genomes. In some cases, the signal to noise ratio may be greater than about 1, 2, 5, 10, 15, 20, 25, 30, 40, 50, 60, 70, 80, 90, 100, 500, 10³ or 10⁴ times higher. In some cases, enrichment may be higher compared to end-capture methods (e.g., single DNaseI cleavage events). In some cases, the enrichment may be 2 fold higher, 3 fold higher, 4 fold higher or 5 fold higher. In some cases, the enrichment may be greater than 1, 2, 5, 10, 15, 20, 25, 30, 40, 50, 60, 70, 80, 90, 100, 500, 1000 or 10,000 fold higher.

The DNaseI cleavage libraries may be sequenced using methods known to those of skill in the art. In some cases, the sequencing depth may be hundreds of millions of DNaseI cleavages per sample. In some cases, the sequencing depth may be 273 million DNaseI cleavages per sample. In some cases, the sequencing depth may be greater than or equal to about 1 million, 2 million, 5 million, 10 million, 15 million, 20 million, 25 million, 30 million, 40 million, 50 million, 60 million, 70 million, 80 million, 90 million, 100 million, 500 million, 1 billion, 2 billion, 5 billion, 10 billion, or 20 billion DNaseI cleavages per sample. For example, deep sequencing (e.g., Illumina) may be used to obtain greater than a billion sequence reads. In some cases, deep sequencing may be used to obtain 14.9 billion sequence reads. In some cases, deep sequencing may result in greater than or equal to 0.1 billion, 1 billion, 2 billion, 5 billion, 10 billion, 15 billion, 20 billion, 25 billion, 30 billion, 40 billion, 50 billion, 60 billion, 70 billion, 80 billion, 90 billion, 100 billion, 500 billion, 1 trillion, 5 trillion, or 10 trillion sequence reads. In some cases, a percentage of the sequence reads may map to unique locations in the human genome.

DNaseI footprints may be detected using the detection algorithm described herein. Numerous footprints (e.g., greater than a million footprints, greater than 10 million footprints) may be detected per sample using a predetermined false discovery rate (e.g., 1%). In some cases, 1.1 million footprints may be detected per sample. In some cases, greater than 1 million, 2 million, 5 million, 10 million, 15 million, 20 million, 25 million, 30 million, 40 million, 50 million, 60 million, 70 million, 80 million, 90 million, 100 million, 500 million, 1 billion, 2 billion, 5 billion, 10 billion, or 20 billion footprints may be detected per sample. In some cases, less than 1 million, 2 million, 5 million, 10 million, 15 million, 20 million, 25 million, 30 million, 40 million, 50 million, 60 million, 70 million, 80 million, 90 million, 100 million, 500 million, 1 billion, or 10 billion footprints may be detected per sample. In some cases, the footprints may be short. In some cases, the footprints may be 6 base pairs in length. In some cases, the footprints may be less than or equal to 30, 20, 15, 10 or 5 base pairs in length. In some cases, footprints may be long. In some cases, the footprints may be greater than about 40 base pairs in length. In some cases, the footprints may be greater than or equal to about 40, 50, 60, 70, 80, 90 or 100 base pairs in length.

For example, numerous elements (e.g., millions) with footprint patterns unique to each sample (e.g., cell type) may be revealed. In some cases, 8.4 million elements with footprints may be revealed. In some cases, more than 1 million, 2 million, 5 million, 10 million, 15 million, 20 million, 25 million, 30 million, 40 million, 50 million, 60 million, 70 million, 80 million, 90 million, 100 million, 500 million, 1 billion, 2 billion, 5 billion, 10 billion, or 20 billion elements with footprints may be revealed. In some cases, at least one footprint may be found in a percentage of the DHSs. In some cases, at least one footprint may be found in more than 75% of the DHSs. In some cases, at least one footprint may be found in greater than or equal to 5%, 10%, 20%, 30%, 40%, 50%, 60%, 70%, 80% or 90% of the DHSs. In some cases, at least one of the footprints may be occupied by a binding protein.

Nucleic Acid Cleaving Agents.

The nucleic acids (e.g., genomic DNA) may be cleaved using a variety of approaches, including many different types of cleaving agents. Cleaving agents may be used in place of, or in conjunction with, the DNaseI in other sections described herein. In some cases, the nucleic acids are cleaved with a nuclease. Illustrative examples of enzymes that may be used in the current disclosure include a double-stranded endonuclease, a single-stranded endonuclease, a double-stranded exonuclease or a single-stranded exonuclease. A variety of nucleases can be used, including sequence-specific nucleases and non-sequence-specific endonucleases. In some cases, sequence-specific nucleases may include restriction enzymes.

In some cases, the non-sequence specific endonucleases may be DNaseI, S1 nuclease, mung bean nuclease. In some cases, the DNA-cleaving agent is DNaseI. DNaseI breaks chemical bonds between nucleotides. In some cases, DNaseI makes single strand cuts under the reaction conditions employed. The reaction conditions that may enhance single strand cuts by DNaseI may include specific concentrations of Mg⁺⁺ and Ca⁺⁺. DNaseI may achieve double strand cleavage under single strand cleaving conditions if the DNaseI nicks the double-stranded DNA twice on the opposite strands of the DNA. In this case, the nicks may be in close proximity. In some cases, the DNaseI may cleave double stranded DNA at sites where a protein (e.g., a regulatory factor) may be bound.

In some cases, nucleic acid (e.g., DNA) cleavage agents may include chemicals, light waves, sound waves and/or mechanical waves. In some cases, chemical cleavage agents may include hydroxyl radicals. In some cases, chemical cleavage agents may include hydroxyl MPE (methidiumpropyl-EDTA), piperidine, iron, and/or potassium permanganate. In some cases, light waves may include ultraviolet irradiation.

Nucleic acid (e.g., genomic DNA) cleavage may be performed using a variety of reaction conditions. The reaction conditions that may be used with a nucleic acid cleavage agent are known to one of skill in the art. In some cases, reaction conditions may need to be adjusted for different agents. In some cases, the result of a cleavage reaction may be determined by examining the cleavage products (e.g. on a gel).

Footprints as Markers of Occupancy of a Nucleic Acid.

The correlation between footprints (e.g., DNaseI) and known regulatory factor recognition sequences within chromatin (e.g., DNaseI hypersensitive sites) may be determined using the methods described herein. In some cases, hypersensitive regions (e.g., DNaseI) can be correlated with databases (e.g., TRANSFAC and JASPAR databases) of transcription factor motifs. In some cases, regulatory factor recognition sequences may be enriched within footprints. In some cases, regulatory factor recognition sequences may be reduced within footprints.

The occupancy of transcription factor recognition sequences within regulatory regions (e.g., DHSs) by binding proteins may be quantified. In some cases, the occupancy may be determined across a nucleic acid. In some cases, the occupancy may be determined across a genome. For example, the occupancy across a genome may be computed using footprint occupancy scores (FOSs). The FOS may relate the density of cleavages (e.g., DNaseI) within the core recognition motif to cleavages in the flanking regions. In some cases, the FOS can be used to rank motif instances by the depth of the footprint at that position. In some cases, the FOS may provide a quantitative measure of factor occupancy.

In an exemplary case, a sequence-specific transcriptional regulator may be profiled using the methods described herein. The cleavage patterns (e.g., DNaseI) surrounding numerous, most or all recognition motifs for the sequence-specific transcriptional regulator contained within regulatory regions (e.g., DHSs) may be ranked by FOS. In some cases, a subset of motifs may coincide with high-confidence footprints. In some cases, the motifs may correlate with sites identified using a different method (e.g., ChIP-seq).

In some cases, evolutionary conservation patterns around sequence-specific transcriptional regulatory binding sites may be determined. In some cases, the binding sites may be determined at the nucleotide-by-nucleotide level. In some cases, the FOS may represent a conserved core motif region. In some cases, the conserved core motif may be a phylogenetic conserved core motif region. For example, FOS and/or nucleotide-level conservation may correlate across transcription factor motifs within a database (e.g., TRANSFAC).

In some cases, evolutionary patterns around transcriptional regulatory binding sites may be determined. For example, evolutionary patterns may not be conserved. In some cases, the methods and compositions described herein may be used to determine an evolutionary mutation rate. For example, the evolutionary mutation rate may be calculated for a sample and may be compared to a different sample to determine the relative mutation rate. In some cases, the relative evolutionary mutation rate may be increased or decreased. In some cases, the different sample may be cleaved by a cleavage agent with hypersensitive regions. For example, the different sample may have hypersensitive regions that are analogous to the sample. In some cases, the hypersensitive regions may not be analogous. For example, the evolutionary mutation rates may correlate with cell behavior. In some cases, cell behavior may be the proliferative potential of the cell.

In some cases, the specific occupancy of a binding motif by a transcriptional regulator may be identified. In some cases, one transcriptional regulator may be bound. In some cases, a plurality of transcriptional regulators may be bound. For example, targeted mass spectrometry may be used to determine transcriptional regulator occupancy of footprints. In some cases, the footprints may be known, predicted and/or novel. In some cases, the methods of mass spectrometry may include motif-to-footprint matching. In some cases, mass spectrometry may be used in the context of a simple transcription factor milieu. In some cases, mass spectrometry may be used in the context of a complex transcription factor milieu (e.g., DNA interacting protein precipitation).

Identification of Functional Variants in Footprints.

Transcription factor recognition sequences may contain variants. In some cases, the variants may be single nucleotide variants. In some cases, the variants may occur at a site in the nucleic acid where a regulatory protein binds. In some cases, the regulatory protein may be a transcription factor. In some cases, the variants may prevent binding of the transcription factor to the site in the nucleic acid (e.g., transcription factor recognition sequence). Using the methods described herein, which may include the combination of deep sequencing methods with footprinting methods, the data output may reveal regulatory sites (e.g., DHSs). In some cases, hundreds, thousands or millions of DHSs may be revealed. In some cases, the variants can be heterozygous. In some cases, the variants can be homozygous. For example, the methods may determine sites of allelic imbalance within DHSs containing variants.

In some cases, the DHSs may be measured and proportion of reads from each allele quantified. In an exemplary case, DHSs may be scanned for heterozygous single nucleotide variants (e.g., identified by the 1000 Genomes Project). Functional variants that confer allelic imbalance within chromatin accessibility may be identified. An analysis of functional variants relative to the DHSs may show enrichment of variants within the footprints.

In another exemplary case, cytosine methylation events within nucleic acid-protein interactions may be determined. For example, DNaseI footprints may be compared against whole-genome bisulphite sequencing methylation data. In some cases, CpG dinucleotides contained within DNaseI footprints may be less methylated than CpGs in non-footprinted regions of the same DHS.

Discovery of Genome-Imprinted Transcription Factor Structure.

DNaseI cleavage patterns may provide information concerning the morphology of the DNA-protein interface. In some cases, DNA-protein co-crystal structures for transcription factors may be mapped along the DNaseI cleavage patterns at individual nucleotide positions. For example, DNaseI cleavage patterns may parallel the topology of the DNA-protein interface with reduced DNaseI cleavage at the contact nucleotides. Relatively low numbers of cleavage sites may indicate that nucleotides are within regions in contact with proteins, while relatively high numbers of cleavage sites may indicate that the nucleotides are present within exposed regions, such as central pocket of a leucine zipper of a protein.

Evolutionary conservation of the DNA-protein interface may be determined. In some cases, the nucleotide-level aggregate DNaseI cleavage may be mapped across multiple samples. In some cases, the samples may be derived from at least one species. In some cases, the samples may be compared to at least a different species. For example, conservation at the per nucleotide level may be calculated by phyloP. In some cases, an antiparallel patterning of cleavage versus conservation may be determined. For example, changes in conservation may be compared to DNaseI accessibility across the DNA-protein interface.

Identification of a Transcript Origination Site Linked Footprint.

Nucleic acid (e.g., genomic DNA) may be subject to a method by which the protein and DNA bound complexes are contacted with a DNA cleaving agent. In some cases, the method may be digital genomic footprinting. In some cases, the footprints may be detected using the methods described herein. In some cases, a footprint detection algorithm that may be designed to detect large footprint features may be used.

Nucleic acid (e.g., genomic DNA) contains regulatory regions which may regulate genes. In some cases, the regulatory regions may control gene expression. In some cases, the regulatory regions may be sites of transcript origination. For example, the initiation of messenger RNA (mRNA) transcription may include binding of at least one regulatory protein to the nucleic acid. In some cases, a plurality of regulatory proteins may bind the DNA. In some cases, the regulatory proteins may bind within close proximity of one another. In some cases, the regulatory proteins may not bind within a close proximity of one another. In some cases, the regulatory proteins may form a multi-protein complex. In some cases, the multi-protein complexes may include RNA polymerase II. In some cases, the multi-protein complex may bind the nucleic acid before the RNA polymerase II binds the nucleic acid. For example, the multi-protein complex may bind the nucleic acid and recruit RNA polymerase II to the nucleic acid.

The regulatory proteins may bind to the nucleic acid upstream of a transcript origination site. In some cases, the transcript origination site may be a transcription start site (TSS). In some cases, the TSS may be located outside of a promoter associated with the gene that is under control of the TSS. In some cases, the TSS may be located inside of a promoter associated with the gene that is under control of the TSS. In some cases, the TSS may be located outside of an enhancer associated with the gene that is under control of the TSS. In some cases, the TSS may be located inside of an enhancer associated with the gene that is under control of the TSS.

The polynucleotide may be contacted with a cleavage agent to generate polynucleotide fragments. In some cases, the frequency of polynucleotide cleavage events may be determined. In some cases, polynucleotide cleavage events may occur near a site of transcript origination. In some cases, the site of transcript orgination may be a transcription start site. For example, the frequency of polynucleotide cleavage events upstream or downstream of a transcription start site may be determined. In some cases, the number of nucleotides that a footprint may be located upstream from a transcription start site may be less than or equal to 50 bp (basepairs, bp), 100 bp, 500 bp, 1 kb (kilobases, kb), 2 kb, 3 kb, 4 kb, 5 kb, 10 kb, 15 kb, 20 kb, 25 kb 26 kb, 27 kb, 28 kb, 29 kb, 30 kb, 31 kb, 32 kb, 33 kb, 34 kb, 35 kb, 36 kb, 37 kb, 38 kb, 39 kb, 40 kb, 41 kb, 42 kb, 43 kb, 44 kb, 45 kb, 46 kb, 47 kb, 48 kb, 49 kb, 50 kb, 55 kb, 60 kb, 65 kb, 70 kb, 75 kb, 80 kb, 90 kb or 100 kb. In some cases, the number of nucleotides that a footprint may be located downstream from a transcription start site may be less than or equal to 50 bp, 100 bp, 500 bp, 1 kb, 2 kb, 3 kb, 4 kb, 5 kb, 10 kb, 15 kb, 20 kb, 25 kb 26 kb, 27 kb, 28 kb, 29 kb, 30 kb, 31 kb, 32 kb, 33 kb, 34 kb, 35 kb, 36 kb, 37 kb, 38 kb, 39 kb, 40 kb, 41 kb, 42 kb, 43 kb, 44 kb, 45 kb, 46 kb, 47 kb, 48 kb, 49 kb, 50 kb, 55 kb, 60 kb, 65 kb, 70 kb, 75 kb, 80 kb, 90 kb or 100 kb.

TSSs may be located within proximity to, or located within, a footprint generated by, amongst other methods, the methods and compositions described herein. Footprints may be generated using nucleic acid cleavage agents where treatment of a nucleic acid with a cleavage agent may form fragments of nucleic acids. In some cases, the plurality of cleavage fragments may be analyzed to determine a cleavage profile for the nucleic acids. In some cases, a footprint may be located within a cleavage profile.

Using the methods and compositions described herein, cleavage profiles (e.g., +/−500 nucleotides in length) of all (e.g., GENCODE V7 level 1 and 2; manual curation) transcription origination sites (e.g., TSSs) can be determined. In some cases, tags may be used to detect the nucleic acid during the generation of a cleavage profile. In some cases, the cleavage profiles may be used as parameters to detect a footprint (e.g., 35-55 bp) for example, during a database search. In some cases, the signal in regions of low tag density may be amplified and background signal from the data set may be eliminated using a mathematical approach (e.g., square the cleavage agent cut counts).

In some cases, the footprint occupancy score (FOS) may be calculated for predetermined lengths of footprints (e.g, 35-55 bp). In some cases, the width of the footprint may be fixed in one direction. In some cases, the width of the footprint may be fixed in both directions. In some cases, the width may be of a fixed flank (e.g., 10 bp). For example, the scored predetermined lengths of nucleic acid segments may be ranked in ascending order (e.g., low FOS to high FOS). In some cases, a FOS threshold may be selected (e.g., 0.75) uniformly across one cell type. In some cases, a FOS threshold may be selected (e.g., 0.75) uniformly across a plurality of cell types. In some cases, the top non-overlapping predetermined lengths of nucleic acid segments may be collected. In some cases, no segments may remain.

The methods provided herein include methods for identifying occupancy at transcription factor recognition sequences within a polynucleotide sample. The methods may involve: a) obtaining a library of polynucleotide fragments produced by cleavage of the polynucleotide sample at cleavage sites, wherein the polynucleotide sample is derived from at least ten different cell types or cell states and wherein greater than 50% of the polynucleotide cleavage sites localize to regions of relatively high cleavage along the length of the polynucleotide; b) performing sequencing reactions on the library of polynucleotide fragments and identifying a plurality of polynucleotide footprints; c) correlating the polynucleotide footprints with a database comprising known regulatory factor recognition sequences; d) enumerating the number of polynucleotide cleavages within core recognition sequences within the regulatory factor recognition sequences; and/or e) quantifying the occupancy at transcription factor recognition sequences within polynucleotide hypersensitivity regions by computing a footprint occupancy score based on the values obtained in step d. The method may also involve assembling the polynucleotide footprint information by cell type and identifying patterns of polynucleotide footprints across different cell-types.

Capped analysis of gene expression (CAGE) tags analysis may be performed. In some cases, an expressed sequenced tag (EST) of 5′ ends analysis may be performed. For example, the density of CAGE tags and the density of 5′ ends of expressed sequenced tags (ESTs) may be compared. The density of CAGE tags and the density of ESTs may be assessed relative to a footprint (e.g., 50-bp central footprint). For example, the assessment may indicate transcript origination at promoters may localize within the footprint. In some cases, the location of the footprint may be offset (e.g., towards the 5′ direction) from annotated TSSs (e.g., GENCODE).

In some cases, the putative footprints may be analyzed and data outputs may include, for example, a graphical profile. The graphical profiles may be generated by enumerating the per-nucleotide cleavages of a nucleic acid (e.g., DNaseI cleavages) within a length of the nucleic acid (e.g., 250 bp). In some cases, the graphical profiles may be centered on the footprint.

The graphical profiles of the footprints may include a phyloP conservation. In some cases, the phyloP conservation may include enumerating enumerating the per-nucleotide DNaseI cleavages within a length of the nucleic acid (e.g., 250 bp). In some cases, the phyloP conservation may be centered on the footprint.

The data generated using the methods and compositions described herein may be arranged into a heat-map. In some cases, the heat-map may be created using a variety of software, algorithms and/or programs. For example, the heat map may be generated using matrix2png. For example, a heat map may be generated as follows, the CAGE tags from the nuclear poly-A fraction (replicate 1) generated by RIKEN may be downloaded from the UCSC Browser. In some cases, the 5′ stranded oriented ends detected per nucleotide base may be summed. For example, the footprint may be stranded to orient towards the nearest regulatory region (e.g., GENCODE V7 TSS). The per-base CAGE tags may be enumerated within a window (e.g., 800-bp). In some cases, the window may be centered on the footprint.

The heat map may also include an analysis of the spatical relationsip of the footprint. In some cases, the spatial relationship may be calculated. For example, the spatial relationship of the transcriptional footprint analysis may be calculated with respect to the nearest distance to the nearest spliced EST. In some cases, the comparison data may be obtained from a database. For example, the comparison data may be curated from GenBank.

The data analysis may reveal a structural signature of transcription initiation within a nucleic acid (e.g., chromatin). In some cases, the structural signature of transcription initiation may contain information about the interaction of the pre-initiation complex with the core promoter. In an exemplary case, the regions upstream from TSSs (e.g., GENCODE TSSs) may be used to identify a chromatin structure (e.g., 80-bp).

The chromatin structure may comprise a footprint (e.g., 50-bp). In some cases, the footprint (e.g, DNaseI) may be centrally located. In some cases, the footprint may be flanked by regions of elevated levels of cleavage (e.g., DNaseI). The flanking regions may be uniformly elevated sites of cleavage. In some cases, each flanking site may be short (e.g., 15 bp). The per-nucleotide DNaseI cleavage profiles from mapped footprints (e.g., thousands) in the promoters contained within at least one cell type (e.g., K562) may depict the chromatin structure (e.g., 50-bp footprints). In some cases, the mapped footprints may be, for example, 5,041. In some cases, the mapped footprints may be greater than or equal to 100, 200, 300, 400, 500, 600, 700, 800, 900, 1000, 1250, 1500, 1750, 2000, 2500, 3000, 3500, 4000, 4500, 5000, 5500, 6000, 6500, 7000, 7500, 8000, 8500, 9000, 10⁴, 5×10⁴, 10⁵, 5×10⁵, 10⁶, 5×10⁶, or 10⁷.

The evolutionary conservation of nucleic acid cleavage events may be determined. In some cases, evolutionary conservation may be depicted using a map. In some cases, the evolutionary conservation map may peaks within a footprint. The peaks may be compatible with binding sites for binding proteins. In some cases, the binding proteins may be transcription factors. In some cases, the transcription factors may be paired canonical sequence-specific transcription factors.

The methods may be used to determine where at least one binding protein is bound to the nucleic acid (e.g., genomic DNA) within the footprint region (e.g., 50-bp). In some cases, the binding protein may be a TATA box-binding protein (TBP). For example, the methods may be used to determine if TBP is bound to the nucleic acid (e.g., chromatin) at a central location within the footprint. In some cases, the nucleotide sequence at the peaks within the footprint may be determined. For example, the sequence at the peaks may identify transcription factor binding regions. In some cases, the binding regions may be GC-box-like features. For example, a motif for a transcription factor (e.g., SP1) may be detected. In some cases, the identification of a motif may indicate that pre-initiation complex components (e.g., TBP) could interact with transcriptional factors bound within the central footprint region.

The methods provided herein include methods of detecting expression potential of a target polynucleotide by analyzing cleaved polynucleotide fragments in order to determine the presence of a stereotyped footprint that is about 50 basepairs in length, wherein the stereotyped footprint comprises sequences for GC-box binding proteins; determining whether the stereotyped footprint is located in proximity to a known site of transcription origination for the target polynucleotide; and/or correlating the presence of the stereotyped footprint with the expression potential of the target polynucleotide.

Cis-Regulatory Lexicon

The disclosure provides a method determining the cis-regulatory lexicon of an organism, tissue, cell type, plurality of cells, single cells, cell-free nucleic acid and/or disease state. In some cases, the method provides for conducting comparative studies of the cis-regulatory lexicon profiles and foot print nucleic acid sequences for different traits, treatments, factor, individuals, species, tissues, and/or disease states. In some cases, the annotated footprints of genotype are provided by determining the cis-regulatory lexicons of subjects according to the methods of the disclosure and identifying differences in their lexicons which are associated with a factor of interest (e.g., species of origin, tissue of origin, associated disease state, experimental or control treatment, health state, age and/or diet). In some cases, the disclosure provides methods of identifying genomic polymorphisms (e.g., single nucleotide polymorphisms, deletions, insertions, substitutions of nucleic acids) of a regulatory footprint and associating them with changes in the binding or functionality of a regulatory factor which binds the footprint and in levels of gene expression. In some such cases, the disclosure identifies regulatory factors associated with a particular footprint and or gene. In some cases, the identified differences can then be used in turn in diagnosis or in determining whether a sample belongs to a particular trait, treatments, factor, individuals, species, tissues, and/or disease states.

De novo motif discovery may be applied to the footprint compartments from a sample. In some cases, de novo motif discovery could be applied to multiple samples taken from a single organism. In some cases, de novo motif discovery could be applied to multiple samples taken from multiple organisms. For example, the discovered motifs may be analyzed across multiple samples to identify novel biologically active transcription factor binding motifs.

For example, de novo motif discovery within footprints may be identified in a plurality of cell types (e.g., 41) to identify unique motif models (e.g. 683). The models may be compared against models contained in databases (e.g., TRANSFAC, JASPAR and UniPROBE databases). In some cases, the de novo motif discovery method may identify motifs which match with those in databases (e.g., 58%). In some cases, the footprint-derived motifs may not match those with those in databases (e.g., 289).

In some cases, the novel motifs may be located in DNaseI footprints and may be occupied in vivo. In some cases, the novel motifs may be evolutionarily conserved at the nucleotide-level. For example, DNaseI cleavage patterns at novel motifs in one species may map within DHSs of another species.

The nucleotide diversity of novel motifs within one species may be analyzed across motifs within another species. In some cases, the average nucleotide diversity for each individual motif space may be calculated from genomic sequence data. In some cases, the genomic sequence data may be samples from more than one source. For example, novel motifs in the human population may be under strong purifying selection. In some cases, the novel motifs may be more constrained than motifs described in databases.

Novel Motif Discovery.

Cell-selective gene regulation may be mediated by the differential occupancy of transcriptional regulatory factors at cis-acting elements. Examination of nucleotide-level cleavage patterns within promoters may identify the cis-regulatory pathways which include transcriptional regulators. Using the methods described herein, in combination with genomic footprinting, differential occupancy of multiple regulatory factors in parallel at nucleotide resolution may be resolved.

In an exemplary case, genome-wide DNaseI footprints across distinct cell types (e.g., 12) may be used to identify previously determined and novel factor recognition motifs. To calculate the footprint occupancy of a motif, each motif may be enumerated. The cell type and the number of motif instances encompassed within DNaseI footprints may be normalized to the total number of DNaseI footprints. In some cases, a heat-map representation of cell-selective occupancy at motifs for known and novel transcriptional regulators may be generated.

Indirect Vs. Direct Transcription Factor Binding.

Many transcriptional regulators may interact indirectly, rather than directly, with the DNA sequence of some target sites. Direct binding may, for example, include the binding of a protein to the nucleic acid. Indirect binding may, for example, include binding of a protein to a protein that is bound to the nucleic acid. In some cases, indirect binding may be tethering. For example, tethering may include binding of a modified region of a protein to the same modified region of a different protein, binding of a modified region of a protein to a different modified region of a different protein, binding of a modified region of a protein to the same modified region of the same protein, binding of a modified region of a protein to a different modified region of the same protein, and/or binding of a region of one protein to a different protein through interaction with a different molecule. In some cases, the modified region may include any protein modification discussed herein. In some cases, the modified region may include a sugar, a nucleic acid, a fatty acid and/or a chemical agent.

DNaseI footprint data may be used to distinguish direct binding events from indirect binding events. In some cases, regulatory proteins may be bound at a footprint. In some cases, the regulatory proteins may be transcription factors. In some cases, one transcription factor may be bound at a footprint. In some cases, more than one transcription factor may be bound at a footprint. The transcription factors may be homologous, heterologous and/or inclusive of any protein modification discussed herein.

In some cases, the DNaseI footprint data may be correlated with ChIP-seq-derived occupancy profile data. In an exemplary case, ChIP-seq peaks from transcription factors (e.g., 38 ChIP-seq peaks, ENCODE) can be partitioned into three categories of predicted sites: ChIP-seq peaks containing a compatible footprinted motif (e.g., directly bound sites); ChIP-seq peaks lacking a compatible motif or footprint (e.g., indirectly bound sites); and ChIP-seq peaks overlying a compatible motif lacking a footprint (e.g., indeterminate sites). In some cases, the predicted indirect sites may have reduced ChIP-seq signal compared with predicted directly bound sites. In some cases, indeterminate sites with low ChIP-seq signal may be excluded from analysis.

In some cases, the fraction of ChIP-seq peaks that may be predicted to represent direct versus indirect binding could vary across the population of different factors in the analysis. For example, the fraction may range from complete direct sequence-specific binding to complete indirect binding. In some cases, factors directly bind DNA at distal sites may indirectly occupy promoter regions. In some cases, factors that indirectly bind DNA at distal sites may directly occupy promoter regions.

The frequency by which indirectly bound sites of one transcription factor coincide with directly bound sites of a second factor may be analyzed. In some cases, the analysis may indicate protein-protein interactions (e.g., tethering). In some cases, the analysis may indicate known protein-protein interactions. In some cases, the analysis may indicate novel protein-protein interactions. In some cases, the analysis may reveal a reciprocal mechanism. In some cases, the analysis may reveal a looping mechanism. For example, directly bound promoter-predominant transcription factors may be enriched for co-localization with indirect peaks compared to distal regions.

Mapping of Transcription Factor Networks in Multiple Cell Types.

Binding of transcription factors to a site in a nucleic acid (e.g., genomic DNA) may regulate gene expression. The sites of transcription factor binding to the nucleic acid (e.g., genomic DNA) may be identified. In addition, the identity of the transcription factor bound to a site in the nucleic acid (e.g., genomic DNA) may be determined. In some cases, a network of transcription factor (TF) binding to nucleic acid (e.g., genomic DNA) may be generated. In some cases, the network may consist of one transcription factor bound to more than one sites within the nucleic acid (e.g., genomic DNA) in one sample (e.g., cell type). In some cases, the network may consist of one transcription factor bound to more than one sites within the nucleic acid (e.g., genomic DNA) in more than one sample (e.g., cell type) wherein each sample is a different cell type. In some cases, the network may consist of more than one transcription factor bound to more than one sites within the nucleic acid (e.g., genomic DNA) in one sample (e.g., cell type) wherein each transcription factor is a different transcription factor. In some cases, the network may consist of one transcription factor bound to more than one sites within the nucleic acid (e.g., genomic DNA) in more than one sample (e.g., cell type) wherein each transcription factor is a different transcription factor and wherein each sample is a different cell type.

In an exemplary case, more than one transcriptional regulatory network may be generated using a plurality of cell types. The cell types may all be isolated from one organism (e.g., a human). DNaseI footprinting may be performed using nucleic acid (e.g., genomic DNA) isolated from each cell type. In some cases, 41 cell types may be used. In some cases, greater than or equal to, 1, 2, 5, 10, 20, 30, 40, 50, 60, 70, 80, 90, 100, 150, 200, 250, 300, 350, 400, 500, 600, 700, 800, 900, 1000, 2500, 5000, 7500 or 10,000 different cell types may be used. In some cases, the sites of DNaseI cleavage along the nucleic acid (e.g., genomic DNA) for each cell type may be analyzed. The analysis may include sequencing (e.g., methods of next generation sequencing). The sequencing method may be used to identify DNaseI cleavages in each cell type. In some cases, greater than about 500 million cleavages may be identified per cell type. In some cases, greater than or equal to, about 1 million, 2 million, 5 million, 10 million, 15 million, 20 million, 25 million, 30 million, 40 million, 50 million, 60 million, 70 million, 80 million, 90 million, 100 million, 500 million, 1 billion, 2 billion, 5 billion, 10 billion, or 20 billion cleavages may be identified per cell type. In some cases, DNaseI cleavage sites in each cell type are unique. In some cases, 273 million DNaseI cleavage sites may map to unique genomic positions. In some cases, greater than or equal to, 1 million, 2 million, 5 million, 10 million, 15 million, 20 million, 25 million, 30 million, 40 million, 50 million, 60 million, 70 million, 80 million, 90 million, 100 million, 500 million, 1 billion, 2 billion, 5 billion, 10 billion, or 20 billion cleavages DNaseI cleavage sites may map to unique genomic positions.

In some cases, at least one transcription factor binding site may be identified in at least one cell type. In some cases, the transcription factor binding site may be located within a footprint. In some cases, identification may include determining the sequence of each nucleotide in the binding site. For example, instances of at least one sequence of nucleotides of the binding site may be enumerated. In some cases, the sequence of nucleotides adjacent to the binding site may be determined. For example, instances of the sequence of nucleotides adjacent to the binding site may be enumerated.

In some cases, the transcription factor binding sequences may be common to more than one cell type. In some cases, the transcription factor binding sequences may be unique to one cell type. In some cases, the transcription factor binding sequences may be cell-specific. For example, the transcription factor binding sequences may be highly cell-specific.

In some cases, transcription factor binding sequences may be used to determine an occupancy pattern for at least one cell type. In some cases, the occupancy pattern may be common to more than one cell type. In some cases, the occupancy pattern may be unique to one cell type. In some cases, the occupancy pattern may be cell-specific. For example, the occupancy pattern may be highly cell-specific

In some cases, high-confidence DNaseI footprints may be identified in each cell type. In some cases, 1.1 million high-confidence DNaseI footprints may be identified per cell type at a false discovery rate of about 1%. In some cases, greater than or equal to, 1 million, 2 million, 5 million, 10 million, 15 million, 20 million, 25 million, 30 million, 40 million, 50 million, 60 million, 70 million, 80 million, 90 million, 100 million, 500 million, 1 billion, 2 billion, 5 billion, 10 billion, or 20 billion high-confidence DNaseI footprints may be identified per cell type. Footprints may represent cell-selective binding to distinct genomic sequence elements (previously discussed).

Databases of transcription factor binding motifs may be used to identify factors occupying DNaseI footprints. In some cases, the identifications made using databases may be compared to additional data (e.g., ENCODE ChIP-seq) for the same transcription factors.

TF regulatory networks can be created by analyzing actively bound DNA elements within regulatory regions. The regulatory regions may be proximal or distal. In some cases, the regulatory regions may be DNaseI hypersensitive sites (DHSs) within a 10 kb interval centered on the transcriptional start site (TSS]. In some cases, the DHSs may be centered less than or equal to 1, 5, 10, 20, 25, 30, 35, 40, 45, 50, 75, 100, 250 or 500 kb from the TSS. The regulatory regions of TF genes with well-annotated recognition motifs may be used. In some cases, 475 TF genes may be analyzed. In some cases, greater than or equal to 1, 5, 10, 20, 25, 30, 35, 40, 45, 50, 75, 100, 250, 500, 750, 1000 or 5000 TF genes may be analyzed. The analysis may be used for more than one cell type.

In some cases, a TF regulatory network may reveal unique regulatory interactions among the TFs. There may be less than or equal to 10, 20, 50, 75, 100, 150, 200, 250, 300, 350, 400, 500, 600, 700, 800, 900, 1000, 2500, 5000, 7500 or 10,000 million unique regulatory interactions. The regulatory interactions may be edges of the TF regulatory network.

In some cases, multiple TFs may occupy a single DNaseI footprint in the TF map. In some cases, a single TF may occupy a single DNaseI footprint in the TF map

Generating Transcription Factor Networks

TF regulatory networks may be compared across more than one cell type. In some cases, the TF regulatory networks may be cell-selective. In some cases, the TF regulatory networks may have shared regulatory interactions across at least more than one cell type. A comprehensive landscape of network edges can be determined for cell-selective interactions or multi-cellular interactions. In some cases, the network edges are cell-selective. In some cases, the network edges are multi-cellular. In some cases, the multi-cellular network edges are restricted to less than to five cell types. In some cases, the multi-cellular network edges are restricted to less than or equal 30, 20, 10, 5 or 2 cell types. In some cases, the common network edges are correlated with DNaseI footprints.

In some cases, TF regulatory networks of related TFs may be generated. TF regulatory networks of related TFs may identify cell-type-specific TFs, for example, regulatory interactions between pluripotency factors within a stem cell network, and hematopoietic factors within the network of hematopoietic stem cells.

A complete TF regulatory network may across the edges identified between multiple cell types may be generated. The network may indicate regulatory diversity. In some cases, the network edges may be mapped across one cell type. In some cases, the network edges may be mapped across more than one cell type. Edges that are unique to one cell type may form a subnetwork.

Core Transcriptional Regulatory Networks.

A TF regulatory network may be related to a different TF regulatory network in a cell type with similar TFs. Cell-types may be grouped using TF regulatory networks. The groups may be epithelial and stromal cells; hematopoietic cells; endothelia; and primitive cells including fetal cells and tissues, ESCs, and malignant cells with a dedifferentiated phenotype. In some cases, the degree of relatedness between at least two different TF networks may be determined. The normalized network degree (NND) may be calculated for each cell type. The NND may include the relative number of interactions observed in a cell type for each TF. In some cases, the TF networks may be clustered according to the NND vector scores.

In some cases, individual TFs controlling the clustering of related cell-type networks may be identified. The NND for each TF in at least one cell type may be determined. In some cases specific factors with cell-selective interaction patterns may be identified. In some cases, regulators of cellular identity important to functionally related cell types, neuronal developmental regulators, cardiac developmental regulators, endothelial regulatory network regulators, fetal lung network regulators, ubiquitous transcriptional regulators, genomic regulators, may be identified.

TF regulatory networks generated from genomic DNaseI footprinting datasets may be used to identify cell-selective and/or ubiquitous regulators of cellular state as well as to implicate analogous yet unanticipated roles for many other factors. In some cases, gene expression data may not be used to generate TF regulatory networks. In some cases, gene expression data may be used to generate TF regulatory networks.

Network Analysis for Cell-Type-Specific Behaviors of Transcription Factors.

TFs may be expressed to varying degrees in a number of different cell types and may be used to identify differences in transcriptional regulation that control cellular identity across functionally similar cell types. In some cases, the function of widely expressed TFs may be the same in different cells. In some cases, the TFs may exhibit cell-selective behaviors. In an exemplary case, the regulatory diversity between different cell types within the same lineage may be determined. For example, cells of the hematopoietic lineage may be analyzed for de novo-derived subnetworks comprising at least one TF. In some cases, the normalized outdegree (e.g., the number of outgoing connections) for each TF in each subnetwork for each cell type may be determined. In some cases, the subnetworks may identify the origin of each cell type.

In some cases, TFs that control cell-type-specific behaviors may be identified. For example, TFs involved in developmental processes, physiological processes, pathological processes may be identified. For example, the behavior of a TF within a regulatory network may be determined by identifying the position of the TF within feed forward loops (FFLs). In some cases, the location of the TF in the FFL may alter the organization of the regulatory network. For each cell type, the number of FFLs containing the TF at each of the three different positions may be identified. In some cases, one position is a driver. In some cases, one position is a passenger. In some cases, the driver may be a gene. In some cases, the passenger may be a gene. In some cases, the TF is a passenger and located in positions 2 and 3 in at least one cell type. In some cases, the TF may be a driver and located in position 1 in at least a different cell type.

For example, the driver may control, for example, a disease, state or trait of an organism. In some cases, the disease may be cancer. In some cases, the driver may be an oncogene. In some cases, the driver may be a tumor suppressor gene. In some cases, the state may be differentiation. In some cases, the driver gene may regulate differentiation.

The methods and compositions described herein may be used to identify a hierarchy between transcription factors. In some cases, the hierarchy may be generated from identified regulatory regions. In some cases, the regulatory regions may be located upstream or downstream from a site of transcript origination. For example, the hierarchy may be an ordered regulatory hierarchy. In some cases, the ordered regulatory hierarchy may be generated from the sequences of regulatory regions. In some cases, the sequences of the regulatory regions may not be known.

Architecture of Transcription Factor Regulatory Networks.

Networks may be built from a set of samples wherein each sample may be isolated from a different organism. In some cases, networks may comprise network motifs. Network motifs may represent regulatory circuits and the topology of a given network can be reflected quantitatively in the normalized frequencies (normalized z-score) of different network motifs.

In an exemplary case, the topology of the human TF regulatory network may be analyzed and compared to TF regulatory networks of a different organism. In some cases, the relative frequency and relative enrichment or depletion of each three-node network motifs within each cell-type regulatory network may be determined. In some cases, the human TF regulatory network has 13 three-node networks. In some cases, the human TF regulatory network has greater than or equal to 1, 2, 5, 10, 15, or 20 three-node networks.

In some cases, the topology of a TF regulatory network derived from a single cell type may be analyzed and compared to a TF regulatory network derived from a different single cell type from the same organism. In some cases, the topology of a TF regulatory network derived from a single cell type may be analyzed and compared to a TF regulatory network derived from a single cell type from a different organism. In some cases, the topology of a TF regulatory network derived from more than one cell type may be analyzed and compared to a TF regulatory network derived from a more than one cell type from the same organism. In some cases, the topology of a TF regulatory network derived from more than one cell type may be analyzed and compared to a TF regulatory network derived from a more than one cell type from a different organism.

The FFLs across multiple cell types and multiple organisms may be compared to determine the common core of regulatory interactions. In some cases, the common core of regulatory interactions may control the conserved network architecture.

Transcription Factors and Chromatin Accessibility.

The relationship between chromatin accessibility and the occupancy of regulatory factors at a site in the nucleic acid (e.g., genomic DNA) may be determined. In some cases, the sequencing-depth-normalized DNaseI sensitivity in at least one cell line may be normalized to ChIP-seq signals from all mapped transcription factors (e.g., ENCODE ChIP-seq). The ChIP-seq signals may be summed and, in some cases, compared to the quantitative DNase1 sensitivity at individual DHSs. In some cases, the ChIP-seq signals may be compared across the genome.

In an exemplary case, a specific region (e.g., locus control region) may contain a regulatory element (e.g., enhancer). The specific region may be located at a DHS and in some cases, may be occupied by at least one transcription factor. In some cases, more than one transcription factor may bind at the regulatory element creating overlapping binding patterns. In some cases, the overlapping binding patterns may indicate a weak interaction of the factors at the site with low-affinity recognition sequences. In some cases, the overlapping binding patterns may indicate a compact element with a functional core that contains more than one site of transcription factor-DNA interaction. In some cases, the recognition sequences for a small number of factors may correlate with elevated chromatin accessibility across more than one class of sites and more than one cell type.

In some cases, occupancy sites of factors may represent binding within heterochromatin. For example, targeted mass spectrometry assays for a single factor, and factors with which the single factor localizes at an occupancy site, may be used to quantify abundance in heterochromatin compared to total chromatin.

Promoter Chromatin Signatures.

Sites of transcription origination may be annotated for the location of TSSs which may be indicated by mRNA transcript and histone modifications. The relationship between chromatin accessibility and patterns of histone modifications (e.g., H3K4me3) at promoters, the relationship to transcription origination, and variability across at least one cell type may be performed using the methods and compositions described herein.

In an exemplary case, ChIP-seq can be performed for a target histone modification (e.g., H3K4me3) in at least one cell type. The DnaseI cleavage density data may be compared to ChIP-seq tag density at sites of interest. In some cases, the sites may be TSSs. In some cases, the sites may be promoters, enhancers, introns, exons. In some cases, a directional pattern may be observed. In some cases, the direction of the nucleosome relative to the site of interest may be determined.

The methods and compositions described herein may be used to map the directionality of novel promoters. In some cases, a pattern-matching approach may be used to scan the genome across at least one cell type. For example, distinct promoters (e.g., 113,622) may be identified. In some cases, greater than 10², 5×10², 10³, 5×10³, 10⁴, 2.5×10⁴, 5×10⁴, 10⁵, 2.5×10⁶, 5×10⁶, 10⁶ 2.5×10⁷, 5×10⁷, 10⁷, 2.5×10⁸, 5×10⁸, 10⁸, or 10⁹ promoters may be identified. Some of the identified promoters may be previously identified and annotated in at least one database.

In some cases, the novel promoters may be correlated to evidence from spliced expressed sequence tags (ESTs) and/or cap analysis of gene expression (CAGE) tag clusters. In some cases, the distinct promoter may be located with annotated genes, of which at least one may be oriented antisense to the annotated direction of transcription, and at least one may be immediately downstream of an annotated gene's 3′ end, of which at least one may be in an antisense orientation.

Chromatin Accessibility and Methylation Patterns.

The methods and compositions described herein may be used to identify a relationship between nucleic acid (e.g., DNA) methylation and chromatin structure. In some cases, modifications (e.g., CpG methylation) to regulatory regions of the nucleic acid (e.g., genomic DNA) may be detected. For example, reduced-representation bisulphite sequencing (RRBS) data (e.g., ENCODE), may provide a quantitative methylation measurement for millions of CpGs, may be compared to DHSs data across at least one cell type.

For example, two classes of sites, those with a strong inverse correlation across cell types between DNA methylation and chromatin accessibility, and those with variable chromatin accessibility but constitutive hypomethylation, may be observed. In some cases, a linear regression analysis between chromatin accessibility and DNA methylation at the plurality of CpG-containing DHSs may be performed to map an association between methylation and accessibility.

In some cases, transcription factor transcript levels may be compared to average methylation density at recognition sites within DHSs. In some cases, there may be a negative correlation between transcription factor expression and binding site methylation. In some cases, there may be a positive correlation between transcription factor expression and binding site methylation.

A Genome-Wide Map of DHS-Promoter Connections.

The methods and compositions described herein can be used to correlate the temporal and spatial nature at which cell-selective enhancer elements become DHSs in connection with the target gene promoter. In some cases, map of candidate enhancers controlling specific genes may be generated. For example, the pattern of distal DHSs (e.g., DHSs separated from a TSS by at least one other DHS) across diverse cell types may be correlated to the cross-cell-type DNaseI signal at each DHS position within adjacent promoters. In some cases, the distal DHSs may include 1,454,901 sites. In some cases, the distal DHSs may be greater than or equal to 10⁵, 2.5×10⁵, 5×10⁵, 10⁶, 1.5×10⁶, 2×10⁶, 2.5×10⁶, 5×10⁶, 7.5×10⁶ or 10⁷ sites. In some cases, the adjacent promoter is within ±500 kb. In some cases, the adjacent promoter may be flanked by less than or equal to 1500, 1000, 750, 500, 250, 100, 50, 10 or 1 kb. For example, 578,905 DHSs are highly correlated with at least one promoter.

In some cases, the map of distal DHS/enhancer-promoter connections may be correlated with chromatin interaction profiles generated using the chromosome conformation capture carbon copy (5C) technique. In some cases, the 5C technique may be used to compare a portion of the total nucleic acid sequence within a sample. In some cases, the entire nucleic acid sequence with a sample may be compared. In some cases, the correlation values for DHSs within the gene body may parallel the frequency of long-range chromatin interactions measured by 5C. For example, the 5C technique may show that promoters may be connected to more than one distal DHS. In some cases, interacting intronic DHSs may be controlled by a promoter. For example, the interacting intronic DHSs may be located within an enhancer. In some cases, the intronic DHSs may have enhancer function.

In some cases, the map of distal DHS/enhancer-promoter connections may be correlated with those detected by the polymerase II chromatin interaction analysis with paired-end tag sequencing (ChIA-PET) technique. In some cases, the interactions detected by ChIA-PET may be enriched for DHS-promoter pairings. For example, the ChIA-PET technique may show that promoters may be connected to more than one distal DHS.

The number of distal DHSs connected to a promoter may be a quantitative measure of the regulatory complexity of the gene. For example, the systematic functional features of genes with complex regulation may be determined using the methods and compositions described herein. In some cases, genes may be ranked by the number of distal DHSs that are paired with the promoter of each gene. In some cases, a Gene Ontology analysis can be performed on the rank-ordered list.

In some cases, DHS-promoter pairings may be correlated to a systematic relationship between combinations of regulatory factors. For example, TFs may form a transcriptional network that may control the state of a cell. In some cases, the transcriptional network may control the pluripotent state of embryonic stem cells. For example, a set of motifs of a transcriptional network within distal DHSs may be enriched and may correlate with promoter DHSs that contain a motif located in the same transcriptional network.

In some cases, co-associations between at least one promoter type where at least one promoter type is different from at least one other promoter type and motifs in paired distal DHSs may be generated using the methods and compositions described herein. For example, a promoter type may include one or more motif classes and promoter types may differ from one another by the motif classes. In some cases, a member of one TF family may bind to a motif within a promoter DHS, a different motif within the same promoter DHS may be bound by a TF from the same family. In some cases, a member of one TF family may bind to a motif within a promoter DHS, a different motif within a distal DHS may be bound by a TF from the same family. In some cases, the distal DHS may be in a different promoter.

Chromatin Accessibility and Function.

Using the methods and compositions described herein, a pattern of co-activation among DHSs may be observed. In some cases, the DHSs may be distal. In some cases, the DHSs may be proximal. The patterns of co-activation may be connected to DHSs with similar cross-cell-type patterns of chromatin accessibility. In some cases, DHSs may be separated in trans. In some cases, the DHSs may be separated in cis. For example, the patterns may be tens to hundreds of like elements around the genome and may be located at sites with non-homologous sequence features. In some cases, the pattern of cell-selective chromatin accessibility located within at least one DHS may be achieved using distinct mechanisms (e.g., complex combinatorial tuning).

In an exemplary case, the pattern at distal DHSs with specific functions may indicate or highlight other elements with a similar function. The specific functions may be promoters, enhancers. A pattern-matching algorithm may be used to identify DHSs with similar cross-cell-type accessibility patterns. The role of such DHSs elements may be identified using additional assays (e.g., transient transfection) to determine the function of the element. In some cases, pattern matching may be applied to each role-identified element.

A self-organizing map may be generated to indicate the category and location of cross-cellular DHS patterns. In some cases, a random subsample of DHSs across at least one cell type may be created. In some cases, the random subsample may be used to identify DHS patterns. In some cases, the stereotyped patterns identified by the self-organizing map may include large numbers of DHSs. In some cases, greater than or equal to 10, 50, 100, 200, 300, 400, 500, 600, 700, 800, 900, 1000, 1500, 2000, 2500, 3000, 5000, 7000, or 10000 DHS may be identified.

Variation and Mutation Rates in Regulatory DNA.

The DHS compartment may be under evolutionary constraint. In some cases, evolutionary constraint may vary between different classes and locations of elements, and may be heterogeneous within individual elements. The methods and compositions described herein may be used to identify evolutionary control of regulatory DNA sequences. In some cases, the regulatory DNA sequences may be located in humans. For example, the nucleotide diversity in DHSs may be determined using publicly available whole-genome sequencing data. In some cases, the analysis may include nucleotides that are not located in the exons. In some cases the analysis may include nucleotides that are not located in RepeatMasked regions. In some cases, the analysis may include nucleotides that are not located in either exons or RepeatMasked regions. For example, to account for neutral sequences, computations may account for it in fourfold degenerate synonymous positions of coding exons.

In some cases, DHSs in cells with limited proliferative potential may have uniformly lower average diversity than immortal cells. In some cases, an ordering analysis may be performed to determine diversity. In some cases, the ordering analysis may be performed in the absence of nucleotides. In some cases, the muTable CpG nucleotides may be removed from the ordering analysis.

In some cases, divergence across more than one species may be used for comparison of DHSs. In some cases, one species may be a human. In some cases, one species may be a non-human primate. In some cases, the non-human primate may be a chimpanzee. In some cases, more than one cell type from each species may be used.

In some cases, the DHSs may be associated with normal, malignant and pluripotent cells. For example, the mutation rate of DHSs may affect rare and common genetic variation. In some cases, the derived-allele frequencies for genetic variation may be calculated. For example, single nucleotide polymorphisms (SNPs) in DHSs of rare and common genetic variation may have derived-allele frequencies below 0.05.

Disease- and Trait-Associated Variants in Regulatory DNA.

The methods and compositions described herein may be used to generate associations between variants within regulatory DNA and diseases or traits. In some cases, the associations may be determined using a genome wide association study (GWAS).

In an exemplary case, the distribution of non-coding genome-wide significant associations for diseases and quantitative traits within maps of regulatory DNA (e.g, containing DHSs) may be determined. In some cases, variant regions may contain DHSs. In some cases, single-nucleotide polymorphisms (SNPs) may be located within DHSs. In some cases, variants with the same genomic feature localization, distance from the nearest transcriptional start site, and allele frequency from a database (e.g., the 1000 Genomes Project) may be compared to GWAS SNPs. For example, SNPs within DHSs and variants in complete linkage disequilibrium with SNPs in DHSs may be identified. In some cases, the identification may include use of a database.

Non-coding GWAS SNPs may be enriched in regulatory DNA. In some cases, non-coding GWAS SNPs may be classified by experimental replication. For example, GWAS SNP experimental replication may identify unreplicated SNPs; ‘internally-replicated’ SNPs and ‘externally-replicated’ SNPs. In some cases, the proportion of disease or trait-associated variants localizing in DHSs may correlate with the number of GWAS SNP experimental replication studies, the increasing strength of association and/or, the study sample size.

The methods may be used to construct comprehensive regulatory DNA maps to illuminate associations of GWAS variants within physiologically-relevant specific cell or tissue types. For example, the GWAS variant may be at least one independently-associated SNP. In some cases, the SNP may be distributed widely around the genome and may therefore be common.

In some cases, DHSs harboring GWAS variants may be examined in at least one cell type during a plurality of developmental conditions. In some cases, the conditions may include timepoints during the gestation, exposure to environmental conditions during gestation, exposure to environmental conditions after gestation. In some cases, GWAS variants in DHSs may be detected during gestation. In some cases, the GWAS variants in DHSs are during gestation and during post-gestation development. In some cases, the GWAS variants in DHSs are not detected during gestation but are detected during post-gestation development. In some cases, the GWAS variants in DHSs may be found in immature hematopoietic cells, mature hematopoietic cells, connective tissue, endothelial cells, malignant cells.

In some cases, DHSs harboring at least one genetic variant may be examined in at least one cell type during a plurality of pathogenic conditions. In some cases, the variant may be identified by GWAS. For example, a pathogenic condition may be a phenotype. In some cases, the pathogenic condition may include cancer, cardiovascular disease, aging-related diseases, metabolic disease, neurological disease, and inflammatory disorders. For example, the variant may be associated with a pathologic condition and can confer a state of pathogenesis. In some cases, the genetic variant may be associated with a disease and/or a phenotype.

For example, the genic targets of DHSs harboring GWAS variants may be identified across a plurality of samples taken from a plurality of cell and tissue types described herein. In some cases, DHSs with GWAS variants may be correlated with the promoter of a specific target gene. In some cases, the adjacent promoter is within +500 kb. In some cases, the adjacent promoter may be flanked by less than or equal to 1 500, 1 000, 750, 500, 250, 100, 50, 10 or 1 kb.

GWAS Variants in DHS Sites.

Variants associated with specific diseases or trait classes may be enriched in the recognition sequences of transcription factors which may regulate physiological processes. In some cases, the methods and compositions described herein may identify the pattern of GWAS variant distribution within DHSs. In some cases, the distribution may be correlated with transcription factor recognition sequence and identified by scanning for motifs. For example, GWAS SNPs in DHSs may overlap a transcription factor recognition sequence.

In some cases, GWAS variants may be annotated by gene ontology. In some cases, GWAS variants may be divided into classes. The classes may be disease classes, trait classes. In some cases, the frequency of GWAS variants associated with a particular disease/trait class may be determined. For example, GWAS variants may be partitioned into classes based on gene ontology annotations.

Functional variants that alter transcription factor recognition sequences may affect the chromatin structure. The methods and compositions described herein may be used to detect cell types heterozygous for common SNPs and to quantify the relative proportions of reads from each allele across a plurality of cell types. In some cases, the concentration of sequence reads that overlap read coverage may result in re-sequencing of DHSs. For example, heterozygous GWAS SNPs may be detected with sufficient sequencing coverage. In some cases, 584 heterozygous GWAS SNPs may be detected. In some cases greater than or equal to 10, 50, 100, 200, 300, 400, 500, 600, 700, 800, 900, 1000, 2500, 5000 or 10,000 may be detected.

For example, the sites at which regulatory variants may be associated with allelic chromatin states can be identified. In some cases, the method may be used to predict a higher-affinity allele that may have increased accessibility. The GWAS SNPs may be a site of sequence difference between haplotypes. In some cases, sites with high sequencing depth may have allelic imbalance. In some cases, high sequencing depth may be 200%. High sequencing depth may also be greater than or equal to 50%, 100%, 200%, 300%, 400%, 500%, 750%, 1000%, 2500%, 5000% or more.

Disease-Associated Variants and Transcriptional Regulatory Pathways.

The methods and compositions described herein may be used to determine if non-coding variants are clustered and associated with disease states. For example, variants within the recognition sites for transcription factors may be correlated with the disease to which the transcription factors are associated. In some cases, the non-coding variants may disrupt the peripheral nodes of a regulatory network that is associated with a disease in the same class. In some cases, the non-coding variants may disrupt the peripheral nodes of a regulatory network that is associated with a disease in a different class. For example, transcription factors with recognition sequences in multiple distinct DHSs that contain GWAS variants may be affected.

In some cases, disease-associated variants in the recognition sequences of a central target factor and its interacting partners may be identified. In some cases, the central factor may be associated with one disease and its interacting partners may be associated with one disease. In some cases, the central factor may be associated with more than one disease and its interacting partners may be associated with one disease. In some cases, the central factor may be associated with one disease and its interacting partners may be associated with more than one disease. In some cases, the central factor may be associated with more than one disease and its interacting partners may be associated with more than one disease.

Regulatory Architectures and Diseases.

GWAS variants are associated with multiple diseases within a broad disease class (e.g., inflammation, cancer, heart disease) and localize within the recognition sites of interacting transcription factors. In some cases, the connected GWAS variants may form regulatory architectures containing more than one transcription factor. In some cases, non-coding GWAS SNPs associated with one disease may affect recognition sequences of a different set of transcription factors. For example, transcription factors for which recognition sequences in DHSs were perturbed by GWAS SNPs may be associated disease. In some cases, the regulatory architecture of cancers may be determined. For example, samples from a plurality of malignancies may be compared. The regulatory architecture may indicate different types of malignancies share common transcriptional networks. The regulatory architecture may indicate different types of malignancies do not share common transcriptional networks.

De Novo Identification of Pathogenic Cell Types.

The localization of GWAS SNPs within regulatory regions of DNA within individual cell types may be determined using the methods and compositions described herein to determine the cellular structure of disease and identify pathogenic cell types. In an exemplary case, serial determination of enrichment patterns of associated variants may be performed to identify the localization of GWAS SNPs within regulatory regions of DNA. The enrichment patterns may be determined for at least one cell type and associated across multiple cell types. In some cases, SNPs that meet significant P-value cutoffs (e.g., progressively increasing) may be compared to the proportion of SNPs in DHSs of a single cell to the proportion of SNPs in DHSs of the same cell type. In some cases, weakly associated variants in regulatory DNA may be enriched. For example, use of progressively stringent P-value thresholds may identify selective enrichment of disease-associated variants within specific cell types.

In some aspects, provided herein are methods for generating a map of a regulatory network of a cell or organism, comprising: (a) obtaining a library of polynucleotide fragments, wherein the polynucleotide fragments are produced by cleaving a polynucleotide from the cell or organism with a polynucleotide cleaving agent; (b) identifying sequences of the library of polynucleotide fragments by performing an assay; (c) identifying proximal regulatory regions of at least ten polynucleotides, each encoding a different transcription factor, by aligning the sequences of the library of polynucleotide fragments; (d) detecting at least one transcription factor binding sequence within the proximal regulatory region of the polynucleotide encoding each of the transcription factors; (e) identifying recognition sequences for each of the at least ten transcription factors within the remaining polynucleotide fragments within the library of polynucleotide fragments sequence by using information from at least one transcription factor binding sequence database; and (f) using the information from steps (b)-(e) to generate a map of the regulatory network for the cell or organism. In some embodiments of these aspects, the polynucleotide fragments are derived from at least three different cell-types of the same organism. In some embodiments of these aspects, the at least ten polynucleotides of step c is at least 20 polynucleotides. In some embodiments of these aspects, the one or more second polynucleotides are target genes regulated by the first polynucleotides. In some embodiments of these aspects, the proximal regulatory region of the polynucleotide encoding the first transcription factor is within 10 kilobases of a transcriptional start site (TSS) of the polynucleotide encoding the first transcription factor. In some embodiments of these aspects, the identified regulatory regions comprise footprints. In some embodiments of these aspects, the method further comprises analyzing the first regulatory network using at least one algorithm selected from the group consisting of: a normalized network degree algorithm, a network cluster algorithm; and a feed-forward loop algorithm. In some embodiments of these aspects, the method is performed under the control of one or more computers or processors. In some embodiments of these aspects, the first regulatory network is generated so as to determine whether occupancy of at least one identified transcription factor binding sequence by at least one of the plurality of transcription factors controls cell behavior.

In some aspects provided herein, the methods comprise methods of determining whether an allele of a gene of a heterozygous subject is associated with a functional disease phenotype comprising: a) obtaining a polynucleotide sample from the heterozygous subject, wherein the heterozygous subject has a risk allele and a non-risk allele; b) cleaving the polynucleotide sample in order to generate a library of polynucleotide fragments; c) obtaining sequence reads of the polynucleotide fragments; d) using the sequences of step c, identifying the sequence reads within the region encompassing the risk allele and non-risk allele and counting the number of sequence reads for each allele; e) using the numbers from step d, determining a ratio of the risk-allele sequence reads to the non-risk-allele sequence; and f) identifying the risk allele as functional if the ratio of step e is greater than 1:1. In some embodiments of these aspects, the risk allele is a single nucleotide polymorphism. In some embodiments of these aspects, the disease is cancer, diabetes, aging-related disorders, autoimmune disorder, metabolic disorder, neurodegenerative disease, or an inflammatory disorder. In some embodiments of these aspects, the polynucleotide is a fetal polynucleotide. In some embodiments of these aspects, the method further comprises distinguishing a homozygous allele from a heterozygous allele by comparing the polynucleotide fragment pattern to either: (a) known polynucleotide fragment patterns for homozygous alleles; or (b) known polynucleotide fragment patterns for heterozygous alleles.

In some aspects, provided herein are methods of identifying a cell type associated with a disease caused by a genetic variation comprising: a) cleaving a polynucleotide sample in order to obtain a library of polynucleotide fragments, wherein the polynucleotide sample comprises polynucleotides derived from different cell types; b) analyzing the library of polynucleotide fragments in order to obtain a cleavage pattern; c) determining whether the genetic variation perturbs the cleavage pattern across the different cell types; and d) analyzing the library of polynucleotide fragments in order to identify cell types associated with the cleavage patterns identified in step (c), thereby identifying the cell type associated with the disease. In some embodiments, the different cell types are at least 10 different cell types.

In some aspects, provided herein are methods of identifying a regulatory region of a gene comprising: (a) identifying a plurality of DNaseI hypersensitivity sites (DHS) within a gene wherein at least one of the DHS includes a promoter of the gene; (b) computing a pattern of DHS across greater than 10 cell types, wherein the pattern reflect the presence or absence of DHS; (c) computing the pattern of at least one non-promoter DHS within 500 kilobases of the promoter; and (d) correlating the patterns from step (b) and step (c) in order to identify DHS with synchronous patterns across greater than 10 cell types, thereby identifying a distal regulatory region of the gene.

Sequencing.

The methods provided herein describe sequencing of nucleic acids. In some cases, sequencing may include, Sanger sequencing, massively parallel sequencing, next generation sequencing, polony sequencing, 454 pyrosequencing, Illumina sequencing, SOLEXA sequencing, SOLiD sequencing, ion semiconductor sequencing, DNA nanoball sequencing, heliscope single molecule sequencing, single molecule real time sequencing, nanopore DNA sequencing, tunneling currents DNA sequencing, sequencing by hybridization, sequencing with mass spectrometry, microfluidic Sanger sequencing, microscopy-based sequencing, RNA polymerase sequencing, in vitro virus high-throughput sequencing, Maxam-Gibler sequencing, single-end sequencing, paired-end sequencing, deep sequencing, ultra deep sequencing.

Next-Generation Sequencing.

Next-generation sequencing may be used to determine the sequence of a set of nucleotides within a polynucleotide. In some cases, next-generation sequencing may include, massively parallel sequencing, deep sequencing, ultra-deep sequencing, high throughput sequencing, ultra-high throughput sequencing, single-molecule real-time sequencing, ion semiconductor sequencing, pyrosequencing, sequencing by synthesis, sequencing by ligation and chain terminator sequencing. The polynucleotide may be subject to at least one the methods described herein before sequencing. In some cases, the polynucleotide may be nucleic acid (e.g., genomic DNA).

In some cases, sequencing by synthesis may be used. For example, sequencing by synthesis may be SOLEXA sequencing (Illumina). SOLEXA sequencing relies on DNA amplification suing a solid surface. The methods for DNA amplification may include fold-back PCR with anchored primers. In some cases, nucleic acid (e.g., genomic DNA) may be fragmented, and adapters may be added to the DNA fragments. The adaptors may be added to only the 5′ end, only the 3′ end or to both the 5′ and the 3′ ends of the fragments. In some cases, the DNA fragments may be attached to the surface of flow cell channels. For example, the first cycle of the sequencing reaction may include be that the attached DNA fragments may be extended and amplified using a bridge method. In some cases, the DNA fragments may become double stranded fragments. In some cases, the double stranded DNA fragments may become denatured. In some cases, the cycle may be repeated using the solid surface amplification method. The result of several cycles of amplification may be the generation of several million clusters of DNA products. In some cases, there may be thousands of copies (e.g., 1,000) of single-stranded DNA molecules of the same template in each channel of the flow cell.

In some cases, at least one primer, a DNA polymerase and four fluorophore-labeled, reversibly terminating nucleotides may be used for the sequencing reaction. The results may be detected by excitation of incorporated fluorophores using a laser with which the SOLEXA system may be equipped. In some cases, an image may be captured and the identity of the first base is determined. In some cases, the 3′ terminators and fluorophores may be eliminated from the sample before the detection and identification process is repeated.

In some cases, pyrosequencing may be used. For example, pyrosequencing may be 454 sequencing (Roche). Nucleic acids (e.g., DNA) may be sheared, using any method know to those of skill in the art, into fragments. In some cases, the sheared fragments may be approximately 300-800 base pairs in length. In some cases, the sheared fragments may be subject to a method which results in blunt-ends. The blunt-end method may be used to remove single stranded bases or add bases to single strands to create a paired double stand with blunt ends. In some cases, adaptors (e.g., oligonucleotides) may be added to the ends of the fragments. In some cases, the adaptors may be added by a ligation method. In some cases, the ligated adaptors may be used as primers for amplification and sequencing of the fragments.

In some cases, the fragment-adaptor complexes may be attached to beads. In some cases, the beads may be DNA capture beads (e.g., streptavidin-coated beads) and the adaptors may contain a tag (e.g., 5′-biotin tag). In some cases, the fragment-adaptor complexes may be attached to the beads. In some cases, the complexes may be amplified in droplets using a PCR method which includes an oil-water emulsion. In some cases, the method may yield multiple copies of clonally amplified DNA fragments on each bead.

In some cases, the beads may be captured in wells. The wells may be of a plurality of sizes. In some cases, the wells may be picoliter sized. In some cases, the method of pyrosequencing, known to those of skill in the art, may be performed on each DNA fragment in parallel. The samples may be detected by the addition of one or more nucleotides to the fragment. In some cases, the nucleotide may generate a light signal. In some cases, the light signal may be recorded by a CCD camera. In some cases, the CCD camera may be contained within, or adjacent to, a sequencing instrument. In some cases, the results of the pyrosequencing reaction may be determined by comparing the proportion of the signal strength to the number of nucleotides incorporated.

Controls.

The methods provided herein may use comparisons of obtained data sets to reference data sets. The obtained data sets may be experimentally obtained from at least one sample. The obtained data sets may also be mathematically obtained by performing a set of calculations. In some cases, the reference data sets may be reference data sets. In some cases the reference data sets may be control data sets. Control data sets may be acquired using a number of techniques.

In some cases, the control data set may be acquired as an experimental control. The experimental control could be a sample to which at least one reagent that may have been added to the sample used to generate the obtained data set was not added. The experimental control could be a sample to which at least one step of a method that may have been performed on the sample used to generate the obtained data set was not performed.

In some cases, the control data set may be acquired as a diagnostic control. The diagnostic control could be a sample to which one treatment was performed which causes a response in the sample used to generate the obtained data set was not performed. The diagnostic control could be a sample that was taken from a healthy tissue of the same donor from which the diseased tissue was taken. The diagnostic control could be a sample that was taken from a healthy tissue of a different donor from which the diseased tissue was taken. For example, the diagnostic control could be a sample taken from a donor normal for the disease. In some cases, the donor may be a subject.

In some cases, the control data set may be located within the obtained data set. For example, a control data set may comprise control regions identified on a polynucleotide where other regions of the same polynucleotide comprise the observed data set. In some cases, a control data set may comprise control regions identified on a polynucleotide where the same regions on a different polynucleotide comprise the observed data set. For example, a control data set may comprise control regions identified on a polynucleotide where other regions a different polynucleotide comprise the observed data set. In some cases, a control data set may comprise control regions identified on a polynucleotide where different regions on a different polynucleotide comprise the observed data set.

In some cases, the control data set may be mathematically determined. For example, calculations performed on the control data set may differ from the calculations performed on the obtained data set. In some cases, the calculations may create a mathematically null control data set. In some cases, the calculations may create a mathematical reference control data set wherein the reference is a value assigned by a user.

Computers.

The methods and compositions described in the disclosure include analysis of data by a computer. In some cases, the computer acquires and analyzes data. In some cases the computer may communicate with a measurement device (e.g., a detector), digitize signals (e.g., raw data) obtained from the measurement device, and/or process raw data into a readable form (e.g., table, chart, grid, graph or other output known in the art). Such a form may be displayed or recorded electronically or provided in a paper format.

In some cases, the computer may be programmed to execute the methods and compositions described herein. The computer may be connected to a server that may include a central processing unit. The server may include memory, a data storage unit, an interface for communications across a network and peripheral devices. The memory, storage unit, interface, and peripheral devices may communicate with the processor through a motherboard. The storage unit can be used to store data, files or data associated with the operation of a device or method described herein.

The server may be coupled to a computer network through the communications interface. The network can be the Internet, an intranet and/or an extranet, an intranet and/or extranet that is in communication with the Internet, a telecommunication or data network. The server may be capable of transmitting and receiving computer-readable instructions or data through the network.

The server can communicate with one or more remote computer systems through the network. In some cases, only one server can be used. In other cases, multiple servers in communication with one another through an intranet, extranet and/or the Internet can be used.

A device or system that comprises the device may be arranged such that it is in communication with a control assembly (e.g., FIG. 56B:1150). Moreover, the control assembly may be used for device or system automation, such that it may be programmed to, for example, automatically pre-process samples, perform a desired number of reactions, execute a program that specifies the parameters of the reaction, obtain measurements, digitize any measurements into data, and/or analyze data. In some cases, the reaction may be but is not limited to a sequencing reaction, a protein reaction (e.g., chromatin immunoprecipitation), and/or other methods and compositions described herein.

A control assembly, for example, may include a computer server. An example computer server 1101 is shown in FIG. 56A. In some cases, a control assembly includes a single server 1101. In other situations, the system includes multiple servers in communication with one another through an intranet, extranet and/or the Internet.

The computer server may be programmed, for example, to operate any component of a device or system and/or execute any of the methods and compositions described herein. The server 1101 includes a central processing unit (e.g., processor) 1105 which can include at least one processor for parallel processing. The server 1101 also includes memory 1110 (e.g. random access memory, read-only memory, flash memory); electronic storage unit 1115 (e.g. hard disk); communications interface 1120 (e.g. network adaptor) for communicating with one or more other systems; and peripheral devices 1125 which may include cache, other memory, data storage, and/or electronic display adaptors.

The server can communicate with one or more remote computer systems through the network 1130. The one or more remote computer systems may be, for example, personal computers, laptops, tablets, telephones, Smart phones, or personal digital assistants. The server 1101 can be adapted to store device operation parameters, protocols, methods described herein, and other information of potential relevance. Such information can be stored on the storage unit 1115 or the server 1101 and such data can be transmitted through a network. In some cases, the transmitted data comprises information about the regulatory state of a cell or polynucleotide sample.

In some cases, the memory 1110, storage unit 1115, interface 1120, and peripheral devices 1125 are in communication with the processor 1105 through a communications bus (e.g., motherboard). The storage unit 1115 can be a data storage unit for storing data. The storage unit 1115 can store files or data associated with the operation of a device or method described herein.

In some cases, the server 1101 is operatively coupled to a computer network 1130 with the aid of the communications interface 1120. The network 1130 can be the Internet, an intranet and/or an extranet, an intranet and/or extranet that is in communication with the Internet, a telecommunication or data network. The network 1130 in some cases, with the aid of the server 1101, can implement a peer-to-peer network, which may enable devices coupled to the server 1101 to behave as a client or a server. In general, the server may be capable of transmitting and receiving computer-readable instructions (e.g., device/system operation protocols or parameters) or data (e.g., raw data obtained from detecting nucleic acids, analysis of raw data obtained from detecting nucleic acids, and/or interpretation of raw data obtained from detecting nucleic acids.) via electronic signals transported through the network 1130. In some cases, a network may be used, for example, to transmit or receive data across an international border.

The server 1101 may be in communication with one or more output devices 1135 such as a display or printer, and/or with one or more input devices 1140 such as, for example, a keyboard, mouse, or joystick. An output device that is a display may be a touch screen display, in which case it may function as both a output device and an input device.

Different and/or additional input devices may be present such an enunciator, a speaker, or a microphone. The server may use any one of a variety of operating systems, such as for example, any one of several versions of Windows, or of MacOS, or of Unix, or of Linux.

Devices and/or systems as described herein can be operated by way of machine (or computer processor), executable code (or software) stored on an electronic storage location of the server 1101, such as, for example, on the memory 1110, or the electronic storage unit 1115. In some cases, the code can be executed by the processor 1105. In some cases, the code can be retrieved from the storage unit 1115 and stored on the memory 1110 for ready access by the processor 1105. In some situations, the electronic storage unit 1115 can be precluded, and machine-executable instructions are stored on memory 1110. Alternatively, the code can be executed on a second computer system 1140.

The methods and compositions as described herein may be executed by way of machine (or computer processor), executable code (or software) stored on an electronic storage location of the server 1101, such as, for example, on the memory 1110, or the electronic storage unit 1115. In some cases, the code can be executed by the processor 1105. In some cases, the code can be retrieved from the storage unit 1115 and stored on the memory 1110 for ready access by the processor 1105. In some situations, the electronic storage unit 1115 can be precluded, and machine-executable instructions are stored on memory 1110. Alternatively, the code can be executed on a second computer system 1140.

Aspects of the devices, systems, compositions and methods described herein, such as the server 1101, can be include programming. In some cases, the technology may be a product and/or an article of manufacture that may comprise a machine (e.g., a processor) executable code and/or associated data that may be carried on or comprising a type of machine readable medium. Machine-executable code can be stored on an electronic storage unit, such memory (e.g. read-only memory, random-access memory, flash memory) or a hard disk.

In some cases, storage-type media can include any or all of the tangible memory of the computers, processors, etc., or associated modules thereof, such as various semiconductor memories, tape drives, disk drives, etc., which may provide non-transitory storage at any time for the software programming. All or portions of the software may, at times, be communicated through the Internet or various other telecommunication networks. Such communications, for example, may enable loading of the software from one computer or processor into another, for example, from a management server or host computer into the computer platform of an application server.

In some cases, another type of media that may include software elements may be, for example, optical, electrical, and/or electromagnetic waves. Software elements may be used across physical interfaces between local devices, through wired and optical landline networks and over various air-links. The physical elements that carry such waves, such as wired or wireless links, optical links, etc., also may be considered as media comprising the software.

As used herein, terms such as computer or machine readable medium may refer to any medium that participates in providing instructions to a processor for execution. For example, a machine readable medium, such as computer-executable code, may include but is not limited to, tangible storage medium, a carrier wave medium, and/or physical transmission medium. Non-volatile storage media can include, for example, optical or magnetic disks, such as any of the storage devices in any computer(s) or the like, such may be used to implement the system. Tangible transmission media can include: coaxial cables, copper wires, and fiber optics (including the wires that comprise a bus within a computer system). Carrier-wave transmission media may take the form of electric or electromagnetic signals, or acoustic or light waves such as those generated during radio frequency (RF) and infrared (IR) data communications. Common forms of computer-readable media may include, for example: a floppy disk, a flexible disk, hard disk, magnetic tape, any other magnetic medium, a CD-ROM, DVD, DVD-ROM, any other optical medium, punch cards, paper tame, any other physical storage medium with patterns of holes, a RAM, a ROM, a PROM and EPROM, a FLASH-EPROM, any other memory chip or cartridge, a carrier wave transporting data or instructions, cables, or links transporting such carrier wave, or any other medium from which a computer may read programming code and/or data. Many of these forms of computer readable media may be involved in carrying one or more sequences of one or more instructions to a processor for execution.

In some cases, the computer system may comprise a computer readable medium encoded with a plurality of instructions to perform an operation. In some cases, the operation may be to determine a protein-binding pattern of at least one nucleic acid. The operation may involve receiving or interpreting data from a plurality of nucleic acid fragments generated from the digestion of the nucleic acid in the presence of its binding proteins with a cleavage agent. For example, the data may comprise the identity of at least one nucleotide in at least some of the plurality of nucleic acid fragments. In some cases, the data may include the location of the first and the last nucleotide of each nucleic acid fragment. In some cases, the frequency of the first or last nucleotide appearing in segments (e.g, consecutive) of the nucleic acid may be used to derive a map of protein-binding for the nucleic acid. In some cases, the data may comprise the identity of none of the nucleotides. In some cases, the identify of the nucleic acids may be the sequence of the nucleotides in the nucleic acid.

In some cases, the computer system may be used to compare the protein-binding pattern of a nucleic acid from one source (e.g., organism, organ type, tissue type, cell type) to the protein-binding pattern of a nucleic acid from at least one different source (e.g., organism, organ type, tissue type, cell type). In some cases, the result of the comparison is a map.

In some cases, the operation may be to determine a protein-binding network of a nucleic acid. Such operations may involve receiving or interpreting data from a plurality of nucleic acid fragments generated from the digestion of the nucleic acid in the presence of its binding proteins with a cleavage agent. For example, the data may comprise the identity of at least one nucleotide in at least some of the plurality of nucleic acid fragments. In some cases, the data may include the location of the first and the last nucleotide of each nucleic acid fragment. For example, the frequency of the first or last nucleotide appearing in segments (e.g, consecutive) of the nucleic acid may be used to derive a protein-binding network for the nucleic acid. In some cases, the data may comprise the identity of none of the nucleotides. In some cases, the identify of the nucleic acids may be the sequence of the nucleotides in the nucleic acid.

In some cases, the operation may be to determine a transcription factor network of a nucleic acid; such operation may involve receiving data from a plurality of nucleic acid fragments generated from the digestion of the nucleic acid in the presence of its binding proteins with a cleavage agent. For example, the data may comprise the identity of at least one nucleotide in at least some of the plurality of nucleic acid fragments. In some cases, the data may include the location of the first and the last nucleotide of each nucleic acid fragment. For example, the frequency of the first or last nucleotide appearing in segments (e.g, consecutive) of the nucleic acid may be used to derive a transcription factor network for the nucleic acid. In some cases, the data may comprise the identity of none of the nucleotides. In some cases, the identity of the nucleic acids may be the sequence of the nucleotides in the nucleic acid.

In some cases, the method provides for the computer system to compare the transcription factor network, or the protein binding network, of a nucleic acid from one source (e.g., organism, organ type, tissue type, cell type) to the transcription factor network of a nucleic acid from at least one different source (e.g., organism, organ type, tissue type, cell type). In some cases, the result of the comparison is a generated map.

Software.

The methods described herein result in the acquisition of data sets. The data sets may be interrogated by a computer system. The computer system may be configured with a plurality of programs that may be used to analyze the data sets. In some cases, the programs may be software. In some cases, the data may be analyzed by the software to generate nucleic acid sequences, patterns of protein binding, maps of protein binding, patterns of regulatory networks, maps of regulatory networks.

The software that may be used to interrogate data sets with a computer system may be used with any operating system used by a computer system. In some cases, the software may be of any version of the software. In some cases, the versions may include updates, re-releases, supplemental packages, and new installations.

In some cases, the types of software that may be used include, but are not limited to, alignment, motif scanning, motif comparison, heat map generation, hive plot generation, calculation of conservation scores, statistical analysis, chromatography analysis, rendering of crystallography structures, genomic analysis, population genetics analysis, network rendering, network plot creation, network motif analysis, bean plot generation, expression data analysis, estimation of false discovery rates, gene ontology analysis, transcription factor network analysis. For example, specific software programs that may be used include, but are not limited to, Bowtie, FIMO, matrix2png, phyloP, R program, Skyline, MacPyMOL, BEDOPS, TOMTOM, KING, Circos, R library HiveR, Cytoscape, mfinder, R “beanplot” package, UCSC LiftOver, BWA, Affymetrix Expression Console, R “qvalue” package, GOrilla, R “kohonen” package, Ingenuity Pathways Analysis.

Databases.

Data output using the methods described herein can be analyzed in comparison to data organized in databases such as polynucleotide information databases. The databases may be publically available or privately held and made available on a per user or per request basis. In some cases, many types of databases may be used to compare the data acquired by the methods described herein. For example, databases may include information regarding nucleic acid cleavage sites (e.g., DNaseI), nucleic acid footprinting (e.g., DNaseI footprinting), sequence of nucleotides (e.g., DNA sequence), protein-binding motifs (e.g., histones, polymerases), transcription-factor binding motifs, transcription control (e.g., start site, end site).

In some cases, the databases may contain information derived from only one organism. In some cases, the databases may contain information derived from more than one organism. The more than one organism may be greater than or equal to about 2, 5, 10, 50, 100, 250, 500, 750, 1000, 1500, 2000, 2500, 5000, 10000, 20000, or 50000 organisms. In some cases, the more than one organism may comprise at least one organism that is a different organism from the other organism, or at least about 2, 3, 4, 5, 6, 7, 8, 9, 10, 50, 75 or 100 different organisms. In some cases, the databases may contain information derived from one cell type. In some cases, the databases may contain information derived from more than one cell type. The more than one cell type may be greater than or equal to 2, 5, 6, 7, 8, 9, 10, 20, 25, 50, 75, 100, 250, 500, 750, 1000, 1500, 2000, 2500, 5000, 10,000, 20,000, or 50,000 different cell types. In some cases, the databases may contain information derived from polynucleotides derived from a plurality of subjects with one or more diseases or disorders, e.g. greater than or equal to 2, 5, 6, 7, 8, 9, 10, 20, 25, 50, 75, 100, 250, 500, 750, 1000, 1500, 2000, 2500 diseases or disorders. In some cases, the databases may contain transcription binding factor sequences present in greater than 40%, 50%, 55%, 60%, 65%, 70%, 75%, 80%, 85%, 90%, 95%, 96%, 97%, 98%, or 99% of an entire genome.

In some cases, the databases may include, TRANSFAC, JASPAR, ENCODE, GENCODE, UniPROBE, NCBI Gene Expression Omnibus (GEO), FIMO, 1000 Genomes Project, Protein Data Bank, UCSC Brower, RIKEN, NCBI RefSeq, Complete Genomics, NimblegenSeqCapEZ Exome, GeneCards, UniProt Knowledgebase, Circos, R library HiveR, miRBase, RefSeq, AceView, EST, Eponine, Roadmap Epigenomics Program, NHGRI GWAS Catalog, CCDS project, BEDOPS.

Algorithms.

The methods provided herein may produce data that can be analyzed. In some cases, the analysis may include manipulation of the acquired data using at least one algorithm. In some cases, more than one algorithm may be used. Some algorithms may include use of statistics. Methods for incorporating statistical tests to the algorithms described herein are known to those of skill in the art.

The methods and compositions described herein may produce data that can be analyzed by sequencing. In some cases, sequencing may include determining the identity of at least one nucleotide in a nucleic acid. In some cases, sequencing may include determining the order of at least one nucleotide within a nucleic acid. For example, sequencing may result in information that may be used to determine the location of a protein binding to a nucleic acid. In some cases, the methods and compositions described herein may be used to generate data which does not contain any information about sequencing.

Footprint Detection Algorithm.

A footprint detection algorithm may be applied to a data set acquired by use of the methods described herein. The footprint detection method may include denoting each base of the nucleic acid sample (e.g., genome) with an integer score equal to the number of uniquely-mappable tags whose 5′ ends map to the location of each base.

In some cases, nucleic acid (e.g., genomic) regions (e.g., hundreds to thousands of base-pairs), whose clustered scores are statistically higher than expected can be labeled as hotspot regions. Hotspot regions can be used in further analysis. In some cases, a false discovery rate (FDR) can be applied to determine relevant hotspots. In some cases, the FDR can be at the 0.5% level. In some cases, the location of the hotspot at an FDR can be expanded (e.g., by 100 base-pairs) in the 3′ direction of the forward strand and scanned for footprints along the nucleotide sequence.

A footprint can be comprised of 3 components: a central component with a flanking component to each side. The central (or core) component of a footprint may depict the shadow of one or more bound proteins. The flanking regions may show activity indicative of a DHS (e.g., cutting by the DNaseI enzyme). In some cases, more contrast between the integer score of a central component and the integer scores of the flanking components may indicate a level of evidence that a protein is bound to the nucleic acid (e.g., genomic DNA). The level of evidence can be quantified using the formula:

fp-score=(C+1)/L+(C+1)/R, where

C=the average number of tags in the central component of the footprint,

L=the average number of tags in the left flanking component of the footprint, and

R=the average number of tags in the right flanking component of the footprint.

In some cases, the flanking components of a footprint can have a score of less than or equal to 25. In some cases, the flanking component s of a footprint can have a score of greater than 1. For example, a footprint detection algorithm may search the data set for footprints with central components less than or equal to 40 base-pairs in length or greater than or equal to 6 base-pairs in length. The footprint detection algorithm may search the data set for footprints with flanking components less than or equal to 10 base-pairs in length or greater than or equal to 3 base-pairs in length.

In some cases, the output of the algorithm can be the set of footprints that optimize the fp-score, may be subject to the criteria that L and R must both be greater than C, and may have all central components that may be disjoint. As defined, a lower footprint score (fp-score) is deemed more significant than a higher one.

Two or more potential footprints may, for example, have overlapping central components. In some cases, the footprint with the lowest fp-score may be selected for output. The entire local region around the selected footprint may be analyzed again given the knowledge of the first footprint. Newly identified potential footprints may not have a central component that overlaps with the central component of a previously selected footprint. In some cases, this type of analysis may be performed a plurality of times until new potential footprints are not identified within the local area.

Genomic locations may not be uniquely-mappable. In some cases, these locations may have scores of zero by definition. The central component of a footprint may consist of bases that are not uniquely-mappable, In some cases, the bases that are not uniquely mappable may comprise more than 20% of the entire length of the footprint. In some cases, these footprints may be discarded and may account for less than 1% of all identified footprints. False Discovery Rate Algorithm.

A false discovery rate algorithm may be applied to a data set acquired by use of the methods described herein. The false discovery rate (FDR) can account for the expected value of the quantity defined by the number of truly null features called significant divided by the total number of features called significant. The FDR can be closely approximated by the expected number of truly null features called significant divided by the expected number of total features called significant.

In some cases, an estimate of the expected number of truly null significant features may be determined when then number of footprints may be found with a fp-score at or below a threshold. In some cases, the threshold may be chosen from the randomized data. In some cases, one can estimate the expected number of all significant features analogously as the number of footprints found with a fp-score at or below a threshold. In some cases, the threshold may be the same threshold level in the observed data. In some cases, the fp-score can be calculated with a FDR estimated at 1%. In some cases, the FDR can be applied to a threshold score of the observed data for final footprint output reporting.

The false discovery rate algorithm may be based on a hypothesis. The hypothesis may be that the evidence for footprinting is no stronger than expected by random chance. The hypothesis can be tested. In some cases, the hypothesis can be tested by random assignment of the same number of tags found within a hotspot region to one or more uniquely-mappable locations within the hotspot region. In some cases, each base may be given an integer score equal to the number of tags whose 5′ ends map to that location.

In some cases, an additional 100 base-pairs can be added to the calculation and may account for the hotspot to be flanked the 3′ direction of the forward strand in the observed sample. In some cases, the additional 100 base-pairs may not be accounted for in the sample labeled as random. In some cases, the footprints in the sample can be ignored for the false discovery rate calculations. The proportion of footprints that may be ignored may be less than 1% of the total number of footprints.

In some cases, the identical locations of the random sample and the observed sample can be mapped in the observed sample output. For example, the same number of footprints may be accounted for in both the observed sample and the random sample during the FDR calculations. The average number of tags in either flanking region may be zero in the random case. In some cases, an arbitrarily large value may be assigned for that fp-score.

Hotspot Algorithm.

Binding patterns or cleavage frequencies described herein may be detected using one or more types of algorithms such as pattern-detection algorithms (e.g., hotspot algorithm, footprint occupancy score algorithm, false discovery rate algorithm, multi-set union algorithm, etc.). A hotspot algorithm may be applied to a data set acquired by use of the methods described herein, particularly where a data set output contains hotspots. The purpose of the hotspot algorithm may be to identify regions of local enrichment of short-read (e.g., 27-mer) sequence tags mapped to the nucleic acid (e.g., genome). In some cases, enrichment of the tags can be determined in a small window (e.g., 250 bp) relative to a local background model. In some cases, the enrichment can be determined based on the binomial distribution. In some cases, the binomial distribution can use the observed tags over a large (e.g., 50 kb) surrounding window. For example, each mapped tag can be assigned a z-score for the windows centered on the tag. In some cases, the windows may be small (e.g., 250 bp) and large (e.g., 50 kb).

Z-Score Calculation.

A hotspot can be a location in the nucleic acid (e.g, genome) where a succession of tags are located within a window (e.g., 250 bp). In some cases, the hotspot may be assigned a z-score. In some cases, each of the tags may have a high z-score (e.g., greater than 2). The hotspot z-score may be relative to the windows (e.g., 250 bp and 50 kb) that may be centered at the average position of the tags forming the hotspot.

For example, n observed tags may lie within a 250 bp window, and N total tags lie within the 50 kb surrounding background window (e.g., N≧n). In some cases, each tag in the background window may be considered an “experiment.” Each experiment may have a favorable outcome if it falls in the smaller window. It can be assumed that each base in the 50 kb window has an equally likely chance of occurrence therefore, the probability of success for each tag can be; p=25,050,000.

In some cases, the bases in a window (e.g., 50 kb) may not be uniquely mappable (e.g., using 27-mers). The tags may be adjusted to account for the number of uniquely mappable bases in a window. For example, the binomial distribution may apply and the expected number of tags falling in the smaller window may be μ=Np. In some cases, the standard deviation of this expected value may be σ=\sqrt{Np(1−p)}. The z-score for the observed number of tags in the smaller window may be calculated using; z=n−μσ. The standard deviation may be greater than 1, 2, 3, 4, or 5 standard deviations.

Two-Pass Hotspot Scheme Algorithm.

Scoring hotspots in regions of very high enrichment may cause problems. For example, these hotspots may be monster hotspots and can increase the background signal relative to neighboring regions. In some cases, the monster hotspots may decrease the neighboring z-scores. This may result in regions that may otherwise display high levels of enrichment but rather can be missed due to the monster.

A two-pass hotspot scheme algorithm can be applied to prevent monster hotspots from blocking the detection of other hot spots. The two-pass hotspot scheme algorithm can be used as follows, for example, after the first round of hotspot detection; the tags located in the first-pass hotspots may be deleted. In some cases, a second round of hotspots may be computed accounting for this deleted background. The hotspots from the first and second rounds may be combined using the algorithm and may then be scored again against the deleted background. In some cases, the number of tags in each hotspot may be computed using all tags. In some cases, the 50 kb background windows may be computed using the deleted background.

Hotspot Peaks.

In some cases, hotspots can be resolved into DHSs (e.g., 150 bp) using a hotspot peak-finding algorithm. For example, the sliding window tag density (e.g., tiled every 20 bp in 150 bp windows), can be computed. In some cases, the sliding window tag density can be used to perform a peak-finding analysis. The analysis may include the density of peaks in each hotspot region. In some cases, each peak (e.g., 50 bp) may be assigned the same z-score as the hotspot region in which the peak is found.

FDR Calculations Using Random Tags.

In some cases, an FDR (false discovery rate) z-score threshold can be assigned to a set of hotspot peaks using random data. For example, as a null model, tags can be computationally generated in a uniform manner over uniquely mappable nucleic acid (e.g., genome) bases. The some number of tags may be used for observed and random data sets. In some cases, the random data may also be located in hotspots. The random data may be identified, scored and resolved into peaks using the same technique as may be used for observed data. In some cases, for a given z-score threshold marked “T”, the FDR for the observed hotspot peaks with a z-score that may be greater than T can be estimated using the following equation:

FDR(T)=# of random peaks with, z≧T# of observed peaks with, z≧T.

In some cases, the numerator may be calculated for a null dataset and may overestimate the number of false positives in the observed data. This equation may result in a conservative estimate of the FDR.

De Novo Motif Discovery

Use of the methods provided herein may result in the acquisition of data that can be analyzed to identify novel motifs in a nucleic acid. A plurality of statistical methods can be used for the de novo discovery of such motifs and are known to those of skill in the art. In some cases, de novo discovery can be performed using a zero-or-one-per-sequence (ZOOPS) method, an any-number (ANR) method, In some cases, each method may use overrepresented subsequences in target sequences and determine the relative amount to a background expectation.

For example, the ZOOPS approach may count a particular subsequence once toward the observed or background frequency counts. In some cases, a ZOOPS background can be generated by shuffling all bases in each target region (e.g., 8-mer) with no regard to potential di-nucleotide or higher order structure. In some cases, the target sequence may be shuffled such that it includes the bases within the target region. The number of times every 8-mer occurs across all regions following each shuffle, subject to the ZOOPS constraint, can then be counted.

In some cases, a background mean and variance can be generated for each 8-mer. The background mean and variance may be used in the calculation of the observed motif z-scores. In some cases, an ordered list of all motifs with a z-score may be generated. In some cases, the minimum z-score is at least 10. The ordered list of z-scores can be clustered.

In some cases, an ANR background can be generated by counting the number of times a motif subsequence occurs in a nucleic acid (e.g., genome). The number of times a motif subsequence occurs within the target sequences may also be counted. In some cases, a letter corresponding to the nucleotide (e.g., a, g, c, t) may be assigned at random. The probability that any unknown base exists prior to background generation is equivalent. In some cases, a p-value can be calculated for each observed motif. In some cases, the p-value calculation may utilize a hypergeometric distribution. In some cases, an ordered list of motifs with an uncorrected p-value (e.g., less than 0.01) can be generated. The ordered list of p-values can be clustered.

For example, any 8-mers where the number of intervening Ns may be between 0 and 8 (e.g., aNcNgNtNaNNNNcgt and acgtacgt) may be searched. The generated motif list can be large and may contain variants. In some cases, Heuristics can be used to filter and cluster the list, described below, to obtain a non-redundant motif set. In some cases, the 8-mer background mean and variance for motifs with intervening N's may be used to generate the motif list. The statistics applied with the ZOOPS approach may be generated from shuffled bases. In some cases, a suitable estimate for motifs with intervening N's may be to use the backgrounds and variances calculated for 8-mers.

For example, the ANR approach may use all instances found toward the counts. The ANR approach may apply a first filter that may be used to compare the ordered consensus sequences without any alignments. In some cases, the highest z-score (e.g., lowest p-value) motif may be added to the output list. Each subsequent motif may then be compared to each entry in the output list. In some cases, the motif is discarded if a similar entry is found. In some cases, the new motif may be added to the bottom of the output list if no motif in the output list is a significant match. For example, if there are two consensus sequences, X and Y, the first character of X may be compared to the first character of Y and so on. In some cases, the number of exact matches, not including matching N's, may be accumulated. In some cases, the number of differences can be 1. In some cases, the number of differences can be 2.

In some cases, the motifs in the output list can be reversed. In some cases, the same ordered filtering may be performed to reduce the size of the list. The motifs may be reversed to create the output. In some cases, the reverse complements are not computed or compared during the initial filtering step.

The ANR approach may apply a second filtering step. The second filter step utilizes the consensus sequence representations of the motifs. In some cases, the sequences may be clustered into a list of consensus sequences that may be analyzed and organized into a comparison list. In some cases, the highest ranked motif consensus sequences may be output. In some cases, the ranked motifs may be added to the comparison list. For example, each subsequent consensus sequence may then be compared to each entry in the list. In some cases, if a similar sequence is found in the list, the consensus sequence under consideration may be added to the bottom of the comparison list. In some cases, if a similar sequence is not found on the list, the consensus sequence may be combined with the output and then added to the bottom of the comparison list.

In some cases, during the consensus sequence comparisons, all alignment possibilities and reverse complement combinations may be considered. For example, all of the nucleotides that agree in the pairwise comparisons, not including aligning the N's, may be counted. In some cases, if two consensus sequences are the same length and the N placeholders are in the same positions when the first bases are aligned, exact matches may be required to declare similarity. In some cases, if the two consensus sequences are not the same length and the N placeholders are not in the same position, then fewer matches (e.g., 6) may be required for similarity.

A positional weight matrix (pwm) may then be constructed for each remaining motif consensus sequence. In some cases, pwms may be clusterd into an output list and a clustered list. In some cases, the topmost motif pwms may be added to the output list. Each subsequent pwm may be compared to each entry in the output list. In some cases, if a similar pwm is found, the pwm under consideration may be added to bottom of the clustered list. The pwm may also be compared to each entry of the clustered list. If a similar pwm is on the clustered list, the pwm may be added to the bottom of the clustered list. In some cases, the pwm may be added to the bottom of the output list.

In some cases, during pwm comparisons, all possible alignments and reverse complement combinations may be considered. Statistics known to those of skill in the art may be used. For example, a Pearson correlation coefficient may be calculated.

Multiset Union Algorithm.

Use of the methods provided herein may result in the acquisition of data that can be analyzed to identify the multiset unit of all footprints. The algorithm may be used across a single sample of a nucleic acid. The algorithm may also be used to determine the multiset union across a plurality of cell, tissue or organism types. In some cases, the multiset union may be used to identify novel motifs in a nucleic acid. For example, the multiset union of all footprints across all cell types can be calculated. In some cases, for each element of the union, all significantly overlapping footprints (e.g., 65% or more of their bases in common with the element) can be calculated.

In some cases, the genomic coordinates of the footprint can be redefined to the minimum and maximum coordinates from the overlap set. For example, all redefined footprints from the union may be applied to a subsumption and uniqueness filter. In some cases, if the footprint is located within another footprint on the nucleic acid (e.g., genome), the filter may be used to discard the smaller of the two footprints. In some cases, if the footprint is located within another footprint on the nucleic acid (e.g., genome), the filter may be used to select one footprint that may be identical.

In some cases, footprints that may pass through the filter may comprise the final set of footprints. For example, the final set may comprise 8.4 million combined footprints across a variety of cell types. Unlike footprints that may be generated using a single cell type, the combined set may include overlapping footprints.

Genome Structure Correction.

Use of the methods provided herein may result in the acquisition of data that can be analyzed to identify the significance of overlap between footprints and predicted motifs. In some cases, the overlap between footprints and predicted motifs may occur within hotspot regions. The Genome Structure Correction (GSC) test can be used for such calculations. In some cases, genomic hotspot regions from a variety of cell types (e.g., 41) may be merged to comprise the domain used for the GSC test. In some cases, the GSC test and the domain may include the multiset union data analysis of all footprints. In some cases, the GSC test and the domain may include a set of the motif predictions within the domain. For example, the databases and predictions that may be used can include FIMO; P<1×10⁻⁵ using TRANSFAC and JASPAR Core, separately. These outputs can be used as inputs to the GSC test. In some cases, the program parameters can be set (e.g., -n 10000, -s 0.1, -r 0.1, and -t m). In some cases, the significance can be reported as a Z-score (e.g., the empirical P value of 0).

In some cases, the average per-nucleotide number of overlapping motif instances over segments of a genome-wide partition can be determined. The hotspot regions and footprint regions across multiple (e.g., 41) cell types can be merged. In some cases, genome-wide FIMO scan predictions over TRANSFAC (e.g., P<1×10⁻⁵) can be used to count the number of motif scan bases contained within the merged footprint partition. The number of motif scan bases can be divided by the total number of bases within the partition. In some cases, the average across the genomic complement between merged hotspots and merged footprints may be calculated. For example, a genome-wide average located outside of the hotspots can be divided by the number of nucleotides with known base labels (A, C, G, T).

Normalized Network Degree Algorithm.

Use of the methods provided herein may result in the acquisition of data that can be analyzed to identify a normalized network degree. In some cases, the degree of relatedness between different networks can be established. In some cases, the networks can be arranged by protein binding patterns. In some cases, the proteins may be transcription factors. For example, quantitative global summary of the factors contributing to each cell-type-specific network can be computed. In some cases, the normalized network degree (NND) factor represents the relative number of interactions observed in a sample. In some cases, the NND factor can be associated to each sample (e.g., cell types) for each of the proteins (e.g., transcription factors) analyzed. In some cases, the number of transcription factors analyzed can be more than 100. In some cases, the number of transcription factors can be more than 500. In some cases, the number of transcription factors can be more than 1000.

Feed-Forward Loop Algorithm.

Use of the methods provided herein may result in the acquisition of data that can be analyzed to identify a feed forward loop. In some cases, the behavior of a protein within a cellular regulatory network can be determined by locating the position of the protein within at least one feed forward loop (FFL). FFLs may comprise a three-node structure in which information may be propagated from the top node through the middle to the bottom node. In some cases, the number of FFLs containing a protein of interest at each of the three different positions (top versus middle versus bottom can be identified in at least one cell type. In some cases, the number of FFLs containing a protein of interest at each of the three different positions (top versus middle versus bottom can be identified in at least a plurality of cell types.

For example, a protein may participates in a FFLs at one of two “passenger” positions (e.g., 2 and 3) in a given cell type. The protein may participate in the FFL at a different position in a different cell type. For example, the protein may switch from being a passenger to being a driver (top position) of a FFL. In some cases, the location of a protein in a FFL may change in a diseased cell type. For example, a protein may exist in a driver position during a disease state. The protein may be located in the driver position in more than one cell type sample of a diseased state. In some cases, the protein in the driver position in the disease state may alter the basic organization of the regulatory network in the FFL analysis.

FFLs may be used to identify cell-selective functional specificities of commonly expressed proteins within the context of other proteins within the same cell type. In some cases, the cell-selective functional specificities of commonly expressed proteins may be within the context of other proteins across more than one cell type.

In some cases, a footprint-driven (e.g., DNaseI footprint-driven) network analysis may be used to identify a potential role for a protein in a nucleic acid (e.g., genomic DNA) sample. In some cases, the potential role may be related to a disease state of the organism from which the nucleic acid sample was taken. For example, the role of a protein may be to control the oncogenic transformation of cells. In some cases, the network analysis may be used to derive information about specific factors in cell types. In some cases, the cell types may be physiological. In some cases, the cell types may be pathological.

Pattern-Mapping Algorithm.

Use of the methods provided herein may result in the acquisition of data that can be analyzed to identify a map of protein binding patterns. In some cases, the patterns may indicate the identity of factors which occupy transcription factor binding motifs. In some cases, the transcription factor binding motifs are footprints. For example, databases of transcription-factor binding motifs can be used to infer the identities of factors that occupy footprints. In some cases, the footprints are DNaseI footprints. In some cases, the databases are annotated. In some cases, the identities of factors that occupy footprints can be compared to additional data sets. In some cases, the additional data set may be compiled, in part, from data obtained by the ENCODE ChIP-seq analysis.

Transcription factor regulatory networks may be generated by analysis of bound DNA elements. In some cases, the DNA elements may be located such that the DNA elements can regulate expression of a transcription factor. In some cases, the bound DNA elements are actively bound. In some cases, the bound DNA elements are not actively bound. For example, actively bound DNA elements can be detected within specific regulatory regions. In some cases, the regulatory regions are proximal regulatory regions (e.g., DNaseI hypersensitive sites within a 10 kb interval centered on the transcriptional start site (TSS]) of transcription factor genes (e.g., 475). In some cases, the transcription factor genes may contain annotated recognition motifs.

In some cases, a transcription factor regulatory network may be generated for one cell type. In some cases, a transcription factor regulatory network may be generated for more than one cell type. The analysis may be performed a plurality of times and in some cases, each time the analysis is performed a different source of nucleic acid may be used.

For example, the transcription factor regulatory network (e.g., transcription factor-to-transcription factor) may include regulatory interactions (edges). In some cases, hundreds of transcription factors may be analyzed. In some cases, thousands of edges may be identified.

A functional redundancy of some nucleic acid-binding motifs may be identified. In some cases, the nucleic-acid binding motif may be a DNaseI footprint. In some cases, a single factor could occupy a single DNaseI footprint. In some cases, multiple factors could occupy a single DNaseI footprint.

In some cases, DNaseI hypersensitivity may be detected at proximal regulatory sequences and may parallel gene expression. For example, the expressed set of transcription factors for each cell type may allow for the construction of a comprehensive transcription regulatory network for a given cell type.

In some cases, a tag density file may be prepared. Each cell type may have a unique tag density file. The tag density files may represent the number of times that a nucleic acid may be cut by an enzyme (e.g., DNaseI). In some cases, the number of times that a nucleic acid may be cut may be observed in a window. In some cases, the window may be small (e.g., 150 bp). In some cases, the windows may be shifted. In some cases, the shifts may occur every 20 bp.

In some cases, the datasets may be normalized. The plurality of datasets that may be generated may not be normalized. In some cases, the datasets that are not normalized may have a comparable level sequencing after DNaseI cleavage to the normalized dataset. In some cases, the datasets across all cell types may be summed. The local maxima may be identified and may form a map of genomic locations that may be subject to a pattern search. For example, for a given region, sites may be ranked by a scoring function. In some cases, the scoring function may be determined by comparing a vector of tag (e.g., DNaseI) density to that of a control site. The strongest matches may be defined as the lowest sum of squared absolute differences in tag counts for each cell type between the two locations. In some cases, a weight vector may be applied in order to multiply all tag counts from those cell types by a small factor to increase the relative stringency of the match for those cell types. This could be used, for example, when searching for sites that may be assayed in one or more particular cell types.

Linear Regression Analysis Algorithm.

Use of the methods provided herein may result in the acquisition of data that can be analyzed using a linear regression analysis. In some cases, a linear regression analysis may be used to determine if a nucleic acid binding protein is modified. In some cases, the modification may be methylation. In some cases, the association between methylation status and accessibility may be determined.

For example, a list of DHSs that may be found in a plurality of cell lines (e.g., 19) may be generated. In some cases, the linear regression may be applied to determine accessibility relative to an average proportion modified (e.g., methylated) nucleic acids relative to regions of interest (e.g., CpG islands located within a 150 bp region centered around the DNaseI peak). In some cases, sites where the region of interest may differ across multiple cell lines may be excluded from the analysis. In some cases, the R package qvalue to estimate a global FDR may be used in the linear regression analysis.

In some cases, the relationship between expression of a protein (e.g., transcription factor) and a modification to the regulatory region (e.g, transcription factor binding site methylation) may be determined. For example, a set of putative binding sites for transcription factors, based on matches to database motifs inside of the thousands of previously identified DHSs, can be determined. In some cases, nucleic acid associated proteins may be methylated. In some cases, methylation can be associated with nucleic acid accessibility. For example, the average methylation modifications for each transcription factor may be regressed. In some cases, the regression analysis may occur at a plurality of motifs and may be correlated with gene expression.

Rank-Ordered List Algorithm.

Use of the methods provided herein may result in the acquisition of data that can be analyzed using a rank-ordered list algorithm. The rank-ordered list algorithm can be used to determine the overall regulatory complexity of a gene by connecting the number of distal DHSs to a promoter. In some cases, the rank-ordered list is a quantitative measure. The rank-ordered list algorithm may also be used to determine systematic functional features of genes with complex regulation.

Gene-Ontology Analysis Algorithm.

Use of the methods provided herein may result in the acquisition of data that can be analyzed using a gene-ontology analysis algorithm. In some cases, genes can be ranked by the number of distal DHSs that may be paired with the promoter of each gene. In some cases, a distal DHS may be within ±500 kb of a regulatory region (e.g., promoter). In some cases, genes may have one TSS that may indicate one distinct promoter with one DHS. In some cases, genes may have one TSS that may indicate one distinct promoter with more than one DHS. In some cases, genes may have more than one TSS that may indicate more than one distinct promoter with one DHS. In some cases, genes may have more than one TSS that may indicate more than one distinct promoter with more than one DHS. In some cases, genes can be ranked in descending order by the number of distal DHS using a database (e.g., GENCODE). For example, the rank-ordered list may be used as an input for a gene ontology analysis. In some cases, the analysis may be performed using software. In some cases, the software may be GOrilla.

Random Matched Motif Data Simulation Algorithm.

Use of the methods provided herein may result in the acquisition of data that can be analyzed using random matched motif data simulation algorithm. In some cases, a motif may be located distal to a regulatory region. In some cases, the motif may affect the regulatory region. For example, the regulatory region may be a promoter. For example, the number of observed promoter-distal motif occurrences may be connected. In some cases, the number of co-occurrences may be recorded using a matrix. For example, the matrix may be an asymmetric square matrix (e.g., 732 motifs×732 motifs). In some cases, more than one matrix may be created. In some cases, the matrices may be identical and each may be initialized to zero.

In some cases, the algorithm may include an analysis of each promoter DHS, “p” that may contain “nap” motifs and that may be connected to “dp” DHSs with a minimum correlation (e.g., >0.8). The number of motifs (without replacement) sampled, “mp”, from an observed distribution of motifs in promoter DHSs and the number of independent samples “dp” (with replacement) from the observed distribution of the number of motifs per distal DHS. For each of the “dp numbers”, the same number of motifs may be sampled from the observed distribution of motifs in distal DHSs. Pairs of co-occurrences within the collections of sampled promoter motifs and distal motifs may be tallied and may be added to the matrix of simulated random observations.

In some cases, the tallies of random motif co-occurrences may be accumulated within the random-matched matrix for the promoter DHSs. The observed co-occurrence counts may be compared to each random-matched co-occurrence count. In some cases, one replicate randomization may be performed and accumulated in a third “tally” matrix. The third tally matrix may consist of zeroes and ones. In some cases, a one may be added to the corresponding cell in a third matrix if the random-matched co-occurrence count is the same size as that which is observed. In some cases, the same size may be at least as large as that which is observed. Statistics may be performed and are known to those of skill in the art. In some cases, P-value estimation for co-occurrences of motifs and families of related motifs may be used.

Measurement of Nucleotide Heterozygosity and Estimation of Mutation Rate Calculations Using Algorithms.

Use of the methods provided herein may result in the acquisition of data that can be analyzed to determine nucleotide heterozygosity and estimate the mutation rates across a region of a polynucleotide. The calculation may use a database to interrogate the acquired dataset against. In some cases, the database may be a publicly-available database. For example, the database may be the publically-available genome-wide variant dataset. This dataset (e.g., Complete Genomics) includes 54 unrelated individuals (ftp://ftp2.completegenomics.com/Public_Genome_{—} Summary_{—} Analysis/Complete_Public_{—} Genomes_{—}54 genomes_VQHIGH_VCF.txt.bz2, Complete Genomics assembly software version 2.0.0). In some cases, individuals may be labeled with Coriell IDs.

In some cases, the sites at which variants may be found are filtered. The filter can be used to obtain variants for which a full genotype call could be made for a set of individuals (e.g., at least 20% of all those sampled). In some cases, the partial calls (e.g. a genotype of A and N) may be considered as a non-call. For example, allele frequencies for the locations of all variant sites occurring within a set of genomes (e.g., 51) may be estimated. The estimations may include removal of all sites annotated in a database. In some cases, the database may be GENCODE (e.g., exons). In some cases, the database may be the RepeatMasker.

An equation that may be used to calculate each variant with minor allele frequency “p”, the nucleotide heterozygosity at that site is π=2p(1−p). In some cases, the mean π per site within the DHSs of each sample (e.g., cell line) may be calculated by summing π for all variants within the DHSs and dividing by the total number of bases belonging to the DHSs. In some cases, the mean π per site between DHSs and degenerate (e.g., fourfold) exonic sites may be calculated using called reading frames from a database (e.g., NCBI-called reading frames). In some cases, this can be a summed it for all variants. In some cases, the summed π for all variants may be within the degenerate sites (e.g., non-RepeatMasked fourfold-degenerate sites). The degenerate sites may be divided by the total number of sites considered. In some cases, confidence intervals (e.g., 95%) on π per degenerate (e.g., fourfold) site may be performed using bootstrap samples (e.g., 10,000).

Relative mutation rates within the DHSs of each cell line may be estimated. In some cases, the relative mutation rates may be estimated using at least one genome alignment. In some cases, the genome alignment may be the human/chimpanzee alignments from the UCSC Genome Browser (reference versions hg19 and panTro2, http://hgdownload.cse.ucsc.edu/goldenPath/hg19/vsPanTro2/syntenicNet/). Various parameters may be considered. In some cases, a conservative alignment may be chosen. For example, the conservative alignment may be a syntenicNet alignment (e.g., http://hgdownload.cse.ucsc.edu/goldenPath/hg19/vsPanTro2/README.txt).

In some cases, for DHSs that may be called in each cell line, the number of nucleotide differences between chimpanzee and human (d) and the number of bases aligned (n) may be extracted. In some cases, the DHS-specific relative mutation rates μ per site per generation as μ=(d/n) may be estimated.

Applications.

The disclosure provides methods and compositions that may be used in a variety of applications. In some cases, the methods and compositions may be used for an application which may provide a diagnosis of a condition or a prognosis for a condition. In some cases, the methods and compositions may be used for an application which may provide a risk of a condition. In some cases, the application may be an assay. The condition may be associated with at least one nucleic acid. For example, the sequence of the nucleic acid may be known, determined using the methods and compositions described herein, determined using methods known to those of skill in the art, or unknown. In some cases, the nucleic acid is genomic DNA. The condition may be associated with occupation of at least one nucleic acid sequence, for example, a regulatory motif, by a regulatory factor. In some cases, the regulatory factor may be a transcription factor or a histone. The condition may be associated with a regulatory network and may be detected, diagnosed or prognosed, by the identified regulatory network or the comparison of the identified regulatory network with a different regulatory network.

In some cases, the condition may be associated with at least one structure of the nucleic acid (e.g., genomic DNA). For example, the structure of the nucleic acid may be the chromatin. In some cases, the structure of the chromatin may be a topography, wherein the features of the nucleic acid may be determined. In some cases, the features may include the distance between nucleotides in the chromatin, the distance between grooves in the nucleic acid (e.g., major groove, minor groove), the features of the chromatin when the nucleic acid is not bound to a protein, features of nucleic acid-protein interfaces, the features of the chromatin when the nucleic acid is bound to a protein, the features of the chromatin when the nucleic acid is adjacent to a region of the nucleic acid that is not bound to a protein and/or the features of the chromatin when the nucleic acid is adjacent to a region of the nucleic acid that is bound to a protein, or a particular pattern or frequency of binding between polynucleotides and proteins. In some cases, the features described herein may be the particular topography of the chromatin structure. In some cases, the topography may be associated with a condition.

The methods and compositions described herein may be used to determine a set of information about the nucleic acid (e.g., genomic DNA, mitochondrial DNA) of a sample. In some cases, the nucleic acid may comprise more than half of the genome of an organism, or greater than 40%, 50%, 60%, 65%, 70%, 75%, 80%, 85%, 90%, 91%, 92%, 93%, 94%, 95%, 96%, 97%, 98%, 99%, 99.1%, 99.5%, 99.8%, 99.9% of the total polynucleotides of a particular type (e.g., total DNA, total genomic DNA, total RNA, total mRNA) of an organism. The nucleic acids may comprise the total polynucleotides of a particular cellular or extracellular compartment (e.g., organelle, nucleus, mitochondrion, exosome, etc.), or percentage thereof, such as greater than 40%, 50%, 60%, 65%, 70%, 75%, 80%, 85%, 90%, 91%, 92%, 93%, 94%, 95%, 96%, 97%, 98%, 99%, 99.1%, 99.5%, 99.8%, 99.9% of the polynucleotides in such cellular or extracellular compartment. In some cases, the nucleic acids may comprise the entire genome of an organism. In some cases, the set of information may be a regulatory protein binding pattern, a transcription factor binding pattern, a network of regulatory proteins, a network of transcription factors, a map of regulatory regions which regulate genes, a map of regulatory regions associated with footprints, and/or the association of footprints with genes. In some cases, the set of information may be information from a deoxyribonucleic acid, and/or a ribonucleic acid.

The methods and compositions described herein may be applied to a polynucleotide which, for example, may be bound to a binding protein. The binding of a binding protein to a polynucleotide creates a region of engagement between the binding protein and the polynucleotide. In some cases, the presence or absence of a region of engagement may be determined. For example, a disease, disorder and/or a trait may be predicted based on the presence or absence of at least one region of engagement. In some cases, the region of engagement may occur at or near a gene. In some cases, the region of engagement may control gene activity. For example, gene activity may be reduced or enhanced.

The methods and compositions may be applied to samples containing nucleic acid (e.g., genomic DNA) taken from multiple sources. In some cases, the source may be a cell. In some cases, the cell may be in a stage of cell behavior. For example, cell behavior may include a cell cycle, mitosis, meiosis, proliferation, differentiation, apoptosis, necrosis, senescence, non-dividing, quiescence, hyperplasia, neoplasia and/or pluripotency. In some cases, the cell may be in a phase or state of cellular maturity. In some cases, the phase or state of cellular maturity may include a phase or state during the process of differentiation from a stem cell into a terminal cell type.

In some cases, the methods and compositions may be used to identify a regulator of cell behavior. For example, a regulator may comprise a nucleic acid binding protein, a protein which binds a nucleic acid binding protein, a modification to a nucleic acid binding protein, a modification to a protein which binds a nucleic acid binding protein, a sequence of a nucleic acid in a regulatory region, and a sequence of a nucleic acid not in a regulatory region. In some cases, the regulator may be directly bound to the nucleic acid. In some cases, the regulator may be indirectly bound to the nucleic acid.

In some cases, the methods and compositions described herein may be used to predict changes in cell behavior. Changes in cell behavior may include, a stage or transition through stages of pluripotency, transition between proliferation and quiescence or senescence and apoptosis or necrosis in any order, change from one cell function to a different cell function, differentiation from one cell type into a different sub-cell type, differentiation from one cell type into a different cell type or regulation of cell fate.

Regulators of cell behavior may be organized into networks using the methods and compositions described herein. In some cases, the networks may comprise, regulatory networks, transcriptional regulatory networks, variant networks, trait-associated networks, disease-associated networks, transcription start site networks, distal regulatory networks, master regulatory networks and cell-fate associated networks. In some cases, there may be one regulator in a regulatory network. In some cases, there may be greater than 1, 2, 3, 4, 5, 10, 20, 30, 40, 50, 60, 70, 80, 90, 100, 150, 200, 250, 300, 350, 400, 450 or 500 regulators in a network. In some cases, the transcription start site network may include a 50 base pair footprint region.

Cell behavior may be controlled by, amongst other factors, changes in gene expression. In some cases, the methods and compositions described herein may be used to predict gene expression. Occupation of at least one nucleic acid sequence by a regulatory factor may affect gene expression in at least one of the following ways; increase gene expression, decrease gene expression, prevent gene expression, indicate previous expression of a gene or indicate past expression of a gene. In some cases, occupation of at least one nucleic acid sequence which controls a gene by a regulatory factor may affect expression of at least more than one gene. In some cases, occupation of at least one nucleic acid sequence which controls a gene by a regulatory factor may affect expression of a different gene.

The state of cell differentiation may be predicted using the methods and compositions described herein. In some cases, differentiation includes identification of stem cells wherein stem cells may be, fetal, embryonic, adult, tissue-specific (e.g., adipose, skin, neuronal, vascular, cardiac, gastric, gonad, etc.). In some cases, the identification of stem cells includes the identification of the stage of potency, the potency, the potential, or the stemness of a stem cell. In some cases, a stem cell may be pluripotent, totipotent, multipotent. In some cases, the stage of potency includes identification of de-differentiation, differentiation, the proliferative potential or the quiescent potential. In some cases, the methods may be used to identify stages of T cell maturation.

The methods and compositions described herein may be used to diagnose or prognose a disease. The disease may be oncologic, neurodegenerative, metabolic, cardiovascular, endocrine, immunologic, hematologic, developmental, muscular, rheumatoid, neuropathologic, glandular, aging-related, metabolic or autoimmune. In some cases, the disease may be, multiple sclerosis, Crohn's disease, muscular dystrophy, coronary heart disease, body mass index, blood pressure, bipolar disorder, ulcerative colitis, type 1 diabetes, type 2 diabetes, aging-related disorder, primary biliary cirrhosis, rheumatoid arthritis, schizophrenia, celiac disease, Parkinson's disease, Alzheimer's disease, lupus, asthma, Kaswaskai disease, psoriasis, Bechet's disease, Grave's disease, eosinophilic esophagitis, systemic sclerosis or ankylosing spondylitis.

In some cases, the methods and compositions described herein may be used to diagnose or prognose a fetal disease, disorder or trait. The fetal disease, disorder or trait may include cancer, metabolic disorders, chromosomal abnormalities, or inherited genetic diseases or disorders (e.g., Tay Sachs, etc.).

In some cases, an oncologic disease is cancer and cancer may include any cancer originating in the blood, bladder, breast, prostate, cervical, colon, rectal, endometrial, kidney, liver, lung, pancreatic, thyroid, skin, bone, brain, bone marrow, white blood cells, eye, embryo, germ cells, gastrointestinal system, heart, vessel, artery, or renal system. In some cases, cancer may include any cancer detected in the blood, bladder, breast, prostate, cervical, colon, rectal, endometrial, kidney, liver, lung, pancreatic, thyroid, skin, bone, brain, bone marrow, white blood cells, eye, embryo, germ cells, gastrointestinal system, heart, vessel, artery, or renal system. In some cases, the cancer may be testicular, ovarian, colorectal, breast, prostate, lung, pancreatic, bladder, neuroblastoma, nasopharyngeal, glioma, melanoma, multiple myeloma, leukemia, polymorphic leukemia, acute leukemia, acute promyleocytic leukemia, acute lymphoblastic leukemia, chronic leukemia, lymphoma, B-cell lymphoma, non-Hodgkin's lymphoma, or Hodgkins lymphoma.

In some cases, the methods and compositions described herein may be used to diagnose or prognose the stage of a disease. The diagnosis or prognosis may include use of the diseased tissue, the healthy tissue or a tissue from a different organism. In some cases, the healthy tissue may be taken from the same tissue or organ. For example, cancer could be diagnosed or prognosed at Stage I, Stage II, Stage III, or Stage IV or between stages. In some cases, a treatment regimen for a disease may be determined.

The methods and compositions described herein may also be used to identify injured tissue. For example, changes in gene expression or activity of a regulatory network may occur in response to an injury. In some cases, a sample of injured tissue may be taken from an organism and compared to a sample of non-injured tissue from the same organ. In some cases, a sample of injured tissue may be taken from an organism and compared to a sample of non-injured tissue from the same organism. In some cases, a sample of injured tissue may be taken from an organism and compared to a sample of non-injured tissue from a different organism. In some cases, a sample of injured tissue may be taken from an organism and compared to a sample of injured tissue from a different organism. The injury may include, for example, but is not limited to, a crushing injury, a tearing injury, a cutting injury, a lacerating injury, a puncture injury, an avulsion injury, an abrasion injury, an incision injury, a severing injury or a poisoning injury.

An agent which affects a cellular state may be used to treat a sample prior to analysis using the methods and compositions described herein. In some cases, the methods and compositions may be used to screen a sample, or a set of samples, for the presence of an agent which may affect a cellular state. In some cases, the screen may include one sample or more than one sample. In some cases, the method may be a screen for one sample. In some cases, the method may include a screen for more than one sample. In some cases, the method may be a high-throughput screen.

In some cases, an agent may be one which is activatory. An activatory agent may, for example, increase modifications to a nucleic acid, increase modifications to a regulatory region binding protein, increase modifications to a transcription factor, increase modifications to a binding protein, decrease modifications to a nucleic acid, decrease modifications to a regulatory region binding protein, decrease modifications to a transcription factor or decrease modifications to a binding protein.

In some cases, an agent may be one which is inhibitory. An inhibitory agent may, for example, increase modifications to a nucleic acid, increase modifications to a regulatory region binding protein, increase modifications to a transcription factor, increase modifications to a binding protein, decrease modifications to a nucleic acid, decrease modifications to a regulatory region binding protein, decrease modifications to a transcription factor or decrease modifications to a binding protein.

In some cases, an agent may enhance the interaction of a nucleic acid with, for example, a regulatory protein, a binding protein or a transcription factor. In some cases, an agent may inhibit the interaction of a nucleic acid with, for example, a regulatory protein, a binding protein or a transcription factor.

In some cases, an agent may be a control agent, for example, an agent which stabilizes the interaction of a nucleic acid with, for example, a regulatory protein, a binding protein or a transcription factor. In some cases, the control agent may not have an effect on the interaction of a nucleic acid with, for example, a regulatory protein, a binding protein or a transcription factor.

The methods and compositions described herein may be used to screen at least one agent from a library of agents to identify an agent that may elicit a particular effect on a target. In some cases, the agent may be a drug, a chemical, a compound, a small molecule, a biosimilar, a pharmacomimetic, a sugar, a protein, a polypeptide, a polynucleotide, an siRNA, or a genetic therapeutic. In some cases, the target may be an organism, an organ, a tissue, a cell, an organelle of a cell, a part of an organelle of a cell, chromatin, a protein, nucleic acid (e.g., genomic DNA) or a nucleic acid. In some cases, the screen may include high-throughput screening and/or array screening, which may be combined with the methods and compositions described herein.

In some cases, a screening assay is performed in order to identify agents that may reverse a phenotype. For example, the polynucleotides (e.g., genomic DNA, mitochondrial DNA, etc.) of a cellular sample may have a particular cleavage pattern indicative of a disease, disorder or trait. The screening assay may be performed in order to identify agents capable of changing elements within the cleavage pattern. The method may involve, for example: (a) identifying a cleavage pattern associated with a disease, disorder or trait in a cellular sample; (b) contacting cells or polynucleotides expected to have such cleavage patterns with a plurality of agents; (c) isolating polynucleotides from the cells; (d) cleaving the polynucleotides with a polynucleotide cleavage agent (e.g., DNaseI) in order to obtain a cleavage pattern; (e) comparing the cleavage pattern with the cleavage pattern in step (a) in order to identify samples with reversals in phenotype (e.g., cleavage pattern); and/or (f) identifying the agent that contacted the cellular sample with the reversed phenotype.

The methods and compositions described herein may be used to identify at least one gene target associated with a phenotype. In some cases, the phenotype may be associated with one gene target. In some cases, the phenotype may be associated with at least one gene target. In some cases, a phenotype may be attributed to the regulation of one gene. In some cases, a phenotype may be attributed to the regulation of at least one gene.

The methods and compositions described herein may be used to determine at least one causality of a disease. In some cases, causality of a disease may be one cell type. In some cases, the causality of a disease may be at least one cell type. In some cases, a disease may be attributed to the behavior of one cell type. In some cases, a disease may be attributed to the behavior of one cell type. The methods and compositions described herein may be used to determine at least one causality of a trait. In some cases, causality of a trait may be one cell type. In some cases, the causality of a trait may be at least one cell type. In some cases, a trait may be attributed to the behavior of one cell type. In some cases, a trait may be attributed to the behavior of one cell type.

The methods and compositions described herein may be used to identify at least one gene associated with a disese. In some cases, the disease may be associated with one gene. In some cases, the disease may be associated with at least one gene. For example, the at least one gene may be associated with cancer. In some cases, the gene may be an oncogene. In some cases, the gene may be a tumor suppressor gene. In some cases, the oncogene and/or tumor suppressor gene may be part of any network described herein.

The methods and compositions described herein may be used to differentiate between the temporal onset of disease. In some cases, the temporal onset may be gestational. In some cases, the temporal onsent may be adult. For example, a sample taken from an organism may be analyzed using the methods and compositions described herein to determine the cause of disease wherein the cause may be gestational or adult. In some cases, the temporal onset of a disease may be attributed to at least one gene. In some cases, the at least one gene may be an oncofetal gene.

The methods and compositions provided herein may include treating a subject having a disease or disorder associated with a particular cleavage pattern described herein. Treating a subject may involve administering an agent to the subject in order to reverse a phenotype (e.g., a disease or disorder) or in order to reduce the likelihood, or prevent, a subject from contracting a disease or disorder. In some cases, a subject may be treated with an agent to enhance levels of gene products (e.g., drug, gene therapy) from a gene with lower-than-normal activity, as determined by analysis of the polynucleotide cleavage pattern of a sample from the subject. In some cases, a subject may be treated with an agent to reduce the level of gene products (e.g., drug, interfering RNA, siRNA) from a gene with higher-than-normal activity, as determined by analysis of the polynucleotide cleavage pattern of a sample from the subject.

The methods and compositions described herein may be useful with the following methods: gene therapy methods, endonuclease approaches, ribonucleic acid approaches, deoxyribonucleic acid approaches and/or protein-based approaches. In some cases, endonuclease approaches may include zinc-finger endonucleases and/or transcription activator-like effector nucleases (TALENs). In some cases, ribonucleic acid approaches may include use of ribonucleic acid interference (RNAi). In some cases, deoxyribonucleic acid approaches may include viral deoxyribonucleic acid approaches. In some cases, protein-based approaches may include delivery of a protein to an organism.

The methods and compositions provided herein may be used to determine if a gene therapy approach achieves a particular goal. For example, the methods and compositions described herein may identify a change in the binding of a nucleic acid by a regulatory factor to a nucleic acid. In some cases, the change may be compared to a different binding of a nucleic acid by a regulatory factor to a nucleic acid. In some cases, the comparison may determine the result of the gene therapy approach. For example, the result may be a diagnosis and/or a prognosis.

Accuracy, Sensitivity and Specificity.

The methods and compositions described herein are accurate for predicting the association of at least one particular nucleic acid (e.g., genomic DNA) sequence, at least one chromatin structure and at least one regulatory network, with a biologic event. In some cases, the biologic event may be diagnosis of a condition, a prognosis for a condition, a change in cell phase, a change in cell behavior or a change in the state of cell differentiation, discussed herein.

The accuracy of the methods and compositions for predicting gene expression, binding of a factor to a site in a nucleic acid sequence, or the structure of chromatin, may be comparable to, or at least two-fold, three-fold, four-fold or five-fold better than methods of chromatin immunoprecipitation, mass spectrometry, DNaseI footprinting or crystallography. In some cases, the methods and compositions described herein may be comparable to methods of chromatin immunoprecipitation, mass spectrometry, DNaseI footprinting and/or crystallography wherein each method may be combined with sequencing. In some cases, the methods and compositions described herein may be comparable to methods of chromatin immunoprecipitation, mass spectrometry, DNaseI footprinting and/or crystallography wherein each method may not be combined with sequencing.

The accuracy of the methods and compositions for predicting gene expression, binding of a factor to a site in a nucleic acid sequence, or the structure of chromatin, may be better than the methods of chromatin immunoprecipitation, mass spectrometry, DNaseI footprinting or crystallography. In some cases, the methods and compositions described herein may be better than the methods of chromatin immunoprecipitation, mass spectrometry, DNaseI footprinting or crystallography wherein each method may be combined with sequencing. In some cases, the methods and compositions described herein may be better than the methods of chromatin immunoprecipitation, mass spectrometry, DNaseI footprinting or crystallography wherein each method may not be combined with sequencing.

The methods and compositions described herein are accurate and may be used to detect at least one past and/or detect at least one present event related to gene expression. The at least one event related to gene expression may be the occupation of a regulatory region by at least one factor wherein the occupation of the regulatory region may affect gene expression. In some cases, the accuracy of detection gene expression may be greater than or equal to 50%, 60%, 70%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8% or 99.9%.

The methods and compositions described herein are accurate may be used to predict at least one future event related to gene expression. The at least one event related to gene expression may be the occupation of a regulatory region by at least one factor wherein the occupation of the regulatory region may affect gene expression. In some cases, the accuracy of prediction of gene expression may be greater than or equal to 50%, 60%, 70%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8% or 99.9%.

In some cases, the accuracy of detection of the methods and compositions described herein may be better than other methods of determining gene expression. For example, when compared to microarray or reverse transcriptase PCR, the accuracy of detection may be better than microarray or reverse transcriptase PCR by greater than or equal to 50%, 60%, 70%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8% or 99.9%.

In some cases, the accuracy of detection of the methods and compositions described herein may be better than other methods of determining gene expression. For example, when compared to microarray or reverse transcriptase PCR, the accuracy of prediction may be better than microarray or reverse transcriptase PCR by greater than or equal to 50%, 60%, 70%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8% or 99.9%.

The methods and compositions described herein are sensitive for predicting the association of at least one particular nucleic acid (e.g., genomic DNA) sequence, at least one chromatin structure and at least one regulatory network, with a biologic event. In some cases, the biologic event may be diagnosis of a condition, a prognosis for a condition, a change in cell phase, a change in cell behavior or a change in the state of cell differentiation, discussed herein.

The sensitivity of the methods and compositions for predicting gene expression, binding of a factor to a site in a nucleic acid sequence, or the structure of chromatin, may be comparable to methods of chromatin immunoprecipitation, mass spectrometry, DNaseI footprinting or crystallography. In some cases, the methods and compositions described herein may be comparable to methods of chromatin immunoprecipitation, mass spectrometry, DNaseI footprinting and/or crystallography wherein each method may be combined with sequencing. In some cases, the methods and compositions described herein may be comparable to methods of chromatin immunoprecipitation, mass spectrometry, DNaseI footprinting and/or crystallography wherein each method may not be combined with sequencing.

The sensitivity of the methods and compositions for predicting gene expression, binding of a factor to a site in a nucleic acid sequence, or the structure of chromatin, may be better than the methods of chromatin immunoprecipitation, mass spectrometry, DNaseI footprinting or crystallography. In some cases, the methods and compositions described herein may be better than the methods of chromatin immunoprecipitation, mass spectrometry, DNaseI footprinting or crystallography wherein each method may be combined with sequencing. In some cases, the methods and compositions described herein may be better than the methods of chromatin immunoprecipitation, mass spectrometry, DNaseI footprinting or crystallography wherein each method may not be combined with sequencing.

The methods and compositions provided herein can be successful using a small quantity of nucleic acid. In some cases, the sensitivity of prediction may be achieved using an amount of nucleic acid (e.g., genomic DNA) within a sample. In some cases, the amount of nucleic acid (e.g., genomic DNA) within a sample, may be less than or equal to the contents of, 1 cell, 2 cells, 3 cells, 4 cells, 5 cells, 10 cells, 20 cells, 30 cells, 40 cells, 50 cells, 60 cells, 70 cells, 80 cells, 90 cells, 100 cells, 150 cells, 200 cells, 300 cells, 400 cells, 500 cells, 750 cells, 1000 cells, 5000 cells, 10³ cells, 5×10³ cells, 10⁴ cells, 5×10⁴ cells, 10⁵ cells, 5×10⁵ cells, 10⁶ cells, 5×10⁶ cells, 10⁷ cells, 5×10⁷ cells, 10⁸ cells, 5×10⁸ cells, 10⁹, 5×10⁹ cells or 10¹⁰ cells.

In some cases, the sensitivity of the methods and compositions described herein can be improved by increasing the amount of nucleic acid (e.g., genomic DNA) within a sample. In some cases, the sample may be greater than or equal to the contents of, 1 cell, 2 cells, 3 cells, 4 cells, 5 cells, 10 cells, 20 cells, 30 cells, 40 cells, 50 cells, 60 cells, 70 cells, 80 cells, 90 cells, 100 cells, 150 cells, 200 cells, 300 cells, 400 cells, 500 cells, 750 cells, 1000 cells, 5000 cells, 10³ cells, 5×10³ cells, 10⁴ cells, 5×10⁴ cells, 10⁵ cells, 5×10⁵ cells, 10⁶ cells, 5×10⁶ cells, 10⁷ cells, 5×10⁷ cells, 10⁸ cells, 5×10⁸ cells, 10⁹, 5×10⁹ cells or 10¹⁰ cells.

In some cases, the sensitivity of the methods and compositions described herein may be achieved using an amount of nucleic acid (e.g., genomic DNA) within a sample. In some cases, the amount of nucleic acid (e.g., genomic DNA) in a sample may be less than or equal to 1 pg, 2 pg, 3 pg, 4 pg, 5 pg, 10 pg, 20 pg, 30 pg, 40 pg, 50 pg, 60 pg, 70 pg, 80 pg, 90 pg, 100 pg, 150 pg, 200 pg, 300 pg, 400 pg, 500 pg, 750 pg, 1000 pg, 5000 pg, 10³ pg, 5×10³ pg, 10⁴ pg, 5×10⁴ pg, 10⁵ pg, 5×10⁵ pg, 10⁶ pg, 5×10⁶ pg, 10⁷ pg, 5×10⁷ pg, 10⁸ pg, 5×10⁸ pg, 10⁹, 5×10⁹ pg or 10¹⁰ pg.

In some cases, the sensitivity of the methods and compositions described herein can be improved by increasing the amount of nucleic acid (e.g., genomic DNA) within a sample. In some cases, the amount of nucleic acid (e.g., genomic DNA) in a sample may be greater than or equal to 1 pg, 2 pg, 3 pg, 4 pg, 5 pg, 10 pg, 20 pg, 30 pg, 40 pg, 50 pg, 60 pg, 70 pg, 80 pg, 90 pg, 100 pg, 150 pg, 200 pg, 300 pg, 400 pg, 500 pg, 750 pg, 1000 pg, 5000 pg, 10³ pg, 5×10³ pg, 10⁴ pg, 5×10⁴ pg, 5×10⁴ pg, 10⁵ pg, 5×10⁵ pg, 5×10⁵ pg, 10⁶ pg, 5×10⁶ pg, 5×10⁶ pg, 10⁷ pg, 5×10 pg, 5×10⁷ pg, 10⁸ pg, 5×10⁸ pg, 5×10⁸ pg, 10⁹ pg, 5×10⁹ pg or 10¹⁰ pg.

The sensitivity of the methods and compositions may be better than other methods that do not use enriched DNaseI cleavage libraries. In some cases, the methods and compositions provided herein may use enriched DNaseI cleavage libraries from diverse cell types wherein the DNaseI cleavage events are localized to DHS. In some cases, the cell types may include greater than or equal to 1, 5, 10, 15, 20, 25, 30, 35, 36, 37, 38, 38, 39, 40, 41, 42, 43, 44, 45, 46, 47, 48, 49, 50, 51, 52, 53, 54, 55, 56, 57, 58, 59, 60, 65, 70, 75, 80, 85, 90, 95, 100, 125, 150, 175, 200, 225, 250, 275, 300, 325, 350, 375, 400, 425, 450, 475, 500, 750, 1000, 1250, 1500, 1750, 2000, 2500, 5000, 7500 or 10,000.

The specificity of the methods and compositions may include the generation of DHS maps. In some cases, the percentage of DNaseI cleavage sites that may be localized to DHSs in the DHS maps may be less than or equal to 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% or 100%.

The specificity of the methods and compositions may be better than other methods wherein DHS maps are not generated. In some cases, the methods and compositions provided herein may use DNaseI seq to estimate the sensitivity and accuracy of DHSmaps. In some cases, the sequencing depth that may be achieved with DNaseI-seq may be less than or equal to 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8%, 99.9% or 100%.

The methods and compositions described herein are accurate for predicting the association of at least one particular nucleic acid (e.g., genomic DNA) sequence with the binding of a protein. In some cases, the protein may be a regulatory protein, a nucleic acid binding protein, a protein which does not bind nucleic acid, a protein which binds another protein, a transcription factor or a protein which binds to a modification on another protein. In some case, the binding of the protein may be direct to the nucleic acid (e.g., genomic DNA). In some case, the binding of the protein may be indirect to the nucleic acid (e.g., genomic DNA).

The accuracy of the methods and compositions for the binding of a first protein to a site in a nucleic acid sequence, the binding of a second protein to a first protein at a site in a nucleic acid sequence structure of chromatin, or the binding of a second protein to a first protein at a site that is distal to the site where the first protein is bound in a nucleic acid sequence may be comparable to methods of chromatin immunoprecipitation, mass spectrometry, DNaseI footprinting or crystallography. In some cases, the methods and compositions described herein may be comparable to methods of chromatin immunoprecipitation, mass spectrometry, DNaseI footprinting and/or crystallography wherein each method may be combined with sequencing. In some cases, the methods and compositions described herein may be comparable to methods of chromatin immunoprecipitation, mass spectrometry, DNaseI footprinting and/or crystallography wherein each method may not be combined with sequencing.

The accuracy of the methods and compositions for the binding of a first protein to a site in a nucleic acid sequence, the binding of a second protein to a first protein at a site in a nucleic acid sequence structure of chromatin, or the binding of a second protein to a first protein at a site that is distal to the site where the first protein is bound in a nucleic acid sequence may be better than methods of chromatin immunoprecipitation, mass spectrometry, DNaseI footprinting or crystallography. In some cases, the methods and compositions described herein may be better than the methods of chromatin immunoprecipitation, mass spectrometry, DNaseI footprinting or crystallography wherein each method may be combined with sequencing. In some cases, the methods and compositions described herein may be better than the methods of chromatin immunoprecipitation, mass spectrometry, DNaseI footprinting or crystallography wherein each method may not be combined with sequencing.

The methods and compositions described herein are accurate and may be used to detect the binding of a first protein to a site in a nucleic acid sequence, the binding of a second protein to a first protein at a site in a nucleic acid sequence structure of chromatin, or the binding of a second protein to a first protein at a site that is distal to the site where the first protein is bound in a nucleic acid sequence. In some cases, the accuracy of detection gene expression may be greater than or equal to 50%, 60%, 70%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8% or 99.9%.

The methods and compositions provided herein can be successful using a small quantity of nucleic acid. In some cases, the sensitivity of detection of the binding of a first protein to a site in a nucleic acid sequence, the binding of a second protein to a first protein at a site in a nucleic acid sequence structure of chromatin, or the binding of a second protein to a first protein at a site that is distal to the site where the first protein is bound in a nucleic acid sequence may be achieved using an amount of nucleic acid (e.g., genomic DNA) within a sample. In some cases, the amount of nucleic acid (e.g., genomic DNA) within a sample, may be less than or equal to the contents of, 1 cell, 2 cells, 3 cells, 4 cells, 5 cells, 10 cells, 20 cells, 30 cells, 40 cells, 50 cells, 60 cells, 70 cells, 80 cells, 90 cells, 100 cells, 150 cells, 200 cells, 300 cells, 400 cells, 500 cells, 750 cells, 1000 cells, 5000 cells, 10³ cells, 5×10³ cells, 10⁴ cells, 5×10⁴ cells, 10⁵ cells, 5×10⁵ cells, 10⁶ cells, 5×10⁶ cells, 10⁷ cells, 5×10⁷ cells, 10⁸ cells, 5×10⁸ cells, 10⁹, 5×10⁹ cells or 10¹⁰ cells.

In some cases, the sensitivity of detection of the binding of a first protein to a site in a nucleic acid sequence, the binding of a second protein to a first protein at a site in a nucleic acid sequence structure of chromatin, or the binding of a second protein to a first protein at a site that is distal to the site where the first protein is bound in a nucleic acid sequence can be improved by increasing the amount of nucleic acid (e.g., genomic DNA) within a sample. In some cases, the sample may be greater than or equal to the contents of, 1 cell, 2 cells, 3 cells, 4 cells, 5 cells, 10 cells, 20 cells, 30 cells, 40 cells, 50 cells, 60 cells, 70 cells, 80 cells, 90 cells, 100 cells, 150 cells, 200 cells, 300 cells, 400 cells, 500 cells, 750 cells, 1000 cells, 5000 cells, 10³ cells, 5×10³ cells, 10⁴ cells, 5×10⁴ cells, 10⁵ cells, 5×10⁵ cells, 10⁶ cells, 5×10⁶ cells, 10⁷ cells, 5×10⁷ cells, 10⁸ cells, 5×10⁸ cells, 10⁹, 5×10⁹ cells or 10¹⁰ cells.

In some cases, the sensitivity of detection of the binding of a first protein to a site in a nucleic acid sequence, the binding of a second protein to a first protein at a site in a nucleic acid sequence structure of chromatin, or the binding of a second protein to a first protein at a site that is distal to the site where the first protein is bound in a nucleic acid sequence may be achieved using an amount of nucleic acid (e.g., genomic DNA) within a sample. In some cases, the amount of nucleic acid (e.g., genomic DNA) in a sample may be less than or equal to 1 pg, 2 pg, 3 pg, 4 pg, 5 pg, 10 pg, 20 pg, 30 pg, 40 pg, 50 pg, 60 pg, 70 pg, 80 pg, 90 pg, 100 pg, 150 pg, 200 pg, 300 pg, 400 pg, 500 pg, 750 pg, 1000 pg, 5000 pg, 10³ pg, 5×10³ pg, 10⁴ pg, 5×10⁴ pg, 10⁵ pg, 5×10⁵ pg, 10⁶ pg, 10⁶ pg, 5×10⁶ pg, 10⁷ pg, 5×10⁷ pg, 10⁸ pg, 5×10⁸ pg, 10⁹ pg, 5×10⁹ pg or 10¹⁰ pg.

In some cases, the sensitivity of detection of the binding of a first protein to a site in a nucleic acid sequence, the binding of a second protein to a first protein at a site in a nucleic acid sequence structure of chromatin, or the binding of a second protein to a first protein at a site that is distal to the site where the first protein is bound in a nucleic acid sequence may be improved by increasing the amount of nucleic acid (e.g., genomic DNA) within a sample. In some cases, the amount of nucleic acid (e.g., genomic DNA) in a sample may be greater than or equal to 1 pg, 2 pg, 3 pg, 4 pg, 5 pg, 10 pg, 20 pg, 30 pg, 40 pg, 50 pg, 60 pg, 70 pg, 80 pg, 90 pg, 100 pg, 150 pg, 200 pg, 300 pg, 400 pg, 500 pg, 750 pg, 1000 pg, 5000 pg, 10³ pg, 5×10³ pg, 10⁴ pg, 5×10⁴ pg, 10⁵ pg, 5×10⁵ pg, 10⁶ pg, 5×10⁶ pg, 10⁷ pg, 5×10⁷ pg, 10⁸ pg, 5×10⁸ pg, 10⁹, 5×10⁹ pg or 10¹⁰ pg.

The methods and compositions described herein are accurate for predicting an interaction of a protein with a nucleic acid. In some cases, the methods and compositions may include the use of digital genomic footprinting in combination with ChIP-seq. In some cases, the resolution of digital genomic footprinting in combination with ChIP-seq may predict the interaction between a protein and a nucleic acid.

The accuracy of digital genomic footprinting may be used in combination with ChIP-seq to predict an interaction of a protein with a nucleic acid may be comparable to methods of chromatin immunoprecipitation, mass spectrometry, DNaseI footprinting or crystallography. In some cases, the methods and compositions described herein may be comparable to methods of chromatin immunoprecipitation, mass spectrometry, DNaseI footprinting and/or crystallography wherein each method may be combined with sequencing. In some cases, the methods and compositions described herein may be comparable to methods of chromatin immunoprecipitation, mass spectrometry, DNaseI footprinting and/or crystallography wherein each method may not be combined with sequencing.

The accuracy of digital genomic footprinting may be used in combination with ChIP-seq to predict an interaction of a protein with a nucleic acid may be better than methods of chromatin immunoprecipitation, mass spectrometry, DNaseI footprinting or crystallography. In some cases, the methods and compositions described herein may be better than the methods of chromatin immunoprecipitation, mass spectrometry, DNaseI footprinting or crystallography wherein each method may be combined with sequencing. In some cases, the methods and compositions described herein may be better than the methods of chromatin immunoprecipitation, mass spectrometry, DNaseI footprinting or crystallography wherein each method may not be combined with sequencing.

The accuracy of digital genomic footprinting may be used in combination with ChIP-seq to predict an interaction of a protein with a nucleic acid. In some cases, the accuracy of predicting an interaction of a protein with a nucleic acid may be greater than or equal to 50%, 60%, 70%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8% or 99.9%.

The sensitivity of digital genomic footprinting may be used in combination with ChIP-seq to predict an interaction of a protein with a nucleic acid. In some cases, the amount of nucleic acid (e.g., genomic DNA) within a sample, may be less than or equal to the contents of, 1 cell, 2 cells, 3 cells, 4 cells, 5 cells, 10 cells, 20 cells, 30 cells, 40 cells, 50 cells, 60 cells, 70 cells, 80 cells, 90 cells, 100 cells, 150 cells, 200 cells, 300 cells, 400 cells, 500 cells, 750 cells, 1000 cells, 5000 cells, 10³ cells, 5×10³ cells, 10⁴ cells, 5×10⁴ cells, 10⁵ cells, 5×10⁵ cells, 10⁶ cells, 5×10⁶ cells, 10⁷ cells, 5×10⁷ cells, 10⁸ cells, 5×10⁸ cells, 10⁹, 5×10⁹ cells or 10¹⁰ cells.

The sensitivity of digital genomic footprinting may be used in combination with ChIP-seq to predict an interaction of a protein with a nucleic acid. In some cases, the sample may be greater than or equal to the contents of, 1 cell, 2 cells, 3 cells, 4 cells, 5 cells, 10 cells, 20 cells, 30 cells, 40 cells, 50 cells, 60 cells, 70 cells, 80 cells, 90 cells, 100 cells, 150 cells, 200 cells, 300 cells, 400 cells, 500 cells, 750 cells, 1000 cells, 5000 cells, 10³ cells, 5×10³ cells, 10⁴ cells, 5×10⁴ cells, 10⁵ cells, 5×10⁵ cells, 10⁶ cells, 5×10⁶ cells, 10⁷ cells, 5×10⁷ cells, 10⁸ cells, 5×10⁸ cells, 10⁹, 5×10⁹ cells or 10¹⁰ cells.

The sensitivity of digital genomic footprinting may be used in combination with ChIP-seq to predict an interaction of a protein with a nucleic acid. In some cases, the amount of nucleic acid (e.g., genomic DNA) in a sample may be less than or equal to 1 pg, 2 pg, 3 pg, 4 pg, 5 pg, 10 pg, 20 pg, 30 pg, 40 pg, 50 pg, 60 pg, 70 pg, 80 pg, 90 pg, 100 pg, 150 pg, 200 pg, 300 pg, 400 pg, 500 pg, 750 pg, 1000 pg, 5000 pg, 10³ pg, 5×10³ pg, 10⁴ pg, 5×10⁴ pg, 10⁵ pg, 5×10⁵ pg, 10⁶ pg, 5×10⁶ pg, 10⁷ pg, 5×10⁷ pg, 10⁸ pg, 5×10⁸ pg, 10⁹, 5×10⁹ pg or 10¹⁰ pg.

The sensitivity of digital genomic footprinting may be used in combination with ChIP-seq to predict an interaction of a protein with a nucleic acid. In some cases, the amount of nucleic acid (e.g., genomic DNA) in a sample may be greater than or equal to 1 pg, 2 pg, 3 pg, 4 pg, 5 pg, 10 pg, 20 pg, 30 pg, 40 pg, 50 pg, 60 pg, 70 pg, 80 pg, 90 pg, 100 pg, 150 pg, 200 pg, 300 pg, 400 pg, 500 pg, 750 pg, 1000 pg, 5000 pg, 10³ pg, 5×10³ pg, 10⁴ pg, 5×10⁴ pg, 10⁵ pg, 5×10⁵ pg, 10⁶ pg, 5×10⁶ pg, 10⁷ pg, 5×10⁷ pg, 10⁸ pg, 5×10⁸ pg, 10⁹, 5×10⁹ pg or 10¹⁰ pg.

The methods and compositions described herein are accurate for predicting the interaction of a protein with a nucleic acid. In some cases, the interaction of a protein and a nucleic acid may be the chromatin. In some cases, the structure of the chromatin may be a topography, wherein the topography may be predicted. In some cases, the prediction of the topography of chromatin may be high-resolution. In some cases, the topography may be determined to identify the features of the nucleic acid.

The accuracy of predicting the topography of an interaction of a protein with a nucleic acid may be comparable to methods of chromatin immunoprecipitation, mass spectrometry, DNaseI footprinting or crystallography. In some cases, the methods and compositions described herein may be comparable to methods of chromatin immunoprecipitation, mass spectrometry, DNaseI footprinting and/or crystallography wherein each method may be combined with sequencing. In some cases, the methods and compositions described herein may be comparable to methods of chromatin immunoprecipitation, mass spectrometry, DNaseI footprinting and/or crystallography wherein each method may not be combined with sequencing.

The accuracy of predicting the topography of an interaction of a protein with a nucleic acid may be better than methods of chromatin immunoprecipitation, mass spectrometry, DNaseI footprinting or crystallography. In some cases, the methods and compositions described herein may be better than the methods of chromatin immunoprecipitation, mass spectrometry, DNaseI footprinting or crystallography wherein each method may be combined with sequencing. In some cases, the methods and compositions described herein may be better than the methods of chromatin immunoprecipitation, mass spectrometry, DNaseI footprinting or crystallography wherein each method may not be combined with sequencing.

In some cases, the accuracy of predicting the topography of an interaction of a protein with a nucleic acid may be, for example, greater than or equal to 50%, 60%, 70%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8% or 99.9%.

The methods and compositions described herein may be sensitively for predicting the topography of an interaction of a protein with a nucleic acid. In some cases, the sensitivity of predicting the topography of an interaction of a protein with a nucleic acid may be affected by the amount of nucleic acid in a sample. In some cases, the amount of nucleic acid (e.g., genomic DNA) within a sample, may be less than or equal to the contents of, 1 cell, 2 cells, 3 cells, 4 cells, 5 cells, 10 cells, 20 cells, 30 cells, 40 cells, 50 cells, 60 cells, 70 cells, 80 cells, 90 cells, 100 cells, 150 cells, 200 cells, 300 cells, 400 cells, 500 cells, 750 cells, 1000 cells, 5000 cells, 10³ cells, 5×10³ cells, 10⁴ cells, 5×10⁴ cells, 10⁵ cells, 5×10⁵ cells, 10⁶ cells, 5×10⁶ cells, 10⁷ cells, 5×10⁷ cells, 10⁸ cells, 5×10⁸ cells, 10⁹, 5×10⁹ cells or 10¹⁰ cells. In some cases, the amount of nucleic acid (e.g., genomic DNA) within a sample, may be less than or equal to the contents of, 1 cell, 2 cells, 3 cells, 4 cells, 5 cells, 10 cells, 20 cells, 30 cells, 40 cells, 50 cells, 60 cells, 70 cells, 80 cells, 90 cells, 100 cells, 150 cells, 200 cells, 300 cells, 400 cells, 500 cells, 750 cells, 1000 cells, 5000 cells, 10³ cells, 5×10³ cells, 10⁴ cells, 5×10⁴ cells, 10⁵ cells, 5×10⁵ cells, 10⁶ cells, 5×10⁶ cells, 10⁷ cells, 5×10⁷ cells, 10⁸ cells, 5×10⁸ cells, 10⁹, 5×10⁹ cells or 10¹⁰ cells.

The methods and compositions described herein may be sensitively for predicting the topography of an interaction of a protein with a nucleic acid. In some cases, the sensitivity of predicting the topography of an interaction of a protein with a nucleic acid may be affected by the amount of nucleic acid in a sample. In some cases, the amount of nucleic acid (e.g., genomic DNA) in a sample may be less than or equal to 1 pg, 2 pg, 3 pg, 4 pg, 5 pg, 10 pg, 20 pg, 30 pg, 40 pg, 50 pg, 60 pg, 70 pg, 80 pg, 90 pg, 100 pg, 150 pg, 200 pg, 300 pg, 400 pg, 500 pg, 750 pg, 1000 pg, 5000 pg, 10³ pg, 5×10³ pg, 10⁴ pg, 5×10⁴ pg, 10⁵ pg, 5×10⁵ pg, 10⁶ pg, 5×10⁶ pg, 10⁷ pg, 5×10⁷ pg, 10⁸ pg, 5×10⁸ pg, 10⁹, 5×10⁹ pg or 10¹⁰ pg. In some cases, the amount of nucleic acid (e.g., genomic DNA) in a sample may be greater than or equal to 1 pg, 2 pg, 3 pg, 4 pg, 5 pg, 10 pg, 20 pg, 30 pg, 40 pg, 50 pg, 60 pg, 70 pg, 80 pg, 90 pg, 100 pg, 150 pg, 200 pg, 300 pg, 400 pg, 500 pg, 750 pg, 1000 pg, 5000 pg, 10³ pg, 5×10³ pg, 10⁴ pg, 5×10⁴ pg, 10⁵ pg, 5×10⁵ pg, 10⁶ pg, 5×10⁶ pg, 10⁷ pg, 5×10⁷ pg, 10⁸ pg, 5×10⁸ pg, 10⁹, 5×10⁹ pg or 10¹⁰ pg.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. The term “about” as used herein refers to a range that is 15% plus or minus from a stated numerical value within the context of the particular usage. For example, about 10 would include a range from 8.5 to 11.5.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

### EXAMPLES

### Example 1

### Regulatory DNA is Densely Populated with DNaseI Footprints

To map DNaseI footprints comprehensively within regulatory DNA, digital genomic footprinting (DGF) was adapted to human cells. Within DNaseI hypersensitive sites (DHSs), DNaseI cleavage is not uniform; rather, punctuated binding by sequence-specific regulatory factors occludes bound DNA from cleavage, leaving footprints that demarcate transcription factor occupancy at nucleotide resolution (FIG. 1a). FIG. 1a illustrates that DNaseI footprinting of K562 cells identified the individual nucleotides within the MTPN promoter that are bound by NRF1. The ability to resolve DNaseI footprints sensitively and precisely is critically dependent on the local density of mapped DNaseI cleavages (FIG. 2a-d), and efficient footprinting of a large genome such as human requires substantial concentration of DNaseI cleavages within the small fraction (˜1-3%) of the genome contained in DNaseI-hypersensitive regions. FIG. 2 illustrates identification and distribution of DNaseI footprints. FIG. 2a illustrates that as more DNaseI cleavages were sequenced from SKMC cells, individual DNaseI footprints were easier to distinguish. FIG. 2b illustrates the number of DNaseI footprints identified in SKMC cells at varying DNaseI cleavage tag sequencing levels. FIG. 2c-d illustrate that the number of footprints in DHSs was observed to be higher for DHSs with more mapped DNaseI cleavages. DHSs from all 41 cell types were broken into deciles based on the sequencing depth of that DHS. The number of mapped DNaseI cleavages for DHSs in each quantile is indicated below the graph. The box-and-whisker plot shows the distribution of the number of footprints within DHSs for each quantile.

Highly enriched DNaseI cleavage libraries from 41 diverse cell types in which 53-81% of DNaseI cleavage sites localized to DNaseI-hypersensitive regions were selected (Neph et al., “An expansive human regulatory lexicon encoded in transcription factor footprints.” Nature. 489 (7414):83-90. Sep. 5, 2012. herein “Neph et al., 2012a”), representing nearly tenfold higher signal-to-noise ratio than pervious results from yeast, and two- to fivefold greater enrichment than achieved using end-capture of single DNaseI cleavages. Deep sequencing of these libraries was performed, and 14.9 billion Illumina sequence reads obtained, 11.2 billion of which mapped to unique locations in the human genome (Neph et al., 2012a) An average sequencing depth of ˜273 million DNaseI cleavages per cell type that enabled extensive and accurate discrimination of DNaseI footprints was achieved.

To detect DNaseI footprints systematically, a detection algorithm was implemented based on the original description of quantitative DNaseI footprinting. An average of ˜1.1 million high-confidence (false discovery rate (FDR) 1%) footprints per cell type (range 434,000 to 2.3 million; Neph et al., 2012a), and collectively 45,096,726 6-40-bp footprint events across all cell types were identified. Cell-selective footprint patterns were resolved to reveal 8.4 million distinct elements with a footprint, each occupied in one or more cell type. At least one footprint was found in >75% of DHSs (FIG. 2c, d and Table 1), with detection strongly dependent on the number of mapped DNaseI cleavages within each DHS. 99.8% of DHSs with >250 mapped DNaseI cleavages contained at least one footprint, indicating that DHSs are not simply open or nucleosome-free chromatin features, but are constitutively populated with DNaseI footprints. Modeling DNaseI cleavage patterns using empirically derived intrinsic DNA cleavage propensities for DNaseI showed that only a miniscule fraction (0.24%) of discovered FDR 1% footprints from cell and tissue samples could be caused by inherent DNaseI sequence specificity (Methods).

TABLE 1
Summary of footprints within DHSs.

| | | | | DHS | Mean |
|---|---|---|---|---|---|
| | | Total | FPs in | peaks | FP per |
| | Total | DHS | DHS | with | DHS |
| Cell type | FPs | peaks | peaks | FP | peak |
| AG10803 | 1,106,404 | 181,473 | 677,479 | 139,806 | 4.85 |
| AoAF | 1,566,170 | 165,258 | 820,187 | 148,612 | 5.52 |
| CD20+ | 603,190 | 104,139 | 303,432 | 72,752 | 4.17 |
| CD34+ | 902,386 | 147,098 | 560,210 | 117,862 | 4.75 |
| Mobilized | | | | | |
| fBrain | 1,022,782 | 182,501 | 636,950 | 140,256 | 4.54 |
| fHeart | 954,914 | 173,135 | 562,780 | 129,032 | 4.36 |
| fLung | 1,181,235 | 205,880 | 681,428 | 160,948 | 4.23 |
| GM06990 | 434,561 | 92,709 | 195,168 | 49,295 | 3.96 |
| GM12865 | 811,374 | 143,716 | 487,801 | 104,614 | 4.66 |
| HAEpiC | 1,506,475 | 205,033 | 913,983 | 172,375 | 5.3 |
| HA-h | 966,188 | 200,014 | 506,977 | 134,600 | 3.77 |
| HCF | 1,057,743 | 174,667 | 647,025 | 135,144 | 4.79 |
| HCM | 1,130,292 | 193,375 | 696,405 | 146,587 | 4.75 |
| HCPEpiC | 1,296,454 | 210,380 | 826,565 | 167,674 | 4.93 |
| HEEpiC | 1,263,648 | 209,838 | 834,743 | 173,806 | 4.8 |
| HepG2 | 448,678 | 90,775 | 228,280 | 54,600 | 4.18 |
| H7-hESC | 1,279,454 | 266,618 | 808,678 | 189,181 | 4.27 |
| HFF | 590,904 | 192,282 | 384,995 | 106,555 | 3.61 |
| HIPEpiC | 1,089,936 | 225,744 | 731,881 | 164,569 | 4.45 |
| HMF | 1,434,330 | 190,512 | 874,301 | 162,132 | 5.39 |
| HMVEC-dBl- | 1,085,741 | 162,593 | 644,136 | 123,503 | 5.22 |
| Ad | | | | | |
| HMVEC-dBl- | 1,061,860 | 168,436 | 633,452 | 124,918 | 5.07 |
| Neo | | | | | |
| HMVEC-dLy- | 989,626 | 153,107 | 603,547 | 120,801 | 5 |
| Neo | | | | | |
| HMVEC-LLy | 872,721 | 144,886 | 550,573 | 111,126 | 4.95 |
| HPAF | 1,090,215 | 188,071 | 684,069 | 140,068 | 4.88 |
| HPdLF | 1,404,872 | 171,349 | 785,700 | 147,294 | 5.33 |
| HPF | 1,175,289 | 154,397 | 683,890 | 131,805 | 5.19 |
| HRCEpiC | 1,187,325 | 192,147 | 723,271 | 146,937 | 4.92 |
| HSMM | 1,668,243 | 228,282 | 937,370 | 184,856 | 5.07 |
| Th1 | 498,505 | 84,201 | 220,748 | 53,494 | 4.13 |
| HVMF | 1,263,833 | 170,340 | 688,248 | 137,947 | 4.99 |
| IMR90 | 970,277 | 199,752 | 646,563 | 139,353 | 4.64 |
| K562 | 498,683 | 142,986 | 305,128 | 72,048 | 4.24 |
| NB4 | 1,049,300 | 143,838 | 588,282 | 117,445 | 5.01 |
| NH-A | 977,923 | 191,510 | 601,546 | 130,914 | 4.59 |
| NHDF-Ad | 1,429,399 | 230,696 | 891,028 | 179,529 | 4.96 |
| NHDF-neo | 1,532,853 | 187,962 | 840,887 | 160,662 | 5.23 |
| NHLF | 1,567,106 | 206,254 | 896,218 | 173,139 | 5.18 |
| SAEC | 1,256,188 | 198,442 | 791,686 | 160,216 | 4.94 |
| SKMC | 2,370,723 | 205,493 | 1,230,494 | 198,952 | 6.18 |
| SK-N-SH_RA | 498,926 | 89,968 | 259,755 | 61,111 | 4.25 |

DNaseI footprints were distributed throughout the genome, including intergenic regions (45.7%), introns (37.7%), upstream of transcriptional start sites (TSSs, 8.9%), and in 5′ and 3′ untranslated regions (UTRs, 1.4% and 1.3%, respectively; FIG. 3a-b). FIG. 3 illustrates distribution of DNaseI footprints. FIG. 3a illustrates genomic distribution of footprints found in 41 cell types in relation to annotated genomic features. FIG. 3b illustrates examples of DNaseI footprints at different genomic features. DNaseI footprints were enriched in promoters (3.6-fold; P<2.2×10⁻¹⁶; Binomial test) and 5′ UTRs (2.4-fold; P<2.2×10⁻¹⁶; Binomial test), commensurate with high DNaseI cleavage densities observed in these regions. 2.0% of footprints were found to be localized within exons, raising the possibility that occupancy by DNA binding proteins could further restrict sequence diversity within coding DNA, thus superimposing an unexpected layer of constraint on codon usage.

Methods.

DNaseI digestion and high-throughput sequencing were performed on intact human nuclei from various cell types. Briefly, roughly 10 million cells were grown in appropriate culture media and nuclei were extracted using NP-40 in an isotonic buffer. The NP-40 detergent was removed and the nuclei were incubated for 3 min at 37° C. with limiting concentrations of the DNA endonuclease, DNaseI (DNaseI) (Sigma) supplemented with Ca2+ and Mg2+. The digestion was stopped with EDTA and the samples were treated with proteinase K. The small ‘double-hit’ fragments (<500 bp) were recovered by sucrose ultra-centrifugation, end-repaired and ligated with adapters compatible with the Illumina sequencing platform. High-quality libraries from each cell type were sequenced on the Illumina platform to an average depth of 273 million uniquely mapping single-end tags. The sequencing tags were aligned to the human reference genome and per-nucleotide cleavage counts were generated by summing the 5′ ends of the aligned sequencing tags at each position in the genome. FDR 1% DNaseI footprints were identified using an iterative search method based on optimization of the footprint occupancy score.

Data Downloads.

DNaseI-seq production data for Digital Genomic Footprinting (DGF) are available through the NCBI's Gene Expression Omnibus (GEO) data repository (accessions GSE26328 and GSE18927), and also through the table browser from University of California at Santa Cruz (http://genome.ucsc.edu/cgi-bin/hgTrackUi?db=hg19&g=wgEncodeUwDgf).

Data too large to include in the application are being made available via the ftp server at ebi.ac.uk which contains an organized file structure with the ENCODE data. Analysis data sets are located at ftp://ftp-private.ebi.ac.uk/ (Login:encode-box-01 Password: enc*deDOWN) in the subdirectories of byDataType.

Cell Types Used for DGF.

The following human cell types were subjected to DNaseI digestion and high-throughput sequencing, following previous methods at the 36mer or 27mer* level: AG10803, AoAF, CD20+, CD34+ mobilized, fBrain, fHeart, fLung, GM06990*, GM12865, HAEpiC, HA-h, HCF, HCM, HCPEpiC, HEEpiC, HepG2*, H7-hESC, HFF, HIPEpiC, HMF, HMVEC-dB1-Ad, HMVEC-dB1-Neo, HMVEC-dLy-Neo, HMVEC-LLy, HPAF, HPdLF, HPF, HRCEpiC, HSMM, Th1*, HVMF, IMR90, K562*, NB4, NH-A, NHDF-adult, NHDF-neo, NHLF, SAEC, SKMC and SK-N-SH RA*. Tags were aligned to the reference genome, build GRCh37/hg19 (specified by ENCODE http://hgdownload-test.cse.ucsc.edu/goldenPath/hg19/encodeDCC/referenceSequences/), using Bowtie, version 0.12.7 with parameters: -mm -n 3-v 3-k 2, and -phred33-quals for Illumina HiSeq sequencer runs or -phred64-quals for Illumina GAII sequencer runs.

Identification of DNaseI Footprints.

For each cell type, the DNaseI cleavage per nucleotide was computed by assigning to each base of the human genome an integer score equal to the number of uniquely mappable sequence tags with 5′ ends mapping to that position. To identify DNaseI footprints comprehensively across the genome, an improved and conceptually simplified approach was used versus that applied previously to the yeast genome. High cleavage density regions, hotspot regions as identified by the hotspot algorithm, were focused on within each cell type. The genome was scanned for 6-40-nucleotide stretches of successive nucleotides with low DNaseI cleavage rates relative to the immediately flanking regions, the signature of localized protection from DNaseI cleavage. The findings were filtered to those occurring within the hotspot regions.

A priori, footprints comprise three components: a central area of direct factor engagement, and an immediately flanking component to each side. Upon factor engagement, local DNA architecture is distorted, frequently resulting in enhanced cleavage rates for flanking nucleotides outside of the factor recognition sequence. Greater disparity between the central and flanking components is indicative of higher factor occupancy.

To quantify this, a simple footprint occupancy score (FOS) was applied such that FOS=(C+1)/L+(C+1)/R where C represents the average number of tags in the central component, L is the average number of tags in the left flanking component, R is the average number of tags in the right flanking component, and a smaller FOS value indicates greater average contrast levels between the central component and its flanking regions.

The statistic was optimized across a range of central component (6-40 nucleotides) and flanking component (3-10 nucleotides) sizes. The output of the algorithm was the set of footprints with optimal FOS scores, subject to the criteria that L and R were greater than C, and all central components were disjoint and non-adjoining. When two or more potential footprints (those with L and R greater than C) had overlapping or abutting central components, the one with the lowest FOS was selected (or, in rare cases of identical scores, the 5′-most footprint relative to the forward strand). The entire local region was then rescanned to identify additional footprints. A local region was defined as the smallest genomic segment to contain all potential footprints of shared bases (by transitivity). No newly identified footprint consisted of a central component that overlapped or abutted the central component of any previously selected footprint. The rescan process was iterated until no new footprint was identified within the local region.

Human genomic positions uniquely mappable using 36-nucleotide (and 27-nucleotide as appropriate) sequence reads were computed using the same algorithm previously applied to yeast. Any computed footprint whose central component consisted of non-uniquely mappable bases (thus having no mapped cleavage events by definition) that covered at least 20% of its length was discarded. Typically, less than 1% of unthresholded footprints were discarded during this process.

Owing to the large number of tests for footprints performed over the genome, it was necessary to control for the expected number of false positives that arose due to chance through multiple testing. A false discovery rate (FDR) measure, defined as the expected value of the fraction of truly null features called significant divided by the total number of features called significant, was applied. To estimate FDR, a null set of pseudo-cleavages was first generated. For each hotspot in one cell type, the same number of tags found within the region to uniquely mappable positions within the same genomic interval was randomly reassigned. Analogous with experimental data, each base received an in silico cleavage score equal to the number of tags with 5′ ends mapped to that base. The identical footprint positions under the randomized scenario that were derived as output for the non-thresholded experimental data were then considered, thus encompassing the same number of footprint calls for FDR calculation purposes. T maximum FOS threshold at which the number of footprints in the null set divided by the number of footprints in the observed set was less than or equal to 1% was computed. The 1% FDR estimates were computed separately for all 41 cell types, covering a wide range of total tag levels and number of hotspot regions, to produce an average FOS threshold of 0.95 with a standard deviation of 0.02. A final FOS threshold of 0.95 was applied to footprints across all cell types. The central components of these FDR thresholded footprints, henceforth footprints, made up the final output of the procedure.

It was tested whether DNaseI sequence bias contributed significantly to the FDR thresholded footprint sets. Purified nucleic acid (e.g., genomic DNA) was digested with DNaseI, and the resulting cleavage fragments of size 1 kb or below were sequenced. The data were used to build a model that describes relative cut rate biases among all 6-mer subsequences. Each FDR thresholded footprint in the SkMC cell type was visited and the total number of mapped tags falling in its central, left and right flanking regions counted. The same number of simulated tags to positions within these regions was then randomly assigned, using probabilities proportional to the model's DNaseI cut-rate bias for the sequence context surrounding each position. A new FOS was calculated over the same L, C and R regions as before and compared to the FOS value of the original footprint to see which footprints could be explained by sequence bias alone.

The multiset union of all footprints across all cell types was computed. For each element of the union, all significantly overlapping footprints, which were defined as those footprints with 65% or more of their bases in common with the element, were collected. A footprint's genomic coordinates were redefined to the minimum and maximum coordinates from its overlap set, which always included the footprint itself. All redefined footprints from the union then passed through a subsumption and uniqueness filter: when a footprint was genomically contained within another, the filter discarded the smaller of the two or selected just one footprint if identical. Footprints passing through the filter comprised the final set of 8.4 million combined footprints across all cell types. Unlike footprints from any single cell type, the combined set included overlapping footprints.

Footprinting Versus Tag Levels.

Random subsamples (sampling without replacement) of the 543 million uniquely mappable DNaseI-seq tags from the SKMC cell type were generated. Increasing sample sizes used tags generated from smaller samples in addition to new tags generated from the randomized process. Footprints were called at each subsampled tag level.

FDR 1% DNaseI Hypersensitive Sites.

The number of footprints falling within every DNaseI hypersensitive site (DHS, defined as 150 nucleotides in length) were counted and peaks grouped by their number of footprints. Any peak containing more than ten footprints was grouped with peaks containing exactly ten footprints. The analysis was performed in every cell type separately, and then results were combined. The DHSs were also decile-partitioned by the number of sequencing tags mapped to them. For each partition, a box plot was drawn to indicate the distribution of the number of footprints falling within the DHSs. The average number of footprints falling in DHSs was determined (Table 1).

Annotation of Footprints.

The number of combined footprints (8.4 million) falling into common genomic element categories (defined by at least 1 nucleotide of overlap), such as those overlapping introns, coding elements and intergenic regions, were counted and summarized. Annotations from GENCODE, version 7, were used. Promoter regions were defined as within ±2.5 kb from a transcriptional start site (TSS). Regions within ±2.5 kb of transcriptional end sites were categorized as 3′ proximal. Other feature categories, such as coding, 5′ UTR, 3′ UTR and introns, were derived directly from GENCODE annotations using transcriptional and coding start and stop site information, as well as exon boundary coordinates. When a footprint satisfied more than one category's condition (for example, when a footprint was found near more than one annotated transcript), it was assigned to only a single category. The order of category assignment in such cases was: coding, 5′ UTR, 3′ UTR, promoter, 3′ proximal, intronic and intergenic.

### Example 2

### Footprints are Quantitative Markers of In Vivo Factor Occupancy

The correspondence between DNaseI footprints and known regulatory factor recognition sequences within DNaseI hypersensitive chromatin was examined. Comprehensive scans of DNaseI hyper-sensitive regions for high-confidence matches to all recognized transcription factor motifs in the TRANSFAC and JASPAR databases revealed striking enrichment of motifs within footprints (P=0, Z-score=204.22 for TRANSFAC; Z-score=169.88 for JASPAR; FIG. 1b and FIG. 4). FIG. 1 illustrates parallel profiling of genomic regulatory factor occupancy across 41 cell types. FIG. 1b illustrates an example locus harboring eight clearly defined DNaseI footprints in Th1 and SK-N-SH_RA cells, with TRANSFAC database motif instances indicated below. FIG. 4 illustrates motif density in DNaseI footprints: the density of motifs in DNaseI footprints, DHSs (but not in footprints) and non-hypersensitive genomic regions. Motifs were significantly enriched in footprints (Z-score=204.22, Genome Structure Correction program comparing the locations of TRANSFAC motifs in 1% FDR footprints).

To quantify the occupancy at transcription factor recognition sequences within DHSs genome-wide, a footprint occupancy score (FOS) was computed for each instance relating the density of DNaseI cleavages within the core recognition motif to cleavages in the immediately flanking regions (Methods). The FOS can be used to rank motif instances by the ‘depth’ of the footprint at that position, and is expected to provide a quantitative measure of factor occupancy. To examine this relationship for a well-studied sequence-specific regulator (NRF1), DNaseI cleavage patterns surrounding all 4,262 NRF1 motifs contained within DHSs were plotted and these were ranked by FOS. Whereas only a subset of these motif instances (2,351) coincided with high-confidence footprints, the vast majority of NRF1 motif instances in DNaseI footprints (89%) overlapped reproducible sites of NRF1 occupancy identified by chromatin immunoprecipitation followed by high-throughput sequencing (ChIP-seq) (FIG. 1c). FIG. 1c illustrates heat maps showing per-nucleotide DNaseI cleavage (left) and vertebrate conservation by phyloP (right) for 4,262 NRF1 motifs within K562 DHSs ranked by the local density of DNaseI cleavages. Green ticks indicate the presence of DNaseI footprints over motif instances. Blue ticks indicate the presence of ChIP-seq peaks over the motif instances. In parallel, nucleotide-level evolutionary conservation patterns around NRF1 binding sites were analyzed, revealing that FOS closely paralleled phylogenetic conservation within the core motif region, indicating strong selection on factor occupancy (FIG. 1c). A nearly monotonic relationship between FOS and ChIP-seq signal intensities was observed at NRF1 binding sites within DNaseI footprints of K562 cells (FIG. 1d). FIG. 1d illustrates a Lowess regression of NRF1, USF1, NFE2 and NFYA K562 ChIP-seq signal intensities versus DNaseI footprinting occupancy (footprint occupancy score) at K562 DNaseI footprints containing NRF1, USF, NFE2 and NFYA motifs.

Similarly strong correlations between footprint occupancy and either ChIP-seq signal or phylogenetic conservation were evident for diverse factors (FIG. 1d and Neph et al., 2012a). In an exemplary case (Neph et al., 2012a), an association between footprint occupancy and sequence conservation was observed. Correlations between per nucleotide DNaseI cleavage and vertebrate conservation by phyloP were observed for USF and YY1 motifs within K562 DHSs (4,063 and 4,761 motif instances, respectively) in heat maps ranked by tag density. DNaseI footprints and ChIP-seq peaks for USF and YYI at putative genomic binding sites demonstrated high levels of overlap. Near-monotonic relationships were observed in Lowess regressions of NRF1 and USF maximum phyloP scores versus DNaseI footprinting occupancy (footprint occupancy score) at K562 DNaseI footprints marked by NRF1 and USF motifs (Neph et al., 2012a). Footprint occupancy and nucleotide-level conservation were found to be correlated for 80% of all transcription factor motifs in the TRANSFAC database, of which 50% were statistically significant (P<0.05; Methods). This relationship between footprint occupancy and conservation is most readily explained by evolutionary selection on factor occupancy, with higher conservation of higher affinity binding sites. Taken together, these results indicated that footprint occupancy provides a quantitative measure of sequence-specific regulatory factor occupancy that closely parallels evolutionary constraint and ChIP-seq signal intensity.

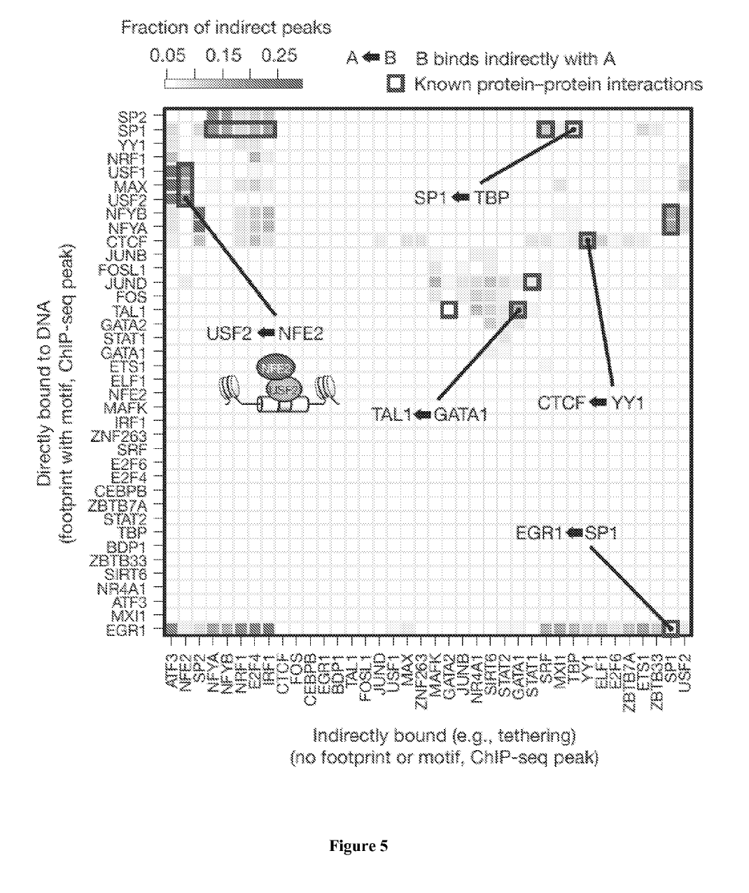

To validate the potential for selective binding of footprints by factors predicted on the basis of motif-to-footprint matching, an approach was developed to quantify specific occupancy in the context of a complex transcription factor milieu using targeted mass spectrometry (DNA interacting protein precipitation or DIPP; Methods). Using DIPP, the specific binding by several different classes of transcription factor was affirmed (FIG. 5a-e). FIG. 5 illustrates validation of footprints as potential sites of protein occupancy in vitro. FIG. 5a illustrates three genomic loci of varying footprint strength targeted using DNA interacting protein precipitation (DIPP). FIG. 5b illustrates a schematic overview of the DIPP protocol. FIG. 5c-d illustrate targeted mass spectrometry measurements of the proteins enriched using the different probe sets. The AP1 protein c-Jun was enriched specifically using the AP1 probes (c) and MAX was enriched specifically using the MAX probe (d). FIG. 5e illustrates that as a negative control for DIPP, CTCF binding to the six probes was tested. CTCF did not appear to be enriched in any of the pulldowns. Together with the analysis of ChIP-seq data described above, these results indicated that the localization of transcription factor recognition motifs within DNaseI footprints can accurately illuminate the genomic protein occupancy landscape.

Methods.

DNaseI digestion and high-throughput sequencing were performed on intact human nuclei from various cell types as previously described in Example 1 herein.

Data Downloads.

Data used are as previously described in Example 1 herein.

Cell Types Used for DGF.

The following human cell types were subjected to DNaseI digestion and high-throughput sequencing as previously described in Example 1 herein.

Identification of DNaseI Footprints.

The identification of DNaseI footprints was performed as previously described in Example 1 herein.

Footprinting Versus Tag Levels.

Footprinting versus tag levels were determined as previously described in Example 1 herein.

FDR 1% DNaseI Hypersensitive Sites.

The number of footprints falling within every DNaseI hypersensitive site was counted as previously described in Example 1 herein.

Putative Motif Binding Sites and Footprints.

The significance of overlap between footprints and predicted motifs within hotspot regions was determined using the Genome Structure Correction (GSC) test. Merged genomic hotspot regions across all 41 cell types made up the domain. The multiset union of all footprints, part of the domain by definition, as well as motif predictions within the domain (FIMO; P<1×10⁻⁵ using TRANSFAC and JASPAR CORE, separately) were used as inputs to GSC. Program parameters were: -n 10000, -s 0.1, -r 0.1, and -t m. Significance was reported as a Z-score (empirical P value was 0).

The average per-nucleotide number of overlapping motif instances over segments of a genome-wide partition was determined. The hotspot regions and footprint regions across the 41 cell types were separately merged. Using genome-wide FIMO scan predictions over TRANSFAC (P<1×10⁻⁵), the number of motif scan bases contained within the merged footprint partition was counted and divided by the total number of bases within the partition. Similarly, the average over the genomic complement between merged hotspots and merged footprints was found.

Finally, a genome-wide average outside of hotspots was found and divided by the number of nucleotides with known base labels (A, C, G, T), thereby ignoring large centromeric and telemeric regions.

DNaseI Cleavages Versus ChIP-Seq.

Motif models (from TRANSFAC, version 2011.1, JASPAR CORE and UniPROBE) were used in conjunction with the FIMO motif scanning software, version 4.6.1, using a P<1×10⁵ threshold, to find all motif instances within DNaseI hotspots of the K562 cell line. A discovered motif instance was buffered (+35 nucleotides) and the number of uniquely mapping DNaseI sequencing tags with 5′ ends mapping to the position was counted at each base position. The buffered motif instances were sorted by their total counts, and then normalized each instance's counts to a mean value of 0 and variance 1. A heat map, with 1 row per motif instance, was generated using matrix2png, version 1.2.1. A phyloP evolutionary conservation score heat map over the same ordered motif instances and bases was generated using the same processing techniques. Motif instances that overlapped footprints by at least 3 nucleotides were annotated. Uniformly processed hg19 K562 ChIP-seq peaks generated from experiments as part of the ENCODE Consortium were downloaded from the UCSC Table Browser. Motif instances overlapping ChIP-seq peaks by at least 1 nucleotide were also annotated.

Footprint Strength Versus ChIP-Seq Signal Intensity.

For a given ChIP-seq factor, footprints that overlapped putative binding sites within hotspot regions by at least 3 nucleotides were collected. The summed ChIP-seq signal density over each region was calculated, after buffering by ±50 nucleotides from footprint centroid. Footprints were ordered by their FOS values, and signal data were plotted using lowess curve fitting with a span of 25%. ChIP-seq data (raw tag counts) included those from first replicates only. Average tag count numbers replaced cases where multiple measurements over the same genomic coordinates existed in the ChIP-seq data.

Footprint Strength Versus Evolutionary Conservation.

Additionally, the maximum phyloP evolutionary conservation score over the same set of footprints was calculated. The maximum score was derived over the core footprint region (no buffering), with 10% of outlying scores removed. As before, footprints were ordered by their FOS values, and signal data were plotted using loess curve fitting with a span of 25%. A linear regression model was applied with R statistical software (http://www.r-project.org) collecting the associated F-test's P value.

DNA interacting protein precipitation (DIPP) experiments.

For protein extraction for DIPP experiments, nuclei were isolated using a standard protocol. Briefly, K562 cells were grown in RPMI (GIBCO) supplemented with 10% fetal bovine serum (PAA), sodium pyruvate (Gibco), L-glutamine (Gibco), penicillin and streptomycin (Gibco), and washed once with 1×DPBS (Gibco). Nuclear extraction was performed by re-suspending cells at 2.5×106 cells ml-l in 0.05% NP-40 (Roche) in buffer A (15 mM Tris pH 8.0, 15 mM NaCl, 60 mM KCl, 1 mM EDTA pH 8.0, 0.5 mM EGTA pH 8.0, 0.5 mM spermidine). After an 8-min incubation on ice, nuclei were pelleted at 400×g for 7 min and washed once with buffer A. Nuclei were then transferred to a 37° C. water bath and re-suspended at 1.25×107 nuclei ml⁻¹ in extraction buffer (10 mM Tris pH 8.0, 600 mM NaCl, 1.5 mM EDTA pH 8.0, 0.5 mM spermidine). After 3 min at 37° C. the sample was transferred to ice and rocked at 4° C. for 2 h. The soluble and insoluble fractions were separated by centrifugation at 3,220 g for 15 min. The soluble fraction was then dialysed for 2 h at 4° C. using a 3,500 Da molecular weight cutoff (MWCO) cartridge (Pierce) against 500 ml dialysis buffer (15 mM Tris pH 7.5, 15 mM NaCl, 60 mM KCl, 5 μM ZnCl2, 6 mM MgCl2, 1 mM DTT, 0.5 mM spermidine, 40% glycerol). The dialysis buffer was refreshed after 1 h of dialysis. Dialysed protein samples were quantified using a BCA assay (Pierce), flash frozen using liquid nitrogen and stored at −80° C. until use.

For DNA probe construction for DIPP experiments, three genomic loci were targeted that demonstrated varying footprinting strengths. These footprints included (in hg19 coordinates) a MAX footprint (chr22: 39707228-39707245) and two AP1 footprints—AP1 site 1 footprint (chr11: 5301978-5302005) and AP1 site 2 footprint (chr5: 75668604-75668626). For each of these sites, a 70-85-bp region of DNA centred on the DNaseI footprint was selected. The selected DNA regions, in hg19 coordinates, were: chr22: 39707201-39707270 for the MAX site; chr11: 5301945-5302029 for the AP1 site 1; and chr5: 75668577-75668646 for the AP1 site 2. DNA oligonucleotides were ordered for the forward and reverse strand for each of these sites, with the forward strand oligonucleotide containing a 5′ biotin modification (Integrated DNA Technologies). For each of these sites, the footprinting sequence was also shuffled and DNA oligonucleotides that contained this shuffled footprinting sequence along with the same flanking sequence as for the oligonucleotides above were ordered (Integrated DNA Technologies). The sequences of each of the probes can be found in Neph et al., 2012.

For generation of dsDNA bound beads for DIPP, for each probe set, 500 pmol of the forward strand biotinylated DNA oligonucleotide was mixed with 1 nmol of the reverse strand DNA oligo in annealing buffer (20 mM Tris pH 8.0, 100 mM KCl, 10 mM MgCl2). The reaction was denatured at 90° C. for 5 min, slowly cooled to 65° C. over 10 min, held at 65° C. for 5 min and then cooled to 25° C. For each reaction, 100 μl of Dynabeads MyOne Streptavidin T1 beads (Invitrogen) were washed twice with 0.75 ml of bead buffer (20 mM Tris pH 8.0, 2 M NaCl, 0.5 mM EDTA, 0.03% NP-40) and re-suspended in 0.8 ml bead buffer. Annealed dsDNA probes were then added to the beads and rocked at room temperature for 1 h. Beads were then washed twice with 0.8 ml bead buffer to remove unbound oligonucleotides. One millilitre of blocking buffer (20 mM HEPES pH 7.9, 300 mM KCl, 50 μg ml⁻¹ bovine serum albumin (BSA), 50 μg ml⁻¹ glycogen, 5 mg ml⁻¹ polyvinylpyrrolidone (PVP), 2.5 mM DTT, 0.02% NP-40) was added to each bead reaction and incubated at room temperature for 2 h. Beads were then washed twice with 0.75 ml of binding buffer (20 mM Tris-HCl pH 7.3, 5 &M ZnCl2, 100 mM KCl, 0.2 mM EDTA pH 8.0, 10 mM potassium glutamate, 2 mM DTT, 0.04% NP-40, 10% glycerol).

For pre-clearing protein extract for DIPP, 60 μl of fresh Dynabeads MyOne Streptavidin T1 beads (Invitrogen) were washed twice with 0.3 ml of bead buffer and once with 0.3 ml of binding buffer and then added to 80 μg of 600 mM soluble K562 nuclear protein extract and 80 μg of poly(dl-dC) (Roche) in a 400 μl total reaction volume with binding buffer. This reaction was incubated at 4° C. for 1.5 h, the beads were removed and the buffered protein extract was cleared by centrifugation at 10,000×g for 8 min at 4° C.

For DIPP reaction and digestion, to each of the washed dsDNA-bound bead reactions, 200 μl of the pre-cleared buffered protein extract was added. This was incubated at 4° C. for 2 h then washed three times with 1 ml binding buffer, twice with 0.5 ml 50 mM ammonium bicarbonate pH 7.8 and re-suspended in 100 μl 0.1% PPS Silent Surfactant (Protein Discovery) in 50 mM ammonium bicarbonate pH 7.8. Bead-bound proteins were boiled at 95° C. for 5 min, reduced with 5 mM DTT at 60° C. for 30 min and alkylated with 15 mM iodoacetic acid (IAA) at 25° C. for 30 min in the dark. Proteins were then digested with 2 μg trypsin (Promega) at 37° C. for 1.5 h while shaking. The supernatant, which now contained digested peptides, was then transferred to a new tube, the pH was adjusted to <3.0 bp 5 μl of 5 M HCl, and incubated at 25° C. for 20 min and then cleared by centrifugation at 20,817 g for 10 min. The digested samples were desalted using an Oasis MCX cartridge 30 mg per 60 μm (Waters). Peptide samples were then re-suspended in 30 μl 0.1% formic acid in H2O. These peptide samples were stored at −20° C. until injected on the mass spectrometer.

For targeted proteomic mass spectrometry on DIPP samples, proteotypic peptides for c-Jun, MAX and CTCF were identified. Briefly, the full-length protein was synthesized in vitro from cDNA clones, digested with trypsin, and the optimal proteotypic peptides were identified from mass spectrometry via selected reaction monitoring. These peptides were CPDCDMAFVTSGELVR and TFQCELCSYTCPR for CTCF; NSDLLTSPDVGLLK and NVTDEQEGFAEGFVR for c-Jun; and QNALLEQQVR and ATEYIQYMR for MAX. For each doubly charged monoisotopic precursor, singly charged monoisotopic y3 to yn-1 product ions were monitored. All cysteines were monitored as carbamidomethyl cysteines. Ions were isolated in both Q1 and Q3 using 0.7 FWHM resolution. Peptide fragmentation was performed at 1.5 mTorr in Q2 using calculated peptide-specific collision energies. Data were acquired using a scan width of 0.002 m/z and a dwell time of 40 ms.

Peptide samples were analysed with a TSQ-Vantage triple-quadrupole instrument (Thermo) using a nanoACQUITY UPLC (Waters). A 5 μl aliquot of each sample was separated on a 20-cm-long 75 μm internal diameter packed column (Polymicro Technologies) using Jupiter 4u Proteo 90A reverse-phase beads (Phenomenex) and suitable chromatography conditions (e.g., a linear gradient running from 2 to 60% (v/v) acetonitrile (in 0.5% acetic acid) with a flow rate of 200-nl/min in 90 min). The injection order for each sample was randomized, and each sample was measured in three separate replicate injections.

Targeted measurements were imported into Skyline for analysis. Chromatographic peak intensities from all monitored product ions of a given peptide were integrated and summed to give a final peptide peak height. For each peptide, peak heights from different samples and replicate runs were normalized such that the injection with the highest intensity was given a value of 1. Final peptide data were generated by taking the average normalized value of a peptide across replicates of a sample.

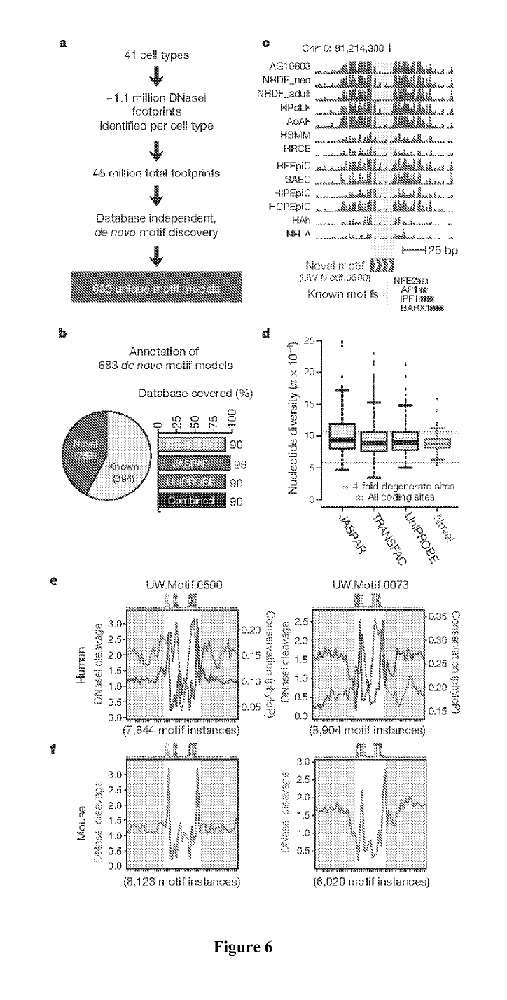

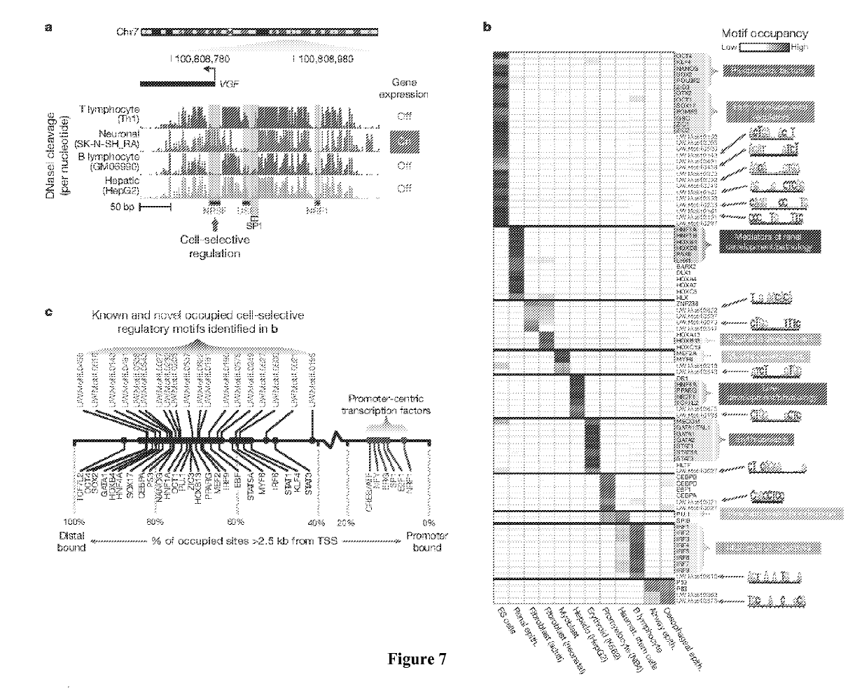

The potential for single nucleotide variants within a transcription factor recognition sequence to abrogate binding of its cognate factor is well known. The depth of sequencing performed in the context of the footprinting experiments provided hundreds- to thousands-fold coverage of most DHSs, enabling precise quantification of allelic imbalance within DHSs harboring heterozygous variants. All DHSs were scanned for heterozygous single nucleotide variants identified by the 1000 Genomes Project and measured, for each DHS containing a single heterozygous variant, the proportion of reads from each allele. Likely functional variants conferring significant allelic imbalance in chromatin accessibility were identified and analysed their distribution relative to DNaseI footprints. This analysis revealed significant enrichment (P<2.2×10⁻¹⁶; Fisher's exact test) of such variants within DNaseI footprints (FIG. 6). FIG. 6 illustrates that DNaseI footprints were observed to mark sites of functional in vivo protein occupancy. Heterozygous SNVs associated with allele-specific occupancy were significantly enriched inside footprints compared to the rest of the DHS (P<2.2×10⁻¹⁶, Fisher's exact test). For example, rs4144593 is a common T-to-C (T/C) variant that lies within a DHS on chromosome 9. This variant was found to fall on a high-information position within an NF1 or CTF1 footprint and substantially disrupted footprinting of this motif, resulting in allelic imbalance in chromatin accessibility (FIG. 7a). FIG. 7 illustrates that DNaseI footprints were observed to mark sites of in vivo protein occupancy. FIG. 7a illustrates a schematic and plots showing the effect of T/C SNV rs4144593 on protein occupancy and chromatin accessibility. The axis of the bar graph shows the number of DNaseI cleavage events containing either the T or C allele. Middle plots show T or C allele-specific DNaseI cleavage profiles from ten cell lines heterozygous for the T/C alleles at rs4144593. Right plots show DNaseI cleavage profiles from 18 cell lines homozygous for the C allele at rs4144593 and one cell line homozygous for the T allele at rs4144593. Cleavage plots are cut off at 60% cleavage height.

Protein-DNA interactions are also sensitive to cytosine methylation. Comparing DNaseI footprints and whole-genome bisulphite sequencing methylation data from pulmonary fibroblasts (IMR90), CpG dinucleotides contained within DNaseI footprints were found to be significantly less methylated than CpGs in non-footprinted regions of the same DHS (Mann-Whitney U-test; P<2.2×10⁻¹⁶; FIG. 7b). FIG. 7b illustrates the average CpG methylation within IMR90 DNaseI footprints, IMR90 DHSs (but not in footprints) and non-hypersensitive genomic regions in IMR90 cells. CpG methylation was observed to be significantly depleted in DNaseI footprints (P<2.2×10⁻¹⁶, Mann-Whitney U-test). Footprints therefore seem to be selectively sheltered from DNA methylation, indicating a widespread connection between regulatory factor occupancy and nucleotide-level patterning of epigenetic modifications.

Methods.

DNaseI digestion and high-throughput sequencing were performed on intact human nuclei from various cell types as previously described in Example 1 herein.

Data Downloads.

Data used are as previously described in Example 1 herein.

Cell Types Used for DGF.

The following human cell types were subjected to DNaseI digestion and high-throughput sequencing as previously described in Example 1 herein.

Identification of DNaseI Footprints.

The identification of DNaseI footprints was performed as previously described in Example 1 herein.

Allelic Imbalance in Footprints.

A set of known autosomal single nucleotide variants (SNVs) was downloaded from the 1000 Genomes Project. To avoid positions subject to mapping bias, SNVs were filtered to exclude any two within a read length (up to 36 nucleotides) of one another. Allele counts used the same DNaseI-seq alignments from which the cut counts were derived. For each cell type, reads overlapping each SNV were queried from the alignment in BAM format using the SAMtools. Reads supporting a base call were counted only if they were mapped with no more than one mismatch excluding the SNV position being counted. If more than one read from a library was mapped at the same chromosome offset and strand, a single read was sampled at random to avoid over-counting from possible PCR duplicates. To call an individual heterozygous at a SNV conservatively, both alleles observed by 1000 Genomes had to be supported by at least four distinct reads. To call homozygotes conservatively, one of the known alleles had to be supported by at least ten reads, and there had to be no reads supporting the other known allele, but a single read supporting another base was tolerated as a sequencing error where total read depth exceeded 50.

In the vicinity of each SNV (36 nucleotides), DNaseI cut counts from individuals homozygous for the same allele were added together, using the same genomic cut-count tracks used for calling footprints. In heterozygous individuals, reads overlapping the SNV were queried from the alignment BAM files but not subjected to the mismatch and duplicate filters used to obtain unbiased counts. The cut position represented by each read was reported as the aligned genomic position of the first base of the read, so cut-counts from reads aligning to the negative genomic strand may be offset by 1 nucleotide, relative to the convention normally used for genomic cut counts. For each allele, the phased cut counts for that allele from all heterozygous individuals were then added together.

At each SNV, the reads supporting each allele from all individuals heterozygous at the SNV were added together. Heterozygous sites were divided into two sets, those within the merged FDR 1% footprints across all cell types and those outside. A read-depth distribution was derived from each set, and the intersection was determined to generate a read-depth-matched random sample as large as possible. At each particular read depth, all sites from the set with fewer instances of that depth were included, and a random sample without replacement was taken from the set with more instances. Finally, sites in each set showing allelic imbalance were counted with two-sided binomial test P<0.01. The difference between these counts was tested for significance with a one-sided Fisher's exact test.

CpG Methylation Calculation within Footprints, DHSs and Non-DHSs.

IMR90 methylation calls were filtered to CpGs covered by at least 40 reads. Methylation at each CpG was defined as the count of reads showing methylation (protection from bisulphite conversion) divided by the total read depth. Three sets of genomic coordinates were generated with this signal: IMR90 FDR 1% footprints, IMR90 DNaseI peaks (subtracting overlapping footprint bases), and locations of CpGs in the GRCh37/hg19 genome reference sequence, removing elements that overlap IMR90 DNaseI hotspots. For each contiguous region in these data sets, the mean methylation of all overlapping CpGs that passed the 40-read coverage threshold was taken. Regions with no such overlap were ignored. To compute P values, vectors of mean methylation values were compared using a two-sided Mann-Whitney U-test.

### Example 4

### Transcription Factor Structure is Imprinted on the Genome

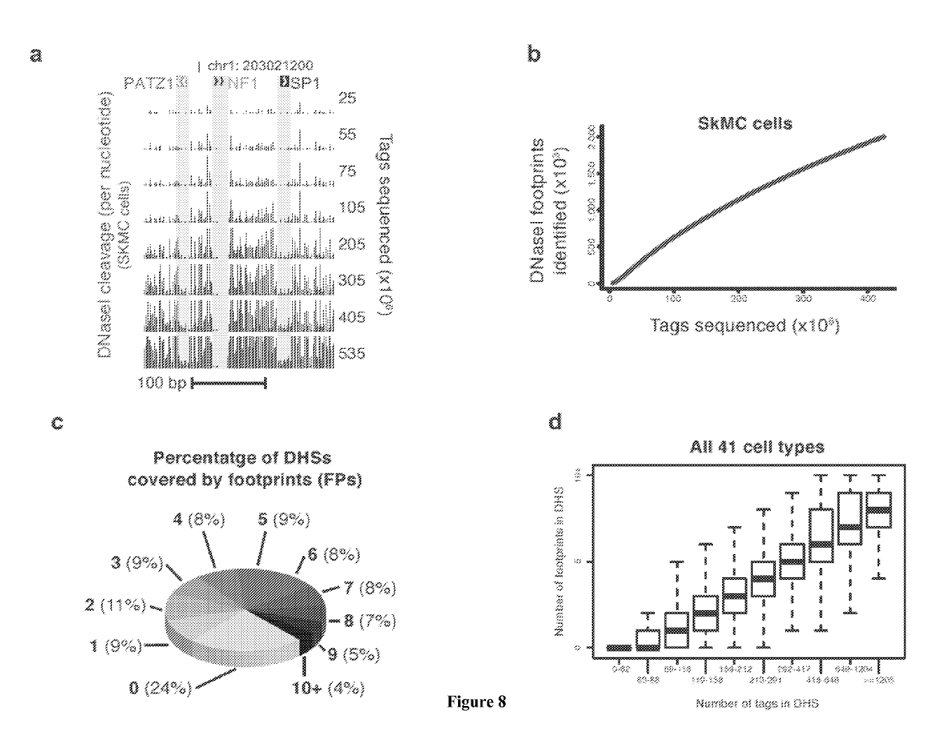

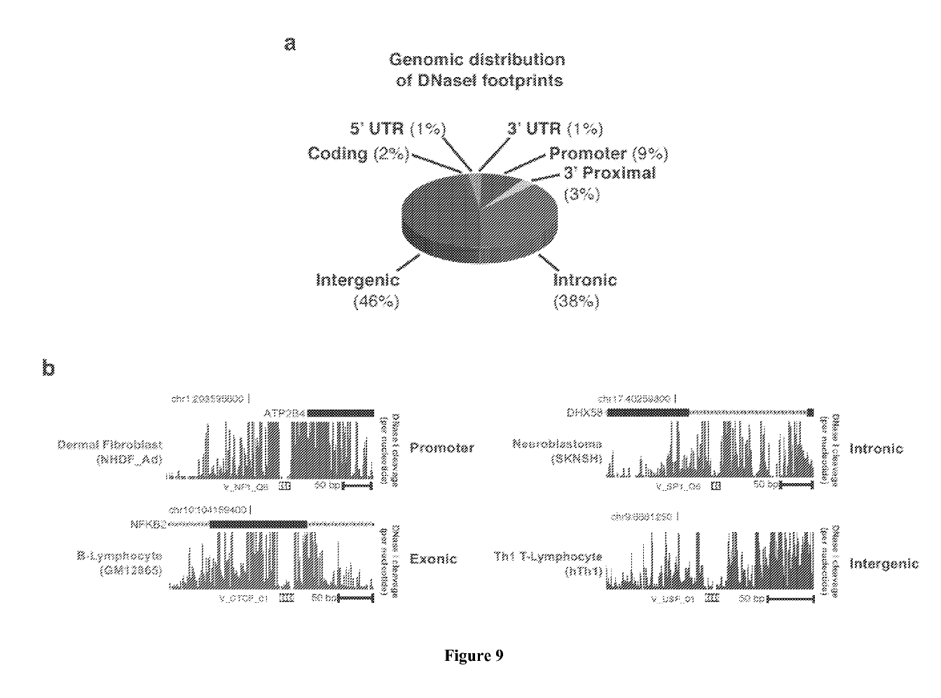

Surprisingly heterogeneous base-to-base variation in DNaseI cleavage rates was observed within the footprinted recognition sequences of different regulatory factors. And yet, the per site cleavage profiles for individual factors were highly stereotyped, with nearly identical local cleavage patterns at thousands of genomic locations (FIG. 8). FIG. 8 illustrates stereotyped cleavage patterns for different TFs: the per-nucleotide DNaseI cleavage patterns at motif instances of 4 different transcription factors in adult dermal fibroblasts (NHDF-Ad), in which the different motif instances (rows) are randomly ordered. This raised the possibility that DNaseI cleavage patterns may provide information concerning the morphology of the DNA-protein interface. Available DNA-protein co-crystal structures for human transcription factors were obtained, and aggregate DNaseI cleavage patterns at individual nucleotide positions were mapped onto the DNA backbone of the co-crystal model. FIG. 9a and Neph et al., 2012a, show two examples: USF1 and SRF. FIG. 9 illustrates that footprint structure was found to parallel transcription factor structure and was observed to be imprinted on the human genome. In FIG. 9a, the co-crystal structure of upstream stimulatory factor (USF1) bound to its DNA ligand is juxtaposed above the average nucleotide-level DNaseI cleavage pattern (blue) at motif instances of USF in DNaseI footprints. Nucleotides that are sensitive to cleavage by DNaseI are colored blue on the co-crystal structure. The motif logo generated from USF DNaseI footprints is displayed below the DNaseI cleavage pattern. Below is a randomly ordered heat map showing the per-nucleotide DNaseI cleavage for each motif instance of USF in DNaseI footprints. In another exemplary case (Neph et al., 2012a), anti-correlation of conservation and DNaseI cleavage for factors with structural data was observed. Similar to FIG. 9a, the co-crystal structure of Serum Response Factor (SRF) bound to its DNA ligand was juxtaposed above the average nucleotide-level DNaseI cleavage pattern at motif instances of SRF in DNaseI footprints, and also above a randomly ordered heat map showing the per-nucleotide DNaseI cleavage for each motif instance of SRF in DNaseI footprints (Neph et al., 2012a). For both factors, DNaseI cleavage patterns was observed to clearly parallel the topology of the protein-DNA interface, including a marked depression in DNaseI cleavage at nucleotides involved in protein-DNA contact, and increased cleavage at exposed nucleotides such as those within the central pocket of the leucine zipper. These data showed that nucleotide-level aggregate DNaseI cleavage patterns reflect fundamental features of the protein-DNA interaction interface at unprecedented resolution.

It was next asked how these patterns related to evolutionary conservation. Plotting nucleotide-level aggregate DNaseI cleavage in parallel with per-nucleotide vertebrate conservation calculated by phyloP revealed striking antiparallel patterning of cleavage versus conservation across nearly all motifs examined (six representative examples are shown in FIG. 9b and Neph et al., 2012a). FIG. 9b illustrates the per-base DNaseI hypersensitivity (blue) and vertebrate phylogenetic conservation (red) for all DNaseI footprints in dermal fibroblasts matching three well-annotated transcription factor motifs. The white box indicates width of consensus motif. The number of motif occurrences within DNaseI footprints is indicated below each graph. In another exemplary case (Neph et al., 2012a), the per-base DNaseI hypersensitivity and vertebrate phylogenetic conservation was compared for all DNaseI footprints in dermal fibroblasts matching three well annotated transcription factor motifs, EBF (11,941 instances within DNaseI footprints), AP2 (12,770 instances), and CTF1 (11,110 instances). Notably, conservation was found to be not limited to only DNA contacting protein residues, but exhibited graded changes that mirrored DNaseI accessibility across the entirety of the protein-DNA interface (Neph et al., 2012a). For example, cleavage profiles were shown to mirror the protein structure and were anti-correlated with vertebrate conservation for USF (3920 motif instances within DNaseI footprints) and SRF (3542 instances) (Neph et al., 2012a). Taken together, these results implied that regulatory DNA sequences have evolved to fit the continuous morphology of the transcription factor-DNA binding interface.

Methods.

DNaseI digestion and high-throughput sequencing were performed on intact human nuclei from various cell types as previously described in Example 1 herein.

Data Downloads.

Data used are as previously described in Example 1 herein.

Cell Types Used for DGF.

The following human cell types were subjected to DNaseI digestion and high-throughput sequencing as previously described in Example 1 herein.

Identification of DNaseI Footprints.

The identification of DNaseI footprints was performed as previously described in Example 1 herein.

Rendering of DNA-Protein Complexes.

Crystallography data showing DNA-protein complexes for selected factors were obtained from the Protein Data Bank and rendered with MacPyMOL (http://www.pymol.org), version 1.3. Nucleotide residues were coloured from white to blue, indicating increasing relative DNaseI cleavage propensity as aggregated across all motif instances.

For a heat map of DNaseI cleavages per nucleotide, every motif instance of a motif model found within hotspot regions was buffered (±35 nucleotides), and the number of uniquely mappable sequencing tags with 5′ ends mapping at each base position counted. Motif instances were sorted by their total counts, and then normalized each instance's counts to a mean value of 0 and variance 1. A heat map, with 1 row per motif instance, was generated using matrix2png.

Visualization of DNaseI Cleavage Profiles by Motif Occurrence.

Motif models (from TRANSFAC, JASPAR CORE and UniPROBE) were used in conjunction with the FIMO motif scanning software, version 4.6.1, using a P<1×10⁵ threshold, to find all motif instances within DNaseI hotspots of each cell type. The left and right coordinates of each motif instance were padded by 35 nucleotides. Using the bedmap tool from the BEDOPS suite, version 1.2, the per-nucleotide DNaseI cleavage values from deeply sequenced DNaseI-seq libraries were recovered for each motif occurrence. A similar approach was used for phyloP vertebrate conservation. Aggregate plots were made by averaging over all strand-oriented motif occurrences the number of DNaseI cleavages and per-base conservation scores. All palindromic and near-palindromic motif occurrences were left in the data set, reasoning that a transcription factor may bind to either orientation of the genomic region and binding events on either strand result in conformal changes to DNA that result in strand-specific cleavage patterns. Sequence logos were generated by assessing the information content of the oriented genomic sequences from all motif occurrences.

### Example 5

### A 50-Bp Footprint Localizes Transcription Initiation

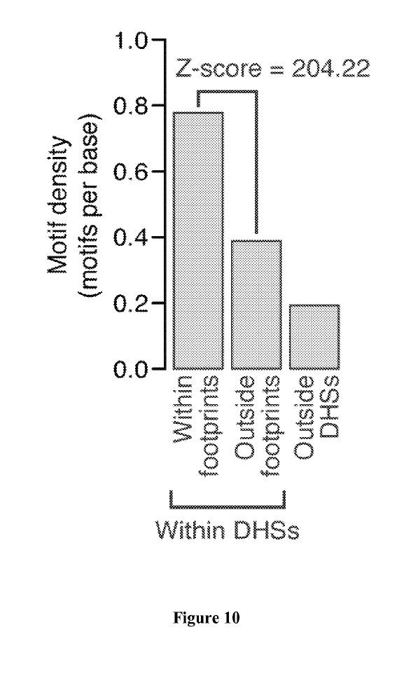

Transcription initiation requires the binding of multi-protein complexes that position RNA polymerase II. Using a modified footprint detection algorithm designed to detect larger features (Methods), the regions upstream from GENCODE TSSs were scanned and highly stereotyped ˜80-bp chromatin structure comprising a prominent ˜50-bp central DNaseI footprint, flanked symmetrically by ˜15-bp regions of uniformly elevated levels of DNaseI cleavage was identified (FIG. 10a). FIG. 10 illustrates that a highly stereotyped chromatin structural motif was observed to mark sites of transcription initiation in human promoters. FIG. 10a illustrates that a 35-55-bp footprint was found to be the predominant feature of many promoter DHSs and was observed to be in tight spatial coordination with the transcription start site. Alignment of per-nucleotide DNaseI cleavage profiles from 5,041 prominent footprints mapped in different K562 promoters highlighted the homogeneous, nearly invariant nature of the structure (FIG. 10b). FIG. 10b illustrates a heat map of the per-nucleotide DNaseI cleavage pattern at 5,041 instances of this stereotypical footprint in K562 cells.

Plotting evolutionary conservation in parallel with DNaseI cleavage revealed two distinct peaks in evolutionary conservation within the central footprint (FIG. 10c) compatible with binding sites for paired canonical sequence-specific transcription factors. FIG. 10c illustrates an aggregate per-base DNaseI cleavage profile (blue line) and mean per-nucleotide conservation score (phyloP) surrounding instances of this stereotypical footprint in K562 cells (red dashed line). The density of capped analysis of gene expression (CAGE) tags (FIG. 10d; green line) and 5′ ends of expressed sequenced tags (ESTs) (FIG. 10d; orange line) relative to the central-50-bp footprint revealed that, at the vast majority of promoters, RNA transcript initiation localized precisely within the stereotyped footprint. FIG. 10d illustrates aggregate strand corrected CAGE sequencing data (green line) and the average nearest 5′ end of a spliced EST (orange line) surrounding instances of this stereotypical footprint in K562 cells. It is notable that the location of this footprint was observed to be often offset, typically 5′, from many GENCODE-annotated TSSs. This probably derives from the incomplete nature of many of the 5′ transcript ends used to define TSSs.

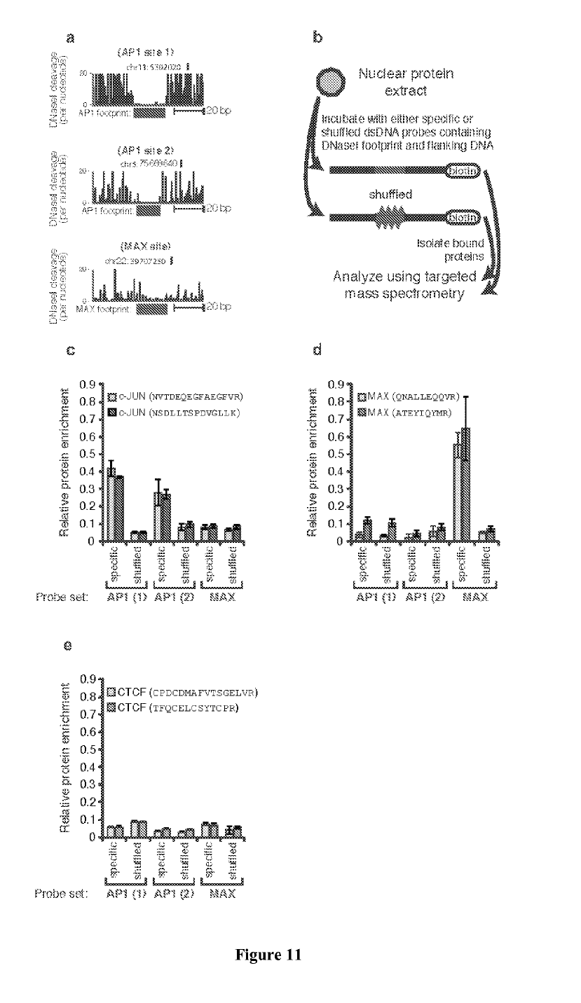

These data together defined a new high-resolution chromatin structural signature of transcription initiation and the interaction of the pre-initiation complex with the core promoter. Indeed, chromatin occupancy of TATA-binding protein (TBP), a critical component of the pre-initiation complex, was found to be maximal precisely over the centre of the 50-bp footprint region (FIG. 11a). FIG. 11 illustrates that general transcriptional activators were observed to occupy the PIC footprint. FIG. 11a illustrates a mean ChIP-seq tag density for TATA-binding protein centered on the TSS-linked footprint in K562 cells. Sequence analysis of the two conservation peaks within the 50-bp footprint identified motifs for GC-box-binding proteins such as SP1 and, less frequently, other general transcription factors (though with the notable absence of TATA motifs) (FIG. 11b), indicating that TBP (and potentially other pre-initiation complex components) interacts preferentially with general transcriptional factors bound to GC-box-like features in the central footprinted region. FIG. 11b illustrates that motifs associated with general transcription factors were found within the footprint. TRANSFAC motifs, reduced by similarity and non-overlapping instances of each motif group, were enumerated inside of the PIC footprint. The results were therefore consistent with a model in which a limited number of sequence-specific factors function both to prime the chromatin template for recruitment of RNA polymerase II and to guide transcriptional positioning.

Methods.

DNaseI digestion and high-throughput sequencing were performed on intact human nuclei from various cell types as previously described in Example 1 herein.

Data Downloads.

Data used are as previously described in Example 1 herein.

Cell Types Used for DGF.

The following human cell types were subjected to DNaseI digestion and high-throughput sequencing as previously described in Example 1 herein.

Identification of DNaseI Footprints.

The identification of DNaseI footprints was performed as previously described in Example 1 herein.

Analysis of Stereotyped TSS-Linked Footprint.

The cleavage profiles±500 nucleotides of all GENCODE V7 (level 1 and 2; manual curation) transcription start sites were used as regions to search for a 35-55-bp footprint following the method outline above with modifications. To amplify the signal in regions of low tag density and to remove noise in the data, the DNaseI cut counts were squared (×2). The FOS score was then calculated for every segment 35-55 bp in width using a fixed flank width of 10 bp (left and right). The scored segments were ranked in ascending order (low FOS to high FOS) and the top non-overlapping segments were collected until no segments remained. Finally, a FOS threshold was selected (0.75, uniformly across 41 cell types) and these putative footprints were used in the subsequent analysis.

Graphical profiles were generated by enumerating the per-nucleotide DNaseI cleavages and phyloP conservation in a 250-bp window centred on the footprint. The heat-map representation was created using matrix2png.

CAGE tags from the nuclear poly-A fraction (replicate 1) generated by RIKEN was downloaded from the UCSC Browser and the 5′ stranded oriented ends were summed per base. The footprint was stranded oriented to the nearest GENCODE V7 TSS. The per-base CAGE tags were enumerated in an 800-bp window centred on the footprint. To evaluate the spatial relationship of transcription the distance to the nearest spliced EST curated from GenBank was calculated.

Determining Direct and Indirect Transcription Factor Binding.

Uniformly processed hg19 K562 ChIP-seq peaks generated from experiments as part of the ENCODE Consortium were downloaded from the UCSC Genome Browser. Peaks overlapping DNaseI hypersensitive hotspot regions by at least 20% were stratified into three categories: direct peaks, indirect peaks and indeterminate peaks. Direct peaks contained an appropriate motif instance (FIMO scan software, version 4.6.1, using P<1×10⁻⁵ threshold and motifs from TRANSFAC, version 2011.1) that overlapped a DNaseI footprint by at least 1 nucleotide. Indirect peaks did not contain a cognate motif and indeterminate peaks were ambiguous (contained a motif that did not overlap a footprint). To identify enriched direct/indirect binding pairs, the number of overlapping occurrences of all possible direct/indirect combinations was counted. Each ChIP-seq peak-pair count was normalized by the total number of indirect peaks for the indirectly bound factor, to reduce the effect of noise (due to incomplete motif models, insufficient DNase1 coverage, and/or nonspecific antibodies).

### Example 6

### Differentiating Direct/Indirect Transcription Factor Binding

Many transcriptional regulators are posited to interact indirectly with the DNA sequence of some target sites though mechanisms such as tethering. Approaches such as ChIP-seq detect chromatin occupancy, but cannot by themselves distinguish sites of direct DNA binding from non-canonical indirect binding. Therefore it was asked whether DNaseI footprint data could illuminate ChIP-seq-derived occupancy profiles by differentiating directly bound factors from indirect binding events. ChIP-seq peaks were first partitioned from each of 38 ENCODE transcription factors mapped in K562 cells into three categories of predicted sites: ChIP-seq peaks containing a compatible footprinted motif (directly bound sites); ChIP-seq peaks lacking a compatible motif or footprint (indirectly bound sites); and ChIP-seq peaks overlying a compatible motif lacking a footprint (indeterminate sites). Predicted indirect sites showed significantly reduced ChIP-seq signal compared with predicted directly bound sites (Neph et al., 2012a), consistent with lack of direct crosslinking to DNA (and therefore reduced ChIP efficiency).

In an exemplary case (Neph et al., 2012a), it was demonstrated that occupancy of transcription factors differs by mode of interaction with chromatin. ChIP-seq peaks of the factors YY1, NFE2, USF1, and FYA were partitioned into the three classes, direct (footprinted motif), indirect (no motif), and indeterminate (motif with no footprint). The signal from the indirect class for these three factors was observed to be lower than that of the direct class. Indeterminate sites exhibited low ChIP-seq signal and were therefore excluded from further analysis (Neph et al., 2012a).

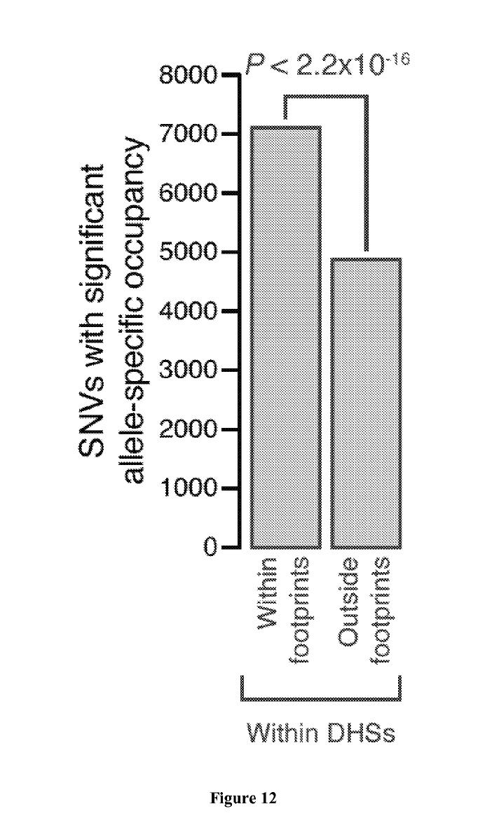

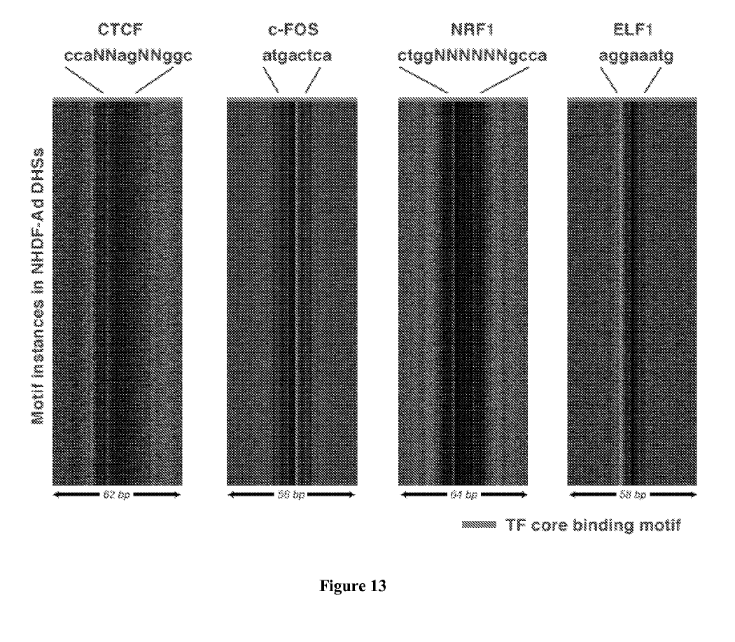

The fraction of ChIP-seq peaks predicted to represent direct versus indirect binding varied widely between different factors, ranging from nearly complete direct sequence-specific binding (for example, CTCF), to nearly complete indirect binding (for example, TBP; FIG. 12). FIG. 12 illustrates a distribution of indirect binding by transcription factor. Transcription factors are ordered by the percentages of total peaks bound indirectly (bottom). The values of indirect binding were compared to motif occurrences (presumably direct binding) determined by Factorbook (http://www.factorbook.org) (top). ChIP-seq peaks are ordered by intensity and binned into groups of 500 peaks (x-axis). The fraction of ChIP-seq peaks containing a discovered motif (y-axis) is plotted. Red and green lines represent the known binding motif, except for TATA-binding protein, for which a TATA-box was not identified. The dotted horizontal line on the bottom plot represents 20% and 60% direct binding (80% and 40% indirect, respectively). Corresponding dotted lines are drawn on the Factorbook plots highlighting the percentage of binding sites that contain a cognate recognition site. In many cases factors that preferentially engage in direct DNA binding at distal sites show predominantly indirect occupancy in promoter regions and vice versa (FIG. 13a-b). FIG. 13 illustrates a distribution of direct and indirect transcription factor binding. FIG. 13a illustrates that the percentage of K562 ChIP-seq peaks bound directly in distal regions was computed for each factor. Here, distal was defined as sites greater that 5 kilobases from any GENCODE level 1 and 2 annotated promoter. FIG. 13b illustrates enrichment of indirect ChIP-seq peaks found in promoters for transcription factors in (a). The enrichment was defined as the log₂ ratio between the fraction of indirect sites in promoters and distal regions.

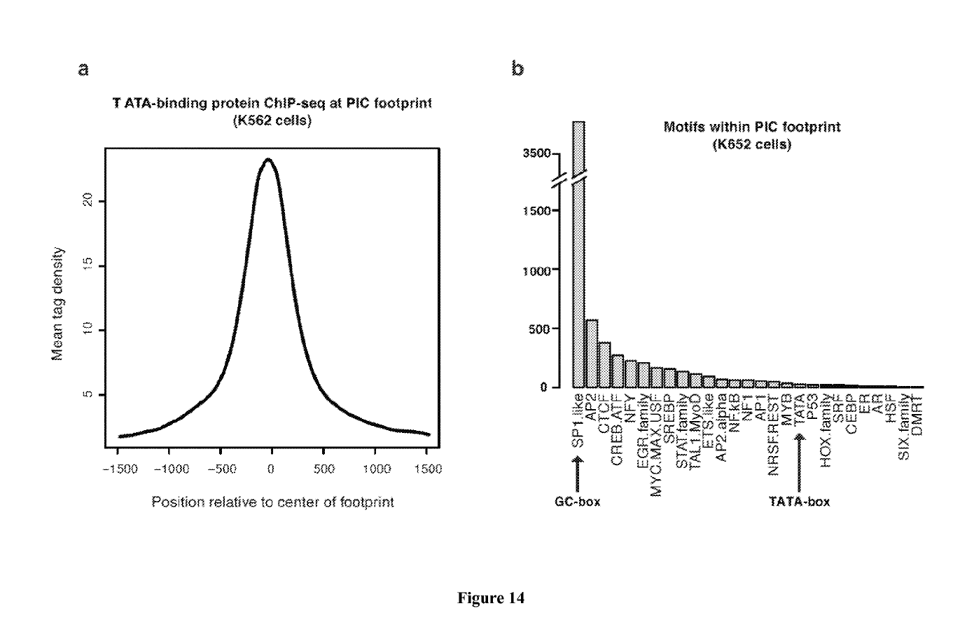

Next, the frequency with which indirectly bound sites of one transcription factor coincided with directly bound sites of a second factor was analyzed, indicative of protein-protein interactions (for example, tethering). This analysis recovered many known protein-protein interactions, such as CTCF-YY1 and TAL1-GATA1, as well as many novel associations (FIG. 14). FIG. 14 illustrates distinguishing direct and indirect binding of transcription factors: a heat map of the enrichment of pairs of transcription factors in a direct-indirect association. Direct peaks were defined by ChIP occupancy accompanied by a footprint overlapping a compatible motif Indirect peaks do not have a compatible motif. The color of each cell was determined by the fraction of indirect peaks that co-localize with the direct peaks of another factor. Enrichment was observed for NFE2 indirect interactions at promoter-bound USF2 sites, compatible with their known interaction. At distal sites, the opposite was observed, with NFE2 predominantly directly bound accompanied by USF2 indirect peaks (FIG. 13a-b), indicating the possibility of a reciprocal or looping mechanism. Notably, directly bound promoter-predominant transcription factors were enriched for co-localization with indirect peaks compared to distal regions (Neph et al., 2012a). In an exemplary case (Neph et al., 2012a), it was demonstrated that directly bound promoter elements mediate indirect transcription factor interactions. The number of overlapping indirect ChIP-seq peaks of other factors was computed for each directly bound ChIP-seq peak for many factors. On average, directly bound NFE2 ChIP-seq peaks were observed to overlap two indirect peaks of other factors, while Sp1 was found to overlap on average 6.5 indirect peaks. CTCF and Nrf1 were observed to overlap 1 and 5 indirect peaks of other factors, respectively (Neph et al, 2012a). These results suggested that combining DNaseI footprinting with ChIP-seq has the potential to expose a previously unappreciated landscape of complex transcription factor occupancy modes.

Methods.

DNaseI digestion and high-throughput sequencing were performed on intact human nuclei from various cell types as previously described in Example 1 herein.

Data Downloads.

Data used are as previously described in Example 1 herein.

Cell Types Used for DGF.

The following human cell types were subjected to DNaseI digestion and high-throughput sequencing as previously described in Example 1 herein.

Identification of DNaseI Footprints.

The identification of DNaseI footprints was performed as previously described in Example 1 herein.

Determining Direct and Indirect Transcription Factor Binding.

Uniformly processed hg19 K562 ChIP-seq peaks generated from experiments as part of the ENCODE Consortium were downloaded from the UCSC Genome Browser. Peaks overlapping DNaseI hypersensitive hotspot regions by at least 20% were stratified into three categories: direct peaks, indirect peaks and indeterminate peaks. Direct peaks contained an appropriate motif instance (FIMO scan software, version 4.6.1, using P<1×10-5 threshold and motifs from Transfac, version 2011.1) that overlapped a DNaseI footprint by at least 1 nucleotide. Indirect peaks did not contain a cognate motif and indeterminate peaks were ambiguous (contained a motif that did not overlap a footprint). To identify enriched direct/indirect binding pairs, the number of overlapping occurrences of all possible direct/indirect combinations was counted. Each ChIP-seq peak-pair count was normalized by the total number of indirect peaks for the indirectly bound factor, to reduce the effect of noise (due to incomplete motif models, insufficient DNaseI coverage, and/or nonspecific antibodies).

### Example 7

### Footprints Encode an Expansive Cis-Regulatory Lexicon

Since the discovery of the first sequence-specific transcription factor, considerable effort has been devoted to identifying the cognate recognition sequences of DNA-binding proteins. Despite these efforts, high-quality motifs are available for only a minority of the >1,400 human transcription factors with predicted sequence-specific DNA binding domains.

It was reasoned that the genomic sequence compartment defined by DNaseI footprints in a given cell type ideally should contain much, if not all, of the factor recognition sequence information relevant for that cell type. Consequently, applying de novo motif discovery to the footprint compartments gleaned from multiple cell types should greatly expand the current knowledge of biologically active transcription factor binding motifs.

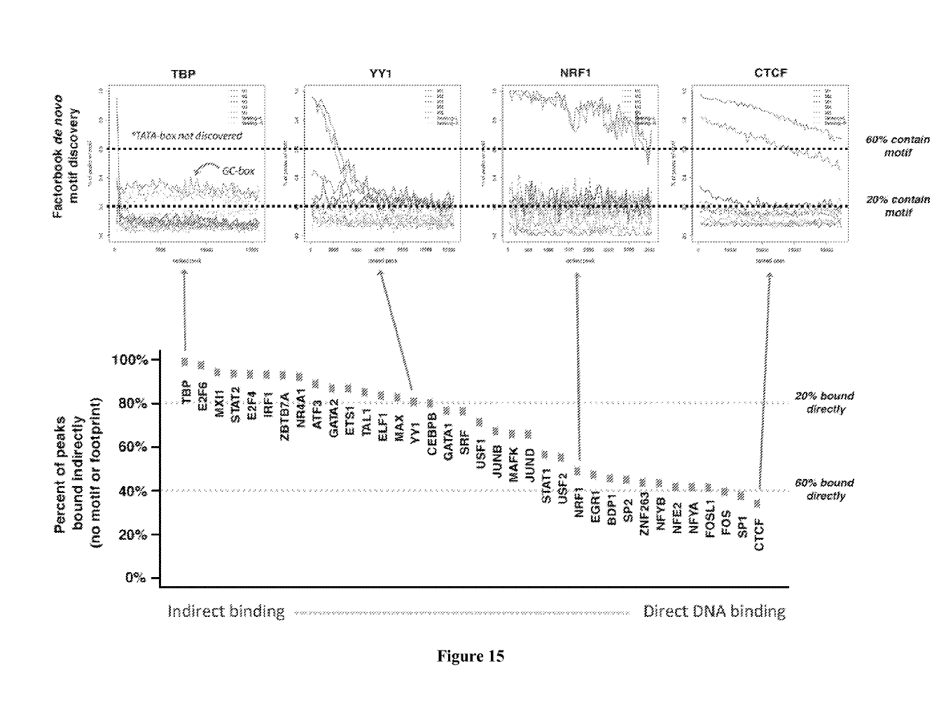

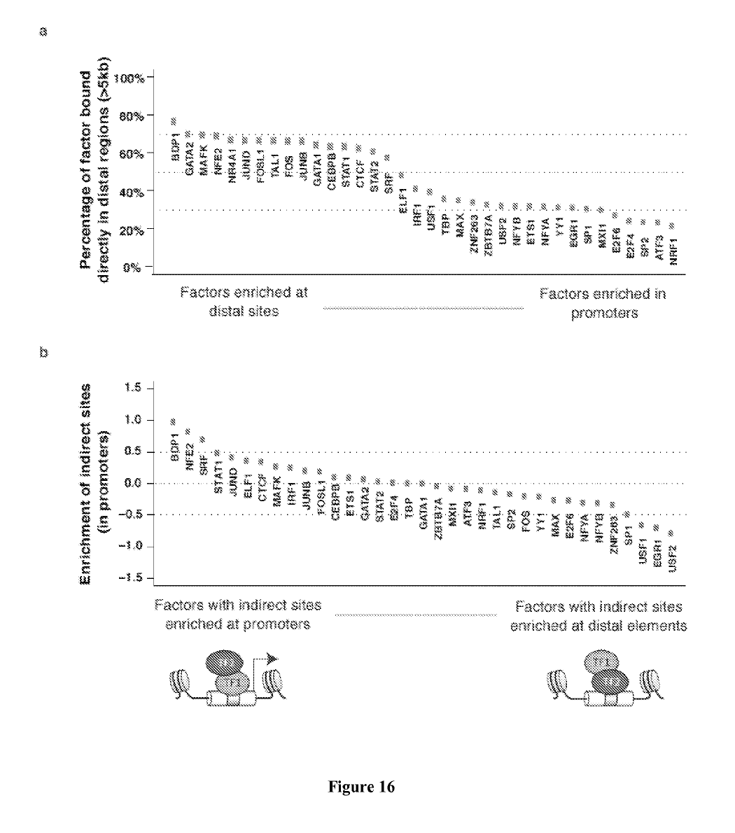

Unbiased de novo motif discovery within the footprints identified in each of the 41 cell types was performed that yielded 683 unique motif models (FIG. 15a and Methods). FIG. 15 illustrates that de novo motif discovery expanded the human regulatory lexicon. FIG. 15a illustrates an overview of de novo motif discovery using DNaseI footprints. These models were compared with the universe of experimentally grounded motif models in the TRANSFAC, JASPAR and UniPROBE databases. Owing to the redundancy of motif models contained within these databases, all duplicate models were first collapsed (Methods). A total of 394 of the 683 (58%) de novo motifs matched distinct experimentally grounded motif models, accounting collectively for 90% of all unique entries across the three databases (FIG. 15b and FIG. 16a-c). FIG. 15b illustrates an annotation of the 683 de novo-derived motif models using previously identified transcription factor motifs. A total of 394 of these de novo-derived motifs matched a motif annotated within the TRANSFAC, JASPAR or UniPROBE databases, whereas 289 are novel motifs (pie chart). FIG. 16 illustrates de novo motif discovery in footprints. FIG. 16a illustrates a diagram of the depletion scheme used to identify novel motifs. 683 motifs were filtered in successive order using TOMTOM with TRANSFAC, JASPAR-CORE and UniPROBE. The numbers on the arrows display the number of de novo motifs matched to the corresponding database. FIG. 16b illustrates a pie chart annotating the partition of de novo motifs into known and novel motifs. FIG. 16c illustrates example consensus logos of de novo derived motifs that match TRANSFAC models. The de novo consensus matching TRANSFAC, JASPAR or UniPROBE sequences was found to cover the majority of each database (bar chart). The wholesale de novo derivation of the vast majority of known regulatory factor recognition sequences from the small genomic compartment defined by DNaseI footprints highlighted the marked concentration of regulatory information encoded within this sequence space.

Notably, 289 of the footprint-derived motifs were absent from major databases (FIG. 15b and FIG. 16d). FIG. 16d illustrates example consensus logos of novel de novo derived motifs using DNaseI footprints. These novel motifs were observed to populate millions of DNaseI footprints (FIG. 15c), and showed features of in vivo occupancy and evolutionary constraint similar to motifs for known regulators, including marked anti-correlation with nucleotide-level vertebrate conservation (FIG. 9b, 15e, and Neph et al., 2012a). FIG. 9b illustrates the per-base DNaseI hypersensitivity (blue) and vertebrate phylogenetic conservation (red) for all DNaseI footprints in dermal fibroblasts matching three well-annotated transcription factor motifs. The white box indicates width of consensus motif. The number of motif occurrences within DNaseI footprints is indicated below each graph. FIG. 15e illustrates phylogenetic conservation (red dashed) and per-base DNaseI hypersensitivity (blue) for all DNaseI footprints in dermal fibroblast cells matching two novel de novo-derived motifs. The white box indicates width of consensus motif Another exemplary case (Neph et al., 2012a) demonstrates anti-correlation of conservation and DNaseI cleavage with structural data. Similar to FIG. 9a, the co-crystal structure of Serum Response Factor (SRF) bound to its DNA ligand was juxtaposed above the average nucleotide-level DNaseI cleavage pattern at motif instances of SRF in DNaseI footprints, and also above a randomly ordered heat map showing the per-nucleotide DNaseI cleavage for each motif instance of SRF in DNaseI footprints. The per-base DNaseI hypersensitivity and vertebrate phylogenetic conservation was compared for all DNaseI footprints in dermal fibroblasts matching three well annotated transcription factor motifs, EBF (11,941 instances within DNaseI footprints), AP2 (12,770 instances), and CTF1 (11,110 instances). Cleavage profiles were shown to mirror the protein structure and were anti-correlated with vertebrate conservation for USF (3920 motif instances within DNaseI footprints) and SRF (3542 instances) (Neph et al., 2012a). In a further example (Neph et al., 2012a), the per-base DNaseI hypersensitivity and vertebrate phylogenetic conservation was compared for all DNaseI footprints in dermal fibroblasts matching two novel de novo-derived motifs UW.Motif 0458 (2,851 instances within DNaseI footprints) and UW.Motif 0423 (5,428 instances).

To test whether novel motifs were functionally conserved in an evolutionarily distant mammal, DNaseI cleavage patterns around human novel motifs mapped within DHSs assayed in primary mouse liver tissue were analyzed (FIG. 15e-f and Neph et al., 2012a). FIG. 15f illustrates per-nucleotide mouse liver DNaseI cleavage patterns at occurrences of the motifs in (e) at DNaseI footprints identified in mouse liver. In another exemplary case (Neph et al., 2012a), the per-base DNaseI hypersensitivity and vertebrate phylogenetic conservation was compared for all DNaseI footprints in dermal fibroblasts matching two novel de novo-derived motifs (UW.Motif 0458 and UW.Motif 0423) as described above. The per-nucleotide mouse liver DNaseI cleavage patterns at occurrences of these motifs at DNaseI footprints identified in mouse liver were shown to be similar to the cleavage patterns in humans (Neph et al., 2012a). This analysis demonstrated that many novel motifs show nearly identical DNaseI footprint patterns in both human cells and mouse liver, indicating that these novel motifs correspond to evolutionarily conserved transcriptional regulators that are functional in both mice and human.

Given the conservation of protein occupancy in a distant mammal, it was assessed whether the novel motifs are under selection in human populations by analyzing nucleotide diversity across all motif instances found within accessible chromatin. Using high-quality genomic sequence data from 53 unrelated individuals (Neph et al., 2012a), the average nucleotide diversity for each individual motif space was calculated (Neph et al., 2012a). The average human nucleotide diversity across all motif instances within DNaseI footprints was plotted for each of the motif models in the TRANSFAC database and for each of the novel de novo-derived motif models (Neph et al., 2012a). Reduced diversity levels are indicative of functional constraint, through the elimination of deleterious alleles from the population by natural selection. Novel motifs were found to be collectively under strong purifying selection in human populations. On average, the new motifs were more constrained than most motifs found in the major databases (FIG. 15d and Neph et al., 2012a), even after exclusion of motifs containing highly mutable CpG dinucleotides, which underlie the marked increase in nucleotide diversity seen with a subset of known motifs (Neph et al., 2012a). Collectively, these results demonstrated that DNaseI footprints encode an expansive cis-regulatory lexicon encompassing both known transcription factor recognition sequences and novel motifs that are functionally conserved in mouse and bear strong signatures of ongoing selection in humans.

Methods.

DNaseI digestion and high-throughput sequencing were performed on intact human nuclei from various cell types as previously described in Example 1 herein.

Data Downloads.

Data used are as previously described in Example 1 herein.

Cell Types Used for DGF.

The following human cell types were subjected to DNaseI digestion and high-throughput sequencing as previously described in Example 1 herein.

Identification of DNaseI Footprints.

The identification of DNaseI footprints was performed as previously described in Example 1 herein.

De Novo Motif Discovery.

Different footprint subsets were created for each cell type for the purpose of de novo motif discovery. A proximal subset was defined as all footprints within 2,000 nucleotides of the canonical transcriptional start site of genes as annotated by NCBI RefSeq, a non-proximal set was defined as all footprints not in the proximal subset, a distal set was defined as all footprints more than 10,000 nucleotides from any transcriptional start site, and cell-type-specific footprints were those footprints found within cell-type-specific DHSs. Cell-type-specific DHSs and constituent footprints were those found in only a single cell type.

An exhaustive motif discovery procedure was developed for inputs consisting of millions of genomic regions. To accomplish the exhaustive search, several simple heuristic filtering and clustering techniques were used, along with a compute cluster. De novo motif discovery was performed separately for every cell type and on every footprint subset. For each subset, the central components of footprints were symmetrically padded by 4 nucleotides and genomic sequence information extracted to create target regions for de novo discovery. The number of target regions within which each subsequence pattern occurred was counted, separately considering every 8-nucleotide permutation over the four-letter DNA nucleotide alphabet, with up to eight intervening IUPAC ‘N’ degenerate symbols. For background estimates, nucleotide labels within every target region were randomly shuffled, thereby maintaining local nucleotide label compositions. The number of regions within which each pattern existed was determined after each of 1,000 shuffling operations to establish sample mean and variance values for expectation. These estimates for patterns further served as conservative estimates for longer patterns in the background case. For example, the estimates for ‘acgttacc’ also served as estimates for the ‘aacgNttacc’ pattern. A Z-score was computed for each observed subsequence pattern by subtracting the mean background frequency estimate from the observed frequency and then dividing by the estimated standard deviation. Patterns with a Z-score of at least 14 were listed in descending Z-score order and then further filtered and clustered to remove redundant motifs. Initially, the highest Z-score pattern was added to an output list, and each subsequent pattern was compared to every entry in the list. If a similar entry was found, the pattern was discarded; otherwise, the pattern was added to the bottom of the output list. Pattern similarities were determined by sequentially comparing characters. When two patterns were the same length and their ‘N’ placeholders aligned, they were considered similar if they had one character difference; otherwise, they were declared similar if they had up to two character differences. The reverse character sequence of every pattern then underwent the same filtering. The re-tuned motif list underwent a similar second stage filter that included all alignment possibilities and reverse complement combinations. Sequence patterns were converted to positional weight matrices (PWMs) by scanning all target sequences and normalizing over the nucleotide alphabet. Only exact matches to a subsequence pattern, ignoring all ‘N’ placeholders, were considered during PWM construction, which underwent further filtering. The PWM corresponding to the highest Z-score pattern was added to an output list and a comparison list. PWMs for subsequent patterns, still in descending Z-score order, were compared to every entry in the comparison list and then added to the bottom of that list. If no similar entry was found, the PWM was also added to the output list. During comparisons, Pearson correlation coefficients were calculated over all alignment possibilities and reverse complement combinations. PWMs were converted into one-dimensional vector representations. Vectors were temporarily padded using samples from the genome-wide background nucleotide frequency distribution and renormalized for various alignments as needed. If a correlation value of at least 0.75 was found, two PWMs were considered similar. PWMs were reverted to their subsequence pattern forms and rescanned target regions, allowing up to one nucleotide mismatch from the pattern's subsequence representation. PWM filtering comparisons were performed as before, and PWM outputs from this stage formed the output.

The de novo discovery results for all footprint subsets and cell types were combined, clustered and filtered further into a final set of 683 motifs. The PWM representations were converted to their subsequence pattern forms and combined in descending Z-score order. The first pattern was added to the output list. Each subsequent pattern was compared to every entry of the output list. If no similar entry was found, the pattern was added to the bottom of the list. Pattern comparisons included all alignment possibilities and reverse complement combinations. For a given alignment, the patterns were compared sequentially, character by character. In the event that all ‘N’ placeholders aligned, two patterns were declared similar if they had up to one character difference; otherwise, they were declared similar with up to two character difference.

For the final stage of clustering, the proportion of instances of one pattern that genomically overlapped instances from another pattern was determined. All pairwise combinations between patterns were considered. Scanning was performed twice for every pattern's instances. The first scan included only those instances that did not deviate from their motif pattern. The second included all instances that had up to one mismatch. Scanning occurred over all padded footprints, merged across all cell types. If the proportion of overlapping instances between two patterns was 0.1 or more in the first case and 0.33 in the second case, in either motif comparison direction, the pattern of lower Z-score was discarded. All cases with any amount of overlap (at least 1 nucleotide) were considered. For example, if two patterns' instances overlapped at one part of the genome by 5 nucleotides, and two more instances overlapped in another part of the genome by 2 nucleotides, both cases were conservatively counted towards the proportion of overlaps (in contrast to the potential requirement of counting overlapping proportions at fixed offsets between instances). All patterns passing through this step made up the set of final motif models.

Motif Matching.

De novo motifs were compared to motifs available as part of various databases, including TRANSFAC, version 2011.1, JASPAR CORE, and UniPROBE using the TOMTOM software, version 4.6.1. TRANSFAC and JASPAR CORE were filtered for motifs annotated to the human genome, and mouse motifs in UniPROBE. Redundant motifs were filtered per database to a single motif using redundant motif-name heuristics (for example, CTCF_{—}01 and CTCF_{—}02 are highly similar in TRANSFAC). TOMTOM parameters were set to their default values during motif comparisons with the exception of the min-overlap setting of 5. When partitioning the de novo motifs, assigning each to a single category, the order of match assignment preference was to TRANSFAC, JASPAR CORE, UniPROBE, and then to the novel motif category. The de novo motifs were also compared directly to motifs recently discovered via sequence conservation alone. Using the same motif matching scheme described above, 100% and 97% of these putative motifs were found within the de novo derived motif collection.

Mouse Scans of Novel Human Motifs.

Novel de novo motifs (those with no motif match to entries of the TRANSFAC, JASPAR CORE and UniPROBE databases) were scanned across DNaseI hotspot regions of the mouse genome (build NCBI37/mm9) using FIMO at P<1×10⁵. Average cleavage profiles were generated and compared to analogous profiles of the human genome.

Nucleotide Diversity in DNaseI Footprints.

To quantify the nature of selection operating on regulatory DNA, nucleotide diversity (π) in footprint calls was surveyed. Population genetics analyses were performed on 53 unrelated, publicly available human genomes (Neph et al., 2012a) released by Complete Genomics, version 1.10. Relatedness was determined both by pedigree and with KING. Two Maasai individuals in the public data set (NA21732 and NA21737) were not reported as related, but were found with KING to be either siblings or parent-child. NA21737 was removed from the analysis.

Fourfold degenerate sites were defined using NCBI-called reading frames and the NimblegenSeqCapEZ Exome version 2.0 definition, downloaded from the NimbleGen website (http://www.nimblegen.com/products/seqcap/ez/v21). Repeats were defined by RepeatMasker, downloaded from the UCSC Genome Browser, version 29Jan2009/open-3-2-7 (http://www.repeatmasker.org). Exome and repeats were removed from all footprints before analysis.

π for a single variant is 2pq, where p=major allele frequency and q=minor allele frequency. π was calculated for each cell type by summing π for all variants and dividing by total number of bases considered. Variant sites were filtered by coverage (>20% of individuals must have calls). Additionally, Complete Genomics makes partial calls at some sites (that is, one allele is A and the other is N). These were counted as fully missing.

### Example 8

### Novel Motif Occupancy Parallels Regulators of Cell Fate

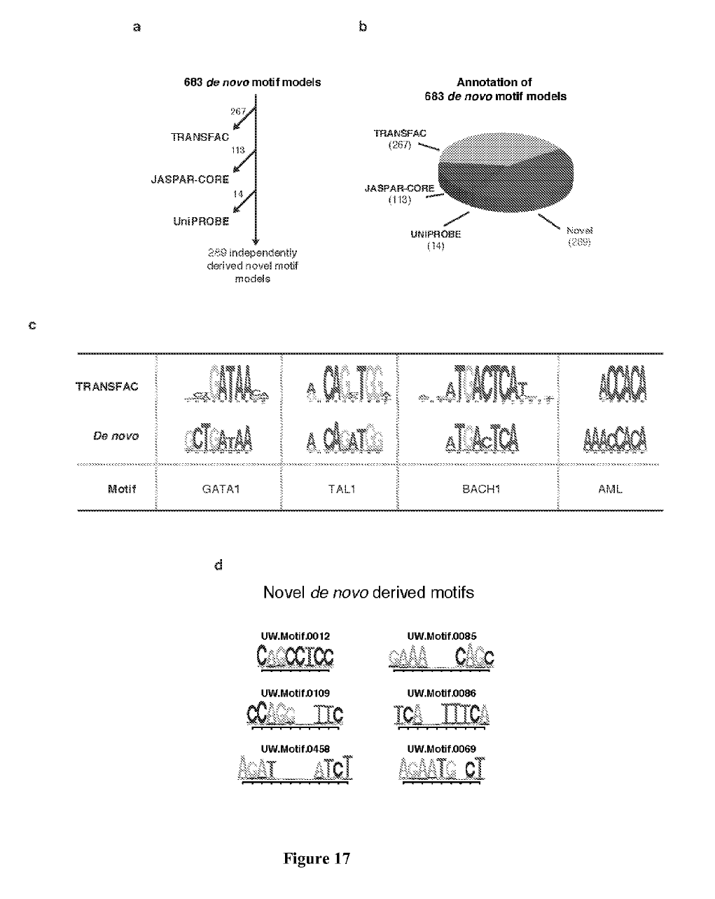

Cell-selective gene regulation is mediated by the differential occupancy of transcriptional regulatory factors at their cognate cis-acting elements. For example, the nerve growth factor gene VGF is selectively expressed only within neuronal cells (FIG. 17a), presumably due to the repressive action of the transcriptional regulator NRSF (also called REST) at the VGF promoter in non-neuronal cell types. FIG. 17 illustrates that multi-lineage DNaseI footprinting revealed cell-selective gene regulators. FIG. 17a illustrates that comparative footprinting of the nerve growth factor gene (VGF) promoter in multiple cell types revealed both conserved (NRF1, USF1 and SP1) and cell-selective (NRSF) DNaseI footprints. Although VGF is expressed only in neuronal cells, its promoter is DNaseI-hypersensitive in most cell types. Examination of nucleotide-level cleavage patterns within the VGF promoter exposed its fundamental cis-regulatory logic, coordinated by the transcriptional regulators NRSF, SP1, USF1 and NRF1. Whereas the NRSF motif was found to be tightly occupied in non-neuronal cells, in neuronal cells, NRSF repression was relieved, and recognition sites for the positive regulators USF1 and SP1 was observed to become highly occupied, resulting in VGF expression. These data collectively illustrated the power of genomic footprinting to resolve differential occupancy of multiple regulatory factors in parallel at nucleotide resolution.

This paradigm was next extended using genome-wide DNaseI footprints across 12 functionally distinct cell types to identify both known and novel factors showing highly cell-specific occupancy patterns. To calculate the footprint occupancy of a motif, for each motif and cell type, the number of motif instances encompassed within DNaseI footprints was enumerated and normalized by the total number of DNaseI footprints in that cell type. FIG. 17b shows a heat map representation of cell-selective occupancy at motifs for 60 known transcriptional regulators and for 29 novel motifs. In FIG. 17b, a heat map of footprint occupancy computed across 12 cell types (columns) for 89 motifs (rows), including well-characterized cell/tissue-selective regulators, and novel de novo-derived motifs (red text), is shown. The motif models for some of these novel de novo-derived motifs are indicated next to the heat map. This approach appropriately identified a number of known cell-selective transcriptional regulators including: (1) the pluripotency factors OCT4 (also called POU5F1), SOX2, KLF4 and NANOG in human embryonic stem cells; (2) the myogenic factors MEF2A and MYF6 in skeletal myocytes; and (3) the erythrogenic regulators GATA1, STAT1 and STAT5A in erythroid cells (FIG. 17b).

Many of the footprint-derived novel motifs displayed markedly cell-selective occupancy patterns highly similar with the aforementioned well-established regulators. This suggests that many novel motifs correspond to recognition sequences for important but uncharacterized regulators of fundamental biological processes. Notably, both known and novel motifs with high cell-selective occupancy predominantly localized to distal regulatory regions (FIG. 17c), further highlighting the role of distal regulation in developmental and cell-selective processes. In FIG. 17c, the proportion of motif instances in DNaseI footprints within distal regulatory regions for known (black) and novel (red) cell-type-specific regulators in (b) is indicated. Also noted are these values for a small set of known promoter-proximal regulators (green).

Methods.

DNaseI digestion and high-throughput sequencing were performed on intact human nuclei from various cell types as previously described in Example 1 herein.

Data Downloads.

Data used are as previously described in Example 1 herein.

Cell Types Used for DGF.

The following human cell types were subjected to DNaseI digestion and high-throughput sequencing as previously described in Example 1 herein.

Identification of DNaseI Footprints.

The identification of DNaseI footprints was performed as previously described in Example 1 herein.

Cell Type Predominance: Motifs within Footprints.

Hotspot regions were scanned for motifs in each cell type using the FIMO software tool with a maximum P-value threshold of 1×10⁵ and defaults for other parameters. Scans included motif templates from TRANSFAC, JASPAR CORE, UniPROBE and novel de novo (those with no match to motifs in the aforementioned databases). Predicted motifs were filtered to those that overlapped footprints by at least 1 nucleotide. For each cell type, the number of discovered motif instances for a motif template was counted and normalized to the total number of bases within footprints. A row-normalized heat map over results in selected cell types was created using the matrix2png program.

Proximal Versus Distal Regulators.

For every motif template, the number of gene-distal and gene-proximal instances overlapping footprints by at least 1 nucleotide was quantified, with proximal defined as within 2,500 nucleotides of the TSSs of genes in the reference sequence (NCBI RefSeq). The number of motifs found within a partition was scaled by the number of bases covered by footprints in that partition. Finally, the partition values were rescaled to proportions that summed to one.

Examples 9-13 refer to Tables 2 and 3, below. Table 2 shows the sizes and statistics of derived regulatory networks. Table 3 summarizes the order of factors in all Circos diagrams and hive plots.

TABLE 2
Sizes and statistics of derived regulatory networks, related to
FIG. 23. Displayed are the number of edges in each of the 41
networks and the summed squared error (SSE) of each
network versus the C. elegans neuronal network.
Size and statistics of derived regulatory networks

| | | SSE from C. elegans |
|---|---|---|
| Cell-Type | Edges | neuronal network |
| AG10803 | 9910 | 0.0739 |
| AoAF | 11804 | 0.0799 |
| CD20 | 13557 | 0.1098 |
| CD34 | 13240 | 0.0618 |
| fBrain | 9293 | 0.0753 |
| fHeart | 11496 | 0.0770 |
| fLung | 14245 | 0.0620 |
| GM06990 | 10523 | 0.1586 |
| GM12865 | 12227 | 0.1078 |
| HAEpiC | 10456 | 0.0286 |
| HAh | 13144 | 0.2088 |
| HCF | 11503 | 0.1526 |
| HCM | 12098 | 0.1107 |
| HCPEpiC | 11085 | 0.0782 |
| HEEpiC | 11583 | 0.0866 |
| HepG2 | 10470 | 0.0719 |
| hESCT0 | 13176 | 0.2132 |
| HFF | 9777 | 0.0579 |
| HIPEpiC | 9941 | 0.0624 |
| HMF | 11183 | 0.0534 |
| HMVEC_dBIAd | 10709 | 0.1074 |
| HMVEC_dBINeo | 13311 | 0.0734 |
| HMVEC_dLyNeo | 12347 | 0.1069 |
| HMVEC_LLy | 12295 | 0.0801 |
| HPAF | 10708 | 0.0695 |
| HPdLF | 10236 | 0.1421 |
| HPF | 11732 | 0.0974 |
| HRCE | 7586 | 0.1319 |
| HSMM | 10969 | 0.2035 |
| hTH1 | 10339 | 0.1484 |
| HVMF | 12230 | 0.0671 |
| IMR90 | 8976 | 0.0686 |
| K562 | 7369 | 0.1273 |
| NB4 | 15358 | 0.1336 |
| NHA | 7293 | 0.0972 |
| NHDF_Ad | 10832 | 0.0455 |
| NHDF_Neo | 12553 | 0.0608 |
| NHLF | 11704 | 0.0757 |
| SAEC | 7690 | 0.0864 |
| SkMC | 13793 | 0.0947 |
| SKNSH | 10176 | 0.0721 |

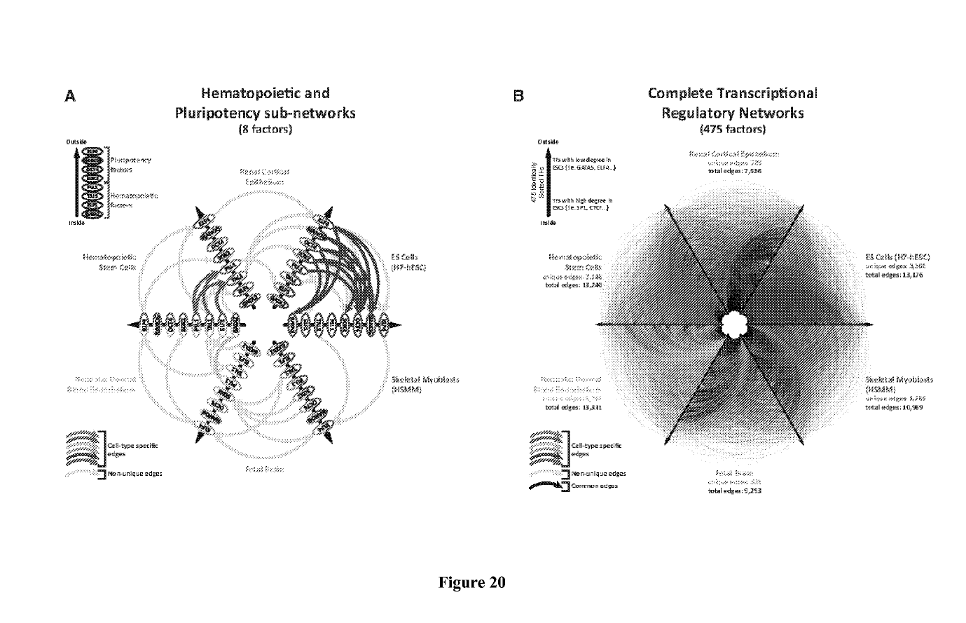

TABLE 3
Order of factors in all Circos diagrams and hive plots, related
to FIGS. 19 and 20. The degree of all 475 factors within the
H7-hESC network is displayed. This ordering was used for the
Circos plots in FIG. 19 and the Hive plot in FIG. 20B.

| Order in | Degree in | |
|---|---|---|
| Hive/Circos | hESC-H7 | |
| plots | network | Factor |
| 1 | 362 | SP1 |
| 2 | 344 | SP3 |
| 3 | 325 | ZBTB7B |
| 4 | 322 | SP4 |
| 5 | 302 | SP2 |
| 6 | 278 | TFAP2A |
| 7 | 274 | EGR2 |
| 8 | 272 | TFAP2C |
| 9 | 266 | EGR1 |
| 10 | 257 | EGR3 |
| 11 | 249 | MAZ |
| 12 | 239 | EGR4 |
| 13 | 231 | CTCF |
| 14 | 227 | TFAP2B |
| 15 | 212 | ZFX |
| 16 | 203 | KLF15 |
| 17 | 198 | ZNF219 |
| 18 | 196 | KLF4 |
| 19 | 193 | PATZ1 |
| 20 | 189 | ZNF148 |
| 21 | 177 | CNOT3 |
| 22 | 175 | HIC1 |
| 23 | 168 | ZNF263 |
| 24 | 167 | TCF3 |
| 25 | 158 | WT1 |
| 26 | 156 | TRIM28 |
| 27 | 154 | NFYA |
| 28 | 152 | GTF2I |
| 29 | 144 | REST |
| 30 | 143 | MZF1 |
| 31 | 139 | TFAP4 |
| 32 | 139 | SREBF1 |
| 33 | 137 | PAX4 |
| 34 | 137 | NR2F1 |
| 35 | 130 | SREBF2 |
| 36 | 129 | STAT3 |
| 37 | 128 | POU5F1 |
| 38 | 127 | HES1 |
| 39 | 126 | NR2F2 |
| 40 | 120 | VDR |
| 41 | 118 | POU2F1 |
| 42 | 118 | BHLHE40 |
| 43 | 116 | MAX |
| 44 | 111 | JUN |
| 45 | 106 | KLF11 |
| 46 | 105 | TAL1 |
| 47 | 103 | ATF1 |
| 48 | 102 | YY1 |
| 49 | 102 | NR6A1 |
| 50 | 102 | CREB1 |
| 51 | 101 | ZFP42 |
| 52 | 101 | RXRA |
| 53 | 101 | NF1 |
| 54 | 99 | SRF |
| 55 | 98 | E2F1 |
| 56 | 98 | ATF4 |
| 57 | 97 | SOX2 |
| 58 | 97 | MYOD1 |
| 59 | 97 | ELK4 |
| 60 | 96 | GLI3 |
| 61 | 95 | TP53 |
| 62 | 95 | FOXD3 |
| 63 | 92 | ZNF143 |
| 64 | 91 | MYF6 |
| 65 | 90 | SPI1 |
| 66 | 90 | JUND |
| 67 | 90 | ETS1 |
| 68 | 90 | DDIT3 |
| 69 | 88 | MYCN |
| 70 | 88 | ARNT |
| 71 | 87 | NFKB1 |
| 72 | 87 | MYOG |
| 73 | 86 | NFE2L2 |
| 74 | 85 | RXRB |
| 75 | 83 | IKZF1 |
| 76 | 82 | FOXO3 |
| 77 | 81 | JUNB |
| 78 | 81 | GATA3 |
| 79 | 81 | FOSL1 |
| 80 | 81 | DEAF1 |
| 81 | 79 | SMAD3 |
| 82 | 79 | GABPA |
| 83 | 79 | ELK1 |
| 84 | 79 | EBF1 |
| 85 | 78 | SPZ1 |
| 86 | 78 | RFX1 |
| 87 | 78 | PAX5 |
| 88 | 78 | NFKB2 |
| 89 | 78 | NEUROD1 |
| 90 | 77 | TGIF1 |
| 91 | 77 | POU3F3 |
| 92 | 77 | NR2F6 |
| 93 | 76 | PURA |
| 94 | 76 | IRF7 |
| 95 | 75 | ZFP161 |
| 96 | 75 | ZBTB7A |
| 97 | 74 | DBP |
| 98 | 74 | ATF5 |
| 99 | 73 | TEF |
| 100 | 73 | STAT1 |
| 101 | 73 | CREM |
| 102 | 72 | SMAD2 |
| 103 | 72 | GFI1 |
| 104 | 71 | USF1 |
| 105 | 71 | PAX6 |
| 106 | 71 | GTF2A1 |
| 107 | 70 | TCF12 |
| 108 | 70 | NFIB |
| 109 | 70 | MAF |
| 110 | 70 | IRF2 |
| 111 | 69 | TFCP2 |
| 112 | 69 | RELA |
| 113 | 69 | PRDM1 |
| 114 | 69 | MECOM |
| 115 | 68 | POU3F2 |
| 116 | 68 | MYB |
| 117 | 68 | HMGA1 |
| 118 | 68 | FOXC1 |
| 119 | 67 | RELB |
| 120 | 67 | OAZ1 |
| 121 | 67 | MAFG |
| 122 | 67 | HIF1A |
| 123 | 67 | GLI1 |
| 124 | 67 | CEBPB |
| 125 | 66 | OTX2 |
| 126 | 65 | SMAD7 |
| 127 | 65 | SIX3 |
| 128 | 65 | NRF1 |
| 129 | 65 | HBP1 |
| 130 | 64 | LHX4 |
| 131 | 64 | FOXA1 |
| 132 | 63 | TOPORS |
| 133 | 63 | NR1I3 |
| 134 | 63 | NR1H2 |
| 135 | 63 | MYC |
| 136 | 63 | GABPB1 |
| 137 | 61 | TBX15 |
| 138 | 61 | SMAD4 |
| 139 | 61 | FOXA2 |
| 140 | 61 | BHLHE41 |
| 141 | 60 | ZNF238 |
| 142 | 60 | TGIF2 |
| 143 | 60 | NHLH1 |
| 144 | 60 | ATF2 |
| 145 | 59 | SPIB |
| 146 | 59 | NANOG |
| 147 | 59 | BACH1 |
| 148 | 58 | TCF4 |
| 149 | 58 | MAFA |
| 150 | 58 | ELF2 |
| 151 | 58 | AHR |
| 152 | 57 | STAT6 |
| 153 | 57 | RREB1 |
| 154 | 57 | REL |
| 155 | 57 | PKNOX2 |
| 156 | 57 | MNX1 |
| 157 | 57 | FOXP1 |
| 158 | 56 | GATA4 |
| 159 | 56 | GATA2 |
| 160 | 56 | ETV4 |
| 161 | 56 | EP300 |
| 162 | 56 | CDX2 |
| 163 | 55 | IRX4 |
| 164 | 55 | ETV7 |
| 165 | 55 | ETS2 |
| 166 | 55 | E2F7 |
| 167 | 55 | ARID3A |
| 168 | 54 | NR3C1 |
| 169 | 54 | IRX2 |
| 170 | 54 | HMBOX1 |
| 171 | 54 | GLIS3 |
| 172 | 53 | ZNF628 |
| 173 | 53 | MAFF |
| 174 | 53 | IRX3 |
| 175 | 53 | IRF9 |
| 176 | 53 | CRX |
| 177 | 52 | PARP1 |
| 178 | 52 | NR2C2 |
| 179 | 52 | FLI1 |
| 180 | 52 | ERF |
| 181 | 52 | EBF2 |
| 182 | 51 | USF2 |
| 183 | 51 | PBX1 |
| 184 | 51 | HOXB13 |
| 185 | 51 | ESRRA |
| 186 | 50 | ZEB1 |
| 187 | 50 | RBPJ |
| 188 | 50 | PKNOX1 |
| 189 | 50 | HMX3 |
| 190 | 50 | FOXJ1 |
| 191 | 50 | FOXH1 |
| 192 | 50 | FOXG1 |
| 193 | 50 | BCL6 |
| 194 | 50 | ATOH1 |
| 195 | 49 | RARA |
| 196 | 49 | POU2F2 |
| 197 | 49 | PAX2 |
| 198 | 49 | LMX1B |
| 199 | 49 | ELF1 |
| 200 | 48 | TCF7 |
| 201 | 48 | T |
| 202 | 48 | NFATC4 |
| 203 | 48 | IRF1 |
| 204 | 48 | HSF1 |
| 205 | 47 | SOX9 |
| 206 | 47 | SOX4 |
| 207 | 47 | PAX7 |
| 208 | 47 | NKX2-2 |
| 209 | 47 | MITF |
| 210 | 47 | MEIS3 |
| 211 | 47 | HAND1 |
| 212 | 47 | GATA6 |
| 213 | 47 | ARID5B |
| 214 | 46 | ZNF589 |
| 215 | 46 | PPARA |
| 216 | 46 | POU2F3 |
| 217 | 46 | NKX2-1 |
| 218 | 46 | LMO2 |
| 219 | 46 | LEF1 |
| 220 | 45 | ZIC3 |
| 221 | 45 | RFX5 |
| 222 | 45 | POU3F1 |
| 223 | 45 | NFE2L1 |
| 224 | 44 | ZIC2 |
| 225 | 44 | RUNX3 |
| 226 | 44 | HOXB3 |
| 227 | 44 | HNF1B |
| 228 | 44 | E2F6 |
| 229 | 43 | SOX21 |
| 230 | 43 | SIX2 |
| 231 | 43 | NFIX |
| 232 | 43 | MTF1 |
| 233 | 43 | IRF3 |
| 234 | 43 | HNF4A |
| 235 | 43 | HMGA2 |
| 236 | 43 | FOXJ3 |
| 237 | 43 | DLX5 |
| 238 | 43 | DLX1 |
| 239 | 42 | ING4 |
| 240 | 42 | HOXC13 |
| 241 | 42 | FOXO4 |
| 242 | 42 | FOXM1 |
| 243 | 42 | ELF3 |
| 244 | 41 | SMAD1 |
| 245 | 41 | NR1I2 |
| 246 | 41 | LMX1A |
| 247 | 41 | CEBPA |
| 248 | 40 | SIX4 |
| 249 | 40 | PPARD |
| 250 | 40 | NKX3-2 |
| 251 | 40 | ISL1 |
| 252 | 40 | HOXA7 |
| 253 | 39 | NFE2 |
| 254 | 39 | NFATC3 |
| 255 | 39 | MSX2 |
| 256 | 39 | MEIS1 |
| 257 | 39 | MAFB |
| 258 | 39 | EOMES |
| 259 | 38 | TBP |
| 260 | 38 | PITX3 |
| 261 | 38 | NKX6-1 |
| 262 | 38 | GATA1 |
| 263 | 38 | FOXA3 |
| 264 | 38 | BRF1 |
| 265 | 38 | ATF7 |
| 266 | 37 | MEF2A |
| 267 | 37 | IRX5 |
| 268 | 37 | IRF6 |
| 269 | 36 | HSF2 |
| 270 | 36 | HOXD1 |
| 271 | 36 | FOXO1 |
| 272 | 36 | EN2 |
| 273 | 36 | CHURC1 |
| 274 | 36 | BACH2 |
| 275 | 36 | ATF3 |
| 276 | 36 | ALX4 |
| 277 | 35 | ZIC1 |
| 278 | 35 | PRRX1 |
| 279 | 35 | ONECUT1 |
| 280 | 35 | MYF5 |
| 281 | 35 | MECP2 |
| 282 | 35 | HOXD13 |
| 283 | 35 | GBX2 |
| 284 | 35 | FOXD1 |
| 285 | 35 | FGF9 |
| 286 | 35 | DMRT3 |
| 287 | 34 | ZBTB33 |
| 288 | 34 | SOX17 |
| 289 | 34 | MSX1 |
| 290 | 34 | IRF8 |
| 291 | 34 | EPAS1 |
| 292 | 34 | DLX2 |
| 293 | 33 | SIX6 |
| 294 | 33 | PITX2 |
| 295 | 33 | PITX1 |
| 296 | 33 | HAND2 |
| 297 | 32 | VAX1 |
| 298 | 32 | TFDP1 |
| 299 | 32 | NR4A1 |
| 300 | 32 | HINFP |
| 301 | 32 | FOXN2 |
| 302 | 32 | E4F1 |
| 303 | 32 | DLX4 |
| 304 | 32 | BARHL1 |
| 305 | 31 | TLX2 |
| 306 | 31 | TBX5 |
| 307 | 31 | MEIS2 |
| 308 | 31 | IKZF2 |
| 309 | 31 | HOXA4 |
| 310 | 31 | ERG |
| 311 | 31 | DMRT1 |
| 312 | 30 | PDX1 |
| 313 | 30 | LHX2 |
| 314 | 30 | HOXD12 |
| 315 | 30 | HOXA9 |
| 316 | 30 | HOXA13 |
| 317 | 29 | STAT4 |
| 318 | 29 | RUNX1 |
| 319 | 29 | RORB |
| 320 | 29 | RFX2 |
| 321 | 29 | IRF4 |
| 322 | 29 | HOXA6 |
| 323 | 29 | HOXA1 |
| 324 | 29 | ATF6 |
| 325 | 29 | ARX |
| 326 | 29 | ALX1 |
| 327 | 28 | ZNF350 |
| 328 | 28 | TBX18 |
| 329 | 28 | STAT5A |
| 330 | 28 | SIRT6 |
| 331 | 28 | GZF1 |
| 332 | 28 | FOXJ2 |
| 333 | 28 | FOXF2 |
| 334 | 28 | FOXF1 |
| 335 | 28 | CDC5L |
| 336 | 27 | PAX3 |
| 337 | 27 | CEBPD |
| 338 | 26 | RAX |
| 339 | 26 | PPARG |
| 340 | 26 | LHX8 |
| 341 | 26 | HOXC10 |
| 342 | 26 | DLX3 |
| 343 | 25 | XBP1 |
| 344 | 25 | UBP1 |
| 345 | 25 | NKX2-5 |
| 346 | 25 | HOXA5 |
| 347 | 25 | GTF2IRD1 |
| 348 | 25 | FOXI1 |
| 349 | 25 | E2F4 |
| 350 | 24 | VAX2 |
| 351 | 24 | STAT2 |
| 352 | 24 | SIX1 |
| 353 | 24 | POU2AF1 |
| 354 | 24 | OVOL2 |
| 355 | 24 | OTX1 |
| 356 | 24 | HOXC5 |
| 357 | 24 | ESRRB |
| 358 | 24 | CUX1 |
| 359 | 24 | BRCA1 |
| 360 | 24 | BARHL2 |
| 361 | 24 | AR |
| 362 | 23 | ZBTB6 |
| 363 | 23 | TBX22 |
| 364 | 23 | PAX8 |
| 365 | 23 | KLF12 |
| 366 | 23 | FOXP3 |
| 367 | 22 | THRB |
| 368 | 22 | TERF1 |
| 369 | 22 | NR5A2 |
| 370 | 22 | ESR1 |
| 371 | 22 | CBFB |
| 372 | 21 | TP73 |
| 373 | 21 | THRA |
| 374 | 21 | RB1 |
| 375 | 21 | NR4A2 |
| 376 | 21 | HOXA11 |
| 377 | 21 | HOMEZ |
| 378 | 20 | TP63 |
| 379 | 20 | TFDP2 |
| 380 | 20 | SOX5 |
| 381 | 20 | POU4F3 |
| 382 | 20 | OTP |
| 383 | 20 | NFATC1 |
| 384 | 20 | HOXB5 |
| 385 | 20 | GLI2 |
| 386 | 20 | FOXL1 |
| 387 | 20 | BPTF |
| 388 | 19 | ZNF333 |
| 389 | 19 | STAT5B |
| 390 | 19 | NR1H4 |
| 391 | 19 | EMX2 |
| 392 | 19 | E2F5 |
| 393 | 19 | ALX3 |
| 394 | 18 | PGR |
| 395 | 18 | MYBL2 |
| 396 | 18 | MEF2C |
| 397 | 17 | SOX10 |
| 398 | 17 | BDP1 |
| 399 | 17 | ARNT2 |
| 400 | 16 | PAX1 |
| 401 | 16 | NR0B1 |
| 402 | 16 | NFATC2 |
| 403 | 16 | HOXC11 |
| 404 | 16 | HNF4G |
| 405 | 15 | ZBTB16 |
| 406 | 15 | TFCP2L1 |
| 407 | 15 | SHOX2 |
| 408 | 15 | NKX3-1 |
| 409 | 15 | ESR2 |
| 410 | 15 | CEBPG |
| 411 | 14 | RUNX2 |
| 412 | 14 | NFIL3 |
| 413 | 14 | HOXB9 |
| 414 | 14 | HOXB4 |
| 415 | 14 | HNF1A |
| 416 | 13 | NR2E3 |
| 417 | 13 | HOXB8 |
| 418 | 12 | HOXA10 |
| 419 | 12 | HIVEP2 |
| 420 | 12 | EVX1 |
| 421 | 11 | VSX1 |
| 422 | 11 | SRY |
| 423 | 11 | MTERF |
| 424 | 11 | GFI1B |
| 425 | 10 | EN1 |
| 426 | 10 | ELF5 |
| 427 | 10 | DMRT2 |
| 428 | 10 | CEBPE |
| 429 | 9 | HLF |
| 430 | 9 | CIZ1 |
| 431 | 8 | HOXC12 |
| 432 | 8 | HOXB7 |
| 433 | 8 | HOXB6 |
| 434 | 8 | GSX2 |
| 435 | 8 | ESX1 |
| 436 | 8 | CDX1 |
| 437 | 8 | BARX2 |
| 438 | 7 | NR5A1 |
| 439 | 7 | LHX5 |
| 440 | 7 | HOXC8 |
| 441 | 7 | HOXA3 |
| 442 | 6 | RORA |
| 443 | 6 | LHX6 |
| 444 | 6 | HOXD9 |
| 445 | 6 | HOXD3 |
| 446 | 6 | GLIS1 |
| 447 | 6 | EHF |
| 448 | 6 | BARX1 |
| 449 | 5 | VSX2 |
| 450 | 5 | HOXC9 |
| 451 | 5 | GCM1 |
| 452 | 5 | AIRE |
| 453 | 4 | POU3F4 |
| 454 | 4 | MEOX1 |
| 455 | 4 | ELF4 |
| 456 | 3 | ZNF217 |
| 457 | 3 | SATB1 |
| 458 | 3 | POU1F1 |
| 459 | 3 | NKX6-2 |
| 460 | 3 | HOXC4 |
| 461 | 3 | HMX1 |
| 462 | 2 | PRRX2 |
| 463 | 2 | POU6F1 |
| 464 | 2 | LTF |
| 465 | 2 | DMBX1 |
| 466 | 2 | ARNTL2 |
| 467 | 1 | LHX3 |
| 468 | 1 | ISX |
| 469 | 1 | HOXA2 |
| 470 | 1 | FOXN1 |
| 471 | 0 | GATA5 |
| 472 | 0 | ITGB2 |
| 473 | 0 | PROP1 |
| 474 | 0 | TFEC |
| 475 | 0 | ZNF354C |

### Example 9

### Comprehensive Mapping of TF Networks in Diverse Human Cell Types; De Novo-Derived Networks Accurately Recapitulate Known TF-to-TF Circuitry

To generate TF regulatory networks in human cells, nucleic acid (e.g., genomic DNA)seI footprinting data from 41 diverse cell and tissue types was analyzed. Each of these 41 samples was treated with DNaseI, and sites of DNaseI cleavage along the genome were analyzed with high-throughput sequencing. At an average sampling depth of 500 million DNaseI cleavages per cell type (of which 273 million mapped to unique genomic positions), an average of 1.1 million high-confidence DNaseI footprints per cell type was identified (range 434,000 to 2.3 million at a false discovery rate of 1% (FDR 1%]). Collectively, 45,096,726 footprints were detected, representing cell-selective binding to 8.4 million distinct 6-40 bp genomic sequence elements. Well-annotated databases of TF-binding motifs were used to infer the identities of factors occupying DNaseI footprints (Methods) and it was confirmed that these identifications matched closely and quantitatively with ENCODE ChIP-seq data for the same cognate factors.

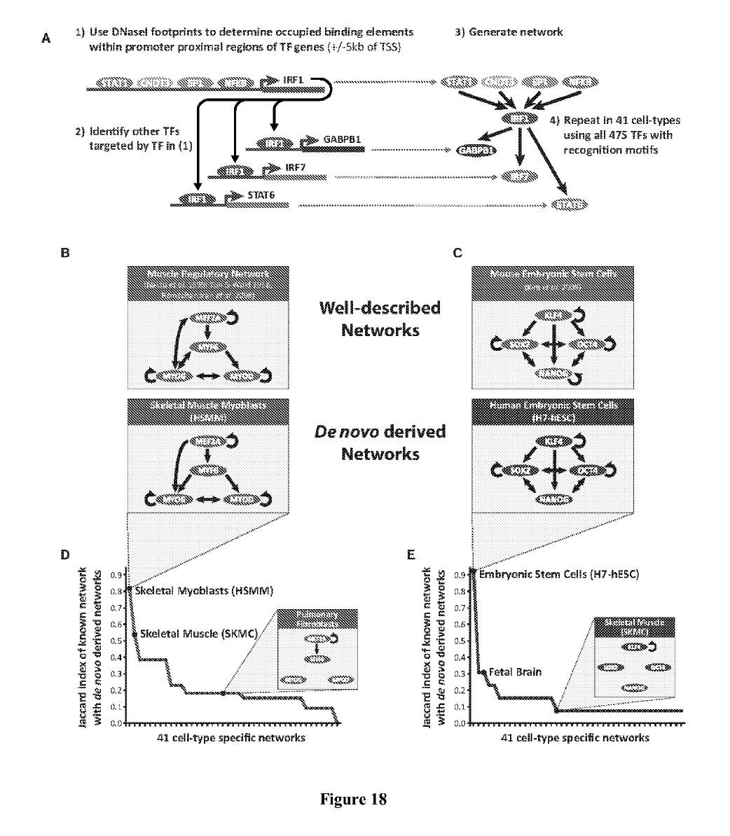

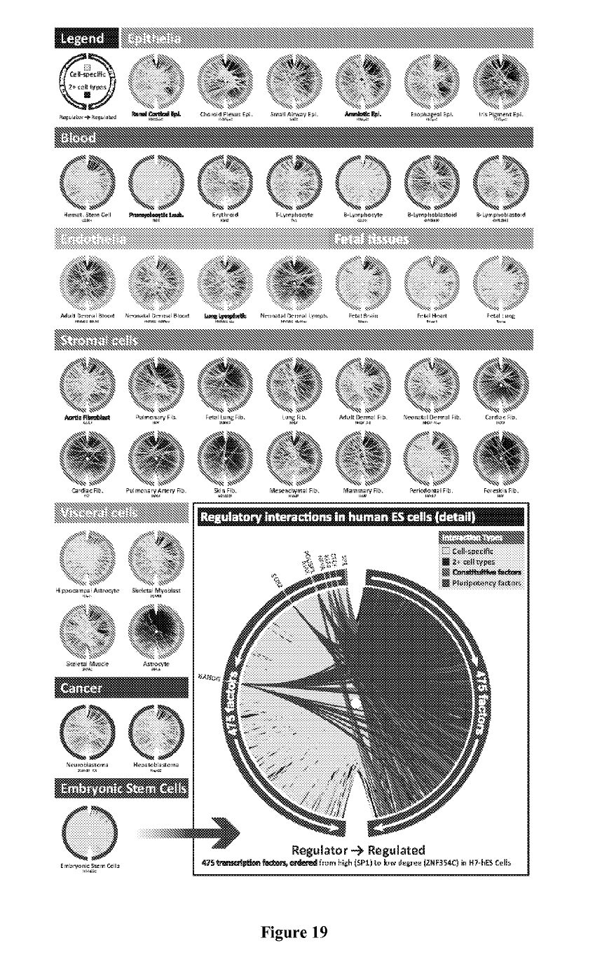

To generate a TF regulatory network for each cell type, actively bound DNA elements within the proximal regulatory regions were analyzed (i.e., all DNaseI hypersensitive sites within a 10 kb interval centered on the transcriptional start site (TSS]) of 475 TF genes with well-annotated recognition motifs (FIG. 18A). FIG. 18 illustrates construction of comprehensive transcriptional regulatory networks. FIG. 18A illustrates a schematic for construction of regulatory networks using DNaseI footprints. Transcription factor (TF) genes represent network nodes. Each TF node has regulatory inputs (TF footprints within its proximal regulatory regions) and regulatory outputs (footprints of that TF in the regulatory regions of other TF genes). Inputs and outputs comprise the regulatory network interactions “edges.” For example: (1) In Th1 cells, the IRF1 promoter was found to contain DNaseI footprints matching four regulatory factors (STAT1, CNOT3, SP1, and NFKB). (2) In Th1 cells, IRF1 footprints were found upstream of many other genes (for example, GABP1, IRF7, STATE). (3) The same process was iterated for every TF gene in that cell type, enabling compilation of a cell-type network comprising nodes (TF genes) and edges (regulatory inputs and outputs of TF genes). (4) Network construction was carried out independently using DNaseI footprinting data from each of 41 cell types, resulting in 41 independently derived cell-type networks. Repeating this process for every cell type disclosed a total of 38,393 unique, directed (i.e., TF-to-TF) regulatory interactions (edges) among the 475 analyzed TFs, with an average of 11,193 TF-to-TF edges per cell type (Data S1, not shown, see (Neph et al., “Circuitry and dynamics of human transcription factor regulatory networks.” Cell. 150 (6): 1274-86. herein “Neph et al., 2012b”)). Given the functional redundancy of a minority of DNA-binding motifs, in certain cases multiple factors could be designated as occupying a single DNase1 footprint. However, most commonly, mappings represented associations between single TFs and a specific DNA element. Because DNase1 hypersensitivity at proximal regulatory sequences closely parallels gene expression, the annotation process utilized naturally focused on the expressed TF complement of each cell type, enabling the construction of a comprehensive transcription regulatory network for a given cell type with a single experiment.

To assess the accuracy of cellular TF regulatory networks derived from DNaseI footprints, several well-annotated mammalian cell-type-specific transcriptional regulatory subnetworks were analyzed (FIG. 18B-C). FIG. 18B-C illustrate a comparison of well-annotated versus de novo-derived regulatory subnetworks. FIG. 18B illustrates a muscle subnetwork. FIG. 18B, top, shows experimentally defined regulatory subnetwork for major factors controlling skeletal muscle differentiation and transcription. Arrows indicate direction(s) of regulatory interactions between factors. FIG. 18B, bottom, shows that regulatory subnetwork derived de novo from the DNaseI footprint-anchored network of skeletal myoblasts closely matched the experimentally annotated network. FIG. 18C illustrates a pluripotency subnetwork. FIG. 18C, top, shows a regulatory subnetwork for major pluripotency factors defined experimentally in mouse ESCs. FIG. 18C, bottom, shows that a regulatory subnetwork derived de novo from human ESCs was observed to be virtually identical to the annotated network. The muscle-specific factors MyoD, Myogenin (MYOG), MEF2A, and MYF6 form a network that was uncovered using a combination of genetic and physical studies, including DNaseI footprinting, and is vital for specification of skeletal muscle fate and control of myogenic development and differentiation. FIG. 18B juxtaposes the known regulatory interactions between these factors determined in the aforementioned studies (FIG. 18B, top) with the nearly identical interactions derived de novo from analysis of the network computed using DNaseI footprints mapped in primary human skeletal myoblasts (HSMM) (FIG. 18B, bottom).

OCT4, NANOG, KLF4, and SOX2 together play a defining role in maintaining the pluripotency of embryonic stem cells (ESCs), and a network comprising the mutual regulatory interactions between these factors has been mapped through systematic studies of factor occupancy by ChIP-seq in mouse ESCs. A nearly identical subnetwork emerged from analysis of the TF network computed de novo from DNaseI footprints in human ESCs (FIG. 18C, bottom). Critically, both the well-annotated muscle and ES sub-networks are best matched by footprint-derived networks computed specifically from skeletal myoblasts and human ESCs, respectively, versus other cell types (FIG. 18D-E). FIG. 18D-E illustrate that de novo-derived subnetworks in (B) and (C) matched the annotated networks in a cell-specific fashion. The vertical axes illustrate the Jaccard index, a measure of network similarity, comparing the annotated subnetwork with regulatory interactions between the four factors derived de novo from each of 41 cell types independently (horizontal axes). For the annotated muscle subnetwork, the highest similarity was seen in skeletal myoblasts, followed by differentiated skeletal muscle. By contrast, subnetworks computed from fibroblasts are largely devoid of relevant interactions. For the annotated pluripotency subnetwork, the highest similarity was seen in human ESCs (H7-ESC). These findings indicated that network relationships between TFs derived de novo from nucleic acid (e.g., genomic DNA)seI footprinting accurately recapitulate well-described cell-type-selective transcriptional regulatory networks generated with multiple experimental approaches.

Methods.

Regulatory Network Construction.

Motif-binding protein information found in TRANSFAC was mapped to 538 coding genes, using GeneCards and UniProt Knowledgebase. Due to database annotations, some of these 538 coding genes were indistinguishable, as multiple genes were annotated as binders to the same set of motif templates by TRANSFAC. In such cases, a single gene was chosen, randomly, as a representative and the others removed. This reduced the number of genes from 538 to 475. Networks built by removing the first redundant motif, alphabetically, or by including all redundant motifs showed very similar properties to the one described here (Neph et al., 2012b). In an exemplary case (Neph et al., 2012b), this similarity was observed in a plot illustrating the relative enrichment or depletion of the 13 possible three-node architectural network motifs within the regulatory networks of each cell type constructed using all 538 TRANSFAC motifs, including redundant motifs. Additionally, this final set included motif models for SOX2, OCT4, and KLF4 from the JASPAR Core database.

The TSSs of these 475 genes were symmetrically padded by 5 kb and scanned for predicted TRANSFAC motif-binding sites using FIMO, version 4.6.1, with a maximum p value threshold of 1×10⁻⁵ and defaults for other parameters. For each cell type, putative motif binding sites were filtered to those that overlapped footprints by at least 3 nt using BEDOPS. Each network contained 475 nodes, one per gene. A directed edge was drawn from a gene node to another when a motif instance, potentially bound by the first gene's protein product, was found within a DNaseI footprint contained within 5 kb of the second gene's TSS, indicating regulatory potential. Table 2 shows the number of edges in every cell-type-specific network.

An approximately 150 nt region of duplicated sequence in the proximal regulatory region of the NANOG gene, with high sequence similarity to a single region proximal to a nearby NANOG pseudogene, prevented many DNaseI-seq reads from mapping per the usual procedure. To identify DNaseI footprints within this central promoter site, all non-uniquely-mappable reads falling within ±5 kb of the TSS of the NANOG gene in each cell type were mapped. Standard footprint detection was then performed on this region, except that footprints with >20% of its length covering non-uniquely-mappable locations were not filtered, as described below. TF-binding elements within these DNaseI footprints were included in the final networks.

Identification of DNaseI Footprints.

The identification of DNaseI footprints was performed as previously described in Example 1 herein, except that footprints with >20% of its length covering non-uniquely-mappable locations were not filtered.

### Example 10

### TF Regulatory Networks Show Marked Cell Selectivity

The dynamics of TF regulatory networks across cell types were systematically analyzed. Four hundred and seventy-five TFs theoretically have the potential for 225,625 combinations of TF-to-TF regulatory interactions (or network edges). However, only a fraction of these potential edges were observed in each cell type (5%), and most were unique to specific cell types (Neph et al., 2012b). For instance, a histogram showing the number of cell types that each transcriptional regulatory interaction (edge) was observed in demonstrated that the majority of interactions were observed in a single cell type (Neph et al., 2012b).

To visualize the global landscape of cell-selective versus shared regulatory interactions, the broad landscape of network edges that are either specific to a given cell type or found in networks of two or more cell types was first computed (FIG. 19; Table 3). FIG. 19 illustrates cell-specific versus shared regulatory interactions in TF networks of 41 diverse cell types. Shown for each of 41 cell types are schematics of cell-type-specific (yellow) versus-nonspecific (black) regulatory interactions between 475 TFs. Each half of each circular plot is divided into 475 points (not visible at this scale), one for each TF. Lines connecting the left and right half-circles represent regulatory interactions between each factor and any other factors with which it interacts in the given cell type. Yellow lines represent TF-to-TF connections that are specific to the indicated cell type. Black lines represent TF-to-TF connections that are seen in two or more cell types. The order of TFs along each half-circular axis is shown in Table 3 and represents a sorted list (descending order) of their degree (i.e., number of connections to other TFs) in the ESC network, from highest degree on top (SP1) to lowest degree on bottom (ZNF354C). Cell types are grouped based on their developmental and functional properties. Insert on bottom right shows a detailed view of the human ESC network and highlights the interactions of four pluripotent (KLF4, NANOG, POU5F1, SOX2) and four constitutive factors (SP1, CTCF, NFYA, MAX) with purple and green edges, respectively. This revealed that regulatory interactions were in general highly cell selective, though the proportion of cell-selective interactions varied from cell type to cell type. Network edges were most frequently restricted to a single cell type, and collectively the majority of edges were restricted to four or fewer cell types (Neph et al., 2012b). By contrast, only 5% of edges were common to all cell types (Neph et al., 2012b). Interestingly, when comparing networks, more common edges than common DNaseI footprints were found (Neph et al., 2012b), implying that a given transcriptional regulatory interaction can be generated using distinct DNA-binding elements in different cell types. In an exemplary case (Neph et al., 2012b), the overlap of transcriptional regulatory interactions (edges) identified in ESCs (H7-hESC), skeletal muscle myoblasts (HSMM), and renal cortical epithelium (HRCEpiC) contained 4,448 edges in common. In comparison, there were 3,341 common DNaseI footprints between the ESCs (H7-hESC), HSMM, HRCEpiC networks (Neph et al., 2012b).

To explore the regulatory interaction dynamics of limited sets of related factors, the regulatory network edges connecting four hematopoietic regulators and four pluripotency regulators in six diverse cell types were plotted (FIG. 20A). FIG. 20 illustrates that transcriptional regulatory networks show marked cell-type specificity (see also Table 4 and Neph et al., 2012b). FIG. 20A illustrates cross-regulatory interactions between four pluripotency factors and four hematopoietic factors in regulatory networks of six diverse cell types. All eight factors are arranged in the same order along each axis. Regulatory interactions (i.e., from regulator to regulated) are shown by arrows in clockwise orientation. Cell-type-specific edges are colored as indicated, whereas regulatory interactions present in two or more cell-type networks are shown in gray. This analysis clearly highlighted the role of cell-type-specific factors within their cognate cell types: regulatory interactions between pluripotency factors within the ESC network and hematopoietic factors within the network of hematopoietic stem cells (FIG. 20A). Next, the complete set of regulatory interactions among all 475 edges between the same six diverse cell types were plotted, exposing a high degree of regulatory diversity (FIG. 20B; Table 3). FIG. 20B illustrates cross-regulatory interactions between all 475 TFs in regulatory networks of six diverse cell types. The 475 TFs are arranged in the same order along each axis, regulatory interactions directed clockwise. Edges unique to a given cell-type network are colored as indicated in the legend, whereas regulatory interactions present in two or more networks are colored gray. Interactions present in all six cell-type networks are colored black.

TABLE 4
Edges unique to a cell type typically form a well-connected
subnetwork, related to FIG. 20. Shown are p values for the
significance of elevation of mean connected component size
for subnetworks containing cell-type-specific edges.
The significance of elevation of the mean connected component
size for networks of cell-type specific edges

| Cell-type specific network | Empirical p-value |
|---|---|
| HAEpiC-DS12663 | 1.00E−05 |
| HCPEpiC-DS12447 | 1.00E−05 |
| HIPEpiC-DS12684 | 1.00E−05 |
| HMF-DS13368 | 1.00E−05 |
| HMVEC_dLyNeo-DS13150 | 1.00E−05 |
| HMVEC_LLy-DS13185 | 1.00E−05 |
| HPAF-DS13411 | 1.00E−05 |
| HPF-DS13390 | 1.00E−05 |
| HVMF-DS13981 | 1.00E−05 |
| IMR90-DS13219 | 1.00E−05 |
| NHDF_Neo-DS11923 | 1.00E−05 |
| NHLF-DS12829 | 1.00E−05 |
| SAEC-DS10518 | 1.00E−05 |
| AG10803-DS12374 | 2.00E−05 |
| HCM-DS12599 | 2.00E−05 |
| HCF-DS12501 | 7.00E−05 |
| HMVEC_dBIAd-DS13337 | 0.00012 |
| NHDF_Ad-DS12863 | 0.00016 |
| HEEpiC-DS12763 | 0.00061 |
| hTH1-DS7840 | 0.00061 |
| NHA-DS12800 | 0.00066 |
| AoAF-DS13513 | 0.00085 |
| HPdLF-DS13573 | 0.0009 |
| fBrain-DS11872 | 0.00105 |
| SkMC-DS11949 | 0.00109 |
| K562-DS9767 | 0.00167 |
| HMVEC_dBINeo-DS13242 | 0.00261 |
| SKNSH-DS8482 | 0.00464 |
| GM12865-DS12436 | 0.00601 |
| HRCE-DS10666 | 0.00692 |
| fLung-DS14724 | 0.01237 |
| HSMM-DS14426 | 0.01309 |
| HepG2-DS7764 | 0.02445 |
| GM06990-DS7748 | 0.03131 |
| HFF-DS15115 | 0.04139 |
| HAh-DS15192 | 0.15864 |
| CD34-DS12274 | 0.41705 |
| fHeart-DS12531 | 0.59285 |
| NB4-DS12543 | 0.67234 |
| CD20-DS18208 | 0.72185 |
| hESCT0-DS11909 | 0.72232 |

Edges unique to a cell type typically form a well-connected subnetwork (Table 4; Neph et al., 2012b), implying that cell-type-specific regulatory differences are not driven merely by the independent actions of a few TFs but rather by organized TF subnetworks. In an exemplary case (Neph et al., 2012b), cytoscape networks showing all edges that unique to the skeletal myoblast (HSMM), renal cortical epithelium (HRCEpiC), and ES cell (H7-hESC) networks were found to be well-connected. In addition, the density of cell-selective net-works varies widely between cell types (e.g., compare ESCs to skeletal myoblasts in FIG. 20B). These observations underscore the importance of using cell-type-specific regulatory networks when addressing specific biological questions.

Methods.

Regulatory Network Construction.

Regulatory network construction was performed as previously described in Example 9 herein.

Identification of DNaseI Footprints.

The identification of DNaseI footprints was performed as previously described in Example 9 herein.

Network Visualization.

Interactions that were unique to a single cell type, or “cell specific,” were identified and those found in two or more of the 41 tested cell types were marked as “common.” Interactions were rendered with Circos, version 0.55. Within Circos nomenclature, two pseudo-chromosomes (ideograms) represent identically sorted lists of “regulator” and “regulated” factors, with a directed edge between ideograms indicating that the first factor regulates the second. Ideograms were colored by association of the cell type with tissue category. Unique and common interactions between ideograms were labeled with yellow and black colors, respectively, to visually differentiate cell types by the number and distribution of edges. TFs were oriented along both ideograms by the sort order provided by the H7-hESC cell type, from highest degree (SP1) to lowest (ZNF354C) (Table 3). For the detail view of H7-hESC, the interactions of four pluripotent (KLF4, NANOG, POU5F1, SOX2) and four constitutive factors (SP1, CTCF, NFYA, MAX) were also highlighted with purple and green edges, respectively.

Hive Plots.

A hive plot was also generated using the R library HiveR, version 0.2.1, to visualize directed interactions for four hematopoietic (PU.1, TAL1, ELF1, GATA2) and four pluripotent factors (KLF4, NANOG, OCT4, SOX2) among six cell types (H7-hESC, HRCEpiC, CD34+, HMVEC_dBlNeo, fBrain, and HSMM). The hive plot was divided into six sections, one for each cell type. Reading the figure in clockwise fashion, a directed edge drawn from one axis to the next indicates the first gene regulating the second. Genes were oriented identically along each axis. Common interactions were defined by an interaction existing in two or more cell types. A second qualitative hive plot was created between the same six cell types and over all 475 TFs (Table 3).

Unique Edge Connectedness.

The mean weakly connected component size was calculated using edges unique to a cell type (Table 4 and Neph et al., 2012b). To identify whether these unique component subnetworks were more connected than would be expected by chance, the same number of real edges in the same cell type were randomly sub-sampled and the mean-component size recalculated. This process was iterated 100,000 times, and the number of times for a cell type that the mean-component size in random graphs equaled or exceeded that of the unique component graph counterpart was tallied. An empirical p value was calculated as the tally plus one divided by 100,000. Subnetworks made up of unique edges belonging to each of HSMM, HRCEpiC, and H7-hESC were separately plotted using Cytoscape (Neph et al., 2012b).

### Example 11

### Functionally Related Cell Types Share Similar Core Transcriptional Regulatory Networks

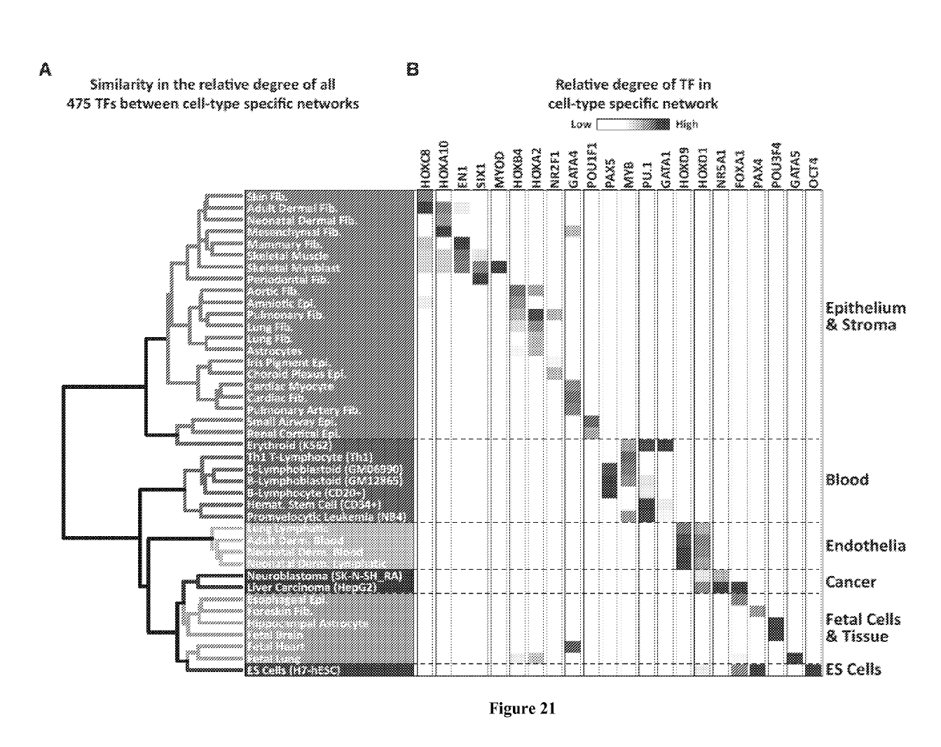

The degree of relatedness between different TF networks was determined To obtain a quantitative global summary of the factors contributing to each cell-type-specific network, for each cell type the normalized network degree (NND) was computed—a vector that encapsulates the relative number of interactions observed in that cell type for each of the 475 TFs. To capture the degree to which different cell-type networks utilize similar TFs, all cell-type networks were clustered based on their NND vector (FIG. 21A). FIG. 21 illustrates that functional related cell types share similar core transcriptional regulatory networks (see also Neph et al., 2012b). FIG. 21A illustrates clustering of cell-type networks by normalized network degree (NND). For each of 475 TFs within a given cell-type network, the relative number of edges was compared between all 41 cell types using a Euclidean distance metric and Ward clustering. Cell types are colored based on their physiological and/or functional properties. The resulting network clusters obtained from an unbiased analysis—strikingly parallel both anatomical and functional cell-type groupings into epithelial and stromal cells; hematopoietic cells; endothelia; and primitive cells including fetal cells and tissues, ESCs, and malignant cells with a “dedifferentiated” phenotype (FIG. 21A; compare the manually curated groupings in FIG. 19). FIG. 19 illustrates cell-specific versus shared regulatory interactions in TF networks of 41 diverse cell types. Shown for each of 41 cell types are schematics of cell-type-specific (yellow) versus-nonspecific (black) regulatory interactions between 475 TFs. Each half of each circular plot is divided into 475 points (not visible at this scale), one for each TF. Lines connecting the left and right half-circles represent regulatory interactions between each factor and any other factors with which it interacts in the given cell type. Yellow lines represent TF-to-TF connections that are specific to the indicated cell type. Black lines represent TF-to-TF connections that are seen in two or more cell types. The order of TFs along each half-circular axis is shown in Table 3 and represents a sorted list (descending order) of their degree (i.e., number of connections to other TFs) in the ESC network, from highest degree on top (SP1) to lowest degree on bottom (ZNF354C). Cell types are grouped based on their developmental and functional properties. Insert on bottom right shows a detailed view of the human ESC network and highlights the interactions of four pluripotent (KLF4, NANOG, POU5F1, SOX2) and four constitutive factors (SP1, CTCF, NFYA, MAX) with purple and green edges, respectively. This result suggests that transcriptional regulatory networks from functionally similar cell types are governed by similar factors. Furthermore, this result suggests a framework for understanding how minor perturbations in network composition may enable trans differentiation among related cell types.

To identify the individual TFs driving the clustering of related cell-type networks, the relative NND (i.e., the normalized number of connections) of each TF across the 41 cell types was computed. This approach uncovered numerous specific factors with highly cell-selective interaction patterns, including known regulators of cellular identity important to functionally related cell types (FIG. 21B). FIG. 21B illustrates the relative degree of master regulatory TFs in cell-type networks. Shown is a heat map representing the relative normalized degree of the indicated TFs between each of the 41 cell types. For a given TF and cell type, high relative degree indicates high connectivity with other TFs in that cell type. Note that the relative degree of known regulators of cell fate such as MYOD, OCT4, or MYB is highest in their cognate cell type or lineage. Similar patterns were found for other TFs without previously recognized roles in specification of cell identify.

For instance, PAX5 is most highly connected in B cell regulatory networks, concordant with its function as a major regulator of B-lineage commitment. Similarly, the neuronal developmental regulator POU3F4 plays a prominent role specifically in hippocampal astrocyte and fetal brain regulatory networks, whereas the cardiac developmental regulator GATA4 shows the highest relative network degree in cardiac and great vessel tissue (fetal heart, cardiomyocytes, cardiac fibroblasts, and pulmonary artery fibroblasts).

In addition to these known develop-mental regulators, the network analysis implicated many regulators with previously unrecognized roles in specification of cell identity. For instance, HOXD9 is highly connected specifically in endothelial regulatory networks, and the early developmental regulator GATA5 appears to play a predominant role in the fetal lung network (FIG. 21B), providing functional insight into the role of GATA5 as a lung tissue biomarker. In addition to factors with strong cell-selective connectivity, a number of TFs with prominent roles in all 41 cell-type networks were found, including several known ubiquitous transcriptional and genomic regulators such as SP1, NFYA, CTCF, and MAX (Neph et al., 2012b). In an exemplary case (Neph et al., 2012b), common highly-connected TFs were identified, (related to FIG. 21). Exemplary highly-connected TFs included SP1, NFYA, and CTCF, while exemplary cell-type specific/less connected factors included PU.1, OCT4, YOD, and GATA1 (Neph et al., 2012b).

Together, the above results demonstrate the ability of transcriptional net-works derived from nucleic acid (e.g., genomic DNA)seI footprinting to pinpoint known cell-selective and ubiquitous regulators of cellular state and to implicate analogous yet unanticipated roles for many other factors. It is notable that the aforementioned results were derived independently of gene expression data, highlighting the ability of a single experimental paradigm (nucleic acid (e.g., genomic DNA)seI footprinting) to elucidate multiple intricate transcriptional regulatory relationships.

Methods.

Regulatory Network Construction.

Regulatory network construction was performed as previously described in Example 9 herein.

Identification of DNaseI Footprints.

The identification of DNaseI footprints was performed as previously described in Example 9 herein.

Network Clustering.

The total number edges for every TF gene node (sum of in and out edges) in a cell type was counted and the proportion of edges for that TF relative to all edges in that cell type calculated (NND). The pairwise euclidean distances between cell types was computed using the resealed NND vectors and the cell types grouped using Ward clustering. Similar cluster patterns were observed when comparing resealed in-degree, resealed out-degree, or unsealed total degree.

### Example 12

### Network Analysis Reveals Cell-Type-Specific Behaviors for Widely Expressed TFs

Many TFs are expressed to varying degrees in a number of different cell types. A major question is whether the function of widely expressed factors remains essentially the same in different cells, or whether such factors are capable of exhibiting important cell-selective actions. To explore this question, the regulatory diversity between different cell types within the same lineage was characterized. Hematopoietic lineage cells have been extensively characterized at both the phenotypic and the molecular levels, and a cadre of major transcriptional regulators, including TAL1/SCL, PU.1, ELF1, HES1, MYB, GATA2, and GATA1, has been defined. Many of these factors are expressed to varying degrees across multiple hematopoietic lineages and their constituent cell types.

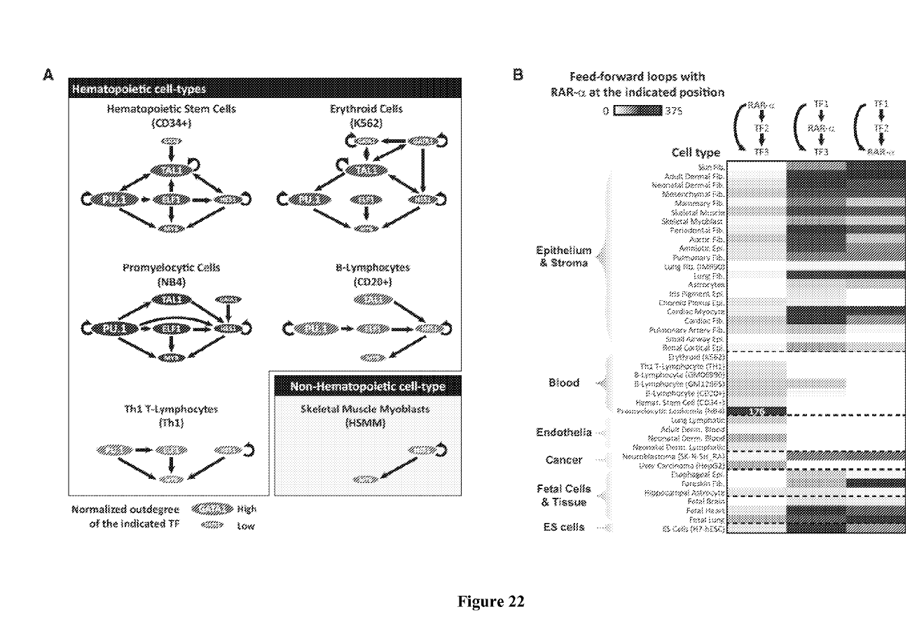

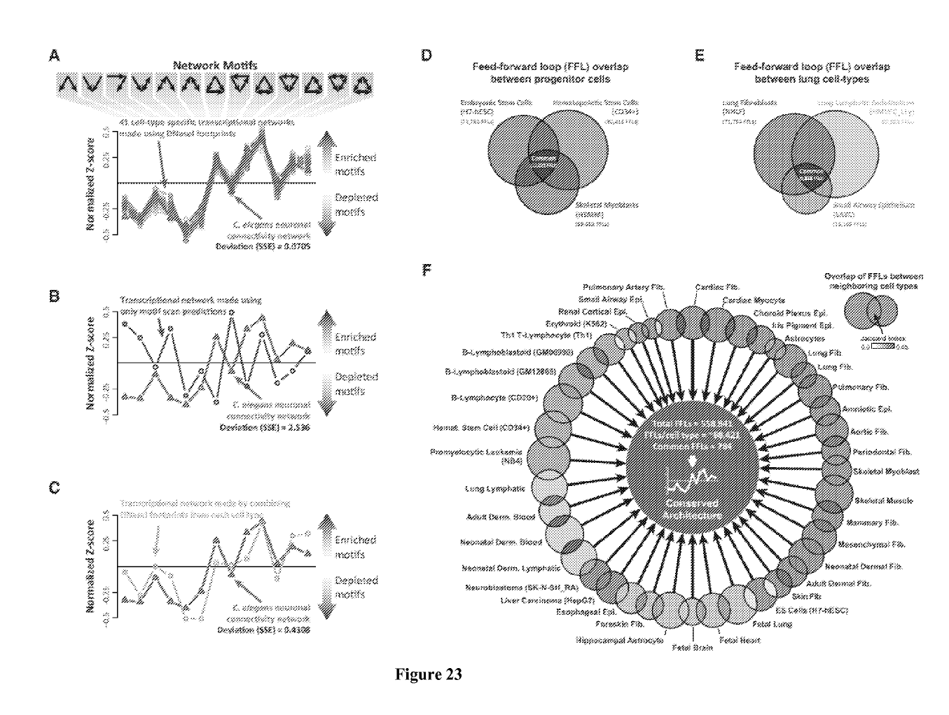

De novo-derived subnetworks comprising the aforementioned seven regulators in five hematopoietic and one nonhematopoietic cell type were analyzed (FIG. 22A). FIG. 22 illustrates cell-selective behaviors of widely expressed TFs. FIG. 22A illustrates regulatory subnetworks comprising edges (arrows) between seven major hematopoietic regulators in five hematopoietic and one non-hematopoietic cell types. For each TF, the size of the corresponding colored oval is proportional to the normalized out-degree (i.e., out-going regulatory interactions) of that factor within the complete network of each cell type. The early hematopoietic fate decision factor PU.1 appears to play the largest role in hematopoietic stem cells (CD34+) and in promyelocytic leukemia (NB4) cells. The erythroid-specific regulator GATA1 appears as a strong driver of the core TAL1/PU.1/HES1/MYB network specifically within erythroid cells. In both B cells and T cells, the subnetwork takes on a directional character, with PU.1 in a superior position. By contrast, the network is largely absent in nonhematopoietic cells (muscle, HSMM, bottom right). For each cell-type subnetwork, the normalized outdegree (i.e., the number of outgoing connections) was also mapped for each factor (FIG. 22A). This analysis revealed both subtle and stark differences in the organization of the seven-member hematopoietic regulatory subnetwork that reflected the biological origin of each cell type. For example, the early hematopoietic fate-decision factor PU.1 appears to play the largest role in the subnetworks generated from hematopoietic stem cells (CD34+) and promyelocytic leukemia (NB4) cells (FIG. 22A). The erythroid-specific regulator GATA1 appears as a strong driver of the core TAL1/PU.1/HES1/MYB subnetwork specifically within erythroid cells (FIG. 22A), consistent with its defining role in erythropoiesis. In both B cells and T cells, the subnetwork takes on a directional character, with PU.1 in a superior position. By contrast, the subnetwork is largely absent in nonhematopoietic cells (muscle, HSMM) (FIG. 22A, bottom right). These findings demonstrate that analysis of the network relationships of major lineage regulators provides a powerful tool for uncovering subtle differences in transcriptional regulation that drive cellular identity between functionally similar cell types.

This analysis was next extended to determine whether commonly expressed factors that manifest cell-type-specific behaviors could be identified. For example, the retinoic acid receptor-alpha (RAR-α) is a constitutively expressed factor involved in numerous developmental and physiological processes. Rather than simply measuring the degree of connectivity of RAR-α to other factors across different cell types, the behavior of RAR-α within each cellular regulatory network was quantified by determining its position within feed forward loops (FFLs). FFLs represent one of the most important network motifs in biological and regulatory systems and comprise a three-node structure in which information is propagated forward from the top node through the middle to the bottom node, with direct top node-to-bottom node reinforcement. For each cell type, the number of FFLs containing RAR-α at each of the three different positions was quantified (top versus middle versus bottom; FIG. 22B, top). FIG. 22B illustrates a heat map showing the frequency with which RAR− is positioned as a driver (top) or passenger (middle or bottom) within FFLs mapped in 41 cell-type regulatory networks. Note that in most cell types, RAR− participates in FFLs at “passenger” positions 2 and 3. However, within blood and endothelial cells, RAR− switches from being a passenger of FFLs to being a driver (top position) of FFLs. In acute promyelocytic leukemia cells (NB4), RAR− acts exclusively as a potent driver of FFLs. Cell types are arranged according to the clustered ordering in FIG. 21. In most cell types, RAR-α chiefly participates in FFLs at “passenger” positions 2 and 3 (FIG. 22B). However, within blood and endothelial cells, RAR-α switches from being a passenger to being a driver (top position) of FFLs. Strikingly, in acute promyelocytic leukemia (APL) cells, RAR-α acts as a uniquely potent driver of FFLs, occurring exclusively in the driver position—a feature unique among all cell types (FIG. 22B). APL is characterized by an oncogenic t(15;17) chromosomal translocation that results in a RAR-α/PML fusion protein that misregulates RAR-α target sites. The results suggest that in APL cells, RAR-α is additionally altering the basic organization of the regulatory network. Critically, using DNaseI footprint-driven network analysis, the prominent role of RAR-α in APL cells was identified without any prior knowledge of the role of RAR-α in the oncogenic transformation of APL cells. This suggests that network analysis is capable of deriving vital pathogenic information about specific factors in abnormal cell types, given a sufficient analyzed spectrum of normal cellular networks. On a more general level, the aforementioned results show clearly that marked cell-selective functional specificities of commonly expressed proteins can be exposed by analyzing factors within the context of their peers.

Methods.

Regulatory Network Construction.

Regulatory network construction was performed as previously described in Example 9 herein.

Identification of DNaseI Footprints.

The identification of DNaseI footprints was performed as previously described in Example 9 herein.

Cell-Type-Specific Behaviors.

The mfinder software, version 1.20, was utilized to pull out all FFL instances in regulatory networks. Prior to using the software, all self-edges, those from a TF gene node to itself, were removed per the requirements of the software. The software parameters were set to -ospmem<motif-number>-maxmem 1000000-s 3-r 250-z -2000, where <motif-number> was one of 13 possible unique three-node network motif identifiers.

### Example 13

### The Common “Neural” Architecture of Human TF Regulatory Networks

Complex networks from diverse organisms are built from a set of simple building blocks termed network motifs. Network motifs represent simple regulatory circuits, such as the FFL described above. The topology of a given network can be reflected quantitatively in the normalized frequencies (normalized z-score) of different network motifs. Specific well-described motifs including FFL, “clique,” “semi-clique,” “regulated mutual,” and “regulating mutual” are recurrently found at higher than expected frequencies within diverse biological networks. Therefore, the topology of the human TF regulatory network was analyzed and compared with those of well-annotated multicellular biological networks.

First, the relative frequency and relative enrichment or depletion of each of the 13 possible three-node network motifs within each cell-type regulatory network was computed. Next, the results for each cell-type network was compared with the relative enrichment of three-node network motifs found in perhaps the best annotated multicellular biological network, the C. elegans neuronal connectivity network. This comparison revealed striking similarity between the topologies of human TF networks and the C. elegans neuronal network (FIG. 23A; Table 4). FIG. 23 illustrates conserved architecture of human TF regulatory networks (see also Table 4 and Neph et al., 2012b). FIG. 23A illustrates the relative enrichment or depletion of the 13 possible three-node architectural network motifs within the regulatory networks of each cell type (red lines), compared with the relative enrichment of the same motifs in the C. elegans neuronal connectivity network. Note that the network architecture of each individual cell type closely mirrors that of the living neuronal network (average SSE of only 0.0705). Remarkably, in spite of their cell selectivity, the topologies of each TF network were nearly identical. Notably, the human TF regulatory network topology also closely resembles that of other well-described networks, including the sea-urchin endomesoderm specification network, the Drosophila developmental transcriptional network, and the mammalian signal transduction network (Neph et al., 2012b), consistent with universal principles for multicellular biological information processing systems. In an exemplary case (Neph et al., 2012b), the topology of the average relative enrichment or depletion of the 13 possible three-node architectural network motifs within the regulatory networks of each cell type was compared with the relative enrichment of the same motifs in four previously published multicellular biological networks; C. elegans neuronal connectivity network, the mammalian signal transduction network, and the sea-urchin and Drosophila developmental transcriptional networks, and shown to be substantially similar.

To test the sensitivity of the above findings to the manner in which the human transcriptional regulatory networks were determined, this network was recomputed solely from scanned TF-binding sites within the promoter-proximal regions of each TF gene, without considering whether the motifs were localized within DNaseI footprints. Using this approach, the remarkable similarity of the footprint-derived TF networks to the neuronal network was almost completely lost (FIG. 23B). FIG. 23B illustrates enrichment of each triad network motif for a TF network computed using only motif scan predictions within ±5 kb of TF promoters (brown line). The resulting network bore little resemblance to the C. elegans network (blue line) (SSE of 2.536). This result affirms the criticality of in vivo footprints for biologically meaningful network inference.

Next, it was determined whether the observed similarity to the neuronal network was a collective property of human TF networks. To test this, a transcriptional regulatory network was computed from the combined regulatory interactions of all 41 cell types and the enrichment of network motifs within this network was determined. The resulting network topology diverged considerably from that of the neuronal network (FIG. 23C), far more so than was observed for any individual cell type (FIG. 23A). FIG. 23C illustrates the relative enrichment of different triad network motifs for a TF regulatory network generated by pooling DNaseI footprints from all 41 tested cell types into a single archetype (orange line). The resulting topology diverged considerably from that of the neuronal network, far more so than was observed for any individual cell type (SSE of 0.4308). This result suggested that the regulatory interactions within each cell-type network are independently balanced to achieve a specific architecture, and that pooling multiple cellular networks together degrades this balance.

Finally, to assess whether a common core of regulatory interactions may be driving the conserved network architecture, FFLs between biologically similar cell types were compared. This comparison revealed marked diversity among different cellular TF networks (FIG. 23D-E), going beyond that observed among individual edges (Neph et al., 2012b). FIG. 23D-E illustrate that network architectures are highly cell specific. FIG. 23D illustrates overlap of FFLs identified in three different progenitor cell types—ESCs (H7-hESC), hematopoietic stem cells (CD34+), and HSMM. Note that most FFLs are restricted to an individual cell type. 27% of the total edges within these networks were common to these three cell types, while only 7.1% of FFLs were common (Neph et al., 2012b). FIG. 23E illustrates overlap of FFLs identified in three pulmonary cell types—lung fibroblasts (NHLF), small airway epithelium cells (SAECs), and pulmonary lymphatic endothelium cells (HMVEC_LLy). Highly distinct architectures were present even among cell types from the same organ structure. 30% of the total edges within these networks were common to these three cell types, while only 6.5% of FFLs were common (Neph et al., 2012b). Indeed, only—0.1% of all observed FFLs across 41 cell types (784/558,841) were common to all cell types (FIG. 23F and Neph et al, 2012b). FIG. 23F illustrates overlap of FFLs from networks of neighboring cell types, following the ordering and coloration shown in FIG. 21A. The size of each circle is proportional to the number of FFLs contained within the network of the corresponding cell type. The color of the intersection region between adjacent cell types indicates the Jaccard index between FFLs from those two cell types (see legend in upper right). The average number of FFLs in each network, the total number of FFLs across all networks, and the number of common FFLs across all networks are indicated in the center of the graph. In another exemplary case (Neph et al., 2012b), analysis of the overlap of FFLs from networks of each cell type, as quantified by the Jaccard index between FFLs from all possible pairs of cell-type-specific networks, demonstrated significant diversity in FFLs between cell-type specific networks. Moreover, only a minority of the TFs represented within a given cellular network contribute to the enriched network motifs (Neph et al., 2012b). This was demonstrated in an exemplary analysis of the contribution of all 470 TFs with interactions in ESCs (H7-hESC) to 13 possible three-node architectural network motifs in the ESC-type-specific network (Neph et al., 2012b). These findings indicate that the conserved “neuronal” network architecture (FIG. 23A) of the human TF regulatory network is specified independently in each cell type using a distinct set of balanced regulatory interactions.

Methods.

Regulatory Network Construction.

Regulatory network construction was performed as previously described in Example 9 herein.

Identification of DNaseI Footprints.

The identification of DNaseI footprints was performed as previously described in Example 9 herein.

Triad Significance Profiles (TSP).

Self-edges were removed from every network and the mfinder software tool used for network motif analysis. A z-score was calculated over each of 13 network motifs of size 3 (three-node network motifs), using 250 randomized networks of the same size to estimate a null. The z-scores from every cell type were vectorized and normalized each to unit length to create TSP. The average TSP was computed over all cell-type-specific regulatory networks and compared to the TSP of the highly curated multicellular information processing networks that have been described. All sum squared error (SSE) calculations were done by comparing the derived networks against the Caenorhabditis elegans profile (Table 4).

To generate a transcriptional network using only motif scan predictions a new network was created, with 86,242 edges, by using all putative motifs within 5 kb of the TSSs of each of the 475 TF genes, without conditioning on footprint overlaps. This network was analyzed using the mfinder software as described above, creating a TSP and comparing to the Caenorhabditis elegans profile.

To generate a transcriptional network from DNaseI footprints from all cell types footprints across all cell types were merged and motif instances were filtered to those overlapping the merged set by at least 3 nt using BEDOPS, creating another new network with 38,165 edges. This network was analyzed using the mfinder software as described above, creating a TSP and comparing to the Caenorhabditis elegans profile.

Network Feature Overlaps.

Cell-type-specific networks were compared in greater detail using only FFLs.

Summaries of overlaps were made between a small number of cell types using Venn diagrams and barplots. All pairwise overlaps were computed and summarized using the Jaccard index (number of FFLs in the pairwise set intersection divided by the number in the pairwise set union—Neph et al., 2012b). Additionally, overlaps and differences between entire regulatory networks in terms of shared and unshared edges were computed, as well as footprints (Neph et al., 2012b). For instance, the overlap of transcriptional regulatory interactions (edges) identified in ESCs (H7-hESC), skeletal muscle myoblasts (HSMM), and renal cortical epithelium (HRCEpiC) was determined, and the number of common edges and common DNaseI footprints between these networks was computed (Neph et al., 2012b).

To identify the contribution of each factor to each network motif, the number of times a factor was present in each of the 13 three-node network motifs within the H7-hESC cell type, in any motif position, was counted (Neph et al., 2012b). Each column vector was scaled to length 100, and then divided each element of a row vector by the maximum value in that row to visualize contributions in heat map form using the matrix2png program without row normalization.

Examples 14-20 refer to Table 5, below. Table 5 summarizes all 125 cell-types for which DNaseI analysis was performed.

TABLE 5
Summary of all 125 cell-types for which DNaseI analysis was performed. Column 1 gives the abbreviated name
as found in the figures, while column 2 gives a fully descriptive name. Column 3 indicates whether the DNase
I data was collected by UW, Duke or both. Column 4 (“H” for “H3K4me3”) indicates those cell-types
for which H3K4me3 data was also available and used for promoter predictions or other analysis (“Y”) or
not (“N”). Column 5 (“S” for “sex”) gives the sex of the donor(s): M, male, F, female, B, both sexes, U, undetermined.

| Cell Line | Description | Lab | H | S | Source | Cell/Tissue Protocol |
|---|---|---|---|---|---|---|
| A549 | epithelial cell line | Duke/UW | Y | M | ATCC CCI-185 | http://genome.ucsc.edu/ENCODE/ |
| | derived from a | | | | | protocols/cell/human/ |
| | lung carcinoma | | | | | A549_Stam_protocol.pdf |
| | tissue | | | | | |
| GM12878 | lymphoblastoid | Duke/UW | Y | F | Coriell | http://genome.ucsc.edu/ENCODE/ |
| | | | | | GM12878 | protocols/cell/human/ |
| | | | | | | GM12878_protocol.pdf |
| HESC | H1 Human | Duke/UW | N | M | Cellular | http://genome.ucsc.edu/ENCODE/ |
| | Embryonic Stem | | | | Dynamics | protocols/cell/human/ |
| | Cells | | | | | H1_ES_protocol.pdf |
| HeLa-S3 | cervical carcinoma | Duke/UW | Y | F | ATCC CCL-2.2 | http://genome.ucsc.edu/ENCODE/ |
| | | | | | | protocols/cell/human/ |
| | | | | | | HeLa-S3_protocol.pdf |
| HepG2 | liver carcinoma | Duke/UW | Y | M | ATCC HB-8065 | http://genome.ucsc.edu/ENCODE/ |
| | | | | | | protocols/cell/human/ |
| | | | | | | HepG2_protocol.pdf |
| HMEC | Human Mammary | Duke/UW | Y | F | Lonza CC-3150 | http://genome.ucsc.edu/ENCODE/ |
| | Epithelial Cells | | | | | protocols/cell/human/ |
| | | | | | | HMEC_Stam_protocol.pdf |
| HSMM | Normal Human | Duke/UW | N | B | Lonza CC-2580 | http://genome.ucsc.edu/ENCODE/ |
| | Skeletal Muscle | | | | | protocols/cell/human/ |
| | Myoblasts | | | | | HSMM_Stam_protocol.pdf |
| HSMM | Normal Human | Duke/UW | N | B | Lonza CC-2580 | http://genome.ucsc.edu/ENCODE/ |
| tube | Skeletal Muscle | | | | | protocols/cell/human/ |
| | Myoblasts | | | | | HSMM_Stam_protocol.pdf |
| HUVEC | Human Umbilical | Duke/UW | Y | U | Lonza CC-2517 | http://genome.ucsc.edu/ENCODE/ |
| | Vein Endothelial | | | | | protocols/cell/human/ |
| | Cell | | | | | HUVEC_Stam_protocol.pdf |
| K562 | Leukemia | Duke/UW | Y | F | ATCC CCL- | http://genome.ucsc.edu/ENCODE/ |
| | | | | | 243 | protocols/cell/human/ |
| | | | | | | K562_protocol.pdf |
| LNCaP | prostate adeno | Duke/UW | Y | M | ATCC CRL- | http://genome.ucsc.edu/ENCODE/ |
| | carcinoma | | | | 1740 | protocols/cell/human/ |
| | | | | | | LNCaP_Stam_protocol.pdf |
| MCF-7 | mammary gland, | Duke/UW | Y | F | ATCC HTB-22 | http://genome.ucsc.edu/ENCODE/ |
| | adeno- carcinoma | | | | | protocols/cell/human/ |
| | | | | | | Stam_15_protocols.pdf |
| Th1 | primary human | Duke/UW | N | U | primary | http://genome.ucsc.edu/ENCODE/ |
| | Th1 T cells | | | | pheresis of | protocols/cell/human/ |
| | | | | | single normal | Stam_15_protocols.pdf |
| | | | | | subject | |
| NHEK | Normal Human | Duke/UW | Y | F | Lonza CC-2501 | http://genome.ucsc.edu/ENCODE/ |
| | Epidermal | | | | | protocols/cell/human/ |
| | Keratinocytes | | | | | Keratinocyte_protocol.pdf |
| AG04449 | Fetal buttock/thigh | UW | Y | M | Coriell | http://genome.ucsc.edu/ENCODE/ |
| | fibroblast | | | | AG04449 | protocols/cell/human/ |
| | | | | | | AGO4449_Stam_protocol.pdf |
| AG04450 | Fetal lung | UW | Y | M | Coriell | http://genome.ucsc.edu/ENCODE/ |
| | fibroblast | | | | AG04450 | protocols/cell/human/ |
| | | | | | | AG04450_Stam_protocol.pdf |
| AG09309 | Adult human toe | UW | Y | F | Coriell | http://genome.ucsc.edu/ENCODE/ |
| | fibroblast | | | | AG09309 | protocols/cell/human/ |
| | | | | | | AG09309_Stam_protocol.pdf |
| AG09319 | Adult human gum | UW | Y | F | Coriell | http://genome.ucsc.edu/ENCODE/ |
| | tissue fibroblasts | | | | AG09319 | protocols/cell/human/ |
| | | | | | | AG09309_Stam_protocol.pdf |
| AG10803 | Adult human | UW | Y | M | Coriell | http://genome.ucsc.edu/ENCODE/ |
| | abdominal skin | | | | AG10803 | protocols/cell/human/ |
| | fibroblasts | | | | | AG10803_Stam_protocol.pdf |
| AoAF | Normal Human | UW | Y | F | Lonza CC-7014, | http://genome.ucsc.edu/ENCODE/ |
| | Aortic Adventitial | | | | CC-7014T75 | protocols/cell/human/ |
| | Fibroblast Cells | | | | | AoAF Stam_protocol.pdf |
| BE2_C | Human | UW | Y | M | ATCC CRL- | http://genome.ucsc.edu/ENCODE/ |
| | neuroblastoma | | | | 2268 | protocols/cell/human/ |
| | | | | | | BE2-C_Stam_protocol.pdf |
| BJ | skin fibroblast | UW | Y | M | ATCC CRL- | http://genome.ucsc.edu/ENCODE/ |
| | | | | | 2522 | protocols/cell/human/ |
| | | | | | | BJ-tert_Stam_protocol.pdf |
| Caco-2 | colorectal | UW | Y | M | ATCC HTB-37 | http://genome.ucsc.edu/ENCODE/ |
| | adenocarcinoma | | | | | protocols/cell/human/ |
| | | | | | | Stam_15_protocols.pdf |
| CMK | Human Acute | UW | N | M | DSMZ ACC- | http://genome.ucsc.edu/ENCODE/ |
| | Megakaryocytic | | | | 392 | protocols/cell/human/ |
| | Leukemia Cells | | | | | CMK_Stam_protocol.pdf |
| GM06990 | B-Lymphocyte | UW | Y | F | Coriell | http://genome.ucsc.edu/ENCODE/ |
| | | | | | GM06990 | protocols/cell/human/ |
| | | | | | | Stam_15_protocols.pdf |
| GM12864 | B-Lymphocyte | UW | Y | M | Coriell | http://genome.ucsc.edu/ENCODE/ |
| | | | | | GM12864 | protocols/cell/human/ |
| | | | | | | GM12864_Stam_protocol.pdf |
| GM12865 | B-Lymphocyte | UW | Y | F | Coriell | http://genome.ucsc.edu/ENCODE/ |
| | | | | | GM12865 | protocols/cell/human/ |
| | | | | | | GM12865_Stam_protocol.pdf |
| H7-hESC | Undifferentiated | UW | Y | U | WiCell | http://genome.ucsc.edu/ENCODE/ |
| | human embryonic | | | | WA07(H7) | protocols/cell/human/ |
| | stem cells | | | | | H7-hESC_Stam_protocol.pdf |
| HAc | Human | UW | Y | U | ScienCell 1810 | http://genome.ucsc.edu/ENCODE/ |
| | Astrocytes- | | | | | protocols/cell/human/ |
| | cerebellar | | | | | HAc_Stam_protocol.pdf |
| HAEpiC | Human Amniotic | UW | N | U | ScienCell 7100 | http://genome.ucsc.edu/ENCODE/ |
| | Epithelial Cells | | | | | protocols/cell/human/ |
| | | | | | | HAEpiC_Stam_protocol.pdf |
| HAh | Human Astrocytes - | UW | N | F | ScienCell 1830 | http://genome.ucsc.edu/ENCODE/ |
| | hippocampal | | | | | protocols/cell/human/ |
| | | | | | | HAh_Stam_protocol.pdf |
| HA-sp | Human astrocytes | UW | Y | U | ScienCell 1820 | http://genome.ucsc.edu/ENCODE/ |
| | spinal cord | | | | | protocols/cell/human/ |
| | | | | | | HA-sp_Stam_protocol.pdf |
| HBMEC | Human Brain | UW | Y | U | ScienCell 1000 | http://genome.ucsc.edu/ENCODE/ |
| | Microvascular | | | | | protocols/cell/human/ |
| | Endothelial Cells | | | | | HBMEC_Myers_protocol.pdf |
| HCF | Human Cardiac | UW | Y | U | ScienCell 6300 | http://genome.ucsc.edu/ENCODE/ |
| | Fibroblasts | | | | | protocols/cell/human/ |
| | | | | | | HCF_Stam_protocol.pdf |
| HCFaa | Human Cardiac | UW | Y | F | ScienCell 6320 | http://genome.ucsc.edu/ENCODE/ |
| | Fibroblasts-Adult | | | | | protocols/cell/human/ |
| | Atrial | | | | | HCFaa_Stam_protocol.pdf |
| HCM | Human Cardiac | UW | Y | U | ScienCell 6200 | http://genome.ucsc.edu/ENCODE/ |
| | Myocytes | | | | | protocols/cell/human/ |
| | | | | | | HCM_Stam_protocol.pdf |
| HConF | Human | UW | N | U | ScienCell 6570 | http://genome.ucsc.edu/ENCODE/ |
| | Conjunctival | | | | | protocols/cell/human/ |
| | Fibroblast | | | | | HConF_Stam_protocol.pdf |
| HCPEpiC | Human Choroid | UW | Y | U | ScienCell 1310 | http://genome.ucsc.edu/ENCODE/ |
| | Plexus Epithelial | | | | | protocols/cell/human/ |
| | Cells | | | | | HCPEpiC_Stam_protocol.pdf |
| HCT-116 | colorectal | UW | Y | M | ATCC CCL- | http://genome.ucsc.edu/ENCODE/ |
| | carcinoma | | | | 247 | protocols/cell/human/ |
| | | | | | | HCT116_Stam_protocol.pdf |
| HEEpiC | Human | UW | Y | U | ScienCell 2700 | http://genome.ucsc.edu/ENCODE/ |
| | Esophageal | | | | | protocols/cell/human/ |
| | Epithelial Cells | | | | | HEEpiC_Stam_protocol.pdf |
| HFF | Human Foreskin | UW | Y | M | Dr. Torok- | http://genome.ucsc.edu/ENCODE/ |
| | Fibroblast | | | | Storb, Fred | protocols/cell/human/ |
| | | | | | Hutchison | HFF_Stam_protocol.pdf |
| | | | | | Cancer | |
| | | | | | Research Center | |
| HFF_Myc | Human Foreskin | UW | Y | M | Dr. Torok- | http://genome.ucsc.edu/ENCODE/ |
| | Fibroblast | | | | Storb, Fred | protocols/cell/human/ |
| | | | | | Hutchison | HFF_Stam_protocol.pdf |
| | | | | | Cancer | |
| | | | | | Research Center | |
| HGF | Human Gingival | UW | N | U | ScienCell 2620 | http://genome.ucsc.edu/ENCODE/ |
| | Fibroblasts | | | | | protocols/cell/human/ |
| | | | | | | HGF_Stam_protocol.pdf |
| HIPEpiC | Human Iris | UW | N | U | ScienCell 6560 | http://genome.ucsc.edu/ENCODE/ |
| | Pigment Epithelial | | | | | protocols/cell/human/ |
| | Cells | | | | | HIPEpiC_Stam_protocol.pdf |
| HL-60 | Human | UW | Y | F | ATCC CCL- | http://genome.ucsc.edu/ENCODE/ |
| | promyelocytic | | | | 240 | protocols/cell/human/ |
| | leukemia cells | | | | | HL-60_Stam_protocol.pdf |
| HMF | Human Mammary | UW | N | F | ScienCell 7630 | http://genome.ucsc.edu/ENCODE/ |
| | Fibroblast | | | | | protocols/cell/human/ |
| | | | | | | HMF_Stam_protocol.pdf |
| HMVEC- | Adult Human | UW | N | U | Lonza CC-2543 | http://genome.ucsc.edu/ENCODE/ |
| dAd | Dermal | | | | | protocols/cell/human/ |
| | Microvascular | | | | | HMVECdAd_Stam_protocol.pdf |
| | Endothelial Cells | | | | | |
| HMVEC- | Normal Adult | UW | N | F | Lonza | http://genome.ucsc.edu/ENCODE/ |
| dBI-Ad | Human Blood | | | | CC-2811, | protocols/cell/human/ |
| | Microvascular | | | | CC-2811T75 | HMVEC-dBI- |
| | Endothelial Cells, | | | | | Ad_Stam_protocol.pdf |
| | Dermal-Derived | | | | | |
| HMVEC- | Normal Neonatal | UW | N | M | Lonza | http://genome.ucsc.edu/ENCODE/ |
| dBI-Neo | Human Blood | | | | CC-2813, | protocols/cell/human/ |
| | Microvascular | | | | CC-2813T75 | HMVEC-dBI- |
| | Endothelial Cells, | | | | | Neo_Stam_protocol.pdf |
| | Dermal-Derived | | | | | |
| HMVEC- | Normal Adult | UW | N | F | Lonza | http://genome.ucsc.edu/ENCODE/ |
| dLy-Ad | Human Blood | | | | CC-2810, | protocols/cell/human/ |
| | Microvascular | | | | CC-2810T75 | HMVEC-dLy- |
| | Endothelial Cells, | | | | | Ad_Stam_protocol.pdf |
| | Dermal- Derived | | | | | |
| HMVEC- | Normal Neonatal | UW | N | M | Lonza | http://genome.ucsc.edu/ENCODE/ |
| dLy-Neo | Human Lymphatic | | | | CC-2812, | protocols/cell/human/ |
| | Microvascular | | | | CC-2812T25 | HMVEC-dLy- |
| | Endothelial Cells, | | | | | Neo_Stam_protocol.pdf |
| | Dermal- Derived | | | | | |
| HMVEC- | Normal Neonatal | UW | N | M | Lonza | http://genome.ucsc.edu/ENCODE/ |
| dNeo | Human | | | | CC-2505, | protocols/cell/human/ |
| | Microvascular | | | | CC-2505T225 | HMVECdNeo_Stam_protocol.pdf |
| | Endothelial Cells | | | | | |
| | (single Donnor), | | | | | |
| | Dermal-Derived | | | | | |
| HMVEC- | Normal Human | UW | N | F | Lonza | http://genome.ucsc.edu/ENCODE/ |
| LBI | Blood | | | | CC-2815, | protocols/cell/human/ |
| | Microvascular | | | | CC-2815T75 | HMVEC- |
| | Endothelial Cells, | | | | | LbI_Stam_protocol.pdf |
| | Lung-Derived | | | | | |
| HMVEC- | Normal Human | UW | N | F | Lonza | http://genome.ucsc.edu/ENCODE/ |
| LLy | Lymphatic | | | | CC-2814, | protocols/cell/human/ |
| | Microvascular | | | | CC-2814T25 | HMVEC- |
| | Endothelial Cells, | | | | | LLy_Stam_protocol.pdf |
| | Lung-Derived | | | | | |
| HNPC- | Human Non- | UW | N | U | ScienCell 6580 | http://genome.ucsc.edu/ENCODE/ |
| EpiC | Pigment Ciliary | | | | | protocols/cell/human/ |
| | Epithelial Cells | | | | | HNPCEpiC_Stam_protocol.pdf |
| HPAEC | Human Pulmonary | UW | N | U | Lonza CC-2530 | http://genome.ucsc.edu/ENCODE/ |
| | Artery Endothelial | | | | | protocols/cell/human/ |
| | Cells | | | | | HPAEC_Stam_protocol.pdf |
| HPAF | Human Pulmonary | UW | Y | U | ScienCell 3120 | http://genome.ucsc.edu/ENCODE/ |
| | Artery Fibroblasts | | | | | protocols/cell/human/ |
| | | | | | | HPAF_Stam_protocol.pdf |
| HPdLF | Normal Human | UW | N | M | ScienCell 7409 | http://genome.ucsc.edu/ENCODE/ |
| | Periodontal | | | | | protocols/cell/human/ |
| | Ligament | | | | | HPdLF_Stam_protocol.pdf |
| | Fibroblast Cells | | | | | |
| HPF | Human Pulmonary | UW | Y | U | ScienCell 3300 | http://genome.ucsc.edu/ENCODE/ |
| | Fibroblasts | | | | | protocols/cell/human/ |
| | | | | | | HPF_Stam_protocol.pdf |
| HRCEpiC | Human Renal | UW | N | U | Lonza CC-2554 | http://genome.ucsc.edu/ENCODE/ |
| | Cortical Epithelial | | | | | protocols/cell/human/ |
| | cells (normal) | | | | | HRCEpiC_Stam_protocol.pdf |
| HRE | Human Renal | UW | Y | U | Lonza CC-2556 | http://genome.ucsc.edu/ENCODE/ |
| | Epithelial cells | | | | | protocols/cell/human/ |
| | (normal) | | | | | HRE_Stam_protocol.pdf |
| HRGEC | Human Renal | UW | N | U | ScienCell 4000 | http://genome.ucsc.edu/ENCODE/ |
| | Glomerular | | | | | protocols/cell/human/ |
| | Endothelial Cells | | | | | HRGEC_Stam_protocol.pdf |
| HRPEpiC | Human Retinal | UW | Y | U | ScienCell 6540 | http://genome.ucsc.edu/ENCODE/ |
| | Pigment Epithelial | | | | | protocols/cell/human/ |
| | Cells | | | | | HRPEpiC_Stam_protocol.pdf |
| HVMF | Human Villous | UW | Y | U | ScienCell 7130 | http://genome.ucsc.edu/ENCODE/ |
| | Mesenchymal | | | | | protocols/cell/human/ |
| | Fibroblast Cells | | | | | HVMF_Stam_protocol.pdf |
| Jurkat | T lymphoblastoid | UW | Y | M | ATCC TIB-152 | http://genome.ucsc.edu/ENCODE/ |
| | cell line derived | | | | | protocols/cell/human/ |
| | from an acute T | | | | | Jurkat_Stam_protocol.pdf |
| | cell leukemia | | | | | |
| Monocytes- | Monocytes- | UW | Y | F | S. Heimfeld | http://genome.ucsc.edu/ENCODE/ |
| CD14+ | CD14+ are CD14- | | | | Laboratory, | protocols/cell/human/ |
| | positive cells from | | | | Fred Hutchison | MonoCD14_Stam_protocol.pdf |
| | human | | | | Cancer | |
| | leukapheresis | | | | Research Center | |
| | product | | | | | |
| NB4 | acute | UW | Y | U | Refer to | http://genome.ucsc.edu/ENCODE/ |
| | promyelocytic | | | | protocol | protocols/cell/human/ |
| | leukemia cell line | | | | documents for | NB4_Stam_protocol.pdf |
| | | | | | differing | |
| | | | | | sources | |
| NH-A | normal human | UW | N | U | Lonza CC-2565 | http://genome.ucsc.edu/ENCODE/ |
| | astrocytes | | | | | protocols/cell/human/ |
| NHDF-Ad | Adult Normal | UW | N | F | Lonza | http://genome.ucsc.edu/ENCODE/ |
| | Human Dermal | | | | CC-2511, | protocols/cell/human/ |
| | Fibroblasts | | | | CC-2511T225 | NHDF-Ad_Stam_protocol.pdf |
| NHDF-neo | Neonatal Human | UW | Y | U | Lonza CC-2509 | http://genome.ucsc.edu/ENCODE/ |
| | Dermal | | | | | protocols/cell/human/ |
| | Fibroblasts | | | | | NHDF-neo_Stam_protocol.pdf |
| NHLF | Normal Human | UW | Y | U | Lonza CC-2512 | http://genome.ucsc.edu/ENCODE/ |
| | Lung Fibroblasts | | | | | protocols/cell/human/ |
| | | | | | | NHLF_Stam_protocol.pdf |
| NT2-D1 | Human malignant | | N | M | ATCC | http://genome.ucsc.edu/ENCODE/ |
| | pluripotent | | | | CRL-1973 | protocols/cell/human/ |
| | embryonal cancer | | | | | NT2-D1_protocol.pdf |
| | cell line - Induced | | | | | |
| | by RA to neuronal | | | | | |
| PANC-1 | pancreatic | UW | Y | M | ATCC | http://genome.ucsc.edu/ENCODE/ |
| | carcinoma | | | | CRL-1469 | protocols/cell/human/ |
| | | | | | | PANC-1_Stam_protocol.pdf |
| PrEC | Human Prostate | UW | N | M | Lonza CC-2555 | http://genome.ucsc.edu/ENCODE/ |
| | Epithelial Cell | | | | | protocols/cell/human/ |
| | Line | | | | | PrEC_Stam_protocol.pdf |
| | (PrEC/NHPRE) | | | | | |
| RPTEC | Renal Proximal | UW | Y | U | Lonza | http://genome.ucsc.edu/ENCODE/ |
| | Tubule Epithelial | | | | CC-2553, | protocols/cell/human/ |
| | Cells | | | | CC-2553T225 | RPTEC_Stam_protocol.pdf |
| SAEC | Small Airway | UW | Y | U | Lonza CC-2547 | http://genome.ucsc.edu/ENCODE/ |
| | Epithelial Cells | | | | | protocols/cell/human/ |
| | | | | | | SAEC_Stam_protocol.pdf |
| SKMC | Human Skeletal | UW | Y | U | Lonza CC-2561 | http://genome.ucsc.edu/ENCODE/ |
| | Muscle Cells | | | | | protocols/cell/human/ |
| | | | | | | SkMC_Stam_protocol.pdf |
| SK_N_MC | Neuro-epithelioma | UW | Y | F | ATCC HBT-10 | http://genome.ucsc.edu/ENCODE/ |
| | cell line derived | | | | | protocols/cell/human/ |
| | from a metastatic | | | | | SK-N-MC_Stam_protocol.pdf |
| | supra-orbital | | | | | |
| | human brain tumor | | | | | |
| SK-N- | neuroblastoma cell | UW | Y | F | ATCC HTB-11 | http://genome.ucsc.edu/ENCODE/ |
| SH_RA | line differentiated | | | | | protocols/cell/human/ |
| | w/retinoic acid | | | | | Stam_15_protocols.pdf |
| Th2 | Primary human | UW | N | U | None | http://genome.ucsc.edu/ENCODE/ |
| | Th2 T cells | | | | (primary | protocols/cell/human/Th2_{—} |
| | | | | | pheresis of | Stam_protocol.pdf |
| | | | | | single normal | |
| | | | | | subject) | |
| WERI-Rb-1 | retinoblastoma | UW | Y | F | ATCC | http://genome.ucsc.edu/ENCODE/ |
| | | | | | HTB-169 | protocols/cell/human/ |
| | | | | | | WERI-Rb-1_Stam_protocol.pdf |
| WI-38 | Embryonic Lung | UW | Y | F | Dr. Carl Mann, | http://genome.ucsc.edu/ENCODE/ |
| | Fibroblast Cells, | | | | SBIGeM | protocols/cell/human/ |
| | hTERT | | | | | WI38_Stam_protocol.pdf |
| | immortalized, | | | | | |
| | includes Raf1 | | | | | |
| | construct | | | | | |
| WI- | Embryonic lung | UW | Y | F | Dr. Carl Mann, | http://genome.ucsc.edu/ENCODE/ |
| 38_TAM | fibroblasts | | | | SBIGeM | protocols/cell/human/ |
| | immortilized | | | | | WI38_Stam_protocol.pdf |
| | hTERT - | | | | | |
| | Tamoxifen treated | | | | | |
| CD20 | Human B Cells | UW | Y | F | S. Heimfeld | http://genome.ucsc.edu/ENCODE/ |
| | | | | | Laboratory, | protocols/cell/human/ |
| | | | | | Fred Hutchison | CD20+_Stam_protocol.pdf |
| | | | | | Cancer | |
| | | | | | Research Center | |
| CD34 | Mobilized primary | UW | N | F | S. Heimfeld | http://www.roadmapepigenomics.org/ |
| | CD34-positive | | | | Laboratory, | files/protocols/experimental/ |
| | cells from human | | | | Fred Hutchison | dnasel_sensitivity/ |
| | leukapheresis | | | | Cancer | HematopoieticCells_{—} |
| | product | | | | Research Center | DNaseTreatment_v5_{—} |
| | | | | | | UW-NREMC.pdf |
| Th0 | Unstimulated Th0 | Duke | N | M | Dr. Robin | Submitted |
| | cells isolated from | | | | Haton at | |
| | Adults' blood | | | | University of | |
| | | | | | Alabama | |
| HSMM_emb | embryonic | Duke | N | U | Duke/UNC/UT/ | http://genome.ucsc.edu/ENCODE/ |
| | myoblast | | | | EBI ENCODE | protocols/cell/human/ |
| | | | | | group Muscle | HSMMe_Crawford_protocol.pdf |
| | | | | | needle biopsies | |
| Ishikawa/ | endometrial | Duke | N | F | SIGMA- | http://genome.ucsc.edu/ENCODE/ |
| Estradiol_10 | adenocarcinoma | | | | ALDRICH | protocols/cell/human/ |
| nM_30m | cells treated with | | | | 99040201 | Ishikawa_Crawford_protocol.pdf |
| | 10 nM 17- | | | | | |
| | bestradiol for 30 | | | | | |
| | min | | | | | |
| Ishikawa/4 | endometrial | Duke | N | F | SIGMA- | http://genome.ucsc.edu/ENCODE/ |
| OHTAM | adenocarcinoma | | | | ALDRICH | protocols/cell/human/ |
| 100nM_30m | treated with 100 | | | | 99040201 | Ishikawa_Crawford_protocol.pdf |
| | nM 4-OH | | | | | |
| | Tamoxifen for 30 | | | | | |
| | min | | | | | |
| RWPE1 | Prostate epithelial | Duke | N | M | ATCC | http://genome.ucsc.edu/ENCODE/ |
| | | | | | CRL-11609 | protocols/cell/human/ |
| | | | | | | RWPE1_Crawford_protocol.pdf |
| 8988T | human pancreas | Duke | N | F | DSMZ | http://genome.ucsc.edu/ENCODE/ |
| | adenocarcinoma | | | | ACC 162 | protocols/cell/human/ |
| | (PA-TU-8988T), | | | | | 8988T_Crawford_protocol.pdf |
| | “established in | | | | | |
| | 1985 from the | | | | | |
| | liver metastasis of | | | | | |
| | a primary | | | | | |
| | pancreatic | | | | | |
| | adenocarcinoma | | | | | |
| | from a 64-year-old | | | | | |
| | woman” - DSMZ | | | | | |
| AoSMC/ | aortic smooth | Duke | N | U | Lonza CC-2571 | http://genome.ucsc.edu/ENCODE/ |
| serum_free_{—} | muscle cells | | | | | protocols/cell/human/ |
| media | treated in serum- | | | | | AoSMC_Crawford_protocol.pdf |
| | free media for 36 h | | | | | |
| Chorion | chorion cells | Duke | N | U | Dr. Amy | http://genome.ucsc.edu/ENCODE/ |
| | (outermost of two | | | | Murtha at Duke | protocols/cell/human/ |
| | fetal membranes), | | | | University | Chorion_and_decidua_Crawford_{—} |
| | fetal membranes | | | | (Durham, NC) | protocol.pdf |
| | were collected | | | | | |
| | from women who | | | | | |
| | underwent planned | | | | | |
| | cesarean delivery | | | | | |
| | at term, before | | | | | |
| | labor and without | | | | | |
| | rupture of | | | | | |
| | membranes. | | | | | |
| CLL | chronic | Duke | N | F | Dr. Jennifer | http://genome.ucsc.edu/ENCODE/ |
| | lymphocytic | | | | Brown, | protocols/cell/human/ |
| | leukemia cell, T- | | | | Department of | CLL_Crawford_protocol.pdf |
| | cell lymphocyte | | | | Medicine, | |
| | | | | | Harvard | |
| | | | | | Medical School | |
| Fibrobl | Normal child | Duke | N | F | Coriell | http://genome.ucsc.edu/ENCODE/ |
| | fibroblast | | | | AG08470 | protocols/cell/human/fibroblast_{—} |
| | | | | | | Crawford_protocol.pdf |
| FibroP | normal fibroblasts | Duke | N | U | Paul Tesar at | http://genome.ucsc.edu/ENCODE/ |
| | taken from | | | | Case Western | protocols/cell/human/FibroP_{—} |
| | individuals with | | | | University | Crawford_protocol.pdf |
| | Parkinson's | | | | | |
| | disease, AG20443, | | | | | |
| | AG08395 and | | | | | |
| | AG08396 were | | | | | |
| | pooled for this | | | | | |
| | sample | | | | | |
| Gliobla | glioblastoma, | Duke | N | U | Duke University | http://genome.ucsc.edu/ENCODE/ |
| | these cells (aka | | | | Medical Center, | protocols/cell/human/ |
| | H54 and D54) | | | | requests for D54 | D54_Crawford_protocol.pdf |
| | come from a | | | | cells should be | |
| | surgical resection | | | | directed to | |
| | from a patient with | | | | Darrell Bigner | |
| | glioblastoma | | | | | |
| | multiforme (WHO | | | | | |
| | Grade IV). D54 is | | | | | |
| | a commonly | | | | | |
| | studied | | | | | |
| | glioblastoma cell | | | | | |
| | line⁸ that has been | | | | | |
| | thoroughly | | | | | |
| | described⁹ | | | | | |
| GM12891 | B-Lymphocyte, | Duke | N | M | Coriell | http://genome.ucsc.edu/ENCODE/ |
| | Lymphoblastoid, | | | | GM12891 | protocols/cell/human/ |
| | International | | | | | GM12891_Crawford_protocol.pdf |
| | HapMap Project, | | | | | |
| | CEPH/Utah | | | | | |
| | pedigree 1463, | | | | | |
| | Treatment: | | | | | |
| | Epstein-Barr Virus | | | | | |
| | transformed | | | | | |
| GM12892 | B-Lymphocyte, | Duke | N | F | Coriell | http://genome.ucsc.edu/ENCODE/ |
| | Lymphoblastoid, | | | | GM12892 | protocols/cell/human/ |
| | International | | | | | GM12892_Crawford_protocol.pdf |
| | HapMap Project, | | | | | |
| | CEPH/Utah | | | | | |
| | pedigree 1463, | | | | | |
| | Treatment: | | | | | |
| | Epstein-Barr Virus | | | | | |
| | transformed | | | | | |
| GM18507 | Lymphoblastoid, | Duke | N | M | Coriell | http://genome.ucsc.edu/ENCODE/ |
| | International | | | | GM18507 | protocols/cell/human/ |
| | HapMap Project, | | | | | GM18507_protocol.pdf |
| | Yoruba in Ibadan, | | | | | |
| | Nigera, Treatment: | | | | | |
| | Epstein-Barr Virus | | | | | |
| | transformed | | | | | |
| GM19238 | B-Lymphocyte, | Duke | N | F | Coriell | http://genome.ucsc.edu/ENCODE/ |
| | Lymphoblastoid, | | | | GM19238 | protocols/cell/human/ |
| | International | | | | | GM19238_Crawford_protocol.pdf |
| | HapMap Project, | | | | | |
| | Yoruba in Ibadan, | | | | | |
| | Nigera, Treatment: | | | | | |
| | Epstein-Barr Virus | | | | | |
| | transformed | | | | | |
| GM19239 | B-Lymphocyte, | Duke | N | M | Coriell | http://genome.ucsc.edu/ENCODE/ |
| | Lymphoblastoid, | | | | GM19239 | protocols/cell/human/ |
| | International | | | | | GM19239_Crawford_protocol.pdf |
| | HapMap Project, | | | | | |
| | Yoruba in Ibadan, | | | | | |
| | Nigera, Treatment: | | | | | |
| | Epstein-Barr Virus | | | | | |
| | transformed | | | | | |
| GM19240 | B-Lymphocyte, | Duke | N | F | Coriell | http://genome.ucsc.edu/ENCODE/ |
| | Lymphoblastoid, | | | | GM19240 | protocols/cell/human/ |
| | International | | | | | GM19240_Crawford_protocol.pdf |
| | HapMap Project, | | | | | |
| | Yoruba in Ibadan, | | | | | |
| | Nigera, Treatment: | | | | | |
| | Epstein-Barr Virus | | | | | |
| | transformed | | | | | |
| H9ES | human embryonic | Duke | N | F | WiCell WA09 | http://genome.ucsc.edu/ENCODE/ |
| | stem cell (hESC) | | | | | protocols/cell/human/ |
| | H9 | | | | | BG02ES_and_H9ES_Myers_{—} |
| | | | | | | protocols.pdf |
| HeLa- | cervical carcinoma | Duke | N | F | ATCC CCL-2.2 | http://genome.ucsc.edu/ENCODE/ |
| S3/IFNa4h | treated with IFN- | | | | | protocols/cell/human/HeLa- |
| | alpha for 4 h | | | | | S3_IFN_Crawford_protocol.pdf |
| Hepatocytes | Primary Human | Duke | N | B | Zin-Bio | http://genome.ucsc.edu/ENCODE/ |
| | Hepatocytes, liver | | | | | protocols/cell/human/ |
| | perfused by | | | | | Hepatocytes_Crawford_protocol.pdf |
| | enzymes to | | | | | |
| | generate single | | | | | |
| | cell suspension | | | | | |
| HPDE6- | normal human | Duke | N | F | Dr. Ming-Sound | http://genome.ucsc.edu/ENCODE/ |
| E6E7 | pancreatic duct | | | | Tsao, Ontario | protocols/cell/human/HPDE6- |
| | cells immortalized | | | | Cancer Institute | E6E7_Crawford_protocol.pdf |
| | with E6E7 gene of | | | | | |
| | HPV | | | | | |
| HTR8svn | Trophoblast | Duke | N | F | Dr. Charles H. | http://genome.ucsc.edu/ENCODE/ |
| | (HTR-8/SVneo) | | | | Graham, | protocols/cell/human/ |
| | cell line. A thin | | | | Department of | HTR8svn_Crawford_protocol.pdf |
| | layer of ectoderm | | | | Anatomy & Cell | |
| | that forms the wall | | | | Biology, | |
| | of many | | | | Queen's | |
| | mammalian | | | | University at | |
| | blastulas and | | | | Kingston, | |
| | functions in the | | | | Kingston, | |
| | nutrition and | | | | Ontario, Canada | |
| | implantation of the | | | | HTR8svhttp:// | |
| | embryo. | | | | genome.ucsc.edu/ | |
| | | | | | ENCODE/protocols/ | |
| | | | | | cell/human/ | |
| | | | | | Trophobl_Crawford_{—} | |
| | | | | | protocol.pdf | |
| Huh-7.5 | Hepatocellular | Duke | N | M | Dr. Ravi Jhaveri | http://genome.ucsc.edu/ENCODE/ |
| | carcinoma, | | | | at Duke | protocols/cell/human/Huh- |
| | hepatocytes | | | | University | 7.5_Crawford_protocol.pdf |
| | selected for high | | | | | |
| | levels of hepatitis | | | | | |
| | C replication | | | | | |
| Huh-7 | Hepatocellular | Duke | N | M | Dr. Ravi Jhaveri | http://genome.ucsc.edu/ENCODE/ |
| | carcinoma | | | | at Duke | protocols/cell/human/Huh- |
| | | | | | University | 7_Crawford_protocol.pdf |
| iPS | induced | Duke | N | B | Dr. Josh | http://genome.ucsc.edu/ENCODE/ |
| | pluripotent stem | | | | Chenoweth, | protocols/cell/human/ |
| | cell derived from | | | | Laboratory of | iPS_Crawford_protocol.pdf |
| | skin fibroblast | | | | Molecular | |
| | | | | | Biology, | |
| | | | | | National | |
| | | | | | Institutes of | |
| | | | | | Health | |
| LNCaP/ | prostate | Duke | N | M | ATCC | http://genome.ucsc.edu/ENCODE/ |
| androgen | adenocarcinoma | | | | CRL-1740 | protocols/cell/human/ |
| | treated with | | | | | LNCaP_Crawford_protocol.pdf |
| | androgen, “LNCaP | | | | | |
| | clone FGC was | | | | | |
| | isolated in 1977 by | | | | | |
| | J. S. Horoszewicz, | | | | | |
| | et al., from a | | | | | |
| | needle aspiration | | | | | |
| | biopsy of the left | | | | | |
| | supraclavicular | | | | | |
| | lymph node of a | | | | | |
| | 50-year-old | | | | | |
| | caucasian male | | | | | |
| | (blood type B+) | | | | | |
| | with confirmed | | | | | |
| | diagnosis of | | | | | |
| | metastatic prostate | | | | | |
| | carcinoma.” - | | | | | |
| | ATCC. | | | | | |
| MCF- | MCF7 cells treated | Duke | N | F | ECACC | http://genome.ucsc.edu/ENCODE/ |
| 7/Hypoxia_{—} | with hypoxia and | | | | 86012803 | protocols/cell/human/ |
| LacAcid | lactose | | | | | MCF-7_Crawford_protocol.pdf |
| Medullo | Medullo-blastoma | Duke | N | F | Darrell Bigner, | http://genome.ucsc.edu/ENCODE/ |
| | (aka D721), | | | | Duke University | protocols/cell/human/ |
| | surgical resection | | | | Medical Center | D721_Crawford_protocol.pdf |
| | from a patient with | | | | | |
| | medulloblastoma | | | | | |
| | as described by | | | | | |
| | Darrell Bigner | | | | | |
| | (1997) | | | | | |
| Melano | epidermal | Duke | N | U | ScienCell 2200 | http://genome.ucsc.edu/ENCODE/ |
| | melanocytes | | | | | protocols/cell/human/ |
| | | | | | | Melano_Crawford_protocol.pdf |
| Myometr | Myometrial cells | Duke | N | F | Dr. Jennifer | http://genome.ucsc.edu/ENCODE/ |
| | | | | | Condon at | protocols/cell/human/ |
| | | | | | Magee | Myometr_Crawford_protocol.pdf |
| | | | | | Women's | |
| | | | | | Research | |
| | | | | | Institute | |
| | | | | | (Pittsburg, PA) | |
| Osteobl | normal human | Duke | N | F | Lonza CC-2538 | http://genome.ucsc.edu/ENCODE/ |
| | osteoblasts | | | | | protocols/cell/human/ |
| | (NHOst) | | | | | Osteoblast_Crawford_protocol.pdf |
| PanIsletD | Dedifferentiated | Duke | N | B | National | http://genome.ucsc.edu/ENCODE/ |
| | human pancreatic | | | | Disease | protocols/cell/human/ |
| | islets from one of | | | | Research | PanIsletD_Crawford_protocol.pdf |
| | the sources for | | | | Interchange | |
| | PanIslets | | | | (NDRI). | |
| | | | | | PanIsletD | |
| PanIslets | human pancreatic | Duke | N | B | See protocol | http://genome.ucsc.edu/ENCODE/ |
| | islets | | | | document | protocols/cell/human/ |
| | | | | | | PanIslets_Crawford_protocol.pdf |
| pHTE | Primary Human | Duke | N | U | Dr. Cal Cotton | http://genome.ucsc.edu/ENCODE/ |
| | Tracheal Epithelial | | | | at Case Western | protocols/cell/human/ |
| | Cells | | | | Reserve | pHTE_Crawford_protocol.pdf |
| | | | | | University | |
| ProgFib | fibroblasts, | Duke | N | M | Progeria | http://genome.ucsc.edu/ENCODE/ |
| | Hutchinson- | | | | Research | protocols/cell/human/ |
| | Gilford progeria | | | | Foundation | progeria_Crawford_protocol.pdf |
| | syndrome (cell | | | | HGADFN167 | |
| | line HGPS, | | | | | |
| | HGADFN167, | | | | | |
| | progeria research | | | | | |
| | foundation) | | | | | |
| Stellate | Human Hepatic | Duke | N | U | Dr. Steve Choi | http://genome.ucsc.edu/ENCODE/ |
| | Stellate Cells, | | | | at Duke | protocols/cell/human/ |
| | Liver that was | | | | University | Stellate_Crawford_protocol.pdf |
| | perfused with | | | | | |
| | collagenase and | | | | | |
| | sellected for | | | | | |
| | hepatic stellate | | | | | |
| | cells by density | | | | | |
| | gradient | | | | | |
| T-47D | a human epithelial | Duke | N | F | ATCC | http://genome.ucsc.edu/ENCODE/ |
| | cell line derived | | | | HTB-133 | protocols/cell/human/ |
| | from an mammary | | | | | T47D_Myers_protocol.pdf |
| | ductal carcinoma. | | | | | |
| Urothelia | A primary culture | Duke | N | F | lab of Dr. D | http://genome.ucsc.edu/ENCODE/ |
| | of urothelial cells | | | | Sens | protocols/cell/human/ |
| | derived from a 12 | | | | (University of | Urothelia_Crawford_protocol.pdf |
| | year-old girl and | | | | N. Dakota) | |
| | immortalized by | | | | Urothelia | |
| | transfection with a | | | | | |
| | temperature- | | | | | |
| | sensitive SV-40 | | | | | |
| | large T antigen | | | | | |
| | gene, normal | | | | | |
| | human ureter cells | | | | | |
| Urothelia/ | Urotsa infected by | Duke | N | F | lab of Dr. D | http://genome.ucsc.edu/ENCODE/ |
| U T189 | UT189 | | | | Sens | protocols/cell/human/ |
| | | | | | (University of | Urothelia_Crawford_protocol.pdf |
| | | | | | N. Dakota) | |
| | | | | | Urothelia | |

### Example 14

### General Features of the Accessible Chromatin Landscape

Two ENCODE production centres (University of Washington and Duke University) profiled DNaseI sensitivity genome-wide using massively parallel sequencing in a total of 125 human cell and tissue types including normal differentiated primary cells (n=71), immortalized primary cells (n=16), malignancy-derived cell lines (n=30) and multipotent and pluripotent progenitor cells (n=8) (Table 5).

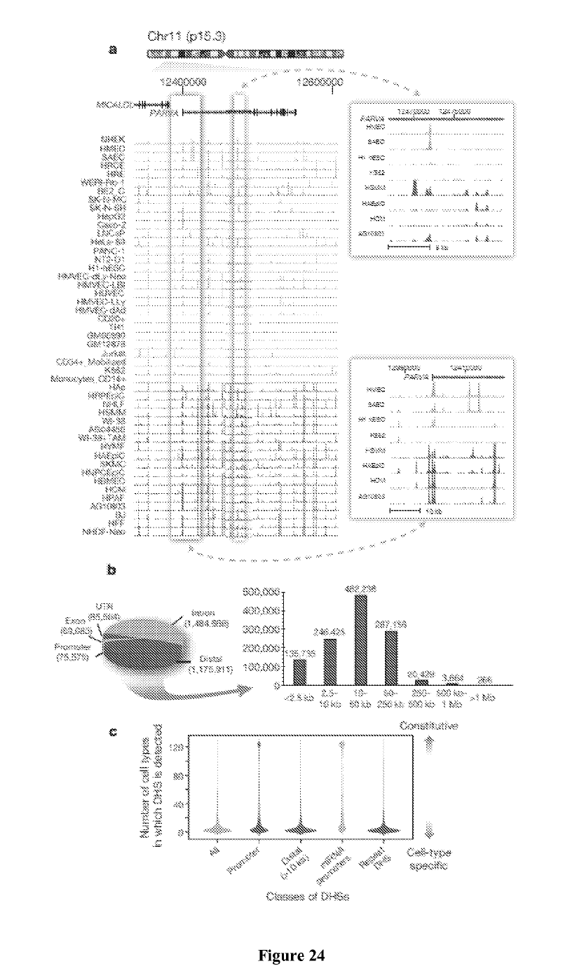

The density of mapped DNaseI cleavages as a function of genome position was observed to provide a continuous quantitative measure of chromatin accessibility, in which DHSs appeared as prominent peaks within the signal data from each cell type (FIG. 24a, Thurman et al., The accessible chromatin landscape of the human genome. Nature. 489 (7414):75-82. Sep. 6, 2012. herein, “Thurman et al., 2012”). FIG. 24 illustrates general features of the DHS landscape. FIG. 24a illustrates density of DNaseI cleavage sites for selected cell types, shown for an example ˜350-kb region. Two regions are shown to the right in greater detail. Furthermore, the density of DNaseI cleavage sites was analyzed for all 125 cell types for two exemplary ˜350-kb regions on chr11 (p15.3 and p15.4) and was observed to be highly consistent across cell types (Thurman et al., 2012). Analysis using a common algorithm (see Methods) identified 2,890,742 distinct high-confidence DHSs (false discovery rate (FDR) of 1%; see Methods), each of which was active in one or more cell types. Of these DHSs, 970,100 were specific to a single cell type, 1,920,642 were active in 2 or more cell types, and a small minority (3,692) was detected in all cell types. The relative accessibility of DHSs along the genome varied by >100-fold and was found to be highly consistent across cell types (Thurman et al., 2012b). To estimate the sensitivity and accuracy of the sequencing-derived DHS maps, one ENCODE production centre (University of Washington) performed 7,478 classical DNaseI hypersensitivity experiments by the Southern hybridization method. Using Southern blots as the standard, the average sensitivity, per cell type, of DNaseI-seq (at a sequencing depth of 30 M uniquely mapping reads) was 81.6%, with specificity of 99.5-99.9%. Of DHSs classified as false negatives within a particular cell type, an average of 92.4% were detected as a DHS in another cell type or upon deeper sequencing. As such, the overall sensitivity for DHSs of the combined cell type maps was estimated to be >98%.

Approximately 3% (n=75,575) of DHSs localize to transcriptional start sites (TSSs) defined by GENCODE and 5% (n=135,735, including the aforementioned) lie within 2.5 kilobases (kb) of a TSS. The remaining 95% of DHSs are positioned more distally, and are roughly evenly divided between intronic and intergenic regions (FIG. 24b). FIG. 24b, left, illustrates a distribution of 2,890,742 DHSs with respect to GENCODE gene annotations (left). Promoter DHSs were defined as the first DHS localizing within 1 kb upstream of a GENCODE TSS. FIG. 24b, right, illustrates a distribution of intergenic DHSs relative to Gencode TSSs. Promoters typically exhibited high accessibility across cell types, with the average promoter DHS detected in 29 cell types (FIG. 24c, second column) By contrast, distal DHSs were largely cell selective (FIG. 24c, third column) FIG. 24c illustrates distributions of the number of cell types, from 1 to 125 (y axis), in which DHSs in each of four classes (x axis) are observed. Width of each shape at a given y value shows the relative frequency of DHSs present in that number of cell types.

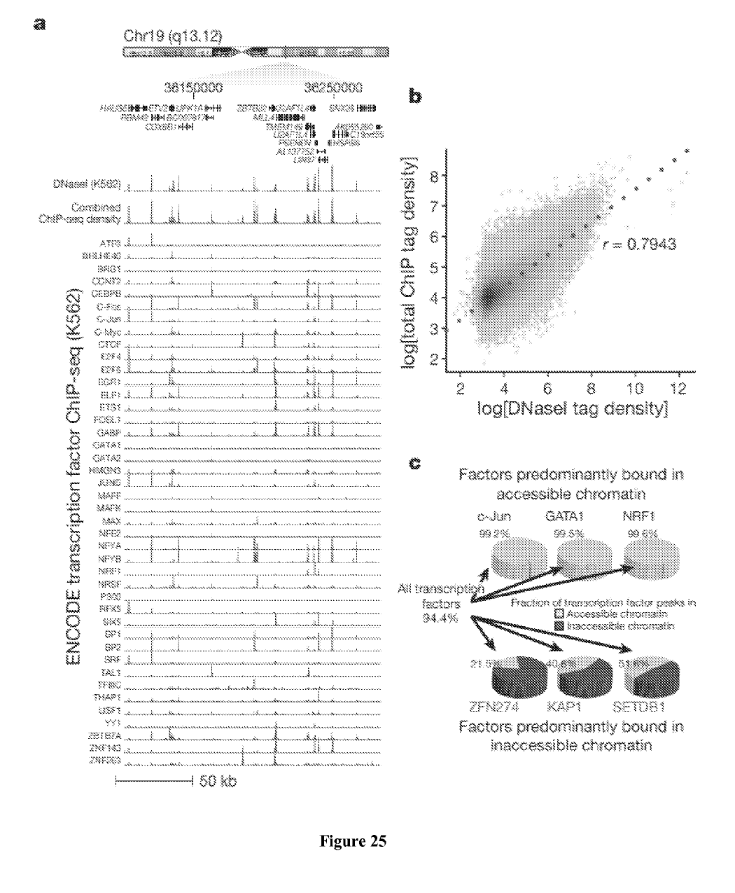

MicroRNAs (miRNAs) comprise a major class of regulatory molecules and have been extensively studied, resulting in consensus annotation of hundreds of conserved miRNA genes, approximately one-third of which are organized in polycistronic clusters. However, most predicted promoters driving microRNA expression lack experimental evidence. Of 329 unique annotated miRNA TSSs (Methods), 300 (91%) either coincided with or dosely approximated (<500 base pairs (bp)) a DHS. Chromatin accessibility at miRNA promoters was highly promiscuous compared with GENCODE TSSs (FIG. 24c, fourth column), and showed cell lineage organization, paralleling the known regulatory roles of well-annotated lineage-specific miRNAs (FIG. 25). FIG. 25 illustrates three examples of DHSs overlapping microRNA promoters. Peaks were usually observed in cell types consistent with known function of the microRNA. Panel (a) shows DNaseI signal at the promoter for MIR126. MIR126 is intronic, part of the transcript of the EGFL7 gene. MIR126 had a DHS at the promoter in several endothelial cell lines, consistent with its known function. Panel (b) shows chromatin accessibility at the promoter for MIR1-2. The transcript is antisense of the MB1 gene. DHSs can be seen in muscle cell lines. Panel (c) shows a DHS at a potential promoter site in the muscle cell types HSMM, HSMMtube, SKMC, and myoblast. MIR1-2 and MIR206 are known to be involved in muscle function.

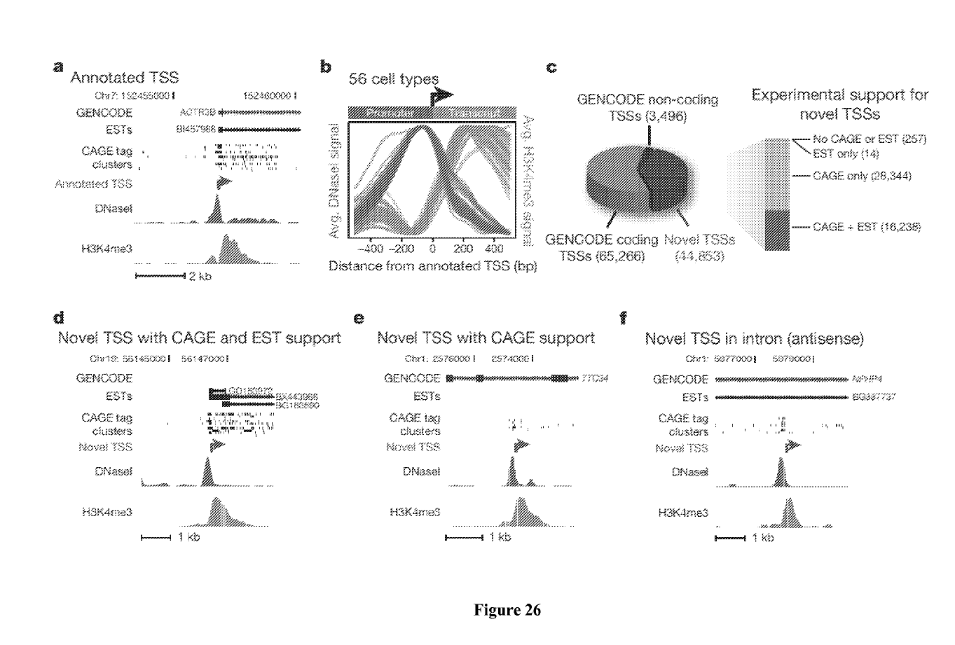

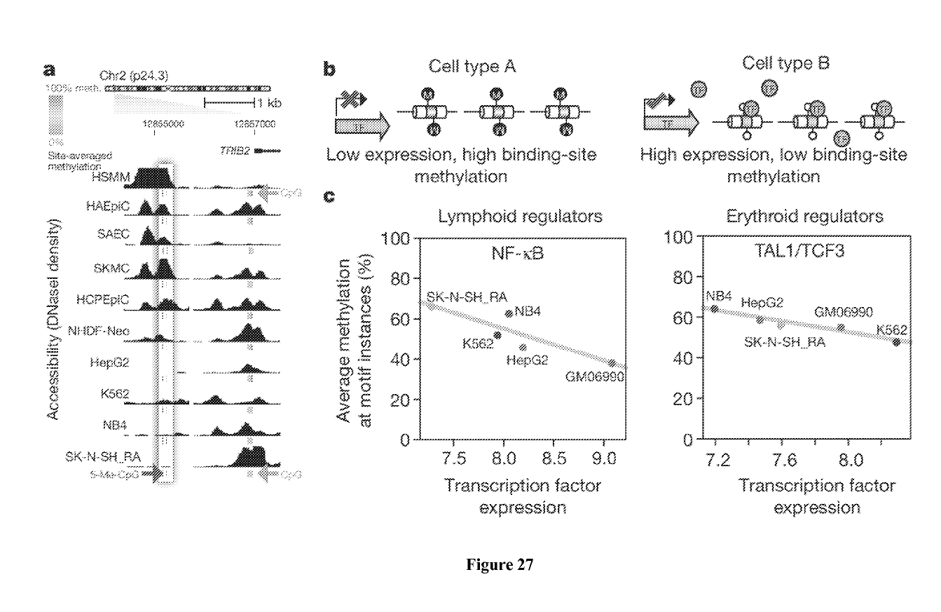

The 20-50-bp read lengths from DNaseI-seq experiments enabled unique mapping to 86.9% of the genomic sequence, allowing interrogation of a large fraction of transposon sequences. A surprising number contained highly regulated DHSs (FIG. 24c, fifth column and FIG. 26-27), compatible with cell-specific transcription of repetitive elements detected using ENCODE RNA sequencing data. FIG. 26 illustrates examples of DHSs in repetitive elements. Panels (a) and (b) show data for two well-characterized enhancers which lie in repeat-masked sequence. A CFTR enhancer is shown in panel (a). A red bar marks the position of the literature enhancer which largely overlaps a SINE element. In vitro footprints observed at the enhancer are shown below the red bar, in black. The enhancer has been previously reported in Caco-2 and Huh7 cells. A strong signal in LNCaP was also observed. The PSA enhancer of the KLK2 gene shown in panel (b) largely overlaps an LTR element. A red bar marks the known site and a black bar below marks the observed in vitro footprint. A strong DHS is observed in the expected cell type, LNCaP, but not in other cell types. Panels (c)-(g) are examples of DHSs primarily overlapping LTR, SINE, LINE, and DNA elements. FIG. 27 illustrates the number of cell-types per DHS overlapping four categories of repeat classes. For each master list peak the number of cell-types whose peaks overlap at that position were counted, giving a cell-type number per master list peak. The plots show the distribution of these cell-type numbers for DHS overlapping various classes of repeats (RepeatMasker track downloaded from UCSC genome browser). The number below each category is the number of DHSs overlapping the repeat class. Average cell-type numbers for each class are: LTR (6.0); LINE (5.3); SINE (5.9); DNA (6.9). This plot was made using the R function “beanplot” from the “beanplot” package. DHSs were most strongly enriched at long terminal repeat (LTR) elements, which encode retroviral enhancer structures (Thurman et al., 2012). Two such examples are shown in FIG. 26, which also illustrates the strong cell-selectivity of chromatin accessibility seen for each major repeat class. Numerous examples of transposon DHSs that displayed enhancer activity in transient transfection assays were also documented (Thurman et al., 2012).

Comparison with an extensive compilation of 1,046 experimentally validated distal, non-promoter cis-regulatory elements (enhancers, insulators, locus control regions, and so on) revealed the overwhelming majority (97.4%) to be encompassed within DNaseI hypersensitive chromatin (Thurman et al., 2012), typically with strong cell selectivity (Thurman et al., 2012). In an exemplary case, distinct cell types generated increased DNaseI cleavage density profiles that were found to be correlated with genes controlled by various enhancers (e.g., KLK3, APOB, RHAG, and GATA1) (Thurman et al., 2012).

Methods.

DNaseI hypersensitivity mapping was performed using protocols developed by Duke University or University of Washington on a total of 125 cell types (Table 5). Data sets were sequenced to an average depth of 30 million uniquely mapping sequence tags (27-35 bp for University of Washington and 20 bp for Duke University) per replicate. For uniformity of analysis, some cell-type data sets that exceeded 40M tag depth were randomly subsampled to a depth of 30 million tags. Sequence reads were mapped using the Bowtie aligner, allowing a maximum of two mismatches. Only reads mapping uniquely to the genome were used in the analyses. Mappings were to male or female versions of hg19/GRCh37, depending on cell type, with random regions omitted. Data were analyzed jointly using a single algorithm to localize DNaseI hypersensitive sites.

DNaseI and Histone Modification Protocols.

DNaseI assays were performed using two different protocols (Duke and UW) on a total of 125 cell-types (85 from UW and 54 from Duke, with 14 cell-types shared; see Table 5). Both protocols involve treatment of intact nuclei with the small enzyme DNaseI which is able to penetrate the nuclear pore and cleave exposed DNA. In the Duke protocol, DNA is isolated following lysis of nuclei, linkers added, and the library sequenced directly on an Illumina instrument. In the UW protocol, small (300-1000 bp) fragments are isolated from lysed nuclei following DNaseI treatment, linkers are added, and sequencing of the library is performed on an Illumina instrument.

For H3K4me3 ChIP-seq, cells were crosslinked withl % formaldehyde (Sigma) and sheared by Diagenode Bioruptor. The antibody used in the ChIP assay was 9751 (Cell Signaling) for histone H3 tri-methyl lysine 4. The ChIP DNA was made into libraries based on the Illumina protocol, and the size-selected libraries were sequenced on an Illumina Genome Analyzer IIx.

Sequence reads were mapped using aligner Bowtie, allowing a maximum of two mismatches. Only reads mapping uniquely to the genome were utilized in the analysis. Mapping was to male or female versions, depending on cell type, of hg19/GRCh37, with random regions omitted.

UW samples were typically sequenced to a depth of 25-35 million tags per replicate. Two replicates were produced for each cell type, and the top-quality replicate of each were chosen for all downstream analyses. All UW replicates were screened for quality by measuring the percent of their tags falling in hotspots genome-wide. A “top-quality replicate” is the replicate with the highest such score for the given cell type. UW replicates tend to be very reproducible, with two replicates' tag densities across chromosome 19, expressed as linear vectors, usually achieving correlations ≧0.9. Thurman et al., 2012 lists the quality scores and chr19 tag-density correlations for all DNaseI replicates obtained by UW.

The Duke data was more variable in the depth to which libraries were sequenced; consequently all replicates for each cell type were combined and subsampled to a depth of 30 million tags. This made the Duke data approximately match the UW datasets.

DNaseI hypersensitive regions of chromatin accessibility (hotspots) and more highly accessible DNaseI hypersensitive sites (DHSs, or peaks) within the hotspots were then identified, using the hotspot algorithm, applied uniformly to datasets from both protocols.

Briefly, the hotspot algorithm is a scan statistic that uses the binomial distribution to gauge enrichment of tags based on a local background model estimated around every tag. General-sized regions of enrichment are identified as hotspots, and then 150-bp peaks within hotspots are called by looking for local maxima in the tag density profile (sliding window tag count in 150-bp windows, stepping every 20 bp). Further stringencies are applied to the local maxima detection to prevent overcalling of spurious peaks. Hotspot also includes an FDR (false discovery rate) estimation procedure for thresholding hotspots and peaks, based on a simulation approach. Random reads are generated at the same sequencing depth as the target sample, hotspots are called on the simulated data, and the random and observed hotspots are compared via their z-scores (based on the binomial model) to estimate the FDR.

Using the above procedure, DHSs were identified at an FDR of 1%. For the 14 cell-types assayed by both UW and Duke, the two peak sets were consolidated by taking the union of peaks. For any two overlapping peaks, the one with the higher z-score was retained; hotspots were consolidated by simply merging the hotspot regions between the two datasets. See below for DHS dataset availability.

Hotspots and peaks were called in the same way on the H3K4me3 ChIP-seq datasets, with the exception that reads mapped to the same location in the genome are all retained for DNaseI analysis, whereas only one tag per location is retained for ChIP-seq analysis.

Dataset Availability.

Aligned reads in BAM format for all datasets can be downloaded from the ENCODE Data Coordination Center at UCSC (http://genome.ucsc.edu/ENCODE/downloads.html) under the links for sections entitled (1) Duke DNaseI HS, (2) UW DNaseI HS, (3) UW DNaseI DGF, and (4) UW Histone.

DHS Master List and its Annotation.

The DHSs called on individual cell-types were consolidated into a master list of 2,890,742 unique, non-overlapping DHS positions by first merging the FDR 1% peaks across all cell-types. Then, for each resulting interval of merged sites, the DHS with the highest z-score was selected for the master list. Any DHSs overlapping the peaks selected for the master list were then discarded. The remaining DHSs were then merged and the process repeated until each original DHS was either in the master list, or discarded.

For the genic annotations in FIG. 24b, all available GENCODE v7 annotations were used, i.e., Basic, Comprehensive, PseudoGenes, 2-way PseudoGenes, and PolyA Transcripts. The promoter class counts, for each GENCODE annotated TSS, the closest master list peak within 1 kb upstream of the TSS. The exon class covers any DHS not in the promoter class that overlaps a GENCODE annotated “CDS” segment by at least 75 bp. The UTR class covers any DHS not in the promoter or exon class that overlaps a GENCODE annotated “UTR” segment by at least 1 bp. For the intron class, introns were defined as the set difference of all GENCODE segments annotated as “gene” with all “CDS” segments. The intron class covers any DHS not in the previous categories that overlaps the introns by at least 1 bp.

Each master list DHS was annotated with the number of cell-types whose original DHSs overlap the master list DHS. This is called the cell-type number for that DHS. Plots in FIG. 24c (made using the R function “beanplot” from the “beanplot” package) summarize the distribution of cell-type numbers for various categories of DHS annotations. Repeat categories for the LINE, SINE, LTR, and DNA repeat classes were taken from UCSC RepeatMasker track annotations. 50% of an individual master list DHS was required to be contained in a repeat element in order to belong to its category. See below for the annotations used for the miRNA TSS category, for which 405 master-list DHSs were within 100 bp. The promoter category is as described above; the distal category refers to the intergenic DHSs (as defined in panel FIG. 24b) located at least 10 kb away from any TSS.

Dataset Availability.

The FDR 1% peaks by cell-type available at, ftp://ftp.ebi.ac.uk/pub/databases/ensembl/encode/integration_datajan2011/byDataType/openchrom/jan2011/combined_peaks and individual cell-type files end in *fdr0.01.merge.pks.bed and *fdr0.01.bed. The 125 cell-type master list are available at, ftp://ftp.ebi.ac.uk/pub/databases/ensembl/encode/integration_datajan2011/byDataType/openchrom/jan2011/combined_peaks/multi-tissue.master.ntypes.simple.hg19.bed.

miRNAs.

miRNA coordinates were downloaded from miRBase (version 10) and used to map miRNAs to their genomic locations. The following miRNAs that are considered dead in the current release (version 18) of miRBase were removed: hsa-miR-801, hsa-miR-560, hsa-miR-565, hsa-miR-923, hsa-miR-220a, hsa-miR-220b, hsa-miR-220c and hsa-miR-453. The names of the following miRNAs were changed to their current names in miRBase (version 18): hsa-miR-128a to hsa-miR-128-1, hsa-miR-128b to hsa-miR-128-2, hsa-miR-320 to hsa-miR-320a, hsa-miR-208 to hsa-miR-208a, hsa-miR-513-5p-1 to hsa-miR-513a-5p-1, hsa-miR-513-3p-1 to hsa-miR-513a-3p-1, hsa-miR-513-5p-2 to hsa-miR-513a-5p-2 and hsa-miR-513-3p-2 to hsa-miR-513a-3p-2. Some miRNAs (e.g., let-7a-1, let-7a-2) are expressed from multiple genomic locations, and hence all of the genomic locations were used to predict Transcription Start Site (TSS). miRNA genomic clusters were also identified by merging all miRNAs into clusters if they mapped to the same strand of the chromosome and were less than 10 kb apart.

To assign a TSS for each miRNA locus, RefSeq, AceView, ESTs, and Eponine predictions downloaded from the UCSC genome browser was used (hg 18 version of the genome assembly; see below). First, miRNAs that were located within and in the same orientation as RefSeq gene were identified. The TSS for these miRNAs was assumed to be the same as for the host genes, as it has been shown that miRNAs within host genes are generally co-transcribed from a shared promoter. For miRNA genes that did not match to RefSeq, AceView was used, which provides comprehensive transcriptional evidence from full length cDNAs and ESTs. Next, predictions by Eponine and EST clones were used to define the TSS of the remaining miRNAs. To identify EST clones, if both 5′ and 3′ ESTs were available from the same clone and formed a transcript containing the miRNA, the miRNA was considered expressed by this transcript and its TSS was the 5′ end of the EST. For the remaining miRNAs whose TSS could not be found by the above methods, the position 500 bp upstream of the miRNA was taken as the TSS.

In the case of miRNAs that lie in genomic clusters, the TSS of the most 5′ miRNA was assigned to all miRNAs in the cluster, because such miRNAs are expressed as a single primary transcript from a shared promoter. MicroRNAs in the same host gene were considered to be in the same cluster irrespective of their distance from each other. All TSS coordinates were converted from hg18 to hg19 using the UCSC LiftOver tool.

Dataset Availability.

The miRNA TSS dataset is available at, ftp://ftp.ebi.ac.k/pub/databases/ensembl/encode/integration_datajan2011/byDataType/openchrom/jan2011/mirna_tss.

Analysis of Repeat-Masked DHSs.

RepeatMasker data was downloaded from the hg19 rmsk table associated with the UCSC Genome Browser. Repeat-masked positions cover 1,446,390,049 bp of standard chromosomes 1-Y. 1,257,126,829 bp (86.9%) of these are uniquely mappable with 36-bp reads.

Even though much of the genome is derived from repetitive elements, evolutionary divergence has resulted in sufficiently different sequences that most positions can have reads uniquely mapped.

There are 1395 distinct named repeats in 56 families in 21 repeat classes. Data was analyzed by repeat family because this gives a granularity suitable for display. A number of the classes are structural classes rather than classes derived from transposable elements. Bedops utilities 23 were used to count the number of DHSs which were overlapped at least 50% by each repeat family. The DHSs in the master list of sites from 125 cell types/tissues were tested for overlap with repeat families. Thurman et al., 2012 shows overlap statistics for families of elements with at least 5000 overlapping DHSs. Table 11 shows DHSs overlapping repeat-masked elements which were tested and found to be enhancers in transient assays.

Cells, Transient Transfection Assay and Reporter Luciferase Activity Assay.

PCR-amplified fragments spanning DHSs were typically 300-500 bp and encompassed the entire 150-bp DHS peak. To the 5′ end of the each primer pair an additional 15 bp of DNA sequence was added (upstream sequence 5′ GCTAGCCTCGAGGATATC-3′ and 5′-AGGCCAGATCTTGATATC-3′ in order to directionally clone via the Infusion Cloning System (Clonetech, Mountain View, Calif.) into pGL4.10[luc2] (Promega, Madison, Wis.), a vector containing the firefly luciferase reporter gene. All recombinants were identified by PCR and sequences verified. DNA concentrations were determined with a fluorospectrometer (Nanodrop, Wilimington, Del.) and diluted to a final concentration of 100 ng/μL for transfections.

The transient transfection assays on K562 and HepG2 cell lines were performed by seeding 50,000 to 100,000 cells with 100 ng of plasmid in a 96-well plate. Twenty-four hours after transfection, the cells were lysed and luciferase substrate was added following the manufacturer's protocol (Promega, Madison, Wis.). Firefly luciferase activity was measured using a Berthold Centro XS3 LB960 luminometer (Berthold Technologies, Oak Ridge, Tenn.).

### Example 15

### Transcription Factor Drivers of Chromatin Accessibility

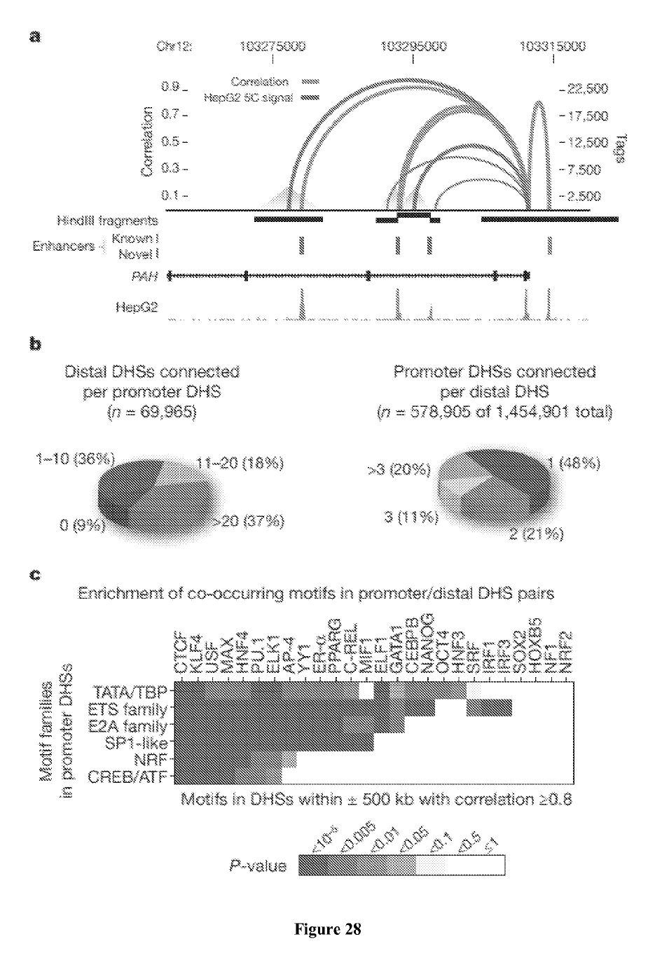

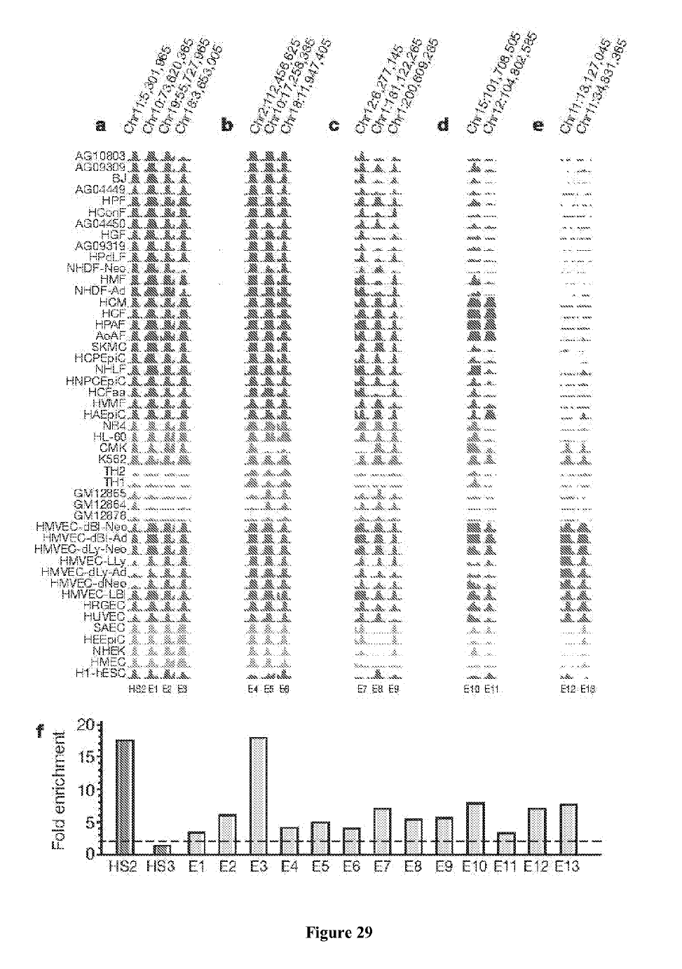

DNaseI hypersensitive sites result from cooperative binding of transcriptional factors in place of a canonical nucleosome. To quantify the relationship between chromatin accessibility and the occupancy of regulatory factors, sequencing-depth-normalized DNaseI sensitivity in the ENCODE common cell line K562 was compared to normalized ChIP-seq signals from all 42 transcription factors mapped by ENCODE ChIP-seq in this cell type (FIG. 28). FIG. 28 illustrates transcription factor drivers of chromatin accessibility. In FIG. 28a, DNaseI tag density is shown in red for a 175-kb region of chromosome 19. FIG. 28a, below, shows normalized ChIP-seq tag density for 45 ENCODE ChIP-seq experiments from K562 cells, with a cumulative sum of the individual tag density tracks shown immediately below the K562 DNaseI data. FIG. 28b illustrates genome-wide correlation (r=0.7943) between ChIP-seq and DNaseI tag densities (log) in K562 cells. FIG. 28c, left, illustrates 94.4% of a combined 1,108,081 ChIP-seq peaks from all transcription factors assayed in K562 cells fall within accessible chromatin (grey areas of pie chart). FIG. 28c, top, illustrates three examples of transcription factors localizing almost exclusively within accessible chromatin. FIG. 28c, bottom, illustrates three transcription factors from the KRAB-associated complex localizing partially or predominantly within inaccessible chromatin. Simple summation of the ChIP-seq signals was observed to markedly parallel quantitative DNaseI sensitivity at individual DHSs (FIG. 28a) and across the genome (r=0.79, FIG. 28b). For example, the β-globin locus control region contains a major enhancer element at hypersensitive site 2 (H52), which appears to be occupied by dozens of transcription factors (FIG. 29a). FIG. 29 illustrates quantifying the impact of transcription factors on chromatin accessibility. In FIG. 29a, as in FIG. 28a, DNaseI tag density is shown in red, followed by normalized ChIP-seq tag density for each of 42 ENCODE ChIP-seq experiments from K562 cells, with a cumulative sum of the individual tag density tracks shown immediately below the K562 DNaseI data; this plot shows a 35-kb region encompassing the beta-globin LCR on Chr11. Such highly overlapping binding patterns have been interpreted to signify weak interactions with lower-affinity recognition sequences potentiated by an accessible DNA template. However, HS2 is a compact element with a functional core spanning ˜110 bp that contains 5-8 sites of transcription factor-DNA interaction in vivo depending on the cell type. The fact that the cumulative ChIP-seq signal closely paralleled the degree of nuclease sensitivity at HS2 and elsewhere is thus most readily explained by interactions between DNA-bound factors and other interacting factors that collectively potentiate the accessible chromatin state (FIG. 29b). FIG. 29b illustrates additive correlation (y-axis) of ChIP-seq with DNaseI across Chr19 with increasing numbers of TFs. TFs are ordered alphabetically (x-axis). Correlation values for individual factors are shown in red. Given the relatively limited number of factors studied, it may seem surprising that such a close correlation should be evident. However, most of the factors selected for ENCODE ChIP-seq studies have well-described or even fundamental roles in transcriptional regulation, and many were identified originally based on their high affinity for DNA. Alternatively, a limited number of factors may be involved in establishment and maintenance of chromatin remodelling whereas others may interact nonspecifically with the remodeled state. The recognition sequences for a small number of factors were also found to be consistently linked with elevated chromatin accessibility across all classes of sites and all cell types (FIG. 29c), indicating that regulators acting through these sequences are key drivers of the accessibility landscape. FIG. 29c illustrates relative chromatin accessibility (x-axis) measured as the mean intensity of DHSs containing the indicated motif (y-axis), divided by the mean intensity of all DHSs (using 84 UW DNaseI datasets). Green density plots indicate the distribution of measurements obtained individually across all cell types; values >1 indicate presence of the motif has an average positive effect on chromatin accessibility.

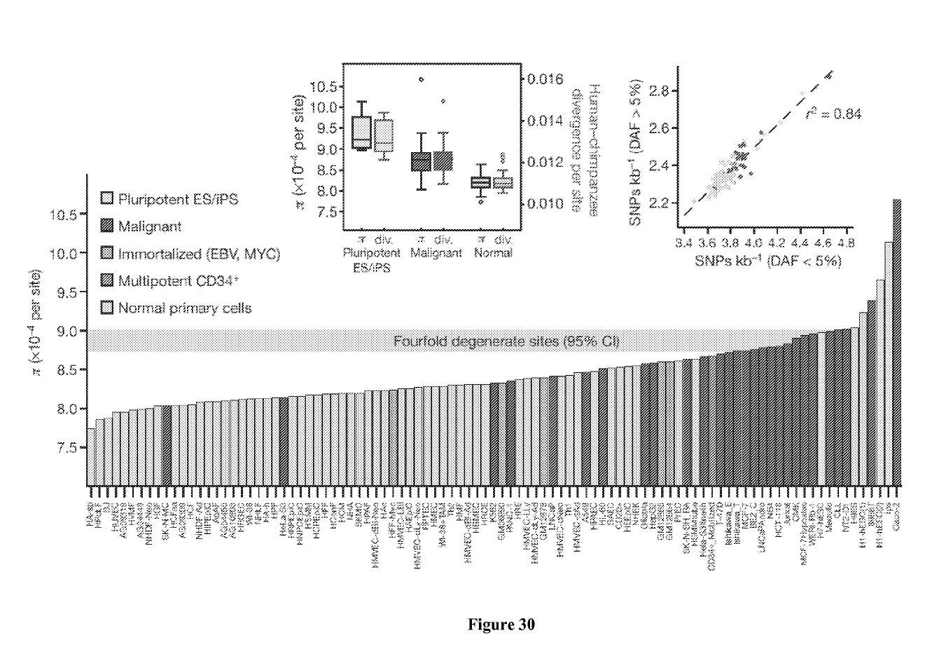

Overall, 94.4% of a combined 1,108,081 ChIP-seq peaks from all ENCODE transcription factors were found to fall within accessible chromatin (FIG. 28c and FIG. 30a), with the median factor having 98.2% of its binding sites localized therein. FIG. 30 illustrates the occupancies of different transcription factors within accessible chromatin. In FIG. 30a, the percentage of transcription factor binding sites within accessible chromatin was calculated for each factor. Accessible chromatin was identified using unthresholded hotspot calls on K562 DNaseI deep-seq data. Transcription factor binding sites were identified in K562 cells using ChIP-seq. Inserts show the aggregate DNaseI density profile (±2.5 kb of ChIP-seq peak) at sites for six different transcription factors that are within (red) and outside (blue) of accessible chromatin. See Methods, below. Notably, a small number of factors diverged from this paradigm, including known chromatin repressors, such as the KRAB-associated factors KAP1 (also called TRIM28), SETDB1 and ZNF274 (FIG. 28c). It was hypothesized that a proportion of the occupancy sites of these factors represented binding within compacted heterochromatin. To test this, targeted mass spectrometry assays were developed for KAP1 and three factors localizing almost exclusively within accessible chromatin (GATA1, c-Jun, NRF1), and quantified their abundance in biochemically defined heterochromatin against a total chromatin fraction (FIG. 30b). FIG. 30b illustrates the biochemical isolation of dense heterochromatin. This analysis confirmed that factors such as KAP1 show a significant level of heterochromatin occupancy (FIG. 30c). FIG. 30c illustrates that the proportion of chromatin-bound protein contained within heterochromatin was measured using targeted mass spectrometry for KAP1 (also called TRIM28), c-Jun and GATA1. Note that nearly 25% of nuclear KAP1 localises to highly compacted heterochromatin, vs. <5% for c-Jun and GATA1.

Methods.

DNaseI hypersensitivity mapping was performed as previously described in Example 14 herein.

DNaseI and Histone Modification Protocols.

DNaseI assays and histone modification were performed as previously described in Example 14 herein.

Dataset Availability.

Datasets used are available as previously described in Example 14 herein.

DHS Master List and its Annotation.

The DHS master list was compiled and annotated as previously described in Example 14 herein.

Dataset Availability.

The FDR 1% peaks by cell-type and the 125 cell-type master list are available as previously described in Example 14 herein.

Determining Relationships Between Sequence Motifs and Chromatin Accessibility.

To obtain the results shown in FIG. 29c, occurrences of motifs from the TRANSFAC database were identified by running FIMO on the GRCh37/hg19 reference sequence with a detection threshold of P<10⁻⁵. For each of the 125 DNaseI cell types each motif's association with chromatin accessibility was scored by dividing the mean intensity (DNaseI tag count) of DHSs containing that motif by the mean intensity of all DHSs identified in that cell type. The R package “beanplot” was used to visualise the distribution of this motif score across cell types.

ChIP-Seq Peaks and Chromatin Accessibility.

ENCODE transcription factor ChIP-seq peaks for K562 were called using a uniform procedure as described, and downloaded from the ftp site below. The presence or absence of ChIP-seq peaks within accessible chromatin was determined by overlap or non-overlap, respectively, of each peak with deep-seq DNaseI hotspots in K562 (overlap by any amount was counted). Deep-seq K562 hotspots were constructed by merging hotspots for UW K562 DGF (sequenced at approximately 115 million reads) and hotspots for Duke K562 combined replicates (approximately 38 million reads). Regular-depth K562 DNaseI tag density was used for the aggregate plots of FIG. 30a.

Dataset Availability.

Uniformly processed ChIP-seq peaks are available at, ftp://ftp.ebi.ac.uk/pub/databases/ensembl/encode/integration_data_j an2011/byDataType/peaks/jan2011/spp/optimal. The deep-seq K562 hotspots are available at, ftp://ftp.ebi.ac.uk/pub/databases/ensembllencode/integration_datajan2011/byDataType/openchrom/jan2011/combinedhotspots/DGF.

Quantification of the Percentage of Chromatin-Bound Protein.

The percentage of total nuclear protein bound to chromatin was measured. Briefly, K562 nuclei were isolated by resuspending cells at 2.5×106 cells/mL in 0.05% NP-40 (Roche) in Buffer A (15 mM Tris pH 9.0, 15 mM NaCl, 60 mM KCl, 1 mM EDTA pH 8.0, 0.5 mM EGTA pH 8.0, 0.5 mM Spermidine). After an 8-minute incubation on ice, nuclei were pelleted at 400 g for 7 minutes and washed once with Buffer A. Nuclei were then transferred to a 37° C. water bath and resuspended at 1.25×107 nuclei/mL in Isotonic Buffer (10 mM Tris pH 8.0, 15 mM NaCl, 60 mM KCl, 6 mM CaCl2, 0.5 mM Spermidine). After 3 minutes at 37° C., EDTA was added to a final concentration of 15 mM and the sample was transferred to ice. The soluble and insoluble fractions were separated by centrifugation at 400 g for 7 minutes. The total amount of nuclear protein that remained bound within the nuclei after this Isotonic Buffer wash was quantified using quantitative targeted proteomics (e.g., targeted mass spectrometry).

Quantification of the Percentage of Nuclear Protein Present within Heterochromatin.

The percentage of total nuclear protein present within heterochromatin was quantified. Briefly, K562 nuclei were isolated by resuspending cells at 2.5×106 cells/mL in 0.05% NP-40 (Roche) in Buffer A (15 mM Tris pH 9.0, 15 mM NaCl, 60 mM KCl, 1 mM EDTA pH 8.0, 0.5 mM EGTA pH 8.0, 0.5 mM Spermidine). After an 8-minute incubation on ice, nuclei were pelleted at 400 g for 7 minutes and washed once with Buffer A. Nuclei were then transferred to a 37° C. water bath and resuspended at 1.25×107 nuclei/mL in MNase Buffer (25 U/mL MNase [Worthington], 10 mM Tris pH 7.5, 10 mM NaCl, 1 mM CaCl2, 3 mM MgCl2, 0.5 mM Spermidine). After 3 minutes at 37° C., EDTA was added to a final concentration of 15 mM and the sample was transferred to ice. The soluble and insoluble fractions were separated by centrifugation at 400 rcf for 7 minutes. The pellet was resuspended in 80 mM Buffer B (10 mM Tris pH 8.0, 80 mM NaCl, 1.5 mM EDTA pH 8.0, 0.5 mM Spermidine), incubated at 4° C. for 1 hour while rocking and then centrifuged at 2000 rcf for 8 minutes. The pellet was then washed sequentially for 1 hour each with 150 mM Buffer B, 350 mM Buffer B and 600 mM Buffer B in a similar manner as the 80 mM Buffer B wash except that the concentration of NaCl in Buffer B was adjusted. All supernatant fractions were cleared by centrifugation at 10,000 rcf for 10 minutes and any insoluble material was discarded. The 350 mM and 600 mM solubilized fractions from MNase treated nuclei correspond to the heterochromatin fraction. The total amount of nuclear protein present within the 350 mM and 600 mM solubilized fractions was quantified using quantitative targeted proteomics, (e.g., targeted mass spectrometry). To calculate the percentage of chromatin bound protein present within heterochromatin, for each factor the total amount of nuclear protein present within heterochromatin was divided by the total amount of that protein bound to chromatin.

### Example 16

### An Invariant Directional Promoter Chromatin Signature

The annotation of sites of transcription origination continues to be an active and fundamental endeavor. In addition to direct evidence of TSSs provided by RNA transcripts, H3K4me3 modifications are closely linked with TSSs. Therefore, the relationship between chromatin accessibility and H3K4me3 patterns at well-annotated promoters, its relationship to transcription origination, and its variability across ENCODE cell types was systematically explored.

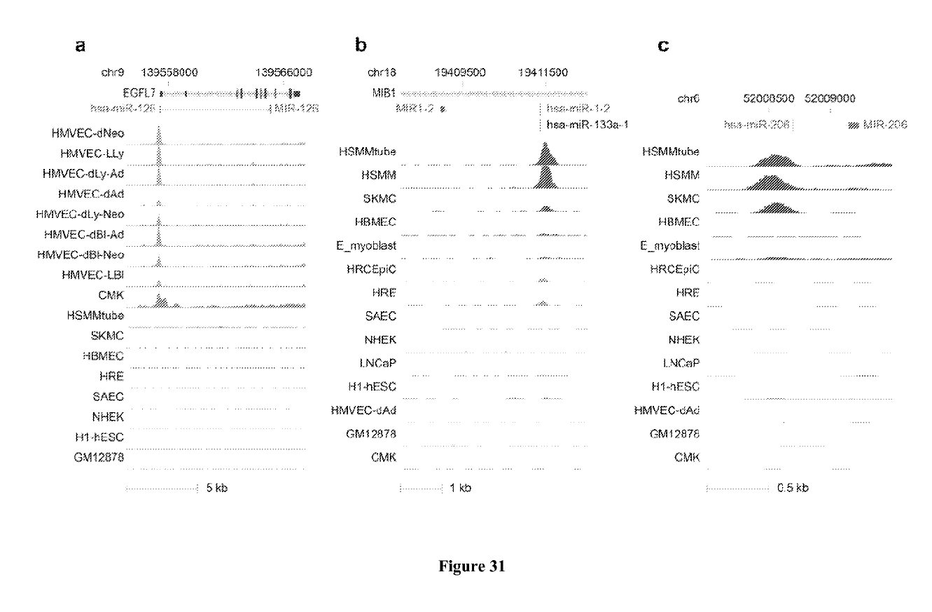

ChIP-seq for H3K4me3 was performed in 56 cell types using the same biological samples used for DNaseI data (Table 5, column D). Plotting DNaseI cleavage density against ChIP-seq tag density around TSSs reveals highly stereotyped, asymmetrical patterning of these chromatin features with a precise relationship to the TSS (FIG. 31a-b). FIG. 31 illustrates identification and directional classification of novel promoters. FIG. 31a illustrates DNaseI (blue) and H3K4me3 (red) tag densities for K562 cells around annotated TSS of ACTR3B. FIG. 31b illustrates averaged H3K4me3 tag density (red, right y axis) and log DNaseI tag density (blue, left y axis) across 10,000 randomly selected GENCODE TSSs, oriented 5′->3′. Each blue and red curve is for a different cell type, showing invariance of the pattern. This directional pattern is consistent with a rigidly positioned nucleosome immediately downstream from the promoter DHS, and is observed to be largely invariant across cell types (FIG. 31b and Thurman et al., 2012). In an exemplary case, the tag density for H3K4me3 and log tag density for DNaseI were averaged and centered across 10,000 randomly-selected GENCODE v7 TSSs and oriented with respect to the transcription direction. The stereotypical pattern of DNaseI and H3K4me3 around annotated promoters could be observed in each of the 56 cell-types for which both DNaseI and H3K4me3 data are available (Thurman et al., 2012).

To map novel promoters (and their directionality) not encompassed by the GENCODE consensus annotations, a pattern-matching approach was applied to scan the genome across all 56 cell types (Methods). Using this approach a total of 113,622 distinct putative promoters were identified. Of these, 68,769 corresponded to previously annotated TSSs, and 44,853 represented novel predictions (versus GENCODE v7). Of the novel sites, 99.5% were supported by evidence from spliced expressed sequence tags (ESTs) and/or cap analysis of gene expression (CAGE) tag clusters (FIG. 31c and Thurman et al., 2012, P<0.0001; see Methods). FIG. 31c illustrates the relation of 113,615 promoter predictions to GENCODE annotations, with supporting EST and CAGE evidence (bar at right). A further breakdown of novel promoter predictions with regard to their overlap separately with Gencode CAGE cluster TSS and RIKEN CAGE cluster TSS was also performed, demonstrating that 43.3% of predictions were supported by CAGE and/or EST for Gencode cluster TSS, and 99.4% were supported by CAGE and/or EST for RIKEN cluster TSS (Thurman et al., 2012), Both of these datasets are described in the Methods. Novel sites were found in every configuration relative to existing annotations (FIG. 31d-f and Thurman et al., 2012). FIG. 31d-f illustrate examples of novel promoters identified in K562; red arrow marks predicted TSS and direction of transcription, with CAGE tag dusters, spliced ESTs and GENCODE annotations above. FIG. 31d illustrates novel TSS confirmed by CAGE and ESTs. FIG. 31e illustrates novel TSS confirmed by CAGE, no ESTs. Note intronic location. FIG. 31f illustrates an antisense prediction within annotated gene. Additional exemplary novel promoters identified in K562 cells included a novel prediction confirmed by CAGE and ESTs, a novel prediction confirmed by CAGE annotation, no ESTs, antisense promoter predictions at 3′ end of annotated genes, and an antisense promoter prediction within GENCODE-annotated genes (Thurman et al., 2012). For example, 29,203 putative promoters are contained in the bodies of annotated genes, of which 17,214 are oriented antisense to the annotated direction of transcription, and 2,794 lie immediately downstream of an annotated gene's 3′ end, with 1,638 in antisense orientation. The results indicate that chromatin data can systematically inform RNA transcription analyses, and suggest the existence of a large pool of cell-selective transcriptional promoters, many of which lie in antisense orientations.

Methods.

DNaseI hypersensitivity mapping was performed as previously described in Example 14 herein.

DNaseI and Histone Modification Protocols.

DNaseI assays and histone modification were performed as previously described in Example 14 herein.

Dataset Availability.

Datasets used are available as previously described in Example 14 herein.

DHS Master List and its Annotation.

The DHS master list was compiled and annotated as previously described in Example 14 herein.

Dataset Availability.

The FDR 1% peaks by cell-type and the 125 cell-type master list are available as previously described in Example 14 herein.

Promoter DHS Identification Scheme.

The promoter DHS identification scheme consists of a joint analysis of DNaseI and H3K4me3 data. The analysis was focused on 56 cell-types for which joint data was available for both DNaseI and H3K4me3. The bulk of these cell-types were only studied by UW. For consistency therefore the analysis was restricted to UW datasets, even on those cell-types for which Duke and UW DNaseI data were both available. These 56 cell-types are indicated in Table 5. The promoter identification scheme proceeds as follows.

For a given cell-type, the 20th percentile D of the mean H3K4me3 density over a 550 bp window around GENCODE v7 promoters overlapping a DHS from that cell-type was computed. Within the set of promoters overlapping DHSs at the 20th percentile or greater for mean H3K4me3 signal, the ratio of the H3K4me3 signal flanking the DHS to the signal at the DHS was examined More specifically, for each selected promoter, the mean H3K4me3 signal DHS was computed over the 150 bp promoter; over the 200 bp window immediately to the left of the DHS; and over the 200 bp immediately to the right of the DHS. For each flank the ratio of the flanking mean to the DHS mean was then computed, and the greater of these two ratios retained. The 20th percentile across all selected promoters of these maximum ratios, R, was then found. To identify the “promoter DHS” from the pool of all DHSs within the given cell-type, all DHSs that have mean 550 bp windowed (centered on the DHS) H3K4me3 density ≧D were found next. Within that set of DHSs, all those that have ratio R′≧R, where R′ is the greater of the ratios of the mean H3K4me3 density in either of the flanking 200 bp windows to the mean H3K4me3 density over the DHS, were flagged. Note that the flanking window that gives the greater ratio also gives the prediction of the direction of the promoter.

A set of 113,615 unique, non-overlapping promoter predictions across 56 cell-types were generated as follows. First, all predictions for a given cell-type were partitioned into known-proximal and novel subsets. Known-proximal are all predictions within 1 kb upstream of annotated GENCODE v7 TSS. Novel subsets are all remaining predictions, filtered so that no two novel predictions are within 5 kb of another prediction (novel or known-proximal), with preference given to predictions with the greatest H3K4me3 flank ratio. Across cell-types, a set of unique novel predictions were generated by taking the union of all cell-type novel predictions and removing overlapping predictions, giving preference when there were overlaps to retaining the one with the greatest H3K4me3 flank ratio. This produced a total set of 44,853 unique novel predictions across cell-types. An all-cell-types known-proximal list was generated by taking all master-list DHSs that overlap any individual cell-type prediction that falls within 1 kb upstream of a GENCODE annotated TSS, resulting in a total of 68,762 known-proximal positions, and a grand total of 113,615 unique, non-overlapping promoter predictions.

For the pie chart in FIG. 31c, GENCODE coding and non-coding labels refer to the known-proximal predictions, with non-coding referring to any annotation with “RNA” in its biotype name, and coding referring to the remainder. The bar plot in the right portion of the panel further breaks down the novel predictions in terms of their supporting evidence by CAGE and EST annotations. For CAGE evidence a combination of GENCODE and RIKEN cluster TSSs was used. RIKEN cluster TSSs were downloaded from the UCSC test browser. For a given cell type clusters for all cell localizations were used, using PolyA+RNA. The overlaps shown here were relative to the pooling of RIKEN CAGE clusters for GM12878, K562, A549, Ag04450, H1Hesc, HelaS3, HepG2, and HUVEC cell types. GENCODE CAGE cluster TSSs are made available through the ENCODE consortium. Spliced ESTs were downloaded from the UCSC test browser. See Thurman et al., 2012 for the overlap of novel predictions with RIKEN and GENCODE cluster TSS measured separately.

Overlaps with CAGE were tested for significance as follows. 2,279 K562 novel predictions were focused on, for which

973 (43%) are within 1 kb of a GENCODE CAGE TSS

540 (24%) are within 100 bp of a GENCODE CAGE TSS

2,217 (97%) are within 1 kb of a RIKEN K562 CAGE tag

1,987 (87%) are within 100 bp of a RIKEN K562 CAGE tag

1,964 (86%) have a RIKEN K562 CAGE tag with the same orientation within 1 kb downstream

1,590 (70%) have a RIKEN K562 CAGE tag with the same orientation within 100 bp downstream

There are 142,986 total K562 DHSs. Of these, the 93,672 of these that are not novel predictions, and not within 2,500 bp of a known GENCODE TSS, were focused on. From this pool random samples of size 2,279 were chosen; in addition, a strand prediction was randomly assigned to each sample element, in the same ratio of positive to negative orientations as assigned in the observed predictions (1,149 positives, 1,130 negatives). 10,000 such samples were generated, and none of them has the degree of overlap in any of the six measures above as those of the novel predictions, for a P-value less than 0.0001 for each result. The mean and standard deviation (SD) of the random sample results for each overlap are as follows:

within 1 kb of a GENCODE CAGE TSS: mean=65, SD=8

within 100 bp of a GENCODE CAGE TSS: mean=23, SD=5

within 1 kb of RIKEN K562 CAGE tag: mean=1,702, SD=21

within 100 bp of RIKEN K562 CAGE tag: mean=994, SD=23

have a RIKEN K562 CAGE tag with the same orientation within 1 kb downstream: mean=906, SD=23

have a RIKEN K562 CAGE tag with the same orientation within 100 bp downstream: mean=518, SD=20

Dataset Availability.

Promoter predictions by cell-type, and unique novel and known predictions across cell-types available at, ftp://ftp.ebi.ac.k/pub/databases/ensembl/encode/integration_datajan2011/byDataType/openchrom/jan2011/promoter_predictions.

### Example 17

### Chromatin Accessibility and DNA Methylation Patterns

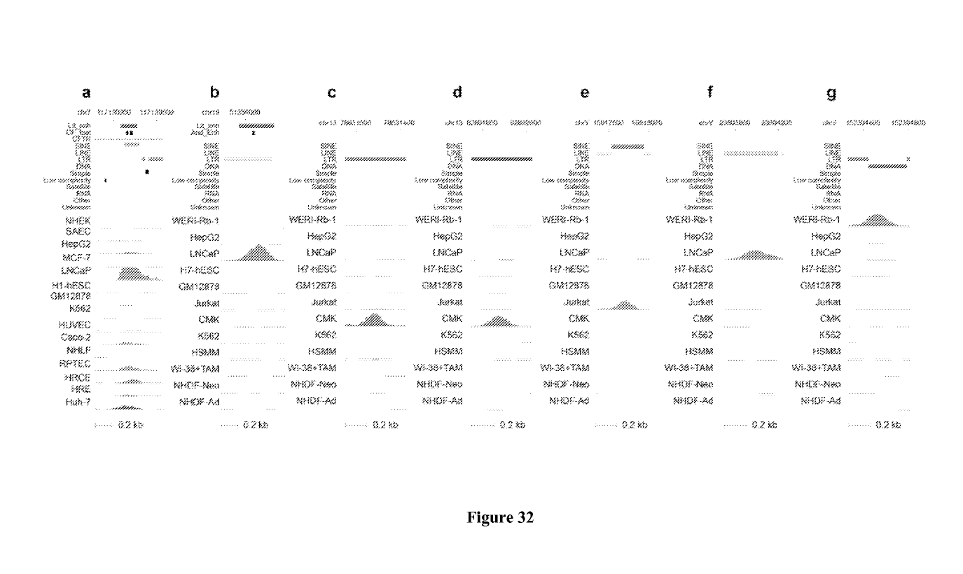

CpG methylation has been closely linked with gene regulation, based chiefly on its association with transcriptional silencing. However, the relationship between DNA methylation and chromatin structure has not been dearly defined. ENCODE reduced-representation bisulphite sequencing (RRBS) data was analyzed, which provide quantitative methylation measurements for several million CpGs. The focus was on 243,037 CpGs falling within DHSs in 19 cell types for which both data types were available from the same sample. Two broad classes of sites were observed: those with a strong inverse correlation across cell types between DNA methylation and chromatin accessibility (FIG. 32a and Thurman et al., 2012), and those with variable chromatin accessibility but constitutive hypomethylation (FIG. 32a, right). FIG. 32 illustrates chromatin accessibility and DNA methylation patterns. FIG. 32a illustrates DNaseI sensitivity in 10 cell types with ENCODE reduced representation bisulphite sequencing data. FIG. 32a, inset box, illustrates that accessibility (y axis) decreases quantitatively as methylation increases. A further exemplary analysis of associations between methylation and accessibility for 19 cell types at three different sites (chr16 q24.2, chr18 q21.1, and chr2 p13.3) demonstrated an inverse correlation between DNA methylation and chromatin accessibility as quantified by DNaseI density (Thurman et al., 2012). In FIG. 32a, right, other DHSs show low correlation between accessibility and methylation. CpG methylation scale: green, 0%; yellow, 50%; red, 100%. To quantify these trends globally, a linear regression analysis between chromatin accessibility and DNA methylation was performed at the 34,376 CpG-containing DHSs (see Methods). Of these sites, 6,987 (20%) showed a significant association (1% FDR) between methylation and accessibility, 10,300 (30%) did not have a significant association between methylation and accessibility, 16,281 (47%) were unmethylated in all cell types, and 808 (2%) were methylated in all cell types (Thurman et al., 2012). Increased methylation was almost uniformly negatively associated with chromatin accessibility (>97% of cases). The magnitude of the association between methylation and accessibility was strong, with the latter on average 95% lower in cell types with coinciding methylation versus cell types lacking coinciding methylation (Thurman et al., 2012). Fully 40% of variable methylation was associated with a concomitant effect on accessibility (Thurman et al., 2012).

The role of DNA methylation in causation of gene silencing is presently unclear. Does methylation reduce chromatin accessibility by evicting transcription factors? Or does DNA methylation passively ‘fill in’ the voids left by vacating transcription factors? Transcription factor expression is closely linked with the occupancy of its binding sites. If the former of the two above hypotheses is correct, methylation of individual binding site sequences should be independent of transcription factor gene expression. If the latter, methylation at transcription factor recognition sequences should be negatively correlated with transcription factor abundance (FIG. 32b). FIG. 32b illustrates a model of transcription factor (TF)-driven methylation patterns in which methylation passively mirrors transcription factor occupancy.

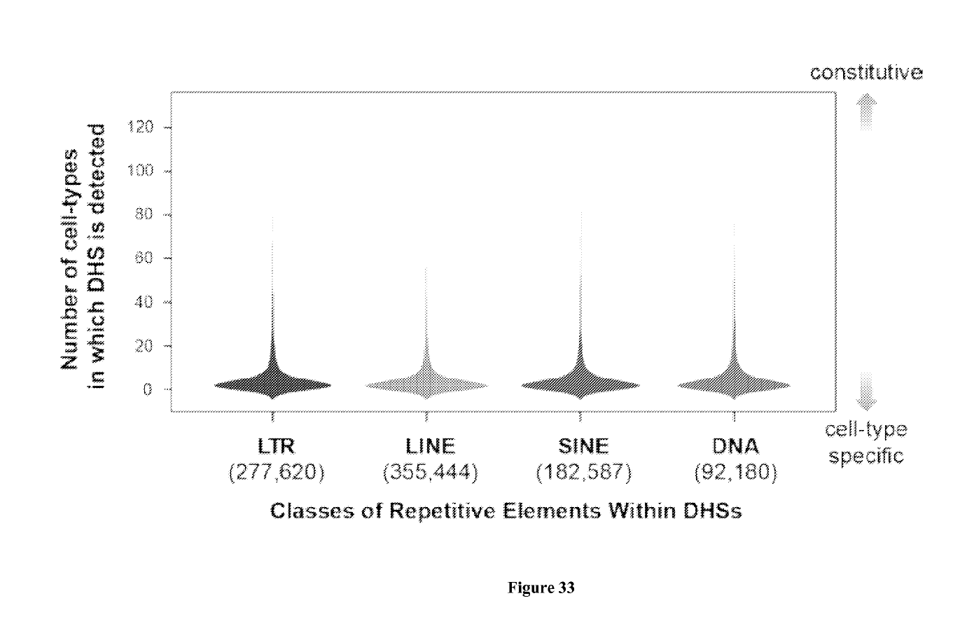

Comparing transcription factor transcript levels to average methylation at cognate recognition sites within DHSs revealed significant negative correlations between transcription factor expression and binding site methylation for most (70%) transcription factors with a significant association (P<0.05). Representative examples are shown in FIG. 32c and FIG. 33a. FIG. 32c illustrates a relationship between transcription factor transcript levels and overall methylation at cognate recognition sequences of the same transcription factors. Lymphoid regulators in B-lymphoblastoid line GM06990 are shown at left and erythroid regulators in the erythroleukaemia line K562 are shown at right. Negative correlation indicates that site-specific DNA methylation follows transcription factor vacation of differentially expressed transcription factors. FIG. 33a illustrates a relationship between TF transcript levels and overall methylation at cognate recognition sequences of the same TFs. Negative correlation indicates that site-specific DNA methylation follows TF vacation of differentially expressed TFs. Left, erythroid regulator in the erythroleukemia line K562; centre, hepatic regulators in the liver carcinoma HepG2; and right, lymphoid regulator in the B lymphoblast line GM06990. These data argued strongly that methylation patterning paralleling cell-selective chromatin accessibility results from passive deposition after the vacation of transcription factors from regulatory DNA, confirming and extending other recent reports

Interestingly, a small number of factors showed positive correlations between expression and binding site methylation (FIG. 33b), including MYB and LUN-1 (also known as TOPORS). FIG. 33b illustrates that MYB and LUN-1 (also called TOPORS) have both been demonstrated to interact with promyelocytic leukemia (PML) bodies, and show increased transcription and binding site methylation in the acute promyelocytic leukemia (APL) line NB4. Although Myb expression is upregulated in both erythroid K562 and the APL line NB4 (green arrows), its putative binding sites exhibited altered methylation only in the APL line NB4. Both of these transcription factors showed increased transcription and binding site methylation specifically within acute promyelocytic leukaemia cells (NB4), and both interact with promyelocytic leukaemia (PML) bodies, a sub-nuclear structure disrupted in PML cells. The anomalous behaviour of these two transcription factors with respect to chromatin structure and DNA methylation may thus be related to a specialized mechanism seen only in pathologically altered cells.

Methods.

DNaseI hypersensitivity mapping was performed as previously described in Example 14 herein.

DNaseI and Histone Modification Protocols.

DNaseI assays and histone modification were performed as previously described in Example 14 herein.

Dataset Availability.

Datasets used are available as previously described in Example 14 herein.

DHS Master List and its Annotation.

The DHS master list was compiled and annotated as previously described in Example 14 herein.

Dataset Availability.

The FDR 1% peaks by cell-type and the 125 cell-type master list are available as previously described in Example 14 herein.

RNA Expression.

For each cell line, total RNA was extracted in 2 replicates from 5×10⁶ cells using Ribopure (Ambion) according to manufacturer's instructions. RNA quality was ascertained using RNA 6000 Nano Chips on a bioanalyzer (Agilent, Santa Clara, Calif.). Approximately 3 μg of total RNA for each sample was used for labeling and hybridization (University of Washington Center for Array Technology) to Affymetrix Human Exon 1.0 ST arrays (Affymetrix) using a standard protocol. Exon expression data were analyzed through Affymetrix Expression Console using gene-level RMA summarization and sketch-quantile normalization method. Measurements from both replicates were then averaged. Raw data have been deposited in GEO under accession number GSE19090.

RRBS Genome-Wide Methylation Profiling.

RRBS methylation data for 19 cell lines was downloaded from the “HAIB Methyl RRBS” track of the UCSC Genome Browser. To measure methylation in each cell line, counts for both strands in both replicates were combined and CpGs with <8× coverage removed. Only CpGs monitored in at least 6 samples were retained.

A linear regression was applied to measure whether methylation status is associated with accessibility. First, a master list of DHSs found in any of the 19 cell lines was generated. Accessibility was then regressed onto the average proportion methylated of all monitored CpGs in a 150 bp region centered around the DNaseI peak. Only sites with both RRBS data for at least one CpG within the 150 bp window and ChIP-seq data for at least 6 cell lines were tested. Sites where the number of monitored CpGs differed by more than 4 among any two cell lines were excluded. A linear regression was performed at each remaining site, the R package qvalue was used to estimate a global FDR.

To assess the relationship between expression and TFBS methylation, a set of putative binding sites for transcription factors was determined, based on matches to database motifs inside the 6,987 DHSs where methylation was significantly associated with accessibility (see Thurman et al., 2012 for the mapping used from TRANSFAC motif names to gene names). For each transcription factor, the average methylation at all of these motif instances was regressed onto the gene expression in each immortal cell type. Only motif models including a CpG were tested.

### Example 18

### A Genome-Wide Map of Distal DHS-to-Promoter Connections

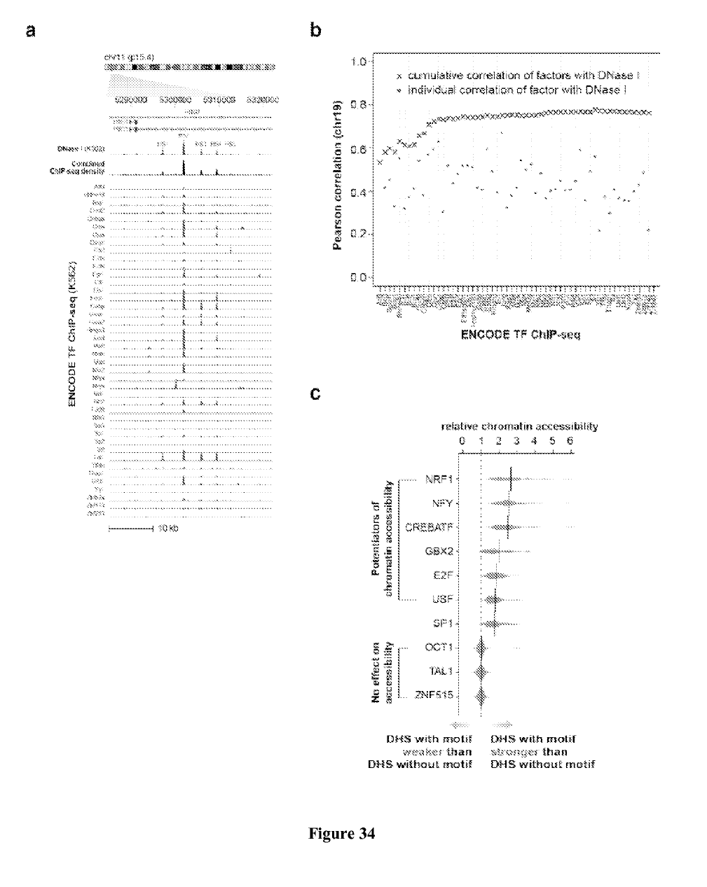

From examination of DNaseI profiles across many cell types many known cell-selective enhancers were observed to become DHSs synchronously with the appearance of hypersensitivity at the promoter of their target gene (FIG. 34). FIG. 34 illustrates cell-specific enhancers (red arrows) in the IFNG locus Enhancers of the IFNG gene are marked by DHSs in the hTH1 (T lymphocyte) cell-type, consistent with the functioning of lymphocytes in producing the gene product interferon gamma. The enhancer loci are lacking in DHSs in other cell-types. Shown are DNaseI tag densities for six cell-types, including hTH1. See Thurman et al., 2012 for IFNG enhancer coordinates and references.

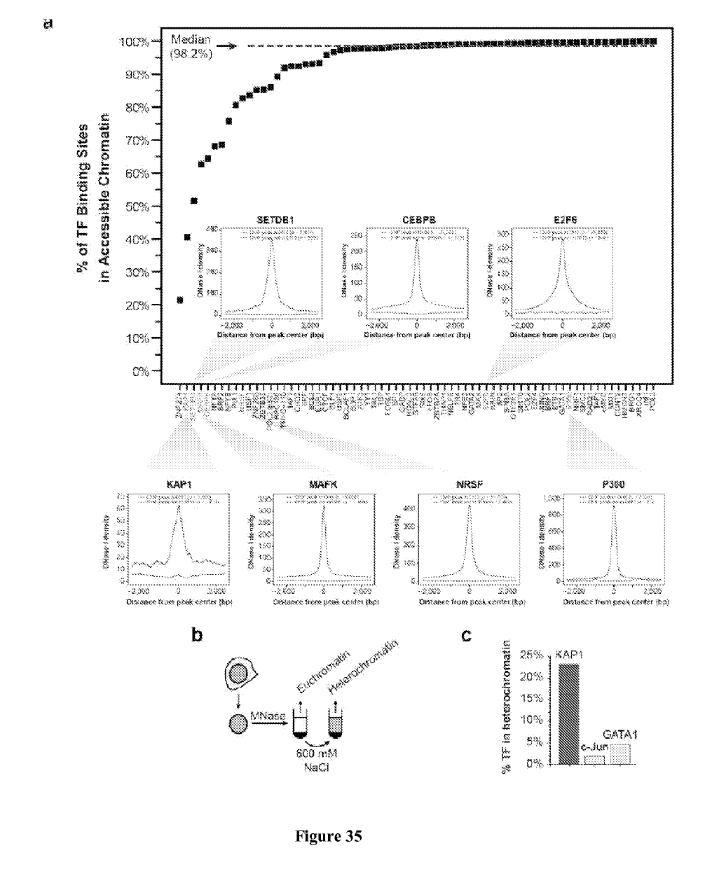

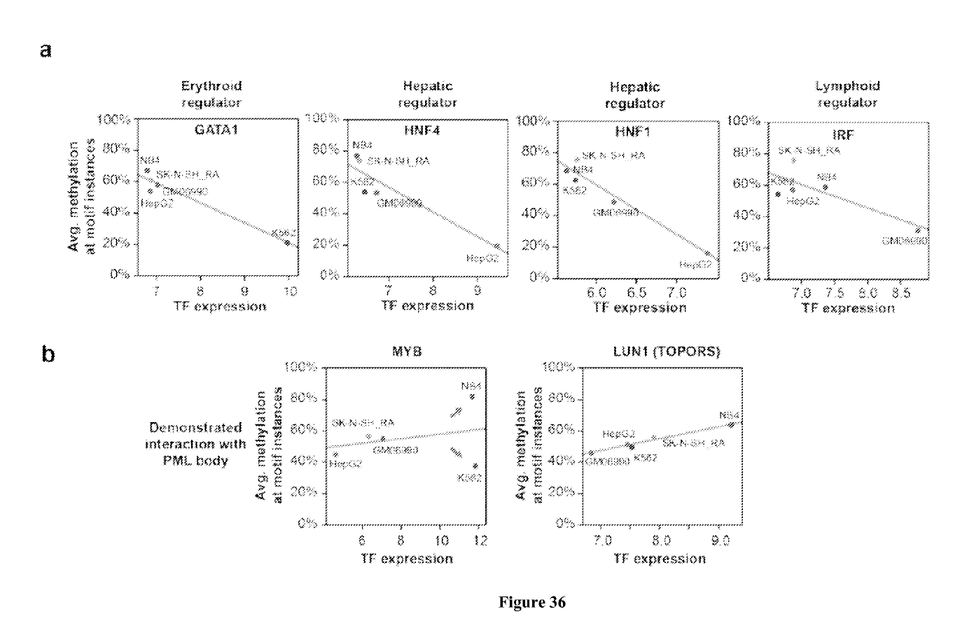

To generalize this, the patterning of 1,454,901 distal DHSs (DHSs separated from a TSS by at least one other DHS) across 79 diverse cell types was analyzed (Methods and Table 6), and the cross-cell-type DNaseI signal at each DHS position correlated with that at all promoters within +500 kb (FIG. 35a). FIG. 35 illustrates enrichments of 5C interactions, ChIA-PET interactions, and gene ontology classes revealed by signal-vector correlation. In FIG. 35a, each of 1,524,865 DHSs is treated as a vector of DNaseI densities across cell types. High correlations between vectors for promoter/distal DHS pairs separated by <500 kb identify DHSs likely co-regulated with specific promoters. A total of 578,905 DHSs that were highly correlated (r>0.7) with at least one promoter (P<10⁻¹⁰⁰) were identified, providing an extensive map of candidate enhancers controlling specific genes (Methods and Thurman et al., 2012). To validate the distal DHS/enhancer-promoter connections, chromatin interactions were profiled using the chromosome conformation capture carbon copy (5C) technique. For example, the phenylalanine hydroxylase (PAH) gene is expressed in hepatic cells, and an enhancer has been defined upstream of its TSS (FIG. 36a). FIG. 36 illustrates a genome-wide map of distal DHS-to-promoter connectivity. FIG. 36a illustrates that cross-cell-type correlation (red arcs, left y axis) of distal DHSs and PAH promoter closely parallels chromatin interactions measured by 5C-seq (blue arcs, right y axis); black bars indicate HindIII fragments used in 5C assays. Known (green) and novel (magenta) enhancers confirmed in transfection assays are shown below. Enhancer at far right is not separable by 5C as it lies within the HindIII fragment containing the promoter. The correlation values for three DHSs within the gene body were observed to closely parallel the frequency of long-range chromatin interactions measured by 5C. The three interacting intronic DHSs cloned downstream of a reporter gene driven by the PAH promoter all showed increased expression ranging from three- to tenfold over a promoter-only control, confirming enhancer function.

TABLE 6
Grouping of 79 cell types into 32 cell-type categories,
for exploration of cis-connectivity among DHSs. The grouping
was obtained by hierarchically clustering the cell types
by their DHS locations across the genome. Descriptions
of the cell types are given in Table 5.

| Category | |
|---|---|
| number | Cell types assigned to category |
| 1 | WERI_Rb1 |
| 2 | BE_2_C |
| 3 | CACO2, HEPG2, SKNSH |
| 4 | HESC, hESCT0 |
| 5 | A549, HCT116, Hela, PANC1 |
| 6 | LNCap, MCF7 |
| 7 | CD56, CD4, hTH1, hTH2 |
| 8 | GM06990, GM12864, GM12865, GM12878 |
| 9 | CD34, Jurkat |
| 10 | K562, CMK |
| 11 | NB4, HL60, CD14 |
| 12 | HRGEC, HMVEC_LBI, HMVEC_dLyNeo, |
| | HMVEC_dBlAd, HMVEC_dBlNeo, |
| | HUVEC |
| 13 | HMVEC_LLy, HMVEC_dLyAd, HMVEC_dNeo |
| 14 | NHLF, NHA |
| 15 | HAc |
| 16 | HAsp |
| 17 | HVMF |
| 18 | HAEpiC |
| 19 | WI_38, AG04450, IMR90 |
| 20 | SkMC |
| 21 | HCFaa |
| 22 | HIPEpiC, HNPCEpiC, HCPEpiC, HBMEC |
| 23 | HSMM, HSMM_D |
| 24 | HCM, HCF, HPAF |
| 25 | AG10803, AG09309, BJ, AG04449, HFF |
| 26 | NHDF_Neo, NHDF_Ad |
| 27 | HPF, HConF, HMF, AoAF |
| 28 | HGF, AG09319, HPdLF |
| 29 | RPTEC, HRCE, HRE |
| 30 | HRPEpiC |
| 31 | HMEC, NHEK |
| 32 | SAEC, HEEpiC |

Next, the comprehensive promoter-versus-all 5C experiments performed over 1% of the human genome in K562 cells was examined. DHS-promoter pairings were markedly enriched in the specific cognate chromatin interaction (P<10⁻¹³, FIG. 35b). FIG. 35b illustrates distributions of maximal correlation scores for DHSs falling within independently ascertained peak interacting restriction fragments by 5C-seq (gold) vs. non-peak fragments (grey) for TSS-vs-all distal 5C-seq data collected over 1% of the human genome defined by ENCODE Pilot regions. DHSs with high promoter correlation by cross-cell-type analysis show significantly increased chromatin interactions with the predicted cognate promoter (P<10⁻¹³). K562 promoter-DHS interactions detected by polymerase II chromatin interaction analysis were also examined with paired-end tag sequencing (ChIA-PET), which quantifies interactions between promoter-bound polymerase and distal sites. The ChIA-PET interactions were also markedly enriched for DHS-promoter pairings (P<10⁻¹⁵, FIG. 35c). FIG. 35c illustrates the distribution of correlation scores for K562 chromatin interaction analysis with paired-end tag sequencing (ChIA-PET) peak interactions in which both tags are in a K562 DHS and the tags are at least 10 kb apart (gold). Correlation scores for a random control set generated by scrambling the inter-tag distances while keeping the promoter tags fixed are shown in grey; as a group, these are significantly lower than the observed scores (P<2.2×10-16). Together, the large-scale interaction analyses affirmed the fidelity of DHS-promoter pairings based on correlated DNase1 sensitivity signals at distal and promoter DHSs.

Most promoters were assigned to more than one distal DHS, indicating the existence of combinatorial distal regulatory inputs for most genes (FIG. 36b and Thurman et al., 2012). FIG. 36b, left, illustrates proportions of 69,965 promoters correlated (r>0.7) with 0 to >20 DHSs within 500 kb. FIG. 36b, right, illustrates proportions of 578,905 non-promoter DHSs (out of 1,454,901) correlated with 1 to >3 promoters within 500 kb. K562 promoter-DHS interactions detected by polymerase II chromatin interaction analysis were also examined with paired-end tag sequencing (ChIA-PET), which quantifies interactions between promoter-bound polymerase and distal sites. A similar result is forthcoming from large-scale 5C interaction data. Surprisingly, roughly half of the promoter-paired distal DHSs were assigned to more than one promoter (FIG. 36b and Methods), indicating that human cis-regulatory circuitry is significantly more complicated than previously anticipated, and may serve to reinforce the robustness of cellular transcriptional programs.

The number of distal DHSs connected with a particular promoter provides, for the first time, a quantitative measure of the overall regulatory complexity of that gene. It was asked whether there are any systematic functional features of genes with highly complex regulation. All human genes were ranked by the number of distal DHSs paired with the promoter of each gene, then a Gene Ontology analysis was performed on the rank-ordered list. The most complexly regulated human genes were found to be markedly enriched in immune system functions (FIG. 35d), indicating that the complexity of cellular and environmental signals processed by the immune system is directly encoded in the cis-regulatory architecture of its constituent genes. FIG. 35d illustrates Gene Ontology analysis performed on a list of all human genes with promoters connected to at least one DHS, ranked by the numbers of DHSs connected with each promoter. Shown is an unfiltered list of GO Biological Processes with P<10⁻⁸, indicating overwhelming enrichment of immune-related genes among genes with the most complex distal regulatory landscapes.

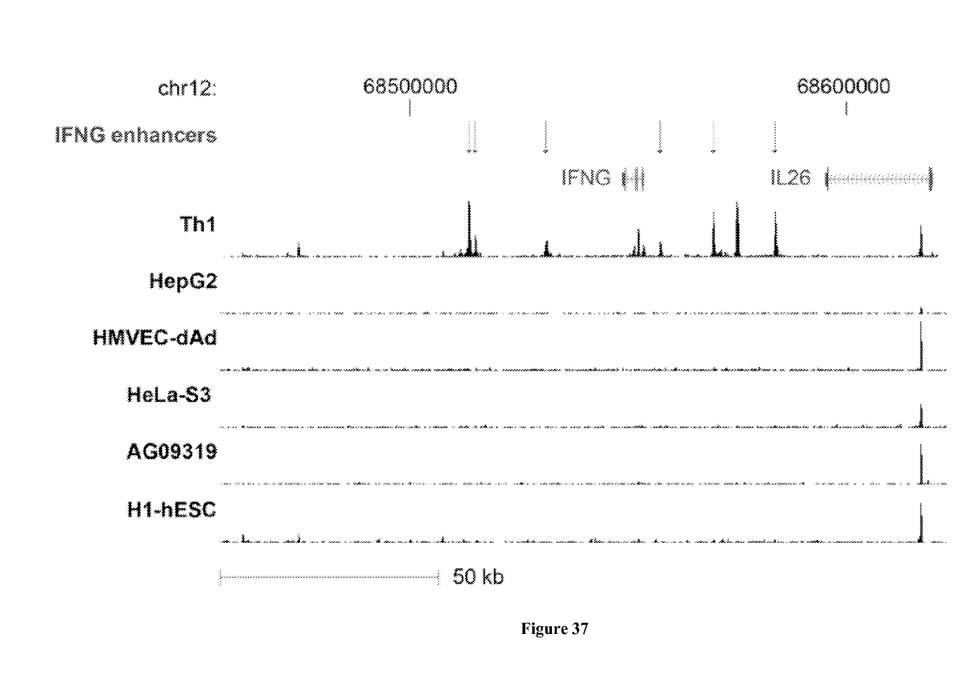

Next, it was asked whether DHS-promoter pairings reflected systematic relationships between specific combinations of regulatory factors (Methods). For example, KLF4, SOX2, OCT4 (also called POU5F1) and NANOG are known to form a well-characterized transcriptional network controlling the pluripotent state of embryonic stem cells. Significant enrichment (P<0.05) of the KLF4, SOX2 and OCT4 motifs within distal DHSs correlated with promoter DHSs containing the NANOG motif; enrichment of NANOG, SOX2 and OCT4 distal motifs co-occurring with promoter motif OCT4; and enrichment of distal SOX2 and OCT4 motifs with promoter SOX2 motifs (FIG. 37a) were found. FIG. 37 illustrates the statistical significance of co-occurrences of motifs and families and classes of motifs within connected (r>0.8) distal/promoter DHS pairs genome-wide. FIG. 37a illustrates co-occurrences among motifs for pluripotency factors KLF4, SOX2, OCT4, and NANOG. Enriched co-occurrences are denoted by arrows shaded by P-value. By contrast, promoters containing KLF4 motifs were associated with KLF4-containing distal DHSs, but not with DHSs containing NANOG, SOX2 or OCT4 motifs (FIG. 37a, bottom).

Significant co-associations between promoter types (defined by the presence of cognate motif classes; see Methods) and motifs in paired distal DHSs (FIG. 36c and FIG. 37b-c) were also tested. FIG. 36c illustrates pairing of canonical promoter motif families with specific motifs in distal DHSs. FIG. 37b-c illustrate co-occurrences of families and classes of motifs. Family and class definitions are given in Thurman et al., 2012. In (b), the motif families and classes are shown in alphabetical order. The matrix is clearly not symmetric; for example, within co-occurrences, TATA/TBP was observed to be enriched in several cases when it appeared in a promoter DHS, but in only a few cases when it appeared in a correlated distal DHS. Panel (c) shows the data from (b), hierarchically clustered by column and row. The DAX, FTZ-F1, RXR-like, Steroid Hormone Receptors, and Thyroid Hormone Receptor-like families, which all belong to the same class, clustered tightly together by rows (presence within promoter DHSs). For example, when a member of the ETS domain family (motifs ETS1, ETS2, ELF1, ELK1, NERF (also called ELF2), SPIB, and others) was present within a promoter DHS, motif PU.1 (also called SPI1) was significantly more likely to be observed in a correlated distal DHS (P<10⁻⁵). These results suggested that a limited set of general rules may govern the pairing of co-regulated distal DHSs with particular promoters.

Methods.

DNaseI hypersensitivity mapping was performed as previously described in Example 14 herein.

DNaseI and Histone Modification Protocols.

DNaseI assays and histone modification were performed as previously described in Example 14 herein.

Dataset Availability.

Datasets used are available as previously described in Example 14 herein.

DHS Master List and its Annotation.

The DHS master list was compiled and annotated as previously described in Example 14 herein.

Dataset Availability.

The FDR 1% peaks by cell-type and the 125 cell-type master list are available as previously described in Example 14 herein.

Connectivity Between Promoter DHSs and Distal DHSs.

For these analyses, the DNaseI tag densities from 79 diverse cell types were collapsed into aggregate densities within 32 categories of biologically similar cell types (Table 6), and called consensus DHSs from these densities. The 32 categories were chosen by hierarchically clustering the genomewide “present/absent” binary DHS vectors for the 79 cell types. For this part of the study, a promoter DHS was defined to be the consensus DHS overlapping a gene's TSS or nearest its TSS in the 5′ direction. 69,965 distinct promoter DHSs were identified across the human genome, using the collection of TSSs in GENCODE. A vector of aggregate DNaseI tag densities within each of the 32 categories was created for each promoter DHS. Similarly, 32-element tag-density vectors were constructed for each of 1,454,901 consensus non-promoter DHSs located within 500 kb of a promoter DHS. A promoter/distal DHS pair is defined to be “connected” if the Pearson correlation coefficient between the DHSs' tag-density vectors is 0.7 or higher. Where indicated, a correlation threshold of 0.8 was used for some analyses within this section. Thurman et al., 2012 contains the full set of promoter/distal DHS pairs connected at correlation threshold 0.7.

The observed distribution of correlations was compared with that of a null model in which two DHSs that lie on different chromosomes were chosen at random, their cell-type category labels shuffled, their correlation computed, and this process repeated 1,500,000 times. Using this null, the probability of observing a correlation >0.7 due to random chance alone was estimated to be 0.0102, 1,454,901 non-promoter DHSs that were each within 500 kb of at least one of 69,965 promoter DHSs were observed; a total of 42,874,775 correlations were computed for all such promoter/distal DHS pairs, and 1,595,025 of them were observed to exceed 0.7, for an empirical probability of 0.0372 of observing a correlation >0.7, more than three times the probability within the null model. Using a binomial, the P-value for observing 1,595,025 or more correlations >0.7 out of 42,874,775, under this null, was estimated to be less than 10-100. These 1.6 million high correlations were distributed among 578,905 distinct distal DHSs. The null model also shows that the promoters have more putative regulatory inputs than would be expected by random-chance assignments. Each promoter was found to be correlated with an average of 22.8 distal DHSs, with 84% of promoters correlated with multiple DHSs. The null model predicts an average of only 6.2 correlated DHSs per promoter, with only 67% of promoters correlated with two or more DHSs

Analysis of 5C and ChIA-PET Data.

For the analysis referenced in FIG. 36a, 5C sequence reads were mapped to forward-reverse fragment pairs; raw data for only the highest read count interactions is displayed. Four enhancer sites match strong DHSs in the PAH region. The three intronic DHSs shown in FIG. 36a were tested by cloning these into pGL4.10[luc2], with the PAH promoter driving luciferase expression. Each of these three DHSs was found to stimulated PAH expression over twofold compared to the promoter-only construct. The site upstream of the promoter lies within the promoter HindIII fragment, and thus was not tested in the 5C experiments; however, this DHS has previously been implicated as an enhancer of PAH activity (see Thurman et al., 2012 for source).

FDR 1% peak interactions have been identified in several segments from the ENCODE pilot regions. The subset of 5C peak interactions from K562 which contained at least one K562 DHS in the reverse (non-promoter) restriction fragment were used to obtain a distribution of maximal correlation scores for peak interactions; each peak interaction was assigned the highest correlation score observed within all promoter/distal DHS pairs in which the promoter DHS overlapped the forward fragment and the distal DHS overlapped the reverse fragment. This distribution of scores was compared to that of the highest-scoring DHS pairs for an interaction distance-matched control fragment for each of the peaks by applying a one-sided Mann-Whitney test to the medians of the distributions (FIG. 35b).

The set of interactions detected via ChIA-PET in K562 cells in an earlier study was filtered for interactions in which each tag overlapped a K562 DHS after padding by 100 bp on either side of the tag start. Correlation scores for interactions in which the ChIA-PET tags were at least 10 kb apart were tabulated. A control set was created by using the same distance distribution as the K562 ChIA-PET set and associating each original promoter site with a new simulated DHS. The set of correlation scores for the genome was filtered and, if a correlation score for the distance had been observed, it was added to the control distribution. The shuffling was repeated until the control set had the same number of observations as the experimental set. The distributions were compared using a one-sided Mann-Whitney test (FIG. 35c).

Gene Ontology Analysis of DHSs.

To perform the analysis referenced in FIG. 35d, all GENCODE genes were ranked in descending order by the number of distal DHSs within ±500 kb correlated with their promoter DHSs at a threshold of 0.7; for genes with multiple TSSs implicating multiple distinct promoter DHSs, the promoter DHS with the highest number of connected distal DHSs was chosen. The rank-ordered list was used as input for a gene ontology analysis using GOrilla; the search terms used are listed in Thurman et al., 2012.

Analysis of sequence motif pairs co-occurring in promoters and connected DHSs.

FIMO was used to identify all TRANSFAC motifs present in DHSs at confidence level P<10⁻⁵. The collection of all promoter DHSs across the genome was taken, and for each one, (1) the number of distinct motifs detected within it, (2) which motifs, if any, these were, and (3) the number of non-promoter DHSs within 500 kb achieving correlation >0.8 with it were recorded. The collection of all non-promoter DHSs across the genome was then taken, which tends to be narrower than promoter DHSs, and for each one, (1) and (2) was recorded. Together, these enabled the creation of random promoter/distal motif pairs matched to the observed data.

Simulating Random, Matched Motif Data.

Specifically, the asymmetric square matrix (732 motifs×732 motifs) of observed promoter/distal motif co-occurrence counts were recorded, and two identically-sized matrices were created, each initialized to all zeroes. For each promoter DHS p containing mₚ motifs and connected to dₚ DHSs with correlation >0.8, mₚ motifs from the observed distribution of motifs in promoter DHSs were sampled (without replacement), and dₚ independent samples were taken (with replacement) from the observed distribution of the number of motifs per distal DHS. (mₚ and dₚ were sometimes zero.) Then for each of the dₚ numbers drawn, that number of motifs was sampled from the observed distribution of motifs in distal DHSs. (Each of the dₚ independent samples was performed without replacement; replacement was allowed across independent samples. Some of the dₚ sample sizes were zero.) All pairwise co-occurrences within the collections of sampled promoter motifs and distal motifs were tallied, while retaining the promoter and distal labels, and these tallies were added to the matrix of simulated random observations. After the tallies of random motif co-occurrences were accumulated within the random-matched matrix for all promoter DHSs, each observed co-occurrence count was compared with each random-matched co-occurrence count, and 1 was added to the corresponding cell in the third matrix whenever the random-matched co-occurrence count was at least as large as the observed one. After performing one replicate randomization, this third, “tally” matrix consisted entirely of zeroes and ones.

P-Value Estimation for Co-Occurrences of Motifs and Families of Related Motifs.

This full procedure was repeated 100,000 times, which gave a tally matrix whose tallies for specific motif co-occurrences ranged from 0 to 100,000. From this, an empirical P-value was obtained for each observed motif co-occurrence (i.e., for each nonzero element of the observation matrix) as the corresponding tally matrix element divided by 100,000. After obtaining P-values for co-occurrences of specific TRANSFAC motifs such as GKLF_{—}02 within promoter DHSs and USF_Q6_{—}01 within distal DHSs, it was investigated whether various groupings of specific motifs co-occur significantly often. Grouping motifs were explored by their “pre-underscore strings,” e.g., pooling BCL6_{—}01, BCL6_{—}02, BCL6_Q3 into “BCL6,” and grouping them into families and classes defined by the structures of their associated proteins, e.g., pooling AFP1_Q6 and HOMEZ_{—}01 into the “homeo domain with zinc-finger motif” family, or pooling HOX-like, NK-like, TALE-type and other homeo-domain factor families into the “homeo domain” class. (The family and class definitions used, given in Thurman et al. 2012, were adapted from http://www.edgar-wingender.de/huTF_classification.html, a web page actively maintained by Prof Edgar Wingender, a co-founder and current board member of BIOBASE GmbH, which maintains the TRANSFAC database.) To compute empirical P-values for groupings of specific motifs, specific motifs were randomly sampled as described above, but the observed and random motif co-occurrences were summed within the groupings of the specific motifs (e.g., any of BCL6_{—}01, BCL6_{—}02, BCL6_Q3 within a distal DHS co-occurring with either of AFP1_Q6 and HOMEZ_{—}01 within a promoter DHS), and for each group×group co-occurrence, its P-value was estimated as the number of replicate data sets in which at least as many co-occurrences were present in the random matched data as in the observed data, divided by the number of replicates. FIG. 37b-c illustrates enrichment of co-occurrences within 42 families and classes of motifs. The P-value matrix is clearly not symmetric (FIG. 37b). Reassuringly and interestingly, closely-related motif families cluster together by membership in promoter DHSs (matrix rows, FIG. 37c).

### Example 19

### Stereotyped Chromatin Accessibility Parallels Function

In addition to the synchronized activation of distal DHSs and promoters described above, a surprising degree of patterned co-activation was observed among distal DHSs, with nearly identical cross-cell-type patterns of chromatin accessibility at groups of DHSs widely separated in trans (Thurman et al., 2012). In an exemplary case analyzing four cell types (immortal cells (pluripotent cells and cancer cell lines; hematopoietic cells; endothelial cells; epithelial, stromal, and visceral cells), stereotyping of DHSs was observed with a nearly identical cross-cell-type pattern of chromatin accessibility at DHS positions for groups of DHSs widely separated in trans (Thurman et al., 2012). Three exemplary patterns and the top 30 genomic site matches to two of them identified by a DNaseI pattern matching algorithm (see Methods) are found in Thurman et al., 2012. For many patterns, tens or even hundreds of like elements were observed around the genome. The simplest explanation is that such co-activated sites share recognition motifs for the same set of regulatory factors. It was found, however, that the underlying sequence features for a given pattern were surprisingly plastic. This suggests that the same pattern of cell-selective chromatin accessibility shared between two DHSs can be achieved by distinct mechanisms, probably involving complex combinatorial tuning

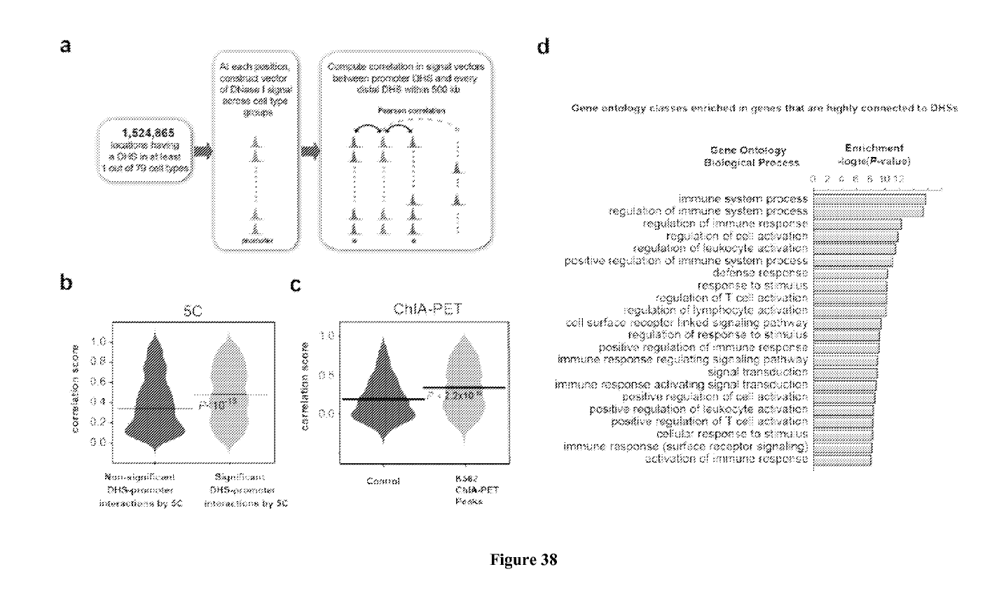

Next, it was asked whether distal DHSs with specific functions such as enhancers exhibited stereotypical patterning, and whether such patterning could highlight other elements with the same function. One of the best-characterized human enhancers, DNaseI HS2 of the (3-globin locus control region, was examined. HS2 is detected in many cell types, but exhibits potent enhancer activity only in erythroid cells. Using a pattern-matching algorithm (see Methods) additional DHSs were identified with nearly identical cross-cell-type accessibility patterns (FIG. 38a). FIG. 38 illustrates stereotyped regulation of chromatin accessibility. FIG. 38a-e illustrates enhancers grouped by similar chromatin stereotypes. Related cell lines are color matched. HS2 from the β-globin locus control region is at left. El-Ell represent progressively weaker matches to the HS2 stereotype. E12-13 derive from matches to a different stereotype based on another K562 enhancer. FIG. 38f illustrates experimental validation of enhancers detected by pattern matching. Bars indicate fold enrichment observed in transient assays in K562 relative to promoter-only control; mean of testing in both orientations is shown. Red bars indicate data from two potent in vivo enhancers, β-globin LCR HS2 and HS3; the latter requires chromatinization to function and is not active in transient assays. Gold bars indicate data from E1-E13 from (a)-(e) above.

20 elements across the spectrum of the top 200 matches to the HS2 pattern were selected, and these were tested in transient transfection assays in K562 cells (Methods). Seventy percent (14 of 20) of these displayed enhancer activity (mean 8.4-fold over control) (FIG. 38a, f). Of note, one (E3) showed a greater magnitude of enhancement (18-fold versus control) than HS2, which is itself one of the most potent known enhancers. Next three elements were selected from the 14 HS2-like enhancers, pattern matching (Methods) was applied to each to identify stereotyped elements, and samples of each pattern were tested for enhancer activity, revealing additional K562 enhancers (total 15 of 25 positive) (FIG. 38b-d, f). In each case, therefore, enhancers were able to be discovered by simply anchoring on the cross-cell-type DHS pattern of an element with enhancer activity. Collectively, these results show that co-activation of DHSs reflected in cross-cell-type patterning of chromatin accessibility is predictive of functional activity within a specific cell type, and suggest more generally that DHSs with stereotyped cellular patterning are likely to fulfill similar functions.

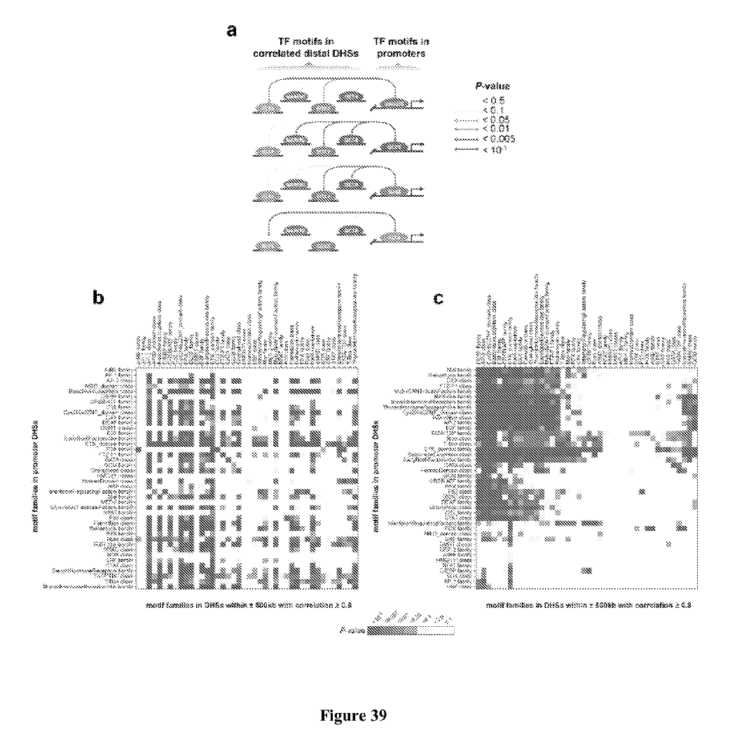

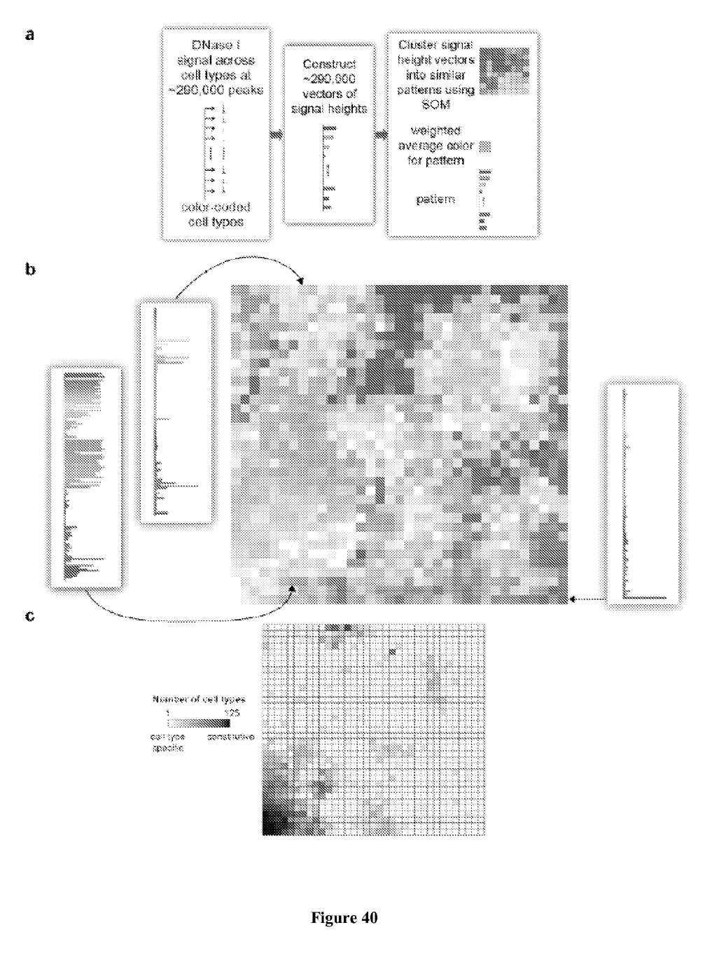

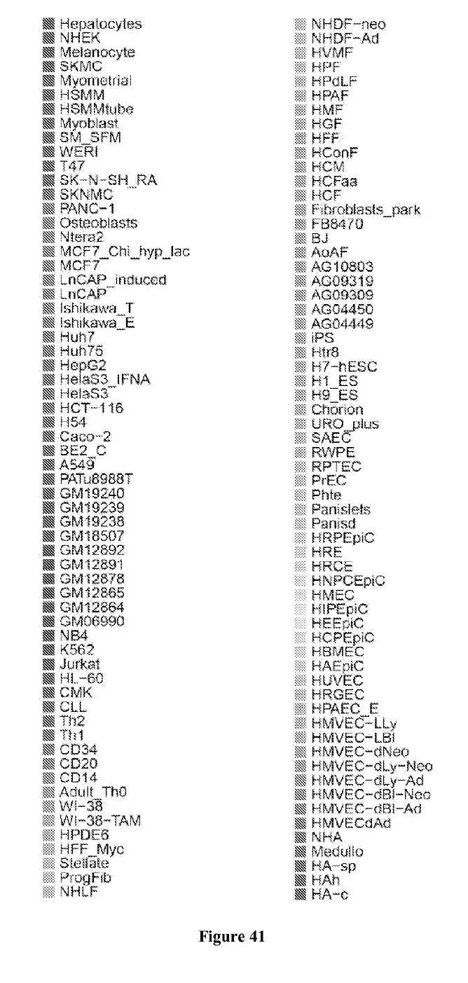

To visualize the qualities and prevalence of different stereotyped cross-cellular DHS patterns, a self-organizing map of a random 10% subsample of DHSs across all cell types was constructed and a total of 1,225 distinct stereotyped DHS patterns were identified (FIG. 39-40). FIG. 39 illustrates clustering of ˜290,000 DHSs by cross-cell-type patterns using a self-organizing map (SOM), which learns patterns in the data and organizes DHSs into stereotyped groups analogous to those shown in FIG. 38a-e. FIG. 39a illustrates a schematic for SOM clustering and color coding of patterns; index of cell types with their colors is given in FIG. 40. FIG. 39b illustrates SOM of 1,225 DHS patterns. Each cell in the 35×35 grid represents one stereotyped pattern, with color coding determined according to the weighted “average” cell type for that pattern. Three example pattern profiles are shown, corresponding to the indicated nodes in the grid. FIG. 39c illustrates a grayscale heat map corresponding to that in (b) showing, for each color-coded pattern, the cell-specificity of that pattern. Shading indicates cell-selectivity; black=DHS is constitutive (i.e. present in all cell types); white=DHS is cell type-specific; grayscale=gradations thereof. Note the concentration of patterns with promiscuous DHSs in the lower right; however, most stereotyped DHS patterns are highly cell-selective. FIG. 40 illustrates a color-coded key to the signal height vectors used as input for the SOM of FIG. 39. Many of the stereotyped patterns discovered by the self-organizing map encompass large numbers of DHSs, with some counting >1,000 elements (FIG. 41). FIG. 41 illustrates the number of instances of each pattern discovered by the SOM illustrated in FIG. 39; the top matrix is simply a heat map version of the numeric matrix underneath.

Taken together, the above results showed that chromatin accessibility at regulatory DNA is highly choreographed across large sets of co-activated elements distributed throughout the genome, and that DHSs with similar cross-cell-type activation profiles probably share similar functions.

Methods.

DNaseI hypersensitivity mapping was performed as previously described in Example 14 herein.

DNaseI and Histone Modification Protocols.

DNaseI assays and histone modification were performed as previously described in Example 14 herein.

Dataset Availability.

Datasets used are available as previously described in Example 14 herein.

DHS Master List and its Annotation.

The DHS master list was compiled and annotated as previously described in Example 14 herein.

Dataset Availability.

The FDR 1% peaks by cell-type and the 125 cell-type master list are available as previously described in Example 14 herein.

DNaseI Pattern Matching.

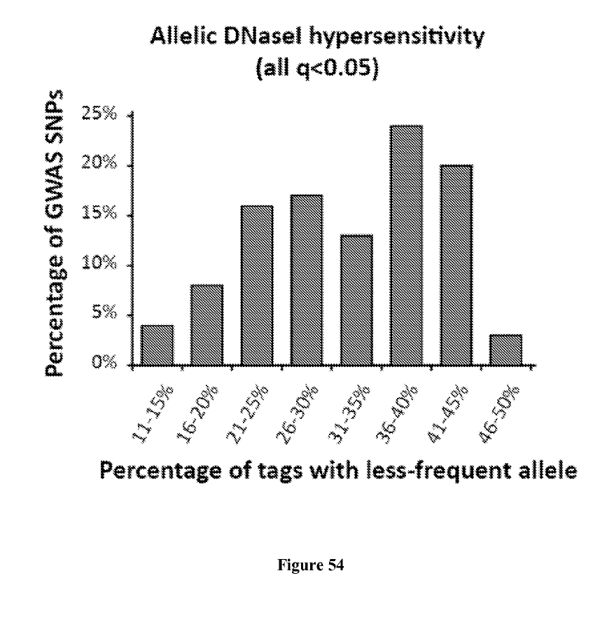

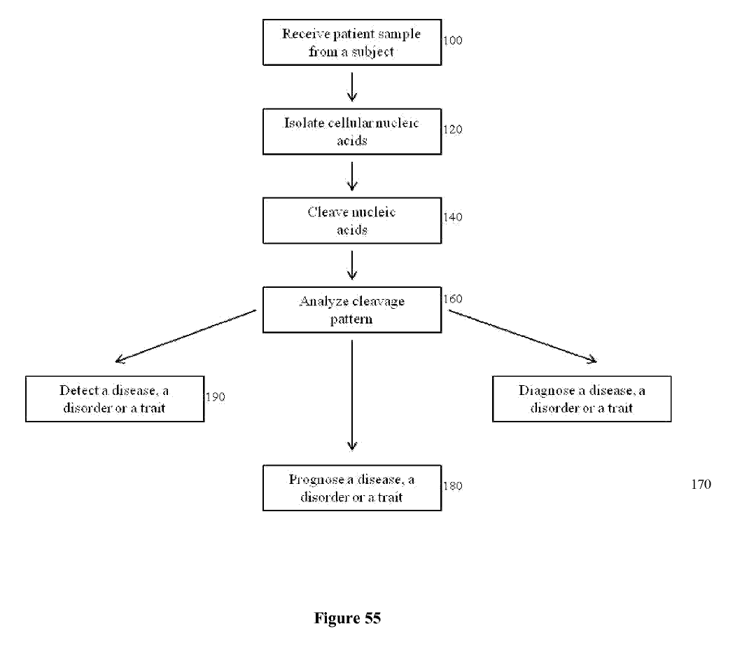

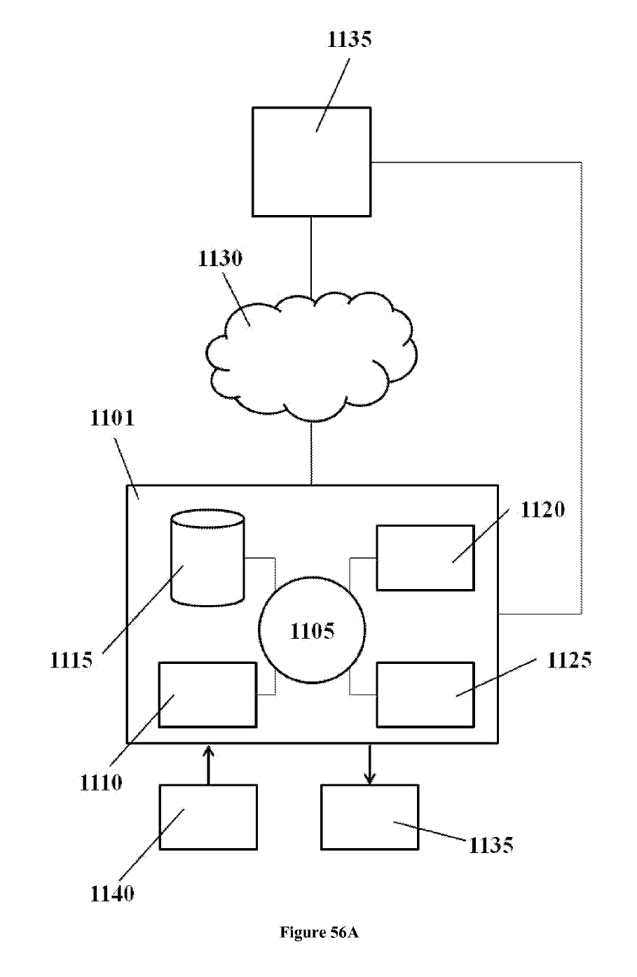

For each cell type, a tag density file was prepared representing DNaseI cut counts observed in 150-bp windows shifted every 20 bp. Datasets were not normalized but represented similar levels of DNaseI sequencing. Summing these across all cell types, local maxima were identified and formed the universe of genomic locations subject to pattern search. For a given exemplar region, all sites were ranked by a scoring function comparing the vector of DNaseI tag density to that of the exemplar site. The best matches were defined as those with the lowest sum of squared absolute differences in tag counts for each cell type between the two locations. Three representative patterns and the top 30 ranked pattern matches for two of them are shown in FIGS. 54-55. When finding sites to be assayed in one or more particular cell types, a weight vector was applied to multiply all tag counts from those cell types by a small factor to increase the relative stringency of the match for those cell types.

Self-Organizing Map.

In order to characterize the patterns of hypersensitivity across the 125 cell types of Table 5, a self-organizing map (SOM) of the DHS data was constructed. A matrix of hypersensitivity scores was built from the maximum DNase-seq signal for each peak and cell type, resulting in a peak-by-cell-type matrix of DHS scores. The scores were quantile-normalized by cell type and then capped at the 99th quantile (by setting the top 1% of scores to a maximum value), and then row-scaled to a decimal between 0 and 1. After normalization, capping, and scaling, an SOM was built using the kohonen package in R. The SOM is an unsupervised clustering method that learns common DHS profiles in the data. Each node is initialized with a random DHS profile across cell types, and nodes are then iteratively adjusted according to the DHS profile of each peak. The SOM eventually assigns each peak to the node with the most similar hypersensitivity profile. The SOM uses a hexagonal 35×35 grid (for 1225 total nodes). Because the software was unable to handle all the data, a random sample of about 288,000 hypersensitive sites was used, under the reasoning that this would capture the major patterns. To create the grayscale plot of FIG. 39c showing the number of “strongly open” cell types, an arbitrary threshold was set (0.4) and cell types above this threshold were counted. For the color plot of FIG. 39a, a color was assigned to each cell type (FIG. 40), and then a colour was assigned to each node by taking a weighted combination of colours of cell types considered open in that node.

### Example 20

### Variation in Regulatory DNA Linked to Mutation Rate

The DHS compartment as a whole is under evolutionary constraint, which varies between different classes and locations of elements, and may be heterogeneous within individual elements To understand the evolutionary forces shaping regulatory DNA sequences in humans, nucleotide diversity (n) in DHSs was estimated using publicly available whole-genome sequencing data from 53 unrelated individuals (see Methods). The analysis was restricted to nucleotides outside of exons and RepeatMasked regions. To provide a comparison with putatively neutral sites, π was computed in fourfold degenerate synonymous positions (third positions) of coding exons. This analysis showed that, taken together, DHSs exhibit lower it than fourfold degenerate sites, compatible with the action of purifying selection.

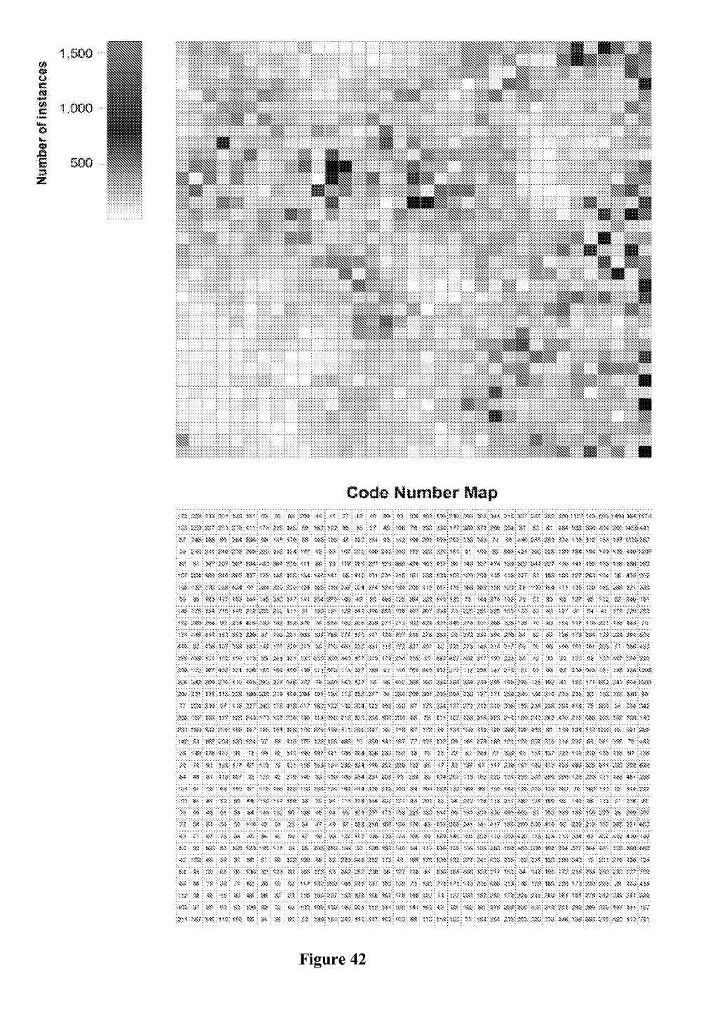

FIG. 42a shows π for the DHSs of all analyzed cell types, with color coding to indicate the origin of each cell type. FIG. 42 illustrates genetic variation in regulatory DNA linked to mutation rate. FIG. 42a illustrates mean nucleotide diversity (π, y axis) in DHSs of 97 diverse cell types (x axis) estimated using whole-genome sequencing data from 53 unrelated individuals. Cell types are ordered left-to-right by increasing mean p. Horizontal blue bar shows 95% confidence intervals on mean π in a background model of fourfold degenerate coding sites. Note the enrichment of immortal cells at right. ES, embryonic stem cell; iPS, induced pluripotent stem cell. Particularly striking is the distribution of diversity relative to proliferative potential. DHSs in cells with limited proliferative potential have uniformly lower average diversity than immortal cells, with the difference most pronounced in malignant and pluripotent lines. This ordering is identical when highly mutable CpG nucleotides are removed from the analysis.

If differences in it are due to mutation rate differences in different DHS compartments, the ratio of human polymorphism to human-chimpanzee divergence should remain constant across cell types. By contrast, differences in π due to selective constraint should result in pronounced differences. To distinguish between these alternatives, polymorphism and human-chimpanzee divergence were first compared for DHSs from normal, malignant and pluripotent cells (FIG. 42b). FIG. 42b illustrates mean π (left y axis) for pluripotent (yellow) versus malignancy-derived (red) versus normal cells (light green), plotted side-by-side with human-chimpanzee divergence (right y axis) computed on the same groups. Boxes indicate 25-75 percentiles, with medians highlighted. Differences in polymorphism and divergence between these three groups are nearly identical, compatible with a mutational cause. Second, raw mutation rate is expected to affect rare and common genetic variation equally, whereas selection is likely to have a larger impact on common variation. ˜62% of single nucleotide polymorphisms (SNPs) in DHSs of each group were consistently observed to have derived-allele frequencies below 0.05. DHSs in different cell lines exhibit differences in SNP densities but not in allele frequency distribution (FIG. 42c). FIG. 42c illustrates that both low- and high-frequency derived alleles show the same effect. Density of SNPs in DHSs with derived allele frequency (DAF)<5% (x axis) is tightly correlated (r2=0.84) with the same measure computed for higher-frequency derived alleles (y axis). Color-coding is the same as in panel (a). Collectively, these observations are consistent with increased relative mutation rates in the DHS compartment of immortal cells versus cell types with limited proliferative potential, exposing an unexpected link between chromatin accessibility, proliferative potential and patterns of human variation.

Methods.

DNaseI hypersensitivity mapping was performed as previously described in Example 14 herein.

DNaseI and Histone Modification Protocols.

DNaseI assays and histone modification were performed as previously described in Example 14 herein.

Dataset Availability.

Datasets used are available as previously described in Example 14 herein.

DHS Master List and its Annotation.

The DHS master list was compiled and annotated as previously described in Example 14 herein.

Dataset Availability.

The FDR 1% peaks by cell-type and the 125 cell-type master list are available as previously described in Example 14 herein.

Measurement of Nucleotide Heterozygosity and Estimation of Mutation Rate.

Publicly-available genome-wide variant data for 54 individuals with no known familial relationships between them were downloaded from Complete Genomics (ftp://ftp2.completegenomics.com/Public_Genome_Summary_Analysis/Complete_Public_Genomes_{—}54 genomes_VQHIGH_VCF.txt.bz2, Complete Genomics assembly software version 2.0.0). The unrelatedness of the individuals were validated using KING, a robust software package for inferring kinship coefficients from high-throughput genotype data. Two Maasai individuals in the dataset (NA21732 and NA21737) were not reported as related, but were found with KING to be either siblings or parent-child. Therefore NA21737 was removed from the analysis, leaving genotype data from 53 unrelated individuals, with Conch IDs HG00731, HG00732, NA06985, NA06994, NA07357, NA10851, NA12004, NA12889, NA12890, NA12891, NA12892, NA18501, NA18502, NA18504, NA18505, NA18508, NA18517, NA18526, NA18537, NA18555, NA18558, NA18940, NA18942, NA18947, NA18956, NA19017, NA19020, NA19025, NA19026, NA19129, NA19238, NA19239, NA19648, NA19649, NA19669, NA19670, NA19700, NA19701, NA19703, NA19704, NA19735, NA19834, NA20502, NA20509, NA20510, NA20511, NA20845, NA20846, NA20847, NA20850, NA21732, NA21733, NA21767. The variant sites were filtered to obtain only those for which full genotype calls were made for at least 20% of the individuals, treating partial calls (e.g. a genotype of A and N) as non-calls. From this filtered set, after first removing from consideration all sites within GENCODE exons and RepeatMasker regions (downloaded from the UCSC Genome Browser), allele frequencies for the locations of all variant sites occurring within the 53 genomes were estimated. For each variant with minor allele frequency p, the nucleotide heterozygosity at that site is it π=2p(1−p).

The mean π per site within the DHSs of each of 97 cell lines was computed by summing it for all variants within the DHSs and dividing by the total number of bases belonging to the DHSs, since π=0 at invariant sites. To compare mean π per site between DHSs and fourfold-degenerate exonic sites, NCBI-called reading frames were used, π was summed for all variants within the non-RepeatMasked fourfold-degenerate sites, and divided by the number of sites considered. 95% confidence intervals on π per fourfold-degenerate site were estimated by performing 10,000 bootstrap samples.

To estimate relative mutation rates within the DHSs of each cell line, human/chimpanzee alignments were downloaded from the UCSC Genome Browser (reference versions hg19 and panTro2, http://hgdownload.cse.ucsc.edu/goldenPath/hg19/vsPanTro2/syntenicNet/), choosing the more conservative syntenicNet alignments; details can be found in http://hgdownload.cse.ucsc.edu/goldenPath/hg19/vsPanTro2/README.txt. Within the DHSs called in each cell line, the number of nucleotide differences between chimpanzee and human (d) and the number of bases aligned (n) were extracted. DHS-specific relative mutation rates μ per site per generation were then estimated as μ=(d/n)/(2×6 my/25 years/generation), with 6 million years being the approximate age of the human/chimp divergence.

### Examples 21-27

Examples 21-27 refer to Table 7, below. Table 7 summarizes the mapping of DHSs in 349 cell and tissue samples.

TABLE 7
Mapping of DHSs in 349 cell and tissue samples. DNaseI mapping of 349 cell types and tissues (115 distinct types)
used in the study, including the shorthand name for the tissue, a description of the tissue, whether the tissue
is of fetal origin, the total number of DHSs observed, the number of GWAS SNPs within the DHSs, whether the DNaseI
data has been previously published in (10), and the preparation protocol for the cell line or tissue.

| | | | | | | Cell/Tissue Isolation/Culture |
|---|---|---|---|---|---|---|
| Cell_line | Description | Fetal | #DHS | #SNP | Pub | Protocol |
| A549 | Epithelial cell line | N | 117,992 | 180 | Y | genome.ucsc.edu/ENCODE/ |
| | derived from a lung | | | | | protocols/cell/human/A549_{—} |
| | carcinoma tissue | | | | | Stam_protocol.pdf |
| AG04449 | Fetal buttock/thigh | Y | 174,802 | 202 | Y | genome.ucsc.edu/ENCODE/ |
| | fibroblast | | | | | protocols/cell/human/AG04449_{—} |
| | | | | | | Stam_protocol.pdf |
| AG04450 | Fetal lung fibroblast | Y | 150,114 | 187 | Y | genome.ucsc.edu/ENCODE/ |
| | | | | | | protocols/cell/human/AG04450_{—} |
| | | | | | | Stam_protocol.pdf |
| AG09309 | Adult human toe | N | 197,301 | 266 | Y | genome.ucsc.edu/ENCODE/ |
| | fibroblast | | | | | protocols/cell/human/AG09309_{—} |
| | | | | | | Stam_protocol.pdf |
| AG09319 | Adult human gum | N | 137,192 | 190 | Y | genome.ucsc.edu/ENCODE/ |
| | tissue fibroblasts | | | | | protocols/cell/human/AG09319_{—} |
| | | | | | | Stam_protocol.pdf |
| AG10803 | Adult human | N | 171,903 | 224 | Y | genome.ucsc.edu/ENCODE/ |
| | abdominal skin | | | | | protocols/cell/human/AG10803_{—} |
| | fibroblasts | | | | | Stam_protocol.pdf |
| AoAF | Normal Human | N | 169,477 | 261 | Y | genome.ucsc.edu/ENCODE/ |
| | Aortic Adventitial | | | | | protocols/cell/human/AoAF_{—} |
| | Fibroblast Cells | | | | | Stam_protocol.pdf |
| BE2_C | Human | N | 168,003 | 259 | Y | genome.ucsc.edu/ENCODE/ |
| | Neuroblastoma cell | | | | | protocols/cell/human/BE2-C_{—} |
| | line | | | | | Stam_protocol.pdf |
| BJ | Skin fibroblasts | N | 162,671 | 246 | Y | genome.ucsc.edu/ENCODE/ |
| | | | | | | protocols/cell/human/BJ-tert_{—} |
| | | | | | | Stam_protocol.pdf |
| Caco-2 | Colorectal | N | 117,293 | 179 | Y | genome.ucsc.edu/ENCODE/ |
| | adenocarcinoma | | | | | protocols/cell/human/Stam_{—} |
| | | | | | | 15_protocols.pdf |
| CD14+ | Monocytes, CD14+ | N | 117,181 | 273 | Y | genome.ucsc.edu/ENCODE/ |
| | | | | | | protocols/cell/human/MonoCD14_{—} |
| | | | | | | Stam_protocol.pdf |
| CD19+ | B-lymphocytes, | N | 75,086 | 225 | N | roadmapepigenomics.org/files/ |
| | CD19+ | | | | | protocols/experimental/dnaseI- |
| | | | | | | sensitivity/HematopoieticCells_{—} |
| | | | | | | DNaseTreatment_V5_UW-NREMC.pdf |
| CD20+ | B-lymphocytes, | N | 170,412 | 328 | Y | genome.ucsc.edu/ENCODE/ |
| | CD20+ | | | | | protocols/cell/human/CD20+_{—} |
| | | | | | | Stam_protocol.pdf |
| CD20+ | B-lymphocytes, | N | 86,908 | 268 | N | genome.ucsc.edu/ENCODE/ |
| | CD20+ | | | | | protocols/cell/human/CD20+_{—} |
| | | | | | | Stam_protocol.pdf |
| CD3+ | T-lymphocytes, | N | 77,933 | 177 | N | roadmapepigenomics.org/files/ |
| | CD3+ | | | | | protocols/experimental/dnaseI- |
| | | | | | | sensitivity/HematopoieticCells_{—} |
| | | | | | | DNaseTreatment_V5_UW-NREMC.pdf |
| CD34+ | Mobilized | N | 134,718 | 230 | Y | genome.ucsc.edu/ENCODE/ |
| | hematopoietic | | | | | protocols/cell/human/ |
| | progenitor cells | | | | | CD34+Mobilized_Stam_protocol.pdf |
| CD3+_{—} | Cord blood, CD3+ | N | 74,992 | 176 | N | roadmapepigenomics.org/files/ |
| CordBlood | | | | | | protocols/experimental/dnaseI- |
| | | | | | | sensitivity/HematopoieticCells_{—} |
| | | | | | | DNaseTreatment_V5_UW-NREMC.pdf |
| CD4+ | T helper cells, | N | 94,881 | 239 | N | roadmapepigenomics.org/files/ |
| | CD4+ | | | | | protocols/experimental/dnaseI- |
| | | | | | | sensitivity/HematopoieticCells_{—} |
| | | | | | | DNaseTreatment_V5_UW-NREMC.pdf |
| CD56+ | Lymphocytes, | N | 105,724 | 277 | N | roadmapepigenomics.org/files/ |
| | CD56+ | | | | | protocols/experimental/dnaseI- |
| | | | | | | sensitivity/HematopoieticCells_{—} |
| | | | | | | DNaseTreatment_V5_UW-NREMC.pdf |
| CD8+ | Cytotoxic T cells, | N | 75,382 | 185 | N | roadmapepigenomics.org/files/ |
| | CD8+ | | | | | protocols/experimental/dnaseI- |
| | | | | | | sensitivity/HematopoieticCells_{—} |
| | | | | | | DNaseTreatment_V5_UW-NREMC.pdf |
| CMK | Acute | N | 123,561 | 210 | Y | genome.ucsc.edu/ENCODE/ |
| | megakaryocytic | | | | | protocols/cell/human/CMK_{—} |
| | leukemia cells | | | | | Stam_protocol.pdf |
| GM06990 | Lymphoblastoid | N | 86,958 | 210 | Y | genome.ucsc.edu/ENCODE/ |
| | | | | | | protocols/cell/human/Stam_{—} |
| | | | | | | 15_protocols.pdf |
| GM12864 | Lymphoblastoid | N | 132,370 | 262 | Y | genome.ucsc.edu/ENCODE/ |
| | | | | | | protocols/cell/human/GM12 |
| | | | | | | 864_Stam_protocol.pdf |
| GM12865 | Lymphoblastoid | N | 133,962 | 280 | Y | genome.ucsc.edu/ENCODE/ |
| | | | | | | protocols/cell/human/GM12865_{—} |
| | | | | | | Stam_protocol.pdf |
| GM12878 | Lymphoblastoid | N | 109,419 | 240 | Y | genome.ucsc.edu/ENCODE/ |
| | | | | | | protocols/cell/human/Stam_{—} |
| | | | | | | 15_protocols.pdf |
| H1_P18 | H1-derived | — | 178,572 | 255 | N | Yu et al., Cell Stem Cell 8, |
| | embryonic stem | | | | | 326-334 (2011) |
| | cells | | | | | |
| H7-hESC | Undifferentiated | — | 284,627 | 305 | Y | genome.ucsc.edu/ENCODE/ |
| | embryonic stem | | | | | protocols/cell/human/H7- |
| | cells | | | | | hESC_Stam_protocol.pdf |
| H9_P42 | H9-derived | — | 140,166 | 192 | N | Yu et al., Cell Stem Cell 8, |
| | embryonic stem | | | | | 326-334 (2011) |
| | cells | | | | | |
| HAEpiC | Human Amniotic | Y | 200,771 | 292 | Y | genome.ucsc.edu/ENCODE/ |
| | Epithelial Cells | | | | | protocols/cell/human/HAEpiC_{—} |
| | | | | | | Stam_protocol.pdf |
| HAc | Human Astrocytes - | Y | 183,752 | 239 | Y | genome.ucsc.edu/ENCODE/ |
| | cerebellar | | | | | protocols/cell/human/HAc_{—} |
| | | | | | | Stam_protocol.pdf |
| HAh | Human Astrocytes - | Y | 215,151 | 351 | Y | genome.ucsc.edu/ENCODE/ |
| | hippocampal | | | | | protocols/cell/human/HAh_{—} |
| | | | | | | Stam_protocol.pdf |
| HAsp | Human Astrocytes - | Y | 215,720 | 350 | Y | genome.ucsc.edu/ENCODE/ |
| | Spinal cord | | | | | protocols/cell/human/HA-sp_{—} |
| | | | | | | Stam_protocol.pdf |
| HBMEC | Human Brain | Y | 196,870 | 320 | Y | genome.ucsc.edu/ENCODE/ |
| | Microvascular | | | | | protocols/cell/human/HBMEC_{—} |
| | Endothelial Cells | | | | | Stam_protocol.pdf |
| HCF | Human Cardiac | Y | 171,858 | 268 | Y | genome.ucsc.edu/ENCODE/ |
| | Fibroblasts | | | | | protocols/cell/human/HCF_{—} |
| | | | | | | Stam_protocol.pdf |
| HCFaa | Human Cardiac | N | 184,810 | 323 | Y | genome.ucsc.edu/ENCODE/ |
| | Fibroblasts - adult | | | | | protocols/cell/human/HCFaa_{—} |
| | atrial | | | | | Stam_protocol.pdf |
| HCM | Human | Y | 191,262 | 308 | Y | genome.ucsc.edu/ENCODE/ |
| | Cardiomyocytes | | | | | protocols/cell/human/HCM_{—} |
| | | | | | | Stam_protocol.pdf |
| HCPEpiC | Human Choroid | Y | 209,492 | 304 | Y | genome.ucsc.edu/ENCODE/ |
| | Plexus Epithelial | | | | | protocols/cell/human/HCPEpiC_{—} |
| | Cells | | | | | Stam_protocol.pdf |
| HCT-116 | Colon | N | 104,196 | 170 | Y | genome.ucsc.edu/ENCODE/ |
| | adenocarcinoma | | | | | protocols/cell/human/HCT116_{—} |
| | | | | | | Stam_protocol.pdf |
| HConF | Human | Y | 150,877 | 209 | Y | genome.ucsc.edu/ENCODE/ |
| | Conjunctival | | | | | protocols/cell/human/HConF_{—} |
| | Fibroblasts | | | | | Stam_protocol.pdf |
| HEEpiC | Human Esophageal | Y | 213,954 | 266 | Y | genome.ucsc.edu/ENCODE/ |
| | Epithelial Cells | | | | | protocols/cell/human/HEEpiC_{—} |
| | | | | | | Stam_protocol.pdf |
| HepG2 | Hepatocellular | N | 81,159 | 133 | Y | genome.ucsc.edu/ENCODE/ |
| | carcinoma | | | | | protocols/cell/human/ |
| | | | | | | Stam_15_protocols.pdf |
| HESC | Human H1 | — | 163,880 | 195 | Y | genome.ucsc.edu/ENCODE/ |
| | Embryonic Stem | | | | | protocols/cell/human/HHSEC_{—} |
| | Cell line | | | | | Stam_protocol.pdf |
| HFF | Human Foreskin | N | 189,148 | 329 | Y | genome.ucsc.edu/ENCODE/ |
| | Fibroblasts | | | | | protocols/cell/human/HFF_{—} |
| | | | | | | Stam_protocol.pdf |
| HFF_Myc | Human Foreskin | N | 215,171 | 333 | Y | genome.ucsc.edu/ENCODE/ |
| | Fibroblasts_Myc | | | | | protocols/cell/human/HFFMyc_{—} |
| | Transgene | | | | | Stam_protocol.pdf |
| HGF | Human Gingival | N | 148,852 | 191 | Y | genome.ucsc.edu/ENCODE/ |
| | Fibroblasts | | | | | protocols/cell/human/HGF_{—} |
| | | | | | | Stam_protocol.pdf |
| HIPEpiC | Human Iris Pigment | Y | 231,963 | 304 | Y | genome.ucsc.edu/ENCODE/ |
| | Epithelial Cells | | | | | protocols/cell/human/HIPEpiC_{—} |
| | | | | | | Stam_protocol.pdf |
| HL-60 | Human | N | 153,865 | 296 | Y | genome.ucsc.edu/ENCODE/ |
| | promyelocyticleukemia | | | | | protocols/cell/human/HL-60_{—} |
| | cells | | | | | Stam_protocol.pdf |
| HMEC | Human mammary | N | 139,620 | 214 | Y | genome.ucsc.edu/ENCODE/ |
| | epithelial cells | | | | | protocols/cell/human/HMEC_{—} |
| | | | | | | Stam_protocol.pdf |
| HMF | Human Mammary | N | 176,102 | 236 | Y | genome.ucsc.edu/ENCODE/ |
| | Fibroblasts | | | | | protocols/cell/human/HMF_{—} |
| | | | | | | Stam_protocol.pdf |
| HMVEC- | Human Lung Blood | N | 161,548 | 283 | Y | genome.ucsc.edu/ENCODE/ |
| LBl | Microvascular | | | | | protocols/cell/human/HMVEC- |
| | Endothelial Cells | | | | | LBl_Stam_protocol.pdf |
| HMVEC- | Human Lung | N | 130,544 | 235 | Y | genome.ucsc.edu/ENCODE/ |
| LLy | Lymphatic | | | | | protocols/cell/human/HMVEC- |
| | Microvascular | | | | | LLy_Stam_protocol.pdf |
| | Endothelial Cells | | | | | |
| HMVEC- | Adult Human | N | 115,973 | 175 | N | genome.ucsc.edu/ENCODE/ |
| dAd | Dermal | | | | | protocols/cell/human/HMVECdAd_{—} |
| | Microvascular | | | | | Stam_protocol.pdf |
| | Endothelial Cells | | | | | |
| HMVEC- | Adult Human | N | 149,796 | 268 | Y | genome.ucsc.edu/ENCODE/ |
| dBl-Ad | Dermal Blood | | | | | protocols/cell/human/HMVEC- |
| | Microvascular | | | | | dBl-Ad_Stam_protocol.pdf |
| | Endothelial Cells | | | | | |
| HMVEC- | Neonatal Human | N | 154,291 | 310 | Y | genome.ucsc.edu/ENCODE/ |
| dBl-Neo | Dermal Blood | | | | | protocols/cell/human/HMVEC- |
| | Microvascular | | | | | dBl-Neo_Stam_protocol.pdf |
| | Endothelial Cells | | | | | |
| HMVEC- | Adult Human | N | 115,834 | 194 | Y | genome.ucsc.edu/ENCODE/ |
| dLy-Ad | Dermal Lymphatic | | | | | protocols/cell/human/HMVEC- |
| | Microvascular | | | | | dLy-Ad_Stam_protocol.pdf |
| | Endothelial Cells | | | | | |
| HMVEC- | Neonatal Human | N | 139,708 | 242 | Y | genome.ucsc.edu/ENCODE/ |
| dLy-Neo | Dermal Lymphatic | | | | | protocols/cell/human/HMVEC- |
| | Microvascular | | | | | dLy-Neo_Stam_protocol.pdf |
| | Endothelial Cells | | | | | |
| HMVEC- | Neonatal Human | N | 132,325 | 215 | Y | genome.ucsc.edu/ENCODE/ |
| dNeo | Dermal | | | | | protocols/cell/human/HMVEC- |
| | Microvascular | | | | | dNeo_Stam_protocol.pdf |
| | Endothelial Cells | | | | | |
| HNPCEpiC | Human Non- | Y | 217,558 | 296 | Y | genome.ucsc.edu/ENCODE/ |
| | Pigment Ciliary | | | | | protocols/cell/human/HNPCEpiC_{—} |
| | Epithelial Cells | | | | | Stam_protocol.pdf |
| HPAEC | Human Pulmonary | N | 125,462 | 170 | Y | genome.ucsc.edu/ENCODE/ |
| | Artery Endothelial | | | | | protocols/cell/human/HPAEC_{—} |
| | Cells | | | | | Stam_protocol.pdf |
| HPAF | Human Pulmonary | Y | 181,244 | 302 | Y | genome.ucsc.edu/ENCODE/ |
| | Artery Fibroblasts | | | | | protocols/cell/human/HPAF_{—} |
| | | | | | | Stam_protocol.pdf |
| HPF | Human Pulmonary | Y | 147,153 | 225 | Y | genome.ucsc.edu/ENCODE/ |
| | Fibroblasts | | | | | protocols/cell/human/HPF_{—} |
| | | | | | | Stam_protocol.pdf |
| HPdLF | Human Periodontal | N | 169,679 | 260 | Y | genome.ucsc.edu/ENCODE/ |
| | Ligament | | | | | protocols/cell/human/HPdLF_{—} |
| | Fibroblasts | | | | | Stam_protocol.pdf |
| HRCEpiC | Human renal | N | 193,462 | 294 | Y | genome.ucsc.edu/ENCODE/ |
| | cortical epithelial | | | | | protocols/cell/human/HRCEpiC_{—} |
| | cells (normal) | | | | | Stam_protocol.pdf |
| HRE | Human renal | N | 197,779 | 257 | Y | genome.ucsc.edu/ENCODE/ |
| | epithelial cells | | | | | protocols/cell/human/HRE_{—} |
| | (normal) | | | | | Stam_protocol.pdf |
| HRGEC | Human Renal | Y | 143,319 | 188 | Y | genome.ucsc.edu/ENCODE/ |
| | Glomerular | | | | | protocols/cell/human/HRGEC_{—} |
| | Endothelial Cells | | | | | Stam_protocol.pdf |
| HRPEpiC | Human Retinal | Y | 229,606 | 298 | Y | genome.ucsc.edu/ENCODE/ |
| | Pigment Epithelial | | | | | protocols/cell/human/HRPEpiC_{—} |
| | Cells | | | | | Stam_protocol.pdf |
| HSMM | Human Skeletal | N | 234,182 | 335 | Y | genome.ucsc.edu/ENCODE/ |
| | Muscle Myoblasts | | | | | protocols/cell/human/HSMM_{—} |
| | | | | | | Stam_protocol.pdf |
| HSMM_D | Human Skeletal | N | 233,756 | 414 | Y | genome.ucsc.edu/ENCODE/ |
| | Muscle | | | | | protocols/cell/human/HSMM_{—} |
| | Myoblasts_{—} | | | | | Stam_protocol.pdf |
| | differentiated | | | | | |
| HUVEC | Human umbilical | N | 115,081 | 229 | Y | genome.ucsc.edu/ENCODE/ |
| | vein endothelial | | | | | protocols/cell/human/Stam_{—} |
| | cells | | | | | 15_protocols.pdf |
| HVMF | Human Villous | Y | 170,308 | 296 | Y | genome.ucsc.edu/ENCODE/ |
| | Mesenchymal | | | | | protocols/cell/human/HVMF_{—} |
| | Fibroblasts | | | | | Stam_protocol.pdf |
| HeLa-S3 | Cervical carcinoma | N | 119,081 | 247 | Y | genome.ucsc.edu/ENCODE/ |
| | | | | | | protocols/cell/human/Stam_{—} |
| | | | | | | 15_protocols.pdf |
| IMR90 | Fibroblasts | N | 196,940 | 278 | N | genome.ucsc.edu/ENCODE/ |
| | | | | | | protocols/cell/human/IMR90_{—} |
| | | | | | | Stam_protocol.pdf |
| Jurkat | T lymphoblastoid | N | 152,487 | 251 | Y | genome.ucsc.edu/ENCODE/ |
| | cell line derived | | | | | protocols/cell/human/Jurkat_{—} |
| | from acute T cell | | | | | Stam_protocol.pdf |
| | leukemia | | | | | |
| K562 | Chronic myeloid | N | 142,920 | 268 | Y | genome.ucsc.edu/ENCODE/ |
| | leukemia | | | | | protocols/cell/human/Stam_{—} |
| | | | | | | 15_protocols.pdf |
| LNCaP | Prostate | N | 184,899 | 239 | Y | genome.ucsc.edu/ENCODE/ |
| | adenocarcinoma cell | | | | | protocols/cell/human/LNCaP_{—} |
| | line | | | | | Stam_protocol.pdf |
| MCF-7 | Mammary gland | N | 133,229 | 168 | Y | genome.ucsc.edu/ENCODE/ |
| | adenocarcinoma | | | | | protocols/cell/human/Stam_{—} |
| | | | | | | 15_protocols.pdf |
| Mesendoderm | H1 derived | — | 214,950 | 273 | N | Vodyanik et al., Cell Stem Cell |
| | mesendoderm cells | | | | | 7, 718-729 (2010) |
| NB4 | Acute | N | 131,948 | 240 | Y | genome.ucsc.edu/ENCODE/ |
| | Promyelocytic | | | | | protocols/cell/human/NB4_{—} |
| | Leukemia cell line | | | | | Stam_protocol.pdf |
| NH-A | Normal Human | Y | 189,150 | 280 | Y | genome.ucsc.edu/ENCODE/ |
| | Astrocytes | | | | | protocols/cell/human/NHA_{—} |
| | | | | | | Stam_protocol.pdf |
| NHDF- | Adult Human | N | 226,683 | 330 | Y | genome.ucsc.edu/ENCODE/ |
| Ad | Dermal Fibroblasts | | | | | protocols/cell/human/NHDF-Ad_{—} |
| | | | | | | Stam_protocol.pdf |
| NHDF- | Neonatal Human | N | 184,888 | 269 | Y | genome.ucsc.edu/ENCODE/ |
| neo | Dermal Fibroblasts | | | | | protocols/cell/human/NHDF-neo_{—} |
| | | | | | | Stam_protocol.pdf |
| NHEK | Normal Human | N | 145,886 | 216 | Y | genome.ucsc.edu/ENCODE/ |
| | Epidermal | | | | | protocols/cell/human/Stam_{—} |
| | Keratinocytes | | | | | 15_protocols.pdf |
| NHLF | Normal Human | N | 204,839 | 296 | Y | genome.ucsc.edu/ENCODE/ |
| | Lung Fibroblasts | | | | | protocols/cell/human/NHLF_{—} |
| | | | | | | Stam_protocol.pdf |
| NPC | H1 derived | — | 93,396 | 148 | N | N/A |
| | neuroprogenitor | | | | | |
| | cells | | | | | |
| NT2-D1 | Human malignant | N | 187,959 | 259 | Y | genome.ucsc.edu/ENCODE/ |
| | pluripotent | | | | | protocols/cell/human/Stam_{—} |
| | embryonal cancer | | | | | 15_protocols.pdf |
| | cell line - Induced | | | | | |
| | by RA to neuronal | | | | | |
| | cells | | | | | |
| PANC-1 | Pancreatic | N | 117,169 | 203 | Y | genome.ucsc.edu/ENCODE/ |
| | carcinoma cell line | | | | | protocols/cell/human/PANC-1_{—} |
| | | | | | | Stam_protocol.pdf |
| PrEC | Human Prostate | N | 176,183 | 220 | Y | genome.ucsc.edu/ENCODE/ |
| | Epithelial Cell Line | | | | | protocols/cell/human/PrEC_{—} |
| | | | | | | Stam_protocol.pdf |
| RPTEC | Human Renal | N | 171,601 | 293 | Y | genome.ucsc.edu/ENCODE/ |
| | Proximal Tubule | | | | | protocols/cell/human/RPTEC_{—} |
| | Cells | | | | | Stam_protocol.pdf |
| SAEC | Small airway | N | 195,662 | 279 | Y | genome.ucsc.edu/ENCODE/ |
| | epithelial cells | | | | | protocols/cell/human/SAEC_{—} |
| | | | | | | Stam_protocol.pdf |
| SK-N- | Neuroblastoma cell | N | 78,279 | 99 | Y | genome.ucsc.edu/ENCODE/ |
| SH_RA | lines differentiated | | | | | protocols/cell/human/Stam_{—} |
| | with retinoic acid | | | | | 15_protocols.pdf |
| SK_N_MC | Neuroepithelioma | N | 154,275 | 177 | Y | genome.ucsc.edu/ENCODE/ |
| | cell line derived | | | | | protocols/cell/human/SK-N-MC_{—} |
| | from a metastatic | | | | | Stam_protocol.pdf |
| | supra-orbital human | | | | | |
| | brain tumor | | | | | |
| SKMC | Human skeletal | Y | 208,844 | 274 | Y | genome.ucsc.edu/ENCODE/ |
| | muscle cells | | | | | protocols/cell/human/SkMC_{—} |
| | | | | | | Stam_protocol.pdf |
| WERI- | Retinoblastoma cell | N | 190,883 | 257 | Y | genome.ucsc.edu/ENCODE/ |
| Rb1 | line | | | | | protocols/cell/human/WERI-Rb-1_{—} |
| | | | | | | Stam_protocol.pdf |
| WI-38 | Embryonic lung | Y | 164,321 | 252 | Y | genome.ucsc.edu/ENCODE/ |
| | fibroblasts | | | | | protocols/cell/human/WI38_{—} |
| | immortilized | | | | | Stam_protocol.pdf |
| | hTERT | | | | | |
| WI- | Embryonic lung | Y | 206,929 | 358 | Y | genome.ucsc.edu/ENCODE/ |
| 38_TAM | fibroblasts | | | | | protocols/cell/human/WI38_{—} |
| | immortilized | | | | | Stam_protocolpdf |
| | hTERT_Tamoxifin | | | | | |
| | treated | | | | | |
| fAdrenal | Fetal adrenal tissue, | Y | 282,181 | 480 | N | roadmapepigenomics.org/files/ |
| | 5 samples, ages | | | | | protocols/experimental/dnaseI- |
| | 7-12 weeks | | | | | sensitivity/Nuclei_isolation_{—} |
| | | | | | | DNase_Treatment_Human_{——}tissue_{—} |
| | | | | | | DouncingV4_UW-NREMC.pdf |
| fBrain | Fetal brain tissue, | Y | 441,136 | 621 | N | roadmapepigenomics.org/files/ |
| | 12 samples, ages | | | | | protocols/experimental/dnaseI- |
| | 12-20 weeks | | | | | sensitivity/Nuclei_isolation_{—} |
| | | | | | | DNase_Treatment_Human_{——}tissue_{—} |
| | | | | | | DouncingV4_UW-NREMC.pdf |
| fHeart | Fetal heart tissue, | Y | 393,615 | 743 | N | roadmapepigenomics.org/files/ |
| | 12 samples, ages | | | | | protocols/experimental/dnaseI- |
| | 13-21 weeks | | | | | sensitivity/Nuclei_isolation_{—} |
| | | | | | | DNase_Treatment_human_{——}tissue- |
| | | | | | | gentleMACS_V5_UW-NREMC.pdf |
| fIntestine_{—} | Fetal large-intestine | Y | 439,553 | 839 | N | roadmapepigenomics.org/files/ |
| Lg | tissue, 15 samples, | | | | | protocols/experimental/dnaseI- |
| | ages 12-16 weeks | | | | | sensitivity/Nuclei_isolation_{—} |
| | | | | | | DNase_Treatment_human_{——}tissue- |
| | | | | | | gentleMACS_V5_UW-NREMC.pdf |
| fIntestine_{—} | Fetal small-intestine | Y | 360,316 | 735 | N | roadmapepigenomics.org/files/ |
| Sm | tissue, 13 samples, | | | | | protocols/experimental/dnaseI- |
| | ages 12-16 weeks | | | | | sensitivity/Nuclei_isolation_{—} |
| | | | | | | DNase_Treatment_human_{——}tissue- |
| | | | | | | gentleMACS_V5_UW-NREMC.pdf |
| fKidney | Fetal kidney tissue, | Y | 666,350 | 1124 | N | roadmapepigenomics.org/files/ |
| | 47 samples, ages | | | | | protocols/experimental/dnaseI- |
| | 12-21 weeks | | | | | sensitivity/Nuclei_isolation_{—} |
| | | | | | | DNase_Treatment_Human_{——}tissue_{—} |
| | | | | | | DouncingV4_UW-NREMC.pdf |
| fLung | Fetal lung tissue, | Y | 442,491 | 917 | N | roadmapepigenomics.org/files/ |
| | 34 samples, ages | | | | | protocols/experimental/dnaseI- |
| | 10-17 weeks | | | | | sensitivity/Nuclei_isolation_{—} |
| | | | | | | DNase_Treatment_Human_{——}tissue_{—} |
| | | | | | | DouncingV4_UW-NREMC.pdf |
| fMuscle | Fetal muscle tissue, | Y | 632,517 | 1176 | N | roadmapepigenomics.org/files/ |
| | 48 samples, ages | | | | | protocols/experimental/dnaseI- |
| | 12-18 weeks | | | | | sensitivity/Nuclei_isolation_{—} |
| | | | | | | DNase_Treatment_human_{——}tissue- |
| | | | | | | gentleMACS_V5_UW-NREMC.pdf |
| fPlacenta | Placenta tissue, | Y | 281,754 | 553 | N | roadmapepigenomics.org/files/ |
| | 4 samples, ages | | | | | protocols/experimental/dnaseI- |
| | 12-15 weeks | | | | | sensitivity/Nuclei_isolation_{—} |
| | | | | | | DNase_Treatment_human_{——}tissue- |
| | | | | | | gentleMACS_V5_UW-NREMC.pdf |
| fSkin | Fetal fibroblasts, | Y | 392,999 | 591 | N | N/A |
| | 17 samples, ages | | | | | |
| | 12-14 weeks | | | | | |
| fSpinal_{—} | Fetal spinal-cord | Y | 320,476 | 554 | N | roadmapepigenomics.org/files/ |
| cord | tissue, 3 samples, | | | | | protocols/experimental/dnaseI- |
| | ages 12-16 weeks | | | | | sensitivity/Nuclei_isolation_{—} |
| | | | | | | DNase_Treatment_human_{——}tissue- |
| | | | | | | gentleMACS_V5_UW-NREMC.pdf, |
| | | | | | | but with gentleMACSDissociator |
| | | | | | | Program “B.01 C Tube” |
| fSpleen | Fetal spleen tissue, | Y | 175,572 | 334 | N | roadmapepigenomics.org/files/ |
| | age 16 weeks | | | | | protocols/experimental/dnaseI- |
| | | | | | | sensitivity/Nuclei_isolation_{—} |
| | | | | | | DNase_Treatment_Human_{——}tissue_{—} |
| | | | | | | DouncingV4_UW-NREMC.pdf |
| fStomach | Fetal stomach tissue, | Y | 346,348 | 658 | N | roadmapepigenomics.org/files/ |
| | 11 samples, ages | | | | | protocols/experimental/dnaseI- |
| | 13-21 weeks | | | | | sensitivity/Nuclei_isolation_{—} |
| | | | | | | DNase_Treatment_human_{——}tissue- |
| | | | | | | gentleMACS_V5_UW-NREMC.pdf |
| fTestes | Fetal testicle tissue, | Y | 170,843 | 309 | N | roadmapepigenomics.org/files/ |
| | age 16 weeks | | | | | protocols/experimental/dnaseI- |
| | | | | | | sensitivity/Nuclei_isolation_{—} |
| | | | | | | DNase_Treatment_Human_{——}tissue_{—} |
| | | | | | | DouncingV4_UW-NREMC.pdf |
| fThymus | Fetal thymus tissue, | Y | 341,548 | 658 | N | roadmapipigenomics.org/files/ |
| | 10 samples, ages | | | | | protocols/experimental/dnaseI- |
| | 12-21 weeks | | | | | sensitivity/Nuclei_isolation_{—} |
| | | | | | | DNase_Treatment_Human_{——}tissue_{—} |
| | | | | | | DouncingV4_UW-NREMC.pdf |
| Th1 | Human primary T | N | 70,474 | 141 | N | N/A |
| | helper 1 cells | | | | | |
| Th1 | Human primary T | N | 73,754 | 190 | Y | genome.ucsc.edu/ENCODE/ |
| | helper 1 cells | | | | | protocols/cell/human/Stam_{—} |
| | | | | | | 15_protocols.pdf |
| Th17 | Human primary T | N | 78,543 | 130 | N | N/A |
| | helper 17 cells | | | | | |
| Th2 | Human primary T | N | 111,450 | 220 | N | N/A |
| | helper 2 cells | | | | | |
| Th2 | Human primary T | N | 80,196 | 201 | Y | genome.ucsc.edu/ENCODE/ |
| | helper 2 cells | | | | | protocols/cell/human/Th2_{—} |
| | | | | | | Stam_protocols.pdf |
| iPS_19_11 | Induced pluripotent | — | 204,668 | 215 | N | Yu et al., Cell Stem Cell 8, |
| | stem cells | | | | | 326-334 (2011) |
| iPS_19_7 | Induced pluripotent | — | 185,193 | 199 | N | Yu et al., Cell Stem Cell 8, |
| | stem cells | | | | | 326-334 (2011) |
| iPS_4_7 | Induced pluripotent | — | 193,671 | 226 | N | Yu et al., Cell Stem Cell 8, |
| | stem cells | | | | | 326-334 (2011) |
| iPS_6_9 | Induced pluripotent | — | 191,788 | 239 | N | Yu et al., Cell Stem Cell 8, |
| | stem cells | | | | | 326-334 (2011) |
| vHMEC | Human Mammary | N | 161,796 | 272 | N | N/A |
| | Epithelial Cells | | | | | |

### Example 21

### Disease- and Trait-Associated Variants are Concentrated in Regulatory DNA

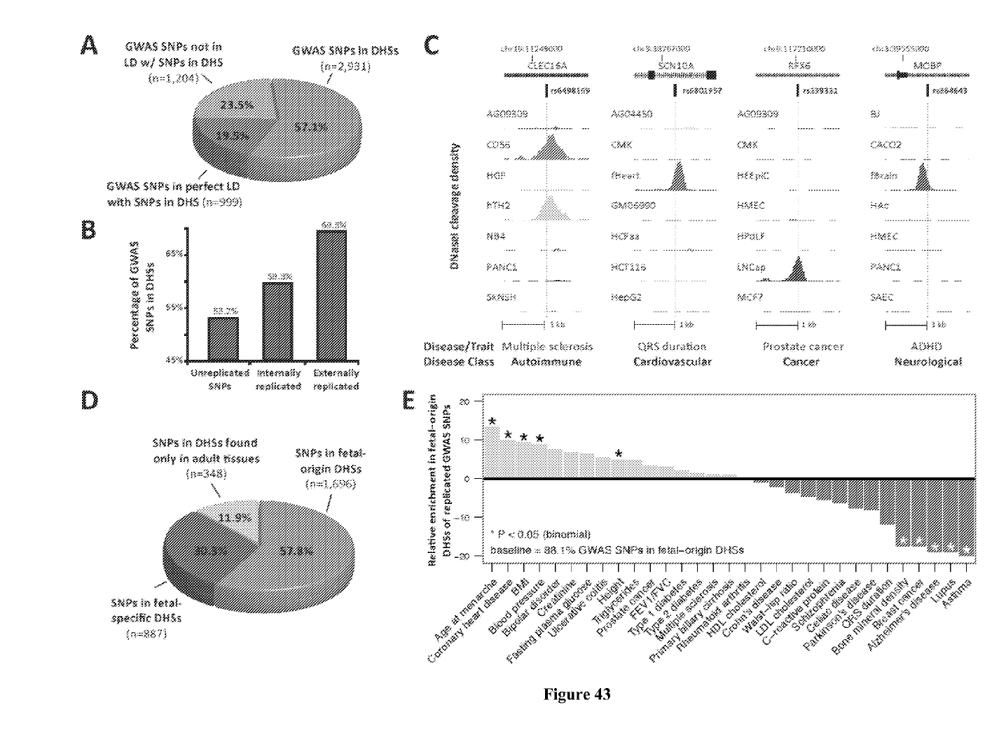

Disease- and trait-associated genetic variants are rapidly being identified with genome-wide association studies (GWAS) and related strategies. To date, hundreds of GWAS have been conducted, spanning diverse diseases and quantitative phenotypes (FIG. 43A). FIG. 43 illustrates diseases and traits studied by GWAS and distribution of GWAS variants. FIG. 43A illustrates a catalog of 6,011 trait-SNP associations (5,386 distinct SNPs) from 920 different studies. Chart shows percentage of GWAS SNPs by disease/trait class. However, the majority (˜93%) of disease- and trait-associated variants emerging from these studies lie within non-coding sequence (FIG. 43B), complicating their functional evaluation. FIG. 43B illustrates location of GWAS SNPs relative to genic features. Note only 4.9% of GWAS SNPs lie in coding sequence. Several lines of evidence suggest involvement of a proportion of such variants in transcriptional regulatory mechanisms, including modulation of promoter and enhancer elements, and enrichment within expression quantitative trait loci (eQTL).

Human regulatory DNA encompasses a variety of cis-regulatory elements within which the cooperative binding of transcription factors creates focal alterations in chromatin structure. DNaseI hypersensitive sites (DHSs) are sensitive and precise markers of this actuated regulatory DNA, and DNaseI mapping has been instrumental in the discovery and census of human cis-regulatory elements. DNaseI mapping was performed genome-wide in 349 cell and tissue samples including 85 cell types studied under the ENCODE Project and 264 samples studied under the Roadmap Epigenomics Program. These encompass several classes of cell types including cultured primary cells with limited proliferative potential (n=55); cultured immortalized (n=6), malignancy-derived (n=18) or pluripotent (n=2) cell lines; and primary hematopoietic cells (n=4) as well as purified differentiated hematopoietic cells (n=11), and a variety of multipotent progenitor and pluripotent cells (n=19). Regulatory DNA was also surveyed by generating DHS maps from 233 diverse fetal tissue samples across post-conception days ˜60-160 (late-first to late-second trimester of gestation). A uniform processing algorithm was used to identify DHSs and the surrounding boundaries of DNaseI accessibility (i.e., the nucleosome-free region harboring regulatory factors). An average of 198,180 DHSs were defined per cell type (range 89,526-369,920; Table 7) spanning on average ˜2.1% of the genome. In total, 3,899,693 distinct DHS positions along the genome were identified (collectively spanning 42.2%), each of which was detected in one or more cell/tissue types (median=5).

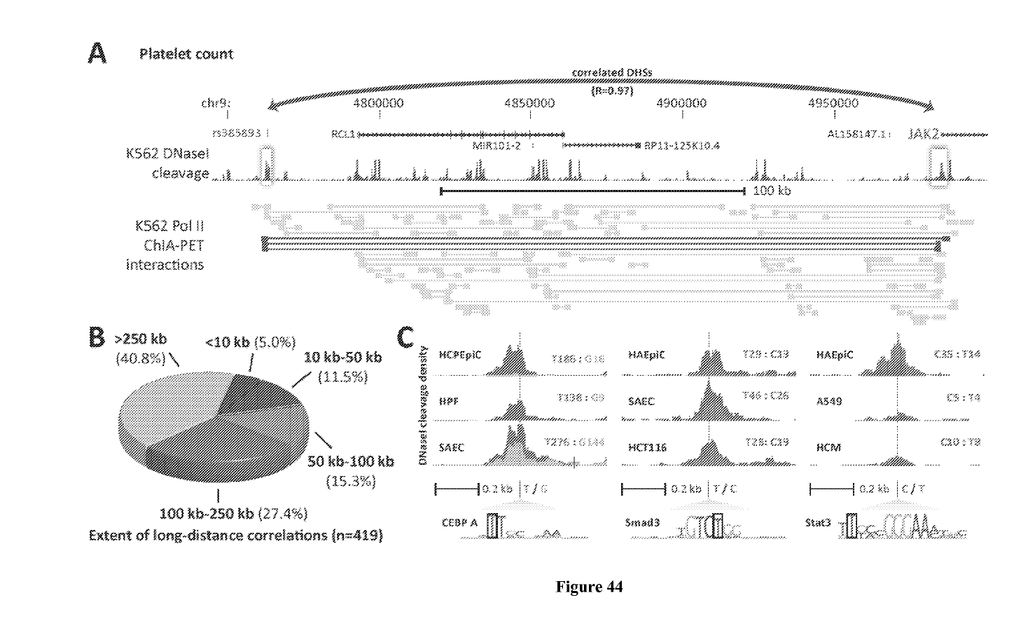

The distribution of 5,654 non-coding genome-wide significant associations was examined (5,134 unique SNPs; FIG. 43, Maurano et al., Systematic localization of common disease-associated variation in regulatory DNA. Science. 337 (6099):1190-5. Sep. 7, 2012. herein “Maurano et al., 2012”) for 207 diseases and 447 quantitative traits with the deep genome-scale maps of regulatory DNA marked by DHSs. This revealed a collective 40% enrichment of GWAS SNPs in DHSs (FIG. 43C, P<10⁻⁵⁵, binomial, compared to the distribution of HapMap SNPs). FIG. 43C illustrates overlap of noncoding GWAS SNPs (5,134 distinct SNPs) and regulatory DNA. FIG. 43C, horizontal axis, illustrates binned distances from DHSs. Central “0” bin contains only GWAS SNPs within DHSs. The overlap is highly significant, even when corrected for a baseline enrichment of HapMap SNPs in DHSs. Fully 76.6% of all non-coding GWAS SNPs either lie within a DHS (57.1%, 2,931 SNPs) or are in complete linkage disequilibrium (LD) with SNPs in a nearby DHS (19.5%, 999 SNPs) (FIG. 44A). FIG. 44 illustrates that disease-associated variation is concentrated in DNase1 hypersensitive sites. FIG. 44A illustrates proportions of non-coding GWAS SNPs localizing within DHSs (green); in complete linkage disequilibrium (r²=1) with a SNP in a DHS (blue); or neither (yellow). Note that 76.5% of GWAS SNPs are either within or in perfect LD with DHSs. To confirm this enrichment, variants were sampled from the 1000 Genomes Project with the same genomic feature localization (intronic vs. intergenic), distance from the nearest transcriptional start site, and allele frequency in individuals of European ancestry. Significant enrichment was confirmed both for SNPs within DHSs (P<10⁻⁵⁹, simulation) and also including variants in complete LD (r²=1) with SNPs in DHSs (P<10⁻³⁷, simulation) (Maurano et al., 2012). In an exemplary case (Maurano et al., 2012), the overlap of noncoding GWAS SNPs and regulatory DNA marked by DHSs was analyzed by a best-fit normal distribution of 1000 independent replicates of randomly-sampled SNPs matching all noncoding GWAS SNPs in genomic feature localization (intronic vs. intergenic), distance from the nearest TSS, and MAF in northwestern European populations. A monotonic increase in the enrichment of disease/trait variants in DHSs was observed with increasing quality of GWAS SNP experimental replication. Control sets consisting of all noncoding 1000 Genomes, HapMap CEU SNPs and Affymetrix 500K SNPs were used for comparison. An additional analysis was also performed using a similar method, but measuring the percentage of GWAS SNPs within or in complete LD with 1000 Genomes SNPs in DHSs.

In total, 47.5% of GWAS SNPs fall within gene bodies (FIG. 43B); however, only 10.9% of intronic GWAS SNPs within DHSs are in strong LD (r²>0.8) with a coding SNP, indicating that the vast majority of non-coding genic variants are not simply tagging coding sequence. Analogously, only 16.3% of GWAS variants within coding sequences are in strong LD with variants in DHSs. SNPs on widely used genotyping arrays (e.g., Affymetrix) were noted to be modestly enriched within DHSs (Maurano et al., 2012), possibly due to selection of SNPs with robust experimental performance in genotyping assays. However, no evidence was found for sequence composition bias (Table 8).

TABLE 8
Enrichment of GWAS and control sites for DHSs. Evaluation of factors that may contribute
to enrichment of sites within DHSs. Mean minor allele frequency (MAF) within the
CEU population was computed using 1000 Genomes data for all except HapMap. Standard
deviation (SD) of the MAF was −0.14 in all cases; SD was −1% of the mean for
each reported % CG value. Only noncoding sites were surveyed for this table. Note
that HapMap SNPs are not distinguished by G + C content. Further, although they
are not enriched for introns, within introns, HapMap SNPs are enriched for DHSs.

| | | | | Median | | | |
|---|---|---|---|---|---|---|---|
| | | | | distance | | | % Intronic |
| | % in | Enrichment | Mean | to nearest | Mean | % in | sites in |
| Sites | DHSs | for DHSs | MAF | TSS (kb) | % CG(±1.0 bp) | introns | DHSs |
| Random 36mer- | 41.1% | 1.00 | NA | 71.4 | 40.16 | 36.7% | 47.5% |
| mappable sites | | | | | | | |
| 1000 Genomes | 42.9% | 1.04 | 0.18 | 77.7 | 41.01 | 35.9% | 49.6% |
| CEU SNPs | | | | | | | |
| HapMap | 46.5% | 1.13 | 0.22 | 84.1 | 40.95 | 37.7% | 52.9% |
| CEU SNPs | | | | | | | |
| Affymetrix | 49.7% | 1.21 | 0.23 | 82.2 | 40.85 | 37.5% | 55.9% |
| 500k SNPs | | | | | | | |
| Unreplicated | 53.2% | 1.29 | 0.24 | 57.0 | 41.66 | 40.2% | 60.3% |
| GWAS SNPs | | | | | | | |
| Internally | 59.5% | 1.45 | 0.28 | 31.4 | 42.97 | 45.2% | 61.9% |
| replicated | | | | | | | |
| GWAS SNPs | | | | | | | |
| All GWAS | 57.1% | 1.39 | 0.26 | 40.7 | 42.36 | 43% | 62% |
| SNPs | | | | | | | |

To further examine the enrichment of GWAS SNPs in regulatory DNA, all non-coding GWAS SNPs were systematically classified by the quality of their experimental replication. This disclosed 2,436 unreplicated SNPs; 2,374 ‘internally-replicated’ SNPs (confirmed in a second population in the initial publication); and 324 ‘externally-replicated’ SNPs (confirmed in an independent study) (Maurano et al., 2012). A monotonic increase in the proportion of disease/trait variants localizing in DHSs was observed with increasing quality of GWAS SNP experimental replication (FIG. 44B), as well as with increasing strength of association and study sample size (Maurano et al., 2012). FIG. 44B illustrates proportions of GWAS SNPs overlapping DHSs after partitioning by degree of replication. In another exemplary analysis (Maurano et al., 2012), enrichment for regulatory DNA was observed to increase with strength of association, as demonstrated by an increasing percentage of GWAS SNPs in DHSs with increasing −log(P-value) and sample size. These progressive enrichments parallel FIG. 44B. For externally replicated non-coding SNPs, 69.8% lie within a DHS (n=226, P<10⁻¹⁴, simulation, Maurano et al., 2012). To exclude the influence of population stratification, the fixation index in African and European populations was compared between GWAS SNPs in DHSs and matched SNPs not in DHSs and found to be nearly identical (F_{ST}=0.0843 vs. 0.0847, respectively). The monotonic relationship between evidence for association and SNP concentration in DHSs strongly suggests that many variants are functional and that unreplicated or weaker associations may obscure the true degree of enrichment in DHSs.

Methods.

Disease- and Trait-Associated Variants from GWAS.

The GWAS SNP set used for analysis was derived from the NHGRI GWAS Catalog, downloaded on Jan. 4, 2012. The catalog is a continually-updated compendium of GWAS which lists the single SNP from each gene or region with the strongest disease association identified by the studies. Each study attempted to assay at least 100,000 SNPs across the genome. The catalog contained 6,896 entries at the time of download. SNPs mapping outside the main chromosome contigs, including the “random” chromosome fragments, SNPs without coordinates in the GRCh37/hg19 human genome assembly, SNPs without a dbSNP ID, and records which were a combination of multiple SNPs associated with a disease or trait were excluded. The catalog contained data from 920 publications mapping 679 total diseases or traits. There were 6,011 unique SNP-disease/trait combinations; as some SNPs have been associated with more than one disease or trait, these represent 5,386 unique dbSNP IDs. Of these, 5,654 associations and 5,134 SNPs were in noncoding regions (Maurano et al., 2012). Coding regions were defined by the CCDS Project (downloaded from the UCSC genome browser at http://hgdownload.cse.ucsc.edu/goldenPath/hg19/database/ccdsGene.txt.gz on Mar. 5, 2011).

For some analyses, SNPs were grouped into classes of similar diseases or traits, namely, aging-related; autoimmune disease; cancer; cardiovascular diseases and traits; diabetes-related; drug metabolism; hematological; kidney, lung, or liver; lipids, miscellaneous, neurological/behavioral; parasitic or bacterial disease; quantitative traits; radiographic (primarily bone density); serum metabolites; and viral disease.

Identification of Replicated GWAS Associations.

Not all reported associations from GWAS studies are replicated when tested in subsequent studies of the same disease or trait. It was examined whether associations with stronger evidence were more likely to map to DNaseI hypersensitive sites (DHSS). Data in the GWAS catalog was tabulated and the SNPs divided into three overlapping classes (Maurano et al., 2012) whose associations had varying levels of experimental support. SNPs were classified as “internally replicated” if the association was confirmed in a second replication population within the study as noted in the NHGRI GWAS Catalog. An association was classed as “externally replicated” if an association was observed in a second publication linking the same disease or trait to the same SNP. Associations which were not yet replicated by a second sample population within the study or by an independent study were classed as “un-replicated”. A SNP could be included in both the “internally replicated” and “externally replicated” class; in such cases it was treated as externally replicated for the purpose of analysis.

DNaseI Mapping.

DNaseI mapping was conducted on cultured cells, primary hematopoietic cells, and isolated fetal tissues using appropriate nuclei isolation protocols (Table 7). Because the cell culture and isolation and handling protocols differ for different cell types, they are not included here but rather are all available online and indexed with URLs in Table 7.

Isolation of Nuclei from Cultured Cells.

Cells were grown in accordance with protocols obtained from the source (Table 7). Freshly grown cells were centrifuged at 500 g for 5 minutes (4° C.) in an Eppendorf Centrifuge 5810R, and washed in cold PBS (Cellgro/Mediatech Inc.). Cell pellets were resuspended in Buffer A (15 mM Tris-Cl pH 8.0, 15 mM NaCl, 60 mM KCl, 1 mM EDTA (Ambion/Life Technologies Corp) pH 8.0, 0.5 mM EGTA (Boston BioProducts) pH 8.0, 0.5 mM spermidine (MP Biomedicals, LLC) and 0.15 mM spermine (MP Biomedicals, LLC) to a final concentration of 2×106 cells/mL. Nuclei were obtained by drop-wise addition of an equal volume of Buffer A containing 0.04% IGEPAL CA-630 (Sigma-Aldrich) to the cells, followed by incubation on ice for 10 min Nuclei were centrifuged at 1,000 g for 5 min and then resuspended and washed with 25 mL of cold Buffer A. Nuclei were resuspended in 2 mL of Buffer A at a final concentration of 1×107 nuclei/mL.

Isolation of Nuclei from Hematopoietic Cells.

Lymphocyte subclasses were isolated by immunomagnetic separation. Cells were pelleted by centrifugation for 5 minutes at 500 g at 4° C. Cells were washed in ice-cold PBS, then resuspended to 5 million cells per mL in Buffer A. An equal volume of ice-cold 2×IGEPAL CA-630 solution (ranging from 0.02%-0.06%) was added and the tube was incubated for 5-6 minutes on ice to lyse the cells. Nuclei were pelleted by centrifugation for 5 minutes at 500 g at 4° C., resuspended in Buffer A and counted with a hemocytometer.

Isolation of Nuclei from Fetal Tissues.

Tissue was minced, resuspended in cold 250 mM sucrose, 1 mM MgCl2, 10 mM Tris-Cl pH 7.5, with added EDTA Protease Inhibitor Cocktail (Roche Applied Science Corp.). Resuspended tissue from fetal brain, fetal lung, fetal kidney, and fetal adrenal was dissociated by slowly homogenizing with a Dounce homogenizer. Resuspended tissue from fetal heart or fetal intestine was dissociated in a gentleMACS Dissociator (Miltenyi Biotech Inc.). Following dissociation, all fetal tissues were filtered through a 100 uM filter, and nuclei pelleted by centrifugation 600 g for 10 minutes. Pelleted nuclei were washed with Buffer A, resuspended in Buffer A and counted in a hemocytometer.

DNaseI Mapping from Isolated Nuclei.

Isolated nuclei (2×10⁶) from suspension cells or dissociated tissue were washed with 15 mM Tris-Cl pH 8.0, 15 mM NaCl, 60 mM KCl, 1 mM EDTA pH 8.0, 0.5 mM EGTA pH 8.0, 0.5 mM spermidine and 0.15 mM spermine then subjected to DNaseI digestion for 3 min at 37° C. in 13.5 mM Tris-HCl pH 8.0, 87 mM NaCl, 54 mM KCl, 6 mM CaCl2, 0.9 mM EDTA, 0.45 mM EGTA, 0.45 mM Spermidine. Digestion was stopped by addition of 50 mM Tris-HCl pH 8.0, 100 mM NaCl, 0.1% SDS, 100 mM EDTA pH 8.0, 1 mM spermidine, 0.3 mM spermine. A range of DNaseI (Sigma-Aldrich), 10-80 U/mL) concentrations was used for each preparation of nuclei and the sample giving the optimum difference between DNaseI treated and untreated was used for sequencing library construction. DNaseI double-hit fragments were collected by ultra-centrifugation and gel-purified. Adaptors were ligated to the ends of purified fragments, and the resulting libraries sequenced on an Illumina Genome Analyzer IIx according to a standard protocol.

Processing of DNaseI-Seq Data.

For the ENCODE cell lines, the primary replicate was used for analysis. For the NIH Roadmap Epigenomics Consortium samples, data sets obtained from the tissues of fetal heart (12 developmental timepoint samples), fetal brain (12 developmental timepoint samples), fetal lung (34 developmental timepoint samples), fetal kidney (47 developmental timepoint samples), fetal intestine (15 developmental timepoint samples), fetal muscle (48 developmental timepoint and anatomical localization samples), fetal placenta (4 developmental timepoint samples), fetal skin (17 samples, 14 of which correspond to 7 replicate pairs from the same individual in different anatomical locations, 2 of which correspond to 1 replicate pair from a different individual and timepoint, and one sample from a third individual), fetal spinal cord (3 developmental timepoint samples), fetal stomach (11 developmental timepoint samples), fetal thymus (10 developmental timepoint samples), fetal adrenal (5 developmental timepoint samples), neonatal skin fibroblasts (4 samples corresponding to 2 replicate pairs from 2 different individuals), and neonatal skin keratinocytes (4 samples corresponding to 2 replicate pairs from 2 different individuals), the data was pooled following hotspot calculation from all timepoints and samples into a single DNaseI hypersensitivity profile for each tissue. 36-base reads with up to two mismatches were mapped to the human genome (GRCh37/hg19) using the sequence aligner BOWTIE. DHSs were identified using the Hotspot algorithm at a false discovery rate (FDR) threshold of 5%. Genomic feature overlaps and distance calculations were performed using the BEDOPS suite of software tools available at http://code.google.com/p/bedops/.

Data Availability.

The DNaseI data used in this study have been released as part of the ENCODE Project or the NIH Roadmap Epigenomics Mapping Consortium. Data released through both projects and available (Table 7) include mapped reads and hotspots that have not been filtered for FDR thresholding. These data have been deposited in GEO under accession numbers GSE29692 and GSE18927. Data are also available for download through www.uwencode.org/data and through www.epigenomebrowser.org.

Enrichment of GWAS SNPs within DHSs Relative to Genomic Space Occupied.

The P-values for the enrichment of GWAS SNPs in DHSs, and various classes of DHSs, were computed using the binomial cumulative distribution function b(x; n, p), the probability of x or more successes in n Bernoulli trials, with probability of success p. The R function pbinom was used for calculating b(x; n,p). The parameter n of the binomial was set to be equal to the total number of GWAS SNPs under consideration. For a given class of DHS the parameter p was set to be equal to the fraction of the 36-mer uniquely-mappable GRCh37/hg19 genome occupied by the DHS class (using 2,630,301,437 uniquely mappable bp), and parameter x equal to the number of the SNPs overlapped by the DHSs.

For comparison of the overlap of GWAS SNPs and DHSs to the overlap of HapMap SNPs and DHSs, 4,029,798 CEPH population (Utah residents with ancestry from northern and western Europe, CEU) HapMap SNPs were obtained from the UCSC Genome Browser (release 27, merged Phase II+Phase III genotypes, lifted over from hg18 to hg19, downloaded from genome.ucsc.edu using the Table Browser). To compute the enrichment of GWAS SNPs in DHSs relative to the enrichment of HapMap SNPs in DHSs (FIG. 43C), the expectation p was set to be equal to the fraction of HapMap SNPs overlapped by DHSs, n was set to be equal to the total number of GWAS SNPs, and x was set to be equal to the number of GWAS SNPs overlapped by DHSs.

Enrichment of GWAS SNPs in LD with SNPs in DHSs Relative to Randomly Chosen 1KG SNPs.

CEU population genotype data from the 1000 Genomes Project was used to compute the linkage disequilibrium (LD) measure r² between GWAS SNPs and SNPs in the DHSs near them. The September 2010 release was converted from GRCh36/hg18 to GRCh37/hg19 genomic coordinates using the UCSC Genome Browser liftOver tool. SNPs for which a phased genotype was not available for all 60 CEU individuals sampled, or more than two alleles were present within the genotypes, or the minor allele frequency (MAF) was under 2/120, were then excluded. The subset of these that were GWAS SNPs lying within intronic and intergenic regions (n=4,885) were then obtained, using the CCDS gene definitions. r² was computed between each such GWAS SNP lying outside a DHS and every SNP within a 125 kb radius lying within a DHS. The overall results were partitioned into three categories: GWAS SNPs within DHSs, GWAS SNPs achieving r²=1 with a SNP lying within a DHS within a 125 kb radius, and all GWAS SNPs not belonging to the first two categories.

For each of 4,885 noncoding GWAS SNPs meeting the filtering criteria, a SNP was drawn at random from the subset of 1000 Genomes noncoding SNPs having the same MAF, approximate distance from the transcription start site (TSS) of the nearest gene, and status of intronic or intergenic. This triple-matching procedure effectively accounts for any positional bias that may have been present in the SNP arrays. In addition to these three matching criteria, the G+C content was also verified to be the same between the GWAS SNPs and the matched control SNPs (Table 8).

1,000 independent, randomly-drawn replicate data sets of 4,885 SNPs were obtained, each set matched to the noncoding GWAS SNPs. For each replicate data set, the r² calculations and categorization of results were performed as had been done for the GWAS SNPs. The percentages of SNPs falling into these categories were tallied within each random data set and a normal distribution fit to these data (Maurano et al., 2012). To estimate the P-value for observing as many of the GWAS SNPs as had been done within the first two categories, the area of the upper tail of this distribution that exceeded the percentage of GWAS SNPs falling into these categories was computed (˜78%). The upper tail had no detectable area in the range beyond 100%. The percentage of noncoding GWAS SNPs within DHSs or achieving r2=1 with a SNP in a nearby DHS is significant at the level P<10⁻³⁷.

To verify that the DHSs showing such strong associations with possibly-functional GWAS SNPs are not merely surrogates for coding exons, any DHS overlapping any coding exon by at least 1 bp were then removed from consideration, and the percentages of GWAS and random-matched SNPs falling within a DHS re-measured. This only removed ˜4% of the DHSs, covering ˜45 Mbp, from the pool, and hence had a negligible effect. ˜77% of noncoding GWAS SNPs were found to lie within these DHSs or be in complete LD with them (P<10⁻²⁸).

Calculation of F_{ST} for GWAS SNPs.

All noncoding autosomal sites for which 1000 Genomes had fully-phased genotypes were identified in both the CEU and Yoruba from Nigeria (YRI) populations, and these partitioned into sites within DHSs and sites outside of DHSs. 150,000 of these DHS sites were then chosen at random, in the same proportion of intergenic to intronic sites that were observed in all noncoding 1000 Genomes CEU data across the autosomes (70.8% intergenic, 29.2% intronic). Next, for each intergenic DHS SNP, an intergenic non-DHS SNP with the same minor allele frequency in CEU located at approximately the same distance from its nearest TSS was chosen, and likewise for the intronic DHS SNPs. Any site at which the MAF pooled across the populations' genotypes fell below 10% was filtered out, leaving 122,648 SNPs in the within-DHSs set and 122,810 SNPs in the non-DHS set. F_{ST} was computed and values of 0.08433 and 0.08455 were obtained for these two SNP sets, respectively. Relaxing the restriction of matching on distance to the nearest TSS did not yield a significantly different result (0.08468). Virtually no difference in F_{ST} was observed between the two SNP sets when relaxing the constraint on MAF to 5% and 0%.

### Example 22

### GWAS Variants Localize in Cell- and Developmental Stage-Selective Regulatory DNA

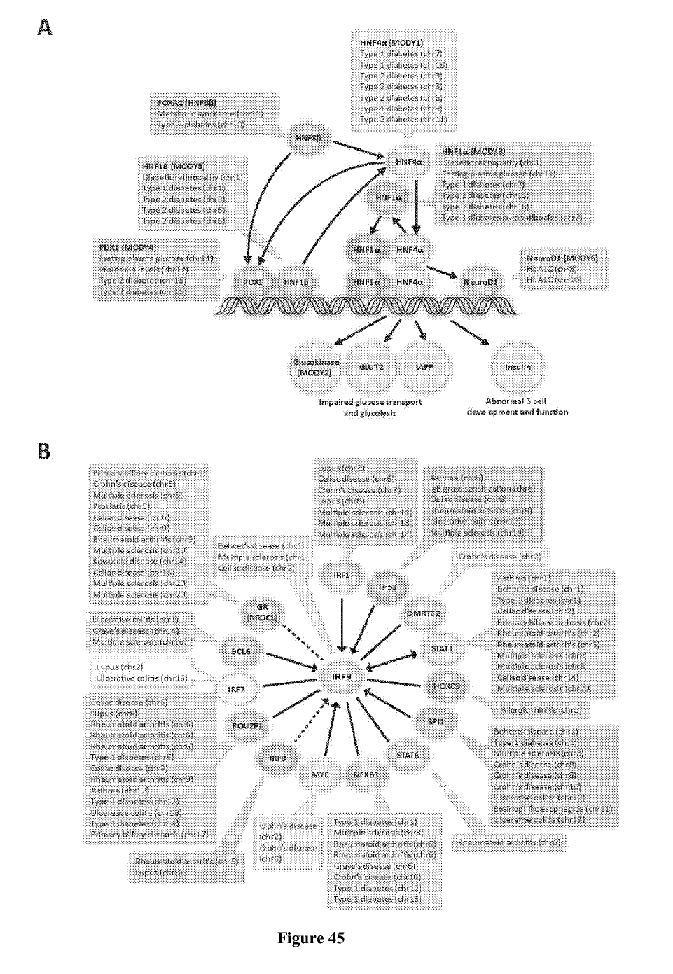

Selective localization within physiologically or pathogenically-relevant specific cell or tissue types was observed, including affected tissues or known or may effector cell types (FIG. 44C). FIG. 44 illustrates that disease-associated variation is concentrated in DNaseI hypersensitive sites. FIG. 44C illustrates representative DNaseI hypersensitivity (tag density) patterns at diverse disease-associated variants. For a given disorder, cell-selective localization within physiologically or pathogenically-relevant cell types was repeatedly observed for multiple independently-associated SNPs distributed widely around the genome (FIG. 45). FIG. 45 illustrates that multiple distinct genomic disease associations repeatedly localize within relevant cell-selective DHSs. Each cell represents the presence or absence of a DHS at the location of the given GWAS SNP. Yellow=DHS present in that cell/tissue class; black=absent. These results suggest a tissue-specific regulatory role for many common variants, as well as the potential for comprehensive regulatory DNA maps to illuminate associations within disease-relevant cell types.

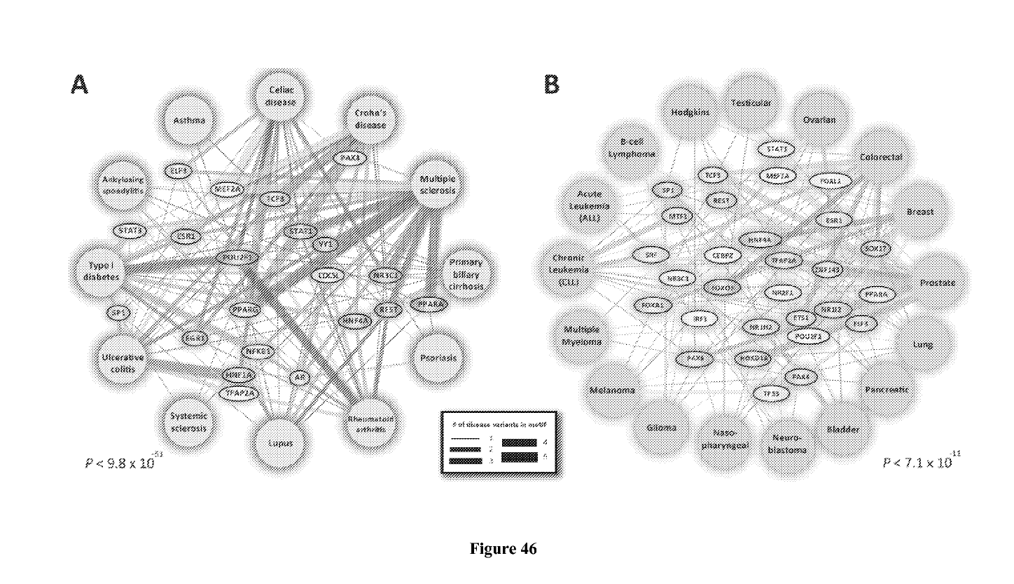

Many common disorders have been linked with early gestational exposures or environmental insults. Because of the known role of the chromatin accessibility landscape in mediating responses to cellular exposures such as hormones, it was examined if DHSs harboring GWAS variants were active during fetal developmental stages. Of 2,931 non-coding disease- and trait-associated SNPs within DHSs globally, 88.1% (2,583) lie within DHSs active in fetal cells and tissues. 57.8% of DHSs containing disease-associated variation are first detected in fetal cells and tissues and persist in adult cells (′fetal origin′ DHSs), while 30.3% are fetal stage-specific DHSs (FIG. 44D). FIG. 44D illustrates the proportion of GWAS SNPs localizing in DHSs active in fetal tissues that persist in adult cells (salmon); fetal stage-specific DHSs (red); and adult stage DHSs (green). GWAS variants in adult stage-specific DHSs localize chiefly in mature hematopoietic cells, connective tissue, endothelial cells, and malignant cells (FIG. 46). FIG. 46 illustrates localization of GWAS SNPs in DHSs of fetal and adult tissue classes. FIG. 46A illustrates a cumulative tally of GWAS SNPs by DHS tissue category. Each color denotes SNPs overlapping DHSs in that tissue type but not in preceding categories. Note that the vast majority of adult-stage DHSs with GWAS variants derive from either differentiated hematopoietic cells or cancer lines. FIG. 46B is same as (A) except for DHSs specific to a tissue class.

Next, the enrichment or depletion of replicated disease-specific GWAS variants in fetal stage DHSs relative to the proportion of total GWAS SNPs in these DHSs was analyzed. The greatest enrichment was found in phenotypes for which gestational exposures or growth trajectory have been shown to play major roles, including menarche, cardiovascular disease, and body mass index (FIG. 44E). FIG. 44E illustrates that GWAS SNPs in DHSs show phenotype-specific enrichment for fetal regulatory elements. By contrast, relative depletion was observed in fetal DHSs of aging-related diseases, cancer, and inflammatory disorders with presumed (postnatal) environmental triggers. These findings suggest a recurring connection between an exposure-responsive gestational chromatin landscape, regulatory genotype, and risk for specific classes of adult diseases and traits.

Methods.

Disease- and Trait-Associated Variants from GWAS.

The GWAS SNP set was used for analysis as previously described in Example 21 herein.

Identification of Replicated GWAS Associations.

The identification of replicated GWAS associations was performed as previously described in Example 21 herein.

DNaseI Mapping.

DNaseI mapping was conducted as previously described in Example 21 herein.

Isolation of Nuclei from Cultured Cells.

The isolation of nucleic from cultured cells was performed as previously described in Example 21 herein.

Isolation of Nuclei from Hematopoietic Cells.

The isolation of nuclei from hematopoietic cells was performed as previously described in Example 21 herein.

Isolation of Nuclei from Fetal Tissues.

The isolation of nuclei from fetal tissues was performed as previously described in Example 21 herein.

DNaseI Mapping from Isolated Nuclei.

DNaseI mapping from isolated nuclei was performed as previously described in Example 21 herein.

Processing of DNaseI-Seq Data.

The processing of DNaseI-seq data was performed as previously described in Example 21 herein.

Data Availability.

The DNaseI data used are available as previously described in Example 21 herein.

Disease-Specific Enrichment of GWAS SNPs in DHSs and Fetal-Origin DHSs.

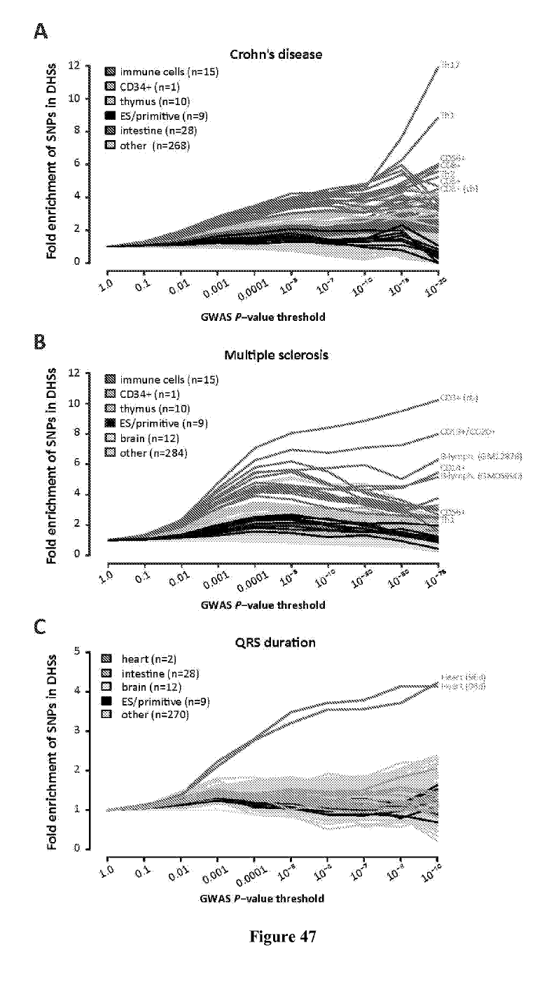

The enrichment of GWAS SNPs from particular diseases or traits in DHSs was computed (FIG. 47) by dividing the proportion of GWAS SNPs in DHSs by the overall proportion of GWAS SNPs in DHSs (57.1%). FIG. 47 illustrates enrichment of GWAS SNPs for DHSs by disease/trait, and shows the magnitude of enrichment or depletion of replicated GWAS SNPs in DHSs (Y-axis) for a given disease/trait (X-axis), relative to the background prevalence of all GWAS SNPs in DHSs (57.1%). Asterisks indicate the significance of the enrichment <0.05, binomial). Only traits with >15 internally- or externally-replicated associations are shown. Enrichments are reported as percentage enrichment or depletion. The individual significances of these enrichments was computed using the binomial distribution b(x; n, p), setting the parameter x to the number of GWAS SNPs of a given disease or trait in DHSs, n to the number of GWAS SNPs for the disease or trait, and p to 0.571.

The enrichment of GWAS SNPs from particular diseases or traits in fetal-origin DHSs (FIG. 44E) was computed by dividing the proportion of GWAS SNPs in fetal-origin DHSs by the overall proportion of GWAS SNPs in fetal-origin DHSs (88.1%). Enrichments are reported as percentage enrichment or depletion. The individual significances of these enrichments was computed using the binomial distribution b(x; n, p), setting the parameter x to the number of GWAS SNPs of a given disease or trait in fetal-origin DHSs, n to the number of GWAS SNPs for the disease or trait, and p to 0.881. To compensate for the overall enrichment or depletion of disease categories in DHSs in general, GWAS SNPs not in any DHS were excluded.

### Example 23

### DHSs Harboring GWAS Variants Control Distant Phenotype-Relevant Genes

Enhancers may lie at great distances from the gene(s) they control and function through long-range regulatory interactions, complicating the identification of target genes of regulatory GWAS variants. Most DHSs display quantitative, cell-selective DNaseI hypersensitivity patterns which may be systematically correlated with DNaseI sensitivity patterns at cis-linked promoters. DHSs that are strongly correlated (R>0.7) with specific promoters function as enhancers that physically interact with their target promoter as detected by chromosome conformation capture methods including 5C and ChIA-PET.

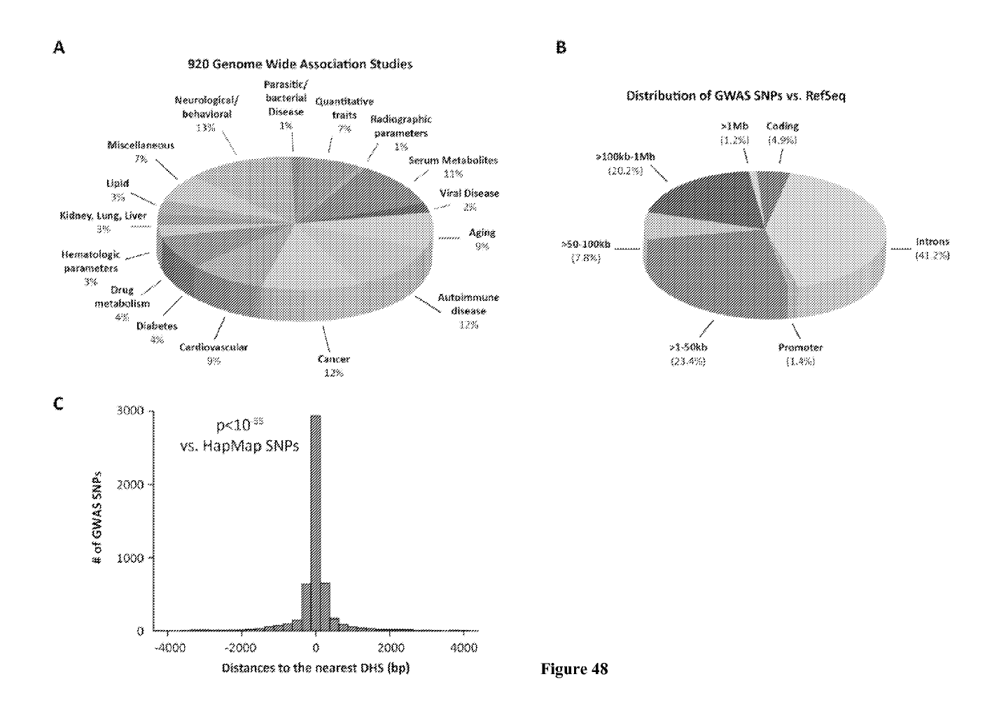

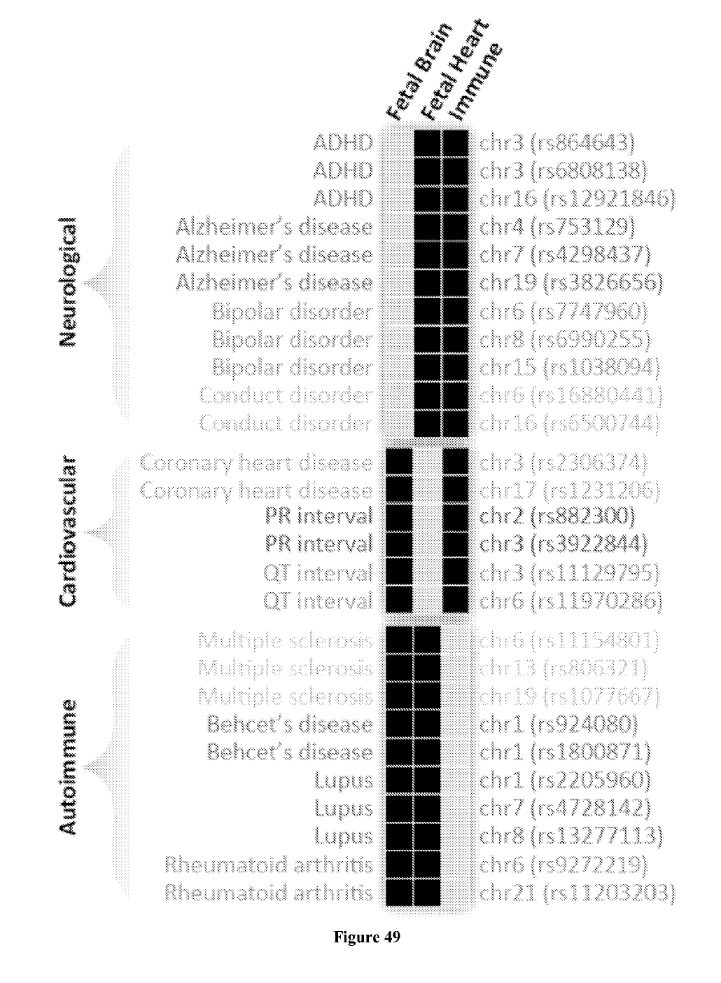

To systematically identify the genic targets of DHSs harboring GWAS variants and thereby gain insights into disease mechanisms, the approach described herein in Examples 14-20 was applied to the much broader range of cell and tissue types in the present study, and the result sets intersected with GWAS data. This analysis revealed 419 DHSs harboring GWAS variants that were strongly correlated (R>0.7) with the promoter of a specific target gene within +500 kb of the DHS (Table 9, Table 10). Among these are numerous examples of target genes that plausibly explain the disease or trait association (Table 11, FIG. 48). FIG. 48 illustrates that regulatory GWAS variants are linked to distant target genes. FIG. 48A illustrates a DHS specific to fetal heart, connected with the gene encoding atrial natriuretic peptide A (NPPA), harbors a GWAS variant associated with atrial fibrillation. FIG. 48B illustrates a distant (336 kb) DHS connected with retinoic acid receptor-alpha (RARA), a nuclear receptor involved in myeloid differentiation, harbors a GWAS variant associated with white blood cell count. For example, a SNP (rs385893) associated with platelet count lies in a DHS tightly correlated (R=0.97) and physically interacting with the 222 kb distant promoter of JAK2, a cytokine-activated signal transducer linked with platelet coagulation and myeloprofilerative disorders (FIG. 49A). FIG. 49 illustrates candidate regulatory roles for GWAS SNPs. FIG. 49A illustrates that a GWAS variant associated with platelet count is connected with the JAK2 gene (myeloproliferative disorders) 222 kb away. FIG. 49A, below, illustrates that ChIA-PET tags validate direct chromatin interactions between this DHS and the JAK2 promoter; red tags demonstrate an interaction between these DHSs. Fully 40.8% of correlated DHS-gene pairs span >250 kb (FIG. 49B), and 79% represent pairings with distant promoters vs. those of the nearest gene (Table 9, Table 10). FIG. 49B illustrates the proportion of DHSs harboring GWAS variants that can be linked to target promoters at the indicated distance. Notably, these interactions typically extend beyond the range of LD (mean r²=0.06; Table 9).

TABLE 9
Genes correlated with distal DHSs harboring GWAS SNPs (Part I). 347 trait-SNP associations (296
unique SNPs) overlapping predicted long-distance interactions established by correlation of chromatin
accessibility (r). LD measures the mean extent of LD between the correlated DHSs (r²); NA means filtered
1000 Genomes SNPs with MAF 5% in the CEU population were not found within 2 kb of both DHSs. Cor_{—}
gene_name represents the most-correlated gene; Dist, distance to gene in kb. “Adjacent?”, whether the
highest-correlated gene is an adjacent gene.

| | Disease or | | | | Cor_gene_{—} | | |
|---|---|---|---|---|---|---|---|
| SNP | trait | Trait Category | r | LD | name | Dist | Adjacent? |
| rs10202497 | Aging_traits- | Aging | 0.75 | 0.05 | COL6A3 | 52 | Y |
| | age_free_from_{—} | | | | | | |
| | disease | | | | | | |
| rs10781380 | Hippocampal_{—} | Aging | 0.93 | 0.01 | FOXB2 | 226 | N |
| | atrophy | | | | | | |
| rs11006923 | Alzheimers_disease | Aging | 0.70 | 0.06 | RP11- | 128 | N |
| | | | | | 351M16.2 | | |
| rs1172822 | Menopause | Aging | 0.95 | 0.01 | NLRP2 | −347 | N |
| rs12203592 | Progressive_{—} | Aging | 0.85 | 0.01 | RP3- | −241 | N |
| | supranuclear_palsy | | | | 416J7.3 | | |
| rs1532278 | Alzheimers_disease_{—} | Aging | 0.81 | 0.01 | RP11- | 89 | N |
| | late_onset | | | | 16P20.2 | | |
| rs1561570 | Pagets_disease | Aging | 0.71 | 0.03 | RP11- | −53 | N |
| | | | | | 730A19.2 | | |
| rs1564282 | Parkinsons_disease | Aging | 0.88 | 0.05 | CPLX1 | −54 | N |
| rs1569476 | Alzheimers_Total_{—} | Aging | 0.98 | 0.03 | SCYL3 | 250 | N |
| | ventricular_volume | | | | | | |
| rs157580 | Alzheimers- | Aging | 0.85 | 0.00 | CEACAM19 | −221 | N |
| | AB1-42 | | | | | | |
| rs157580 | Alzheimers_disease | Aging | 0.85 | 0.00 | CEACAM19 | −221 | N |
| rs16938437 | Menarche | Aging | 0.89 | 0.29 | PHF21A | −71 | Y |
| rs1695739 | Longevity | Aging | 0.78 | 0.01 | DDX25 | −405 | N |
| rs1934951 | Osteonecrosis_{—} | Aging | 0.88 | 0.16 | RP11- | 192 | N |
| | of_the_jaw | | | | 310E22.4 | | |
| rs2104362 | Amyotrophic_{—} | Aging | 1.00 | 0.02 | SYNGAP1 | −412 | N |
| | lateral_sclerosis- | | | | | | |
| | age_of_onset | | | | | | |
| rs2121433 | Alzheimers-t- | Aging | 0.76 | 0.01 | AC105402.1 | 65 | Y |
| | tau | | | | | | |
| rs2244621 | Longevity | Aging | 0.92 | 0.01 | RASGRP2 | 484 | N |
| rs2687729 | Menarche | Aging | 0.73 | 0.01 | DNAJB8 | 291 | N |
| rs2899472 | Alzheimers- | Aging | 0.74 | 0.03 | GLDN | 153 | N |
| | AB1-42 | | | | | | |
| rs3825776 | Amyotrophic_{—} | Aging | 0.71 | 0.02 | AQP9 | −316 | N |
| | lateral_sclerosis | | | | | | |
| rs4955755 | Menopause | Aging | 0.87 | 0.01 | CLDN11 | −339 | N |
| rs5937496 | Amyotrophic_{—} | Aging | 0.86 | N/A | SAR1AP4 | −288 | N |
| | lateral_sclerosis | | | | | | |
| rs6031882 | Hippocampal_{—} | Aging | 0.72 | 0.01 | BLCAP | 348 | N |
| | atrophy | | | | | | |
| rs6602175 | Alzheimers- | Aging | 0.77 | 0.02 | TRDMT1 | 101 | N |
| | Whole- | | | | | | |
| | brain_volume | | | | | | |
| rs6701713 | Alzheimers_disease_{—} | Aging | 0.85 | 0.00 | PLXNA2 | 428 | N |
| | late_onset | | | | | | |
| rs9652490 | Essential_tremor | Aging | 0.77 | 0.01 | SH2D7 | 421 | N |
| rs9871760 | Alzheimers- | Aging | 0.82 | 0.12 | RP11- | −52 | Y |
| | Whole- | | | | 305F5.2 | | |
| | brain_volume | | | | | | |
| rs10036748 | Systemic_lupus_{—} | Autoimmune | 0.78 | 0.01 | ANXA6 | 63 | N |
| | erythematosus | | | | | | |
| rs10737562 | Systemic_lupus_{—} | Autoimmune | 0.83 | 0.65 | RP11- | 21 | Y |
| | erythematosus | | | | 398M15.1 | | |
| rs1077667 | Multiple_sclerosis | Autoimmune | 0.80 | 0.01 | GTF2F1 | −277 | N |
| rs10931468 | Primary_biliary_{—} | Autoimmune | 0.81 | 0.03 | TMEM194B | −147 | N |
| | cirrhosis | | | | | | |
| rs11154801 | Multiple_sclerosis | Autoimmune | 0.90 | 0.15 | AHI1 | −95 | Y |
| rs11616188 | Ankylosing_{—} | Autoimmune | 0.91 | 0.01 | NCAPD2 | 122 | N |
| | spondylitis | | | | | | |
| rs11742570 | Crohns_disease | Autoimmune | 0.77 | 0.03 | PTGER4 | 271 | Y |
| rs12212193 | Multiple_sclerosis | Autoimmune | 0.73 | 0.01 | GJA10 | −394 | N |
| rs12580100 | Psoriasis | Autoimmune | 0.73 | 0.05 | SLC39A5 | 185 | N |
| rs1295686 | Asthma | Autoimmune | 0.91 | 0.24 | AC004041.2 | 4 | Y |
| rs1335532 | Multiple_sclerosis | Autoimmune | 0.92 | 0.01 | CD101 | 443 | N |
| rs1551398 | Crohns_disease | Autoimmune | 1.00 | 0.00 | TRIB1 | −95 | N |
| rs17035378 | Celiac_disease | Autoimmune | 0.87 | 0.02 | ARHGAP25 | 363 | N |
| rs17582416 | Crohns_disease | Autoimmune | 0.71 | 0.51 | RP11- | 232 | N |
| | | | | | 324I22.2 | | |
| rs17716942 | Psoriasis | Autoimmune | 0.71 | 0.01 | AC007740.1 | 365 | N |
| rs1790100 | Multiple_sclerosis | Autoimmune | 0.98 | 0.01 | RP11- | −422 | N |
| | | | | | 324E6.4 | | |
| rs1800871 | Behcets_disease | Autoimmune | 0.88 | 0.01 | PFKFB2 | 297 | N |
| rs2056626 | Systemic_sclerosis | Autoimmune | 0.82 | 0.01 | ILDR2 | −476 | N |
| rs2075726 | Ankylosing_{—} | Autoimmune | 0.88 | 0.01 | LL22NC01- | 50 | N |
| | spondylitis | | | | 81G9.3 | | |
| rs2104286 | Multiple_sclerosis | Autoimmune | 0.70 | 0.11 | IL2RA | −29 | Y |
| rs2187668 | Systemic_lupus_{—} | Autoimmune | 0.88 | 0.01 | BRD2 | 335 | N |
| | erythematosus | | | | | | |
| rs2205960 | Systemic_lupus_{—} | Autoimmune | 0.91 | 0.01 | SLC9A11 | 379 | N |
| | erythematosus | | | | | | |
| rs2233287 | Systemic_sclerosis | Autoimmune | 0.86 | 0.02 | ANXA6 | 68 | N |
| rs2273017 | Graves_disease | Autoimmune | 0.72 | 0.03 | CFB | −424 | N |
| rs2431697 | Systemic_lupus_{—} | Autoimmune | 0.85 | 0.01 | PWWP2A | −334 | N |
| | erythematosus | | | | | | |
| rs2546890 | Multiple_sclerosis | Autoimmune | 0.87 | 0.02 | EBF1 | −313 | N |
| rs2546890 | Psoriasis | Autoimmune | 0.87 | 0.02 | EBF1 | −313 | N |
| rs2618476 | Systemic_lupus_{—} | Autoimmune | 0.93 | 0.11 | BLK | 50 | Y |
| | erythematosus | | | | | | |
| rs2734583 | Stevens-Johnson_{—} | Autoimmune | 0.80 | 0.04 | WASF5P | −249 | N |
| | syndrome_{—} | | | | | | |
| | and_necrolysis | | | | | | |
| rs2836878 | Inflammatory_{—} | Autoimmune | 0.80 | 0.03 | LCA5L | 352 | N |
| | bowel_disease | | | | | | |
| rs2836878 | Ulcerative_colitis | Autoimmune | 0.80 | 0.03 | LCA5L | 352 | N |
| rs3024505 | Crohns_disease | Autoimmune | 0.79 | 0.33 | IL10 | 6 | Y |
| rs3024505 | Ulcerative_colitis | Autoimmune | 0.79 | 0.33 | IL10 | 6 | Y |
| rs3129763 | Systemic_sclerosis | Autoimmune | 0.98 | N/A | HLA-DRA | −183 | N |
| rs3821236 | Systemic_sclerosis | Autoimmune | 0.74 | 0.02 | STAT4 | 113 | Y |
| rs3821236 | Systemic_lupus_{—} | Autoimmune | 0.74 | 0.02 | STAT4 | 113 | Y |
| | erythematosus | | | | | | |
| rs4075958 | Multiple_sclerosis | Autoimmune | 0.90 | 0.02 | GRK6 | 74 | N |
| rs4129267 | Asthma | Autoimmune | 0.88 | 0.39 | IL6R | −19 | Y |
| rs4349859 | Ankylosing_{—} | Autoimmune | 0.92 | 0.02 | POU5F1 | −229 | N |
| | spondylitis | | | | | | |
| rs4409764 | Crohns_disease | Autoimmune | 0.90 | 0.02 | DNMBP | 390 | N |
| rs4639966 | Systemic_lupus_{—} | Autoimmune | 0.99 | N/A | NLRX1 | 473 | N |
| | erythematosus | | | | | | |
| rs4781011 | Ulcerative_colitis | Autoimmune | 0.75 | 0.01 | AC007014.1 | 144 | N |
| rs4845783 | Asthma | Autoimmune | 0.81 | 0.04 | LCE3A | 103 | N |
| rs485499 | Primary_biliary_{—} | Autoimmune | 0.71 | 0.01 | SMC4 | 392 | N |
| | cirrhosis | | | | | | |
| rs5754217 | Systemic_lupus_{—} | Autoimmune | 0.86 | N/A | PI4KAP2 | −73 | N |
| | erythematosus | | | | | | |
| rs6074022 | Multiple_sclerosis | Autoimmune | 0.96 | 0.00 | SLC35C2 | 252 | N |
| rs610604 | Psoriasis | Autoimmune | 0.84 | 0.29 | TNFAIP3 | −11 | Y |
| rs6806528 | Celiac_disease | Autoimmune | 0.89 | 0.18 | FRMD4B | −3 | Y |
| rs6859219 | Rheumatoid_{—} | Autoimmune | 0.75 | 0.09 | RPL17P22 | −13 | Y |
| | arthritis | | | | | | |
| rs6941421 | Multiple_sclerosis | Autoimmune | 0.96 | 0.22 | RP1-190J20.2 | 18 | N |
| rs734999 | Ulcerative_colitis | Autoimmune | 0.84 | 0.00 | C1orf86 | −369 | N |
| rs7579944 | Rheumatoid_{—} | Autoimmune | 0.84 | 0.01 | AC016907.2 | −146 | N |
| | arthritis_celiac_{—} | | | | | | |
| | disease | | | | | | |
| rs794185 | Multiple_sclerosis- | Autoimmune | 0.75 | 0.01 | ITPR1 | 419 | N |
| | Brain_Glutamate_{—} | | | | | | |
| | Concentrations | | | | | | |
| rs806321 | Multiple_sclerosis | Autoimmune | 1.00 | 0.10 | DLEU1 | 43 | Y |
| rs881375 | Rheumatoid_{—} | Autoimmune | 0.97 | 0.07 | RP11-27I1.2 | −44 | N |
| | arthritis | | | | | | |
| rs924080 | Behcets_disease | Autoimmune | 0.87 | 0.01 | IL12RB2 | 13 | Y |
| rs943072 | Ulcerative_colitis | Autoimmune | 0.92 | 0.01 | SLC35B2 | 429 | N |
| rs987870 | Asthma | Autoimmune | 0.92 | 0.06 | MYL8P | 261 | N |
| rs987870 | Systemic_sclerosis | Autoimmune | 0.92 | 0.06 | MYL8P | 261 | N |
| rs9888739 | Systemic_lupus_{—} | Autoimmune | 0.97 | 0.03 | STX4 | −265 | N |
| | erythematosus | | | | | | |
| rs10510102 | Breast_cancer | Cancer | 0.92 | 0.01 | RPS15AP5 | −152 | N |
| rs11892031 | Bladder_cancer | Cancer | 0.92 | 0.03 | AC019221.4 | −302 | N |
| rs12653946 | Prostate_cancer | Cancer | 0.92 | 0.04 | RP11- | 72 | N |
| | | | | | 259O2.3 | | |
| rs13397985 | Chronic_{—} | Cancer | 0.97 | 0.05 | AC009950.1 | −23 | N |
| | lymphocytic_{—} | | | | | | |
| | leukemia | | | | | | |
| rs1432295 | Hodgkins_lymphoma | Cancer | 0.96 | N/A | AC007381.3 | −486 | N |
| rs16886165 | Breast_cancer | Cancer | 0.88 | 0.23 | MAP3K1 | 158 | N |
| rs2157719 | Glioma | Cancer | 0.97 | 0.00 | RP11- | −398 | N |
| | | | | | 344A7.1 | | |
| rs2456449 | Chronic_{—} | Cancer | 0.87 | 0.05 | RP11- | −98 | N |
| | lymphocytic_{—} | | | | 255B23.2 | | |
| | leukemia | | | | | | |
| rs28421666 | Nasopharyngeal_{—} | Cancer | 0.85 | 0.02 | BRD2 | 348 | N |
| | carcinoma | | | | | | |
| rs339331 | Prostate_cancer | Cancer | 0.97 | 0.03 | FAM26D | −335 | N |
| rs402710 | Lung_cancer | Cancer | 0.88 | 0.39 | CLPTM1L | 18 | Y |
| rs4132601 | Acute_{—} | Cancer | 0.75 | 0.02 | AC020743.3 | −226 | N |
| | lymphoblastic_{—} | | | | | | |
| | leukemia_childhood | | | | | | |
| rs4487645 | Multiple_myeloma | Cancer | 0.96 | 0.01 | DNAH11 | −344 | Y |
| rs4975616 | Lung_cancer | Cancer | 0.96 | 0.35 | CLPTM1L | 16 | Y |
| rs4980785 | Renal_cell_{—} | Cancer | 0.77 | 0.01 | RP11- | 322 | N |
| | carcinoma | | | | 300I6.5 | | |
| rs498872 | Glioma | Cancer | 0.71 | 0.02 | SLC37A4 | 423 | N |
| rs674313 | Chronic_{—} | Cancer | 0.92 | 0.05 | PSMB8 | 232 | N |
| | lymphocytic_{—} | | | | | | |
| | leukemia | | | | | | |
| rs7579899 | Renal_cell_{—} | Cancer | 0.72 | 0.02 | RP11- | 188 | N |
| | carcinoma | | | | 417F21.2 | | |
| rs961253 | Colorectal_cancer | Cancer | 0.96 | 0.01 | RP5- | 312 | N |
| | | | | | 859D4.3 | | |
| rs10765792 | Sudden_cardiac_{—} | Cardiovascular | 0.90 | 0.01 | FAM76B | −350 | N |
| | arrest | | | | | | |
| rs11710077 | QRS_duration | Cardiovascular | 0.96 | 0.02 | SCN10A | 181 | N |
| rs12046278 | Systolic_blood_{—} | Cardiovascular | 0.87 | 0.01 | MASP2 | 308 | N |
| | pressure | | | | | | |
| rs12576239 | QT_interval | Cardiovascular | 0.98 | N/A | ASCL2 | −210 | N |
| rs1378942 | Diastolic_blood_{—} | Cardiovascular | 0.84 | 0.09 | SEMA7A | −351 | N |
| | pressure | | | | | | |
| rs1378942 | Systolic_blood_{—} | Cardiovascular | 0.84 | 0.09 | SEMA7A | −351 | N |
| | pressure | | | | | | |
| rs1378942 | Blood_pressure | Cardiovascular | 0.84 | 0.09 | SEMA7A | −351 | N |
| rs16857031 | QT_interval | Cardiovascular | 0.92 | 0.01 | OLFML2B | −157 | N |
| rs16933812 | Blood_pressure | Cardiovascular | 0.82 | 0.02 | RP11- | 465 | N |
| | | | | | 397D12.7 | | |
| rs17259784 | Cardiac_{—} | Cardiovascular | 0.71 | 0.04 | RP11- | 49 | N |
| | hypertrophy | | | | 565N2.2 | | |
| rs1746048 | Coronary_heart_{—} | Cardiovascular | 0.98 | 0.01 | RP11- | 327 | N |
| | disease | | | | 733D4.1 | | |
| rs1746048 | Myocardial_{—} | Cardiovascular | 0.98 | 0.01 | RP11- | 327 | N |
| | infarction | | | | 733D4.1 | | |
| rs17672135 | Coronary_heart_{—} | Cardiovascular | 0.76 | 0.06 | FMN2 | −47 | Y |
| | disease | | | | | | |
| rs17691394 | Carotid_{—} | Cardiovascular | 0.92 | 0.00 | GRM8 | 430 | N |
| | atherosclerosis_{—} | | | | | | |
| | in_HIV_infection | | | | | | |
| rs190759 | Sudden_cardiac_{—} | Cardiovascular | 0.84 | 0.01 | TFAP2B | −198 | N |
| | arrest | | | | | | |
| rs2074238 | QT_interval | Cardiovascular | 0.73 | 0.01 | AC013791.2 | 307 | Y |
| rs4638289 | Atherosclerosis | Cardiovascular | 0.98 | 0.01 | TSG101 | 222 | N |
| rs4687718 | QRS_duration | Cardiovascular | 0.89 | N/A | TMEM110- | −405 | N |
| | | | | | MUSTN1 | | |
| rs54211 | Sudden_cardiac_{—} | Cardiovascular | 0.73 | 0.01 | CTA- | −293 | N |
| | arrest | | | | 150C2.16 | | |
| rs6801957 | QRS_duration | Cardiovascular | 0.85 | 0.04 | SCN10A | 72 | Y |
| rs7808424 | Coronary_heart_{—} | Cardiovascular | 0.86 | 0.37 | AC003045.1 | 15 | N |
| | disease | | | | | | |
| rs789852 | QT_interval | Cardiovascular | 0.93 | 0.01 | ATP13A3 | −146 | N |
| rs8049607 | QT_interval | Cardiovascular | 0.70 | 0.01 | PRM1 | −314 | N |
| rs880315 | Diastolic_blood_{—} | Cardiovascular | 0.97 | N/A | RP11- | 157 | N |
| | pressure | | | | 340B24.3 | | |
| rs880315 | Systolic_blood_{—} | Cardiovascular | 0.97 | N/A | RP11- | 157 | N |
| | pressure | | | | 340B24.3 | | |
| rs9298506 | Intracranial_{—} | Cardiovascular | 0.95 | 0.35 | RP11- | 28 | Y |
| | aneurysm | | | | 53M11.3 | | |
| rs944260 | Sudden_cardiac_{—} | Cardiovascular | 0.77 | 0.01 | RP11- | 52 | Y |
| | arrest | | | | 429E11.3 | | |
| rs9470361 | QRS_duration | Cardiovascular | 0.84 | 0.01 | RP1- | 272 | N |
| | | | | | 90K10.3 | | |
| rs9581094 | Sudden_cardiac_{—} | Cardiovascular | 0.73 | 0.23 | PARP4 | 4 | Y |
| | arrest | | | | | | |
| rs964184 | Coronary_heart_{—} | Cardiovascular | 0.90 | 0.04 | SIK3 | 96 | N |
| | disease | | | | | | |
| rs11867934 | Diabetic_{—} | Diabetes | 0.96 | N/A | FLCN | 195 | N |
| | retinopathy | | | | | | |
| rs17696736 | Type_1_diabetes | Diabetes | 0.75 | 0.08 | ACAD10 | −343 | N |
| rs2237897 | Type_2_diabetes | Diabetes | 0.72 | 0.01 | OSBPL5 | 253 | N |
| rs3007729 | Diabetic_{—} | Diabetes | 0.82 | 0.02 | IGSF21 | −95 | N |
| | retinopathy | | | | | | |
| rs3024505 | Type_1_diabetes_{—} | Diabetes | 0.79 | 0.33 | IL10 | 6 | Y |
| | autoantibodies | | | | | | |
| rs3024505 | Type_1_diabetes | Diabetes | 0.79 | 0.33 | IL10 | 6 | Y |
| rs5753037 | Type_1_diabetes | Diabetes | 0.77 | 0.26 | HORMAD2 | −63 | N |
| rs7111341 | Type_1_diabetes | Diabetes | 0.95 | 0.02 | IGF2 | −43 | N |
| rs7171171 | Type_1_diabetes_{—} | Diabetes | 0.74 | 0.04 | C15orf53 | 82 | Y |
| | autoantibodies | | | | | | |
| rs10202231 | Response_to_{—} | Drug_metabolism | 0.99 | 0.01 | RP11- | 438 | N |
| | antipsychotic_{—} | | | | 416L21.1 | | |
| | therapy_perphenazine- | | | | | | |
| | triglycerides | | | | | | |
| rs1061235 | Response_to_{—} | Drug_metabolism | 0.83 | 0.14 | HLA-A | −3 | N |
| | carbamapezine | | | | | | |
| rs10950821 | Response_to_{—} | Drug_metabolism | 0.84 | 0.01 | MACC1 | −390 | N |
| | statin_therapy- | | | | | | |
| | acylcarnitine | | | | | | |
| rs12147450 | Response_to_{—} | Drug_metabolism | 0.77 | 0.01 | CCNB1IP1 | −160 | N |
| | antipsychotic_{—} | | | | | | |
| | therapy_{—} | | | | | | |
| | extrapyramidal_{—} | | | | | | |
| | side_effects | | | | | | |
| rs1535 | Response_to_{—} | Drug_metabolism | 0.92 | 0.01 | C11orf66 | −342 | N |
| | statin_therapy- | | | | | | |
| | braces | | | | | | |
| rs2163287 | Response_to_{—} | Drug_metabolism | 0.97 | N/A | SERAC1 | 499 | N |
| | antidepressants- | | | | | | |
| | bupropion | | | | | | |
| rs2830840 | Response_to_{—} | Drug_metabolism | 0.71 | 0.01 | AP001601.2 | −404 | N |
| | citalopram_{—} | | | | | | |
| | treatment | | | | | | |
| rs286913 | Response_to_{—} | Drug_metabolism | 0.96 | 0.01 | ELF5 | −120 | N |
| | antipsychotic_{—} | | | | | | |
| | therapy-FEV1/ | | | | | | |
| | FVC | | | | | | |
| rs2954038 | Response_to_{—} | Drug_metabolism | 0.99 | 0.02 | TRIB1 | −62 | N |
| | statin_therapy- | | | | | | |
| | Triglyceride_{—} | | | | | | |
| | sum | | | | | | |
| rs3753242 | Olanzapine_{—} | Drug_metabolism | 0.91 | 0.45 | PRKCZ | −3 | Y |
| | Schizophrenia_{—} | | | | | | |
| | neurocognition | | | | | | |
| rs3795578 | Acetaminophen_{—} | Drug_metabolism | 1.00 | 0.01 | RP11- | 204 | N |
| | hepatotoxicity | | | | 203F10.6 | | |
| rs9658108 | Response_to_{—} | Drug_metabolism | 0.73 | 0.33 | ZNF76 | −105 | N |
| | antipsychotic_{—} | | | | | | |
| | therapy_{—} | | | | | | |
| | clozapine- glucose | | | | | | |
| rs1034566 | Platelet_count | Hematological_{—} | 0.99 | 0.23 | ARVCF | −6 | Y |
| | | param | | | | | |
| rs10489087 | Red_blood_{—} | Hematological_{—} | 0.94 | 0.01 | RP11- | 23 | Y |
| | cell_count | param | | | 341G5.1 | | |
| rs11628318 | Platelet_count | Hematological_{—} | 0.89 | 0.02 | RAGE | −335 | Y |
| | | param | | | | | |
| rs12566888 | Platelet_{—} | Hematological_{—} | 0.87 | 0.00 | IQGAP3 | −360 | N |
| | aggregation-ADP | param | | | | | |
| rs12566888 | Platelet_{—} | Hematological_{—} | 0.87 | 0.00 | IQGAP3 | −360 | N |
| | aggregation- | param | | | | | |
| | epinephrine | | | | | | |
| rs12718597 | Mean_corpuscular_{—} | Hematological_{—} | 0.72 | 0.01 | AC020743.3 | −184 | N |
| | volume | param | | | | | |
| rs1354034 | Mean_platelet_{—} | Hematological_{—} | 0.92 | N/A | CCDC66 | −199 | N |
| | volume | param | | | | | |
| rs1354034 | Platelet_count | Hematological_{—} | 0.92 | N/A | CCDC66 | −199 | N |
| | | param | | | | | |
| rs1408272 | Mean_corpuscular_{—} | Hematological_{—} | 0.70 | 0.06 | TRIM38 | 124 | N |
| | hemoglobin | param | | | | | |
| rs1558324 | Mean_platelet_{—} | Hematological_{—} | 0.87 | 0.13 | VWF | −55 | N |
| | volume | param | | | | | |
| rs2336384 | Platelet_count | Hematological_{—} | 0.80 | 0.05 | MIIP | 34 | N |
| | | param | | | | | |
| rs385893 | Platelet_count | Hematological_{—} | 0.97 | 0.01 | JAK2 | 221 | N |
| | | param | | | | | |
| rs3859192 | WBC_count | Hematological_{—} | 0.85 | 0.02 | RARA | 336 | N |
| | | param | | | | | |
| rs4148441 | Platelet_count | Hematological_{—} | 0.77 | 0.01 | ABCC4 | −188 | Y |
| | | param | | | | | |
| rs4660456 | Platelet_count | Hematological_{—} | 0.93 | 0.01 | COL9A2 | −456 | N |
| | | param | | | | | |
| rs4812048 | Mean_platelet_{—} | Hematological_{—} | 0.98 | 0.00 | EDN3 | 288 | N |
| | volume | param | | | | | |
| rs4895441 | Mean_corpuscular_{—} | Hematological_{—} | 0.86 | 0.08 | RP1-32B1.4 | 155 | N |
| | volume | param | | | | | |
| rs4895441 | WBC_count | Hematological_{—} | 0.86 | 0.08 | RP1-32B1.4 | 155 | N |
| | | param | | | | | |
| rs6108011 | Red_blood_{—} | Hematological_{—} | 0.73 | 0.02 | RP5- | 264 | Y |
| | cell_count | param | | | 836E8.1 | | |
| rs643381 | Mean_corpuscular_{—} | Hematological_{—} | 0.81 | 0.00 | RP11- | 100 | Y |
| | volume | param | | | 15H7.1 | | |
| rs7775698 | Mean_corpuscular_{—} | Hematological_{—} | 0.80 | 0.05 | RP1-32B1.4 | 162 | N |
| | hemoglobin | param | | | | | |
| rs7775698 | Mean_corpuscular_{—} | Hematological_{—} | 0.80 | 0.05 | RP1-32B1.4 | 162 | N |
| | volume | param | | | | | |
| rs7775698 | Red_blood_{—} | Hematological_{—} | 0.80 | 0.05 | RP1-32B1.4 | 162 | N |
| | cell_traits | param | | | | | |
| rs7961894 | Mean_platelet_{—} | Hematological_{—} | 0.96 | 0.01 | CLIP1 | 395 | N |
| | volume | param | | | | | |
| rs7961894 | Platelet_count | Hematological_{—} | 0.96 | 0.01 | CLIP1 | 395 | N |
| | | param | | | | | |
| rs8176746 | Mean_corpuscular_{—} | Hematological_{—} | 0.88 | 0.05 | C9orf7 | 193 | N |
| | hemoglobin | param | | | | | |
| rs9349205 | Mean_corpuscular_{—} | Hematological_{—} | 0.79 | 0.03 | TFEB | −221 | N |
| | hemoglobin | param | | | | | |
| rs9349205 | Mean_corpuscular_{—} | Hematological_{—} | 0.79 | 0.03 | TFEB | −221 | N |
| | volume | param | | | | | |
| rs9483788 | Hematocrit | Hematological_{—} | 0.81 | N/A | HBS1L | −130 | Y |
| | | param | | | | | |
| rs10516526 | FEV1 | Kidney_lung_liver | 0.83 | 0.08 | NPNT | 143 | N |
| rs1529672 | FEV1/FVC | Kidney_lung_liver | 0.81 | 0.01 | TOP2B | 140 | Y |
| rs1883414 | IgA_nepropathy | Kidney_lung_liver | 0.89 | N/A | RXRB | 82 | N |
| rs2187668 | idiopathic_{—} | Kidney_lung_liver | 0.88 | 0.01 | BRD2 | 335 | N |
| | membranous_{—} | | | | | | |
| | nephropathy | | | | | | |
| rs2216228 | NAFLD_histology | Kidney_lung_liver | 0.90 | 0.06 | RP11- | 383 | N |
| | | | | | 268P4.2 | | |
| rs2284746 | FEV1/FVC | Kidney_lung_liver | 0.91 | 0.43 | MFAP2 | 0 | Y |
| rs4129267 | FEF | Kidney_lung_liver | 0.88 | 0.39 | IL6R | −19 | Y |
| rs643608 | NAFLD_histology | Kidney_lung_liver | 0.83 | 0.01 | CBS | −279 | N |
| rs7632299 | NAFLD_histology | Kidney_lung_liver | 0.91 | 0.01 | SLC9A9 | 360 | N |
| rs10194115 | Erectile_{—} | Miscellaneous | 0.99 | 0.01 | C2orf61 | 139 | N |
| | dysfunction_and_{—} | | | | | | |
| | prostate_cancer_{—} | | | | | | |
| | treatment | | | | | | |
| rs12045440 | Goiter | Miscellaneous | 0.95 | N/A | UBR4 | −270 | N |
| rs12045440 | Thyroid_volume | Miscellaneous | 0.95 | N/A | UBR4 | −270 | N |
| rs13208776 | Vitiligo | Miscellaneous | 0.89 | 0.01 | FRMD1 | −469 | N |
| rs2280543 | Uterine_fibroids | Miscellaneous | 0.88 | 0.01 | RNH1 | 299 | N |
| rs2553268 | Exercise_tread | Miscellaneous | 0.74 | 0.01 | CTD- | −437 | N |
| | mill_test_traits | | | | 2373N4.1 | | |
| rs3796619 | Recombination_{—} | Miscellaneous | 0.95 | 0.01 | GAK | −246 | N |
| | rate_males | | | | | | |
| rs6049375 | Erectile_{—} | Miscellaneous | 0.79 | 0.04 | GAPDHP53 | 367 | N |
| | dysfunction_and_{—} | | | | | | |
| | prostate_cancer_{—} | | | | | | |
| | treatment | | | | | | |
| rs6847149 | Exercise_tread | Miscellaneous | 0.90 | 0.03 | AC004067.4 | −205 | N |
| | mill_test_traits | | | | | | |
| rs735860 | Glaucoma | Miscellaneous | 0.86 | 0.01 | RP1- | −312 | N |
| | | | | | 214M20.3 | | |
| rs738322 | Cutaneous_{—} | Miscellaneous | 0.78 | 0.01 | RP1- | 483 | N |
| | nevi | | | | 199H16.5 | | |
| rs7567389 | Self-rated_{—} | Miscellaneous | 0.82 | 0.16 | MAP3K2 | 119 | N |
| | health | | | | | | |
| rs10893366 | Alcohol_{—} | Neurological_{—} | 0.71 | 0.02 | EI24 | 271 | N |
| | dependence | behavioral | | | | | |
| rs1107592 | Biplolar_{—} | Neurological_{—} | 0.83 | 0.04 | MAD1L1 | 215 | Y |
| | disorder_and_{—} | behavioral | | | | | |
| | schizophrenia | | | | | | |
| rs12290811 | Bipolar_disorder | Neurological_{—} | 0.98 | 0.01 | ODZ4 | −102 | Y |
| | | behavioral | | | | | |
| rs12807809 | Schizophrenia | Neurological_{—} | 0.99 | 0.01 | SLC37A2 | 327 | N |
| | | behavioral | | | | | |
| rs1412115 | Schizophrenia | Neurological_{—} | 0.80 | 0.07 | RP11- | 64 | Y |
| | | behavioral | | | 490O24.1 | | |
| rs1449984 | Major_depressive_{—} | Neurological_{—} | 0.95 | 0.02 | AC016768.1 | −158 | Y |
| | disorder | behavioral | | | | | |
| rs1550976 | Asperger_disorder | Neurological_{—} | 0.93 | 0.00 | AP002856.5 | −197 | N |
| | | behavioral | | | | | |
| rs16973500 | ADHD | Neurological_{—} | 0.91 | 0.08 | PMFBP1 | 240 | N |
| | | behavioral | | | | | |
| rs17069122 | Biplolar_{—} | Neurological_{—} | 0.72 | 0.14 | RP1- | 4 | Y |
| | disorder_and_{—} | behavioral | | | 111B22.2 | | |
| | schizophrenia | | | | | | |
| rs1879248 | Schizophrenia | Neurological_{—} | 0.81 | 0.21 | FXR1 | 120 | Y |
| | | behavioral | | | | | |
| rs2002030 | Immediate_{—} | Neurological_{—} | 0.81 | 0.04 | BLK | 75 | N |
| | Story_Recall | behavioral | | | | | |
| rs2021722 | Schizophrenia | Neurological_{—} | 0.70 | 0.11 | KIAA1949 | 482 | N |
| | | behavioral | | | | | |
| rs2070615 | Bipolar_disorder | Neurological_{—} | 0.95 | 0.02 | RPS10P20 | −337 | N |
| | | behavioral | | | | | |
| rs2268983 | Smoking_behavior | Neurological_{—} | 0.76 | 0.03 | EXD2 | 285 | N |
| | | behavioral | | | | | |
| rs2349775 | Neuroticism | Neurological_{—} | 0.90 | 0.00 | ICA1 | −415 | N |
| | | behavioral | | | | | |
| rs4307059 | Autism | Neurological_{—} | 0.85 | 0.19 | MSNP1 | −60 | Y |
| | | behavioral | | | | | |
| rs4380451 | Bipolar_disorder | Neurological_{—} | 0.86 | 0.00 | OSBPL10 | −368 | N |
| | | behavioral | | | | | |
| rs493187 | Biplolar_{—} | Neurological_{—} | 0.91 | 0.06 | RP11- | −327 | N |
| | disorder_and_{—} | behavioral | | | 15J23.1 | | |
| | schizophrenia | | | | | | |
| rs6716455 | Alcohol_{—} | Neurological_{—} | 0.83 | 0.10 | AC113610.1 | −10 | Y |
| | dependence | behavioral | | | | | |
| rs6716455 | Alcohol_use_{—} | Neurological_{—} | 0.83 | 0.10 | AC113610.1 | −10 | Y |
| | disorder | behavioral | | | | | |
| rs6782029 | Anorexia_nervosa | Neurological_{—} | 0.94 | 0.40 | VGLL4 | 0 | Y |
| | | behavioral | | | | | |
| rs6952808 | Biplolar_{—} | Neurological_{—} | 0.89 | 0.16 | MAD1L1 | −15 | N |
| | disorder_and_{—} | behavioral | | | | | |
| | schizophrenia | | | | | | |
| rs6968385 | ADHD | Neurological_{—} | 0.93 | 0.10 | AC003088.1 | 127 | Y |
| | | behavioral | | | | | |
| rs702543 | Neuroticism | Neurological_{—} | 0.82 | 0.00 | PDE4D | −330 | N |
| | | behavioral | | | | | |
| rs7045881 | Schizophrenia | Neurological_{—} | 0.88 | 0.01 | NCRNA00032 | 354 | N |
| | | behavioral | | | | | |
| rs7178909 | Common_traits_{—} | Neurological_{—} | 0.73 | 0.01 | IDH2 | 198 | N |
| | optimism | behavioral | | | | | |
| rs7520258 | Working_memory | Neurological_{—} | 0.92 | 0.01 | LGALS8 | 391 | N |
| | | behavioral | | | | | |
| rs7578035 | Bipolar_disorder | Neurological_{—} | 0.95 | 0.08 | YWHAQP5 | −73 | N |
| | | behavioral | | | | | |
| rs7581919 | Conduct_{—} | Neurological_{—} | 0.99 | 0.01 | RP11- | 345 | N |
| | disorder_case_{—} | behavioral | | | 120J4.1 | | |
| | status | | | | | | |
| rs7992643 | ADHD | Neurological_{—} | 0.97 | 0.05 | CLYBL | −32 | Y |
| | | behavioral | | | | | |
| rs806276 | ADHD | Neurological_{—} | 0.76 | 0.01 | BACH2 | −489 | Y |
| | | behavioral | | | | | |
| rs933688 | Smoking_behavior | Neurological_{—} | 0.95 | 0.21 | RP11- | −245 | N |
| | | behavioral | | | 414H23.2 | | |
| rs9810857 | ADHD | Neurological_{—} | 0.80 | 0.01 | RP11- | −339 | N |
| | | behavioral | | | 372E1.4 | | |
| rs9845475 | ADHD | Neurological_{—} | 0.76 | 0.10 | CNOT10 | −31 | N |
| | | behavioral | | | | | |
| rs1451375 | Malaria | Parasitic_bacterial_{—} | 0.84 | 0.11 | GRB10 | 52 | N |
| | | disease | | | | | |
| rs10514345 | Hip_geometry | Quantitative_traits | 0.91 | 0.03 | RP11- | 94 | Y |
| | | | | | 414H23.2 | | |
| rs11989122 | Height | Quantitative_traits | 0.91 | 0.01 | AC023590.1 | 475 | N |
| rs12203592 | Freckling | Quantitative_traits | 0.85 | 0.01 | RP3- | −241 | N |
| | | | | | 416J7.3 | | |
| rs12203592 | Hair_color- | Quantitative_traits | 0.85 | 0.01 | RP3- | −241 | N |
| | Black_vs._{—} | | | | 416J7.3 | | |
| | blond_hair_color | | | | | | |
| rs12203592 | Hair_color- | Quantitative_traits | 0.85 | 0.01 | RP3- | −241 | N |
| | Black_vs._red_{—} | | | | 416J7.3 | | |
| | hair_color | | | | | | |
| rs12203592 | Hair_color | Quantitative_traits | 0.85 | 0.01 | RP3- | −241 | N |
| | | | | | 416J7.3 | | |
| rs1635852 | Height | Quantitative_traits | 0.76 | 0.00 | CREB5 | 285 | N |
| rs2054989 | Hip_geometry | Quantitative_traits | 0.98 | 0.25 | C3orf63 | 133 | N |
| rs2282978 | Height | Quantitative_traits | 0.76 | 0.02 | KRIT1 | −392 | N |
| rs2284746 | Height | Quantitative_traits | 0.91 | 0.43 | MFAP2 | 0 | Y |
| rs2336725 | Height | Quantitative_traits | 0.95 | 0.01 | PRKCD | 71 | N |
| rs2523178 | Height | Quantitative_traits | 0.87 | 0.04 | DOT1L | −111 | Y |
| rs2730245 | Height | Quantitative_traits | 0.84 | 0.10 | NCAPG2 | −227 | N |
| rs291671 | Hair_color- | Quantitative_traits | 0.83 | 0.02 | RP4- | 430 | N |
| | red_hair | | | | 553F4.6 | | |
| rs3782089 | Height | Quantitative_traits | 0.88 | 0.06 | FIBP | 317 | N |
| rs3791950 | Height | Quantitative_traits | 0.72 | 0.01 | PNKD | 469 | N |
| rs4072910 | Height | Quantitative_traits | 0.91 | 0.01 | PRAM1 | −87 | N |
| rs4282339 | Height | Quantitative_traits | 0.98 | 0.18 | SLIT3 | 15 | Y |
| rs4823006 | Waist- | Quantitative_traits | 0.81 | 0.01 | AP1B1 | 315 | N |
| | hip_ratio | | | | | | |
| rs4932217 | Height | Quantitative_traits | 0.83 | 0.23 | POLG | −40 | Y |
| rs619865 | Freckling | Quantitative_traits | 0.72 | 0.01 | RBM39 | 457 | N |
| rs6784615 | Waist- | Quantitative_traits | 0.73 | 0.22 | BAP1 | −64 | N |
| | hip_ratio | | | | | | |
| rs6899976 | Height | Quantitative_traits | 0.71 | 0.01 | RP1- | −490 | N |
| | | | | | 69D17.4 | | |
| rs7007970 | Height | Quantitative_traits | 0.88 | 0.00 | RP11- | −152 | N |
| | | | | | 775B15.3 | | |
| rs7121446 | Waist_{—} | Quantitative_traits | 0.80 | 0.02 | RP11- | 18 | Y |
| | circumference | | | | 166D19.1 | | |
| rs7349332 | Hair_curl | Quantitative_traits | 0.72 | 0.18 | AC097468.6 | 63 | N |
| rs7349332 | Hair_morphology | Quantitative_traits | 0.72 | 0.18 | AC097468.6 | 63 | N |
| rs735854 | Optic_disc_{—} | Quantitative_traits | 0.72 | 0.01 | APOL3 | −117 | N |
| | size_rim | | | | | | |
| rs7466269 | Height | Quantitative_traits | 0.99 | 0.13 | RP11- | 57 | N |
| | | | | | 57C19.2 | | |
| rs798497 | Height | Quantitative_traits | 0.95 | 0.00 | EIF3B | −379 | N |
| rs941873 | Height | Quantitative_traits | 0.79 | 0.43 | RP11- | 2 | Y |
| | | | | | 342M3.5 | | |
| rs946053 | Height | Quantitative_traits | 0.95 | 0.01 | AMBP | −210 | N |
| rs228769 | Bone_mineral_{—} | Radiographic_{—} | 0.71 | 0.07 | MPP2 | −215 | Y |
| | density-hip | parameter | | | | | |
| rs228769 | Bone_mineral_{—} | Radiographic_{—} | 0.71 | 0.07 | MPP2 | −215 | Y |
| | density-spine | parameter | | | | | |
| rs4870044 | Bone_mineral_{—} | Radiographic_{—} | 0.81 | 0.04 | RP11- | −164 | N |
| | density-hip | parameter | | | 351K16.4 | | |
| rs4870044 | Bone_mineral_{—} | Radiographic_{—} | 0.81 | 0.04 | RP11- | −164 | N |
| | density-spine | parameter | | | 351K16.4 | | |
| rs1039302 | C-reactive_{—} | Serum_metabolites | 0.94 | 0.01 | RNF10 | −265 | N |
| | protein | | | | | | |
| rs10889353 | Cholesterol | Serum_metabolites | 0.96 | 0.02 | RP5- | −463 | N |
| | | | | | 1155K23.1 | | |
| rs10889353 | LDL_cholesterol | Serum_metabolites | 0.96 | 0.02 | RP5- | −463 | N |
| | | | | | 1155K23.1 | | |
| rs10889353 | Triglycerides | Serum_metabolites | 0.96 | 0.02 | RP5- | −463 | N |
| | | | | | 1155K23.1 | | |
| rs11597390 | Alanine_{—} | Serum_metabolites | 0.86 | N/A | ENTPD7 | −442 | N |
| | aminotransferase | | | | | | |
| rs11708067 | Fasting_plasma_{—} | Serum_metabolites | 0.98 | 0.03 | PDIA5 | −223 | N |
| | glucose | | | | | | |
| rs11708067 | Insulin_resistance | Serum_metabolites | 0.98 | 0.03 | PDIA5 | −223 | N |
| rs11761528 | Serum_{—} | Serum_metabolites | 0.91 | 0.31 | ARPC1B | −147 | N |
| | dehydroepiandrosterone | | | | | | |
| rs12239046 | C-reactive_{—} | Serum_metabolites | 0.99 | 0.02 | NLRP3 | −20 | Y |
| | protein | | | | | | |
| rs12239436 | HDL_cholesterol | Serum_metabolites | 0.70 | 0.02 | RP11- | −59 | Y |
| | | | | | 101C11.1 | | |
| rs12740374 | LDL_cholesterol | Serum_metabolites | 0.75 | 0.01 | AMPD2 | 354 | N |
| rs13022873 | Triglycerides_{—} | Serum_metabolites | 0.72 | 0.16 | IFT172 | −131 | N |
| | waist_circumference | | | | | | |
| rs13195786 | Serum_calcium | Serum_metabolites | 0.85 | 0.02 | TFAP2A | 256 | N |
| rs1335645 | Gamma_glutamyl_{—} | Serum_metabolites | 0.74 | N/A | DENND2D | 59 | N |
| | transferase | | | | | | |
| rs1408272 | Transferrin_{—} | Serum_metabolites | 0.70 | 0.06 | TRIM38 | 124 | N |
| | receptor | | | | | | |
| rs1535 | HDL_cholesterol | Serum_metabolites | 0.92 | 0.01 | C11orf66 | −342 | N |
| rs1535 | Serum_polyun | Serum_metabolites | 0.92 | 0.01 | C11orf66 | −342 | N |
| | saturated_fatty_{—} | | | | | | |
| | acids | | | | | | |
| rs157580 | HDL_cholesterol | Serum_metabolites | 0.85 | 0.00 | CEACAM19 | −221 | N |
| rs157580 | LDL_cholesterol | Serum_metabolites | 0.85 | 0.00 | CEACAM19 | −221 | N |
| rs1594468 | Bilirubin | Serum_metabolites | 0.74 | 0.03 | ELMOD2 | 58 | N |
| rs17319721 | Creatinine | Serum_metabolites | 0.77 | N/A | CXCL11 | −405 | N |
| rs174536 | Serum_polyun | Serum_metabolites | 0.88 | 0.00 | DAK | −451 | N |
| | saturated_fatty | | | | | | |
| | acids | | | | | | |
| rs174546 | HDL_cholesterol | Serum_metabolites | 0.86 | 0.01 | DDB1 | −460 | N |
| rs174546 | LDL_cholesterol | Serum_metabolites | 0.86 | 0.01 | DDB1 | −460 | N |
| rs174574 | Serum_polyun | Serum_metabolites | 0.96 | 0.01 | C11orf66 | −344 | N |
| | saturated_fatty_{—} | | | | | | |
| | acids | | | | | | |
| rs1967017 | Serum_urate | Serum_metabolites | 0.76 | 0.03 | RP11- | −348 | N |
| | | | | | 458D21.2 | | |
| rs2052550 | Ferritin | Serum_metabolites | 0.86 | 0.08 | DMGDH | 54 | N |
| rs2066219 | Two_hour_glucose_{—} | Serum_metabolites | 0.75 | 0.05 | RPL12P34 | −311 | Y |
| | challenge | | | | | | |
| rs2078267 | Gout | Serum_metabolites | 0.83 | 0.00 | ARL2 | 450 | N |
| rs2078267 | Serum_urate | Serum_metabolites | 0.83 | 0.00 | ARL2 | 450 | N |
| rs2153960 | IGF1 | Serum_metabolites | 0.97 | 0.02 | NR2E1 | −491 | N |
| rs2235302 | P-selectin | Serum_metabolites | 0.93 | 0.07 | SELL | 94 | N |
| rs2650000 | C-reactive_{—} | Serum_metabolites | 0.83 | 0.01 | KDM2B | 491 | N |
| | protein | | | | | | |
| rs2650000 | LDL_cholesterol | Serum_metabolites | 0.83 | 0.01 | KDM2B | 491 | N |
| rs2836878 | C-reactive_{—} | Serum_metabolites | 0.80 | 0.03 | LCA5L | 352 | N |
| | protein | | | | | | |
| rs2877716 | Two-hour_glucose_{—} | Serum_metabolites | 0.74 | N/A | ADCY5 | −56 | Y |
| | challenge | | | | | | |
| rs3093030 | ICAM1 | Serum_metabolites | 0.94 | 0.08 | ZGLP1 | 19 | Y |
| rs3729639 | HDL_cholesterol | Serum_metabolites | 0.71 | N/A | TRADD | −34 | N |
| rs4129267 | C-reactive_{—} | Serum_metabolites | 0.88 | 0.39 | IL6R | −19 | Y |
| | protein | | | | | | |
| rs4129267 | IL6R | Serum_metabolites | 0.88 | 0.39 | IL6R | −19 | Y |
| rs4273077 | Protein-total | Serum_metabolites | 0.75 | 0.01 | AC055811.5 | 294 | N |
| rs4516970 | Ferritin | Serum_metabolites | 0.76 | 0.01 | RP1- | 182 | N |
| | | | | | 249F5.3 | | |
| rs4607517 | Insulin_{—} | Serum_metabolites | 0.85 | 0.01 | POLD2 | −74 | N |
| | resistance | | | | | | |
| rs4607517 | Fasting_plasma_{—} | Serum_metabolites | 0.85 | 0.01 | POLD2 | −74 | N |
| | glucose | | | | | | |
| rs4686760 | Van_Wildebrand_{—} | Serum_metabolites | 0.87 | 0.02 | VPS8 | 122 | Y |
| | factor_antibodies | | | | | | |
| rs4737009 | HbA1C | Serum_metabolites | 0.94 | 0.03 | AGPAT6 | −197 | N |
| rs4820599 | Gamma_glutamyl_{—} | Serum_metabolites | 0.80 | 0.01 | C22orf13 | −44 | N |
| | transferase | | | | | | |
| rs4963452 | Serum_polyun | Serum_metabolites | 0.80 | 0.03 | SCGB2A2 | 222 | N |
| | saturated_fatty_{—} | | | | | | |
| | acids | | | | | | |
| rs507666 | ICAM1 | Serum_metabolites | 0.83 | 0.08 | C9orf7 | 178 | N |
| rs6442522 | Serum_urate | Serum_metabolites | 0.73 | 0.06 | NR2C2 | −451 | N |
| rs6734238 | C-reactive_{—} | Serum_metabolites | 1.00 | 0.18 | IL1RN | 44 | Y |
| | protein | | | | | | |
| rs6984305 | Alkaline_{—} | Serum_metabolites | 0.85 | 0.02 | RP11- | 118 | N |
| | phosphatase | | | | 115J16.2 | | |
| rs7117404 | Fibrin-D- | Serum_metabolites | 0.79 | 0.01 | ATG13 | −446 | N |
| | dimer_levels | | | | | | |
| rs7120118 | HDL_cholesterol | Serum_metabolites | 0.79 | 0.01 | CELF1 | 225 | N |
| rs7569328 | LDL_cholesterol | Serum_metabolites | 0.80 | 0.01 | HS1BP3 | −262 | N |
| rs7778619 | CD40_ligand | Serum_metabolites | 0.82 | 0.01 | AC060834.2 | −385 | N |
| rs8109578 | Thyroid_stimulating_{—} | Serum_metabolites | 0.92 | 0.01 | PPAN | 5 | Y |
| | hormone | | | | | | |
| rs911119 | Cystatin_C | Serum_metabolites | 0.75 | 0.01 | RP4- | −499 | N |
| | | | | | 737E23.4 | | |
| rs964184 | Alpha- | Serum_metabolites | 0.90 | 0.04 | SIK3 | 96 | N |
| | tocopherol | | | | | | |
| rs964184 | HDL_cholesterol | Serum_metabolites | 0.90 | 0.04 | SIK3 | 96 | N |
| rs964184 | Hypertriglyceridemia | Serum_metabolites | 0.90 | 0.04 | SIK3 | 96 | N |
| rs964184 | Lipoprotein- | Serum_metabolites | 0.90 | 0.04 | SIK3 | 96 | N |
| | associated_{—} | | | | | | |
| | phospholipase_{—} | | | | | | |
| | A2_activity_and_{—} | | | | | | |
| | mass | | | | | | |
| rs964184 | Triglycerides | Serum_metabolites | 0.90 | 0.04 | SIK3 | 96 | N |
| rs9939224 | HDL_cholesterol_{—} | Serum_metabolites | 0.75 | 0.18 | CETP | −7 | Y |
| | fasting_glucose | | | | | | |
| rs9992101 | Creatinine | Serum_metabolites | 0.85 | 0.02 | ART3 | −357 | N |
| rs11697186 | Response_to_{—} | Viral_disease | 0.85 | 0.11 | RP5- | −31 | N |
| | hepatitis_C_{—} | | | | 1187M17.10 | | |
| | treatment | | | | | | |
| rs13394720 | HIV_progression | Viral_disease | 0.90 | 0.02 | AC019221.4 | −239 | N |
| rs2885805 | Cytomegalovirus_{—} | Viral_disease | 0.87 | 0.00 | C1orf88 | 471 | N |
| | antibody_response | | | | | | |
| rs9267665 | Hepatitis- | Viral_disease | 0.94 | 0.07 | UQCRHP1 | −289 | N |
| | B_vaccine_{—} | | | | | | |
| | response | | | | | | |

TABLE 10
Genes correlated with distal DHSs harboring GWAS SNPs (Part II). 128 trait-SNP associations (123
unique SNPs) overlapping predicted long-distance interactions established by correlation of chromatin
accessibility (r) in DHSs in 46 additional cell/tissue types. Cor_gene_name represents the most-correlated
gene; Dist, distance to gene in kb. “Adjacent?”, whether the highest-correlated gene is an adjacent gene.

| | | | | Cor_gene_{—} | | |
|---|---|---|---|---|---|---|
| SNP | Disease or trait | Trait Category | r | name | Dist | Adjacent? |
| rs62209 | Alzheimers_disease_{—} | Aging | 0.94 | RP11- | 496 | N |
| | late_onset | | | 271F18.2 | | |
| rs4938933 | Alzheimers_disease_{—} | Aging | 0.89 | MS4A3 | 201 | N |
| | late_onset | | | | | |
| rs2619566 | Amyotrophic_lateral_{—} | Aging | 0.88 | CNTN4 | 307 | N |
| | sclerosis-age_{—} | | | | | |
| | of_onset | | | | | |
| rs9664222 | Longevity | Aging | 0.74 | RP11- | 62 | N |
| | | | | 57C13.5 | | |
| rs1036819 | Longevity | Aging | 0.87 | RP11- | 279 | N |
| | | | | 513H8.1 | | |
| rs947211 | Parkinsons_disease | Aging | 0.96 | SLC26A9 | 147 | N |
| rs6599388 | Parkinsons_disease | Aging | 0.84 | PDE6B | 294 | N |
| rs6599389 | Parkinsons_disease | Aging | 0.84 | PDE6B | 294 | N |
| rs11248060 | Parkinsons_disease | Aging | 0.99 | SPON2 | 231 | N |
| rs4698412 | Parkinsons_disease | Aging | 0.70 | PROM1 | 349 | N |
| rs10121009 | Parkinsons_disease | Aging | 0.83 | RP11- | 180 | N |
| | | | | 156G14.4 | | |
| rs10767971 | Parkinsons_disease_{—} | Aging | 0.83 | PIGCP1 | 202 | N |
| | age_of_onset | | | | | |
| rs17565841 | Parkinsons_disease_{—} | Aging | 0.74 | AC090696.2 | 23 | N |
| | age_of_onset | | | | | |
| rs13010713 | Celiac_disease | Autoimmune_disease | 0.74 | AC104820.2 | 7 | N |
| rs1819658 | Crohns_disease | Autoimmune_disease | 0.77 | UBE2D1 | 211 | N |
| rs762421 | Crohns_disease | Autoimmune_disease | 0.75 | TRAPPC10 | 105 | N |
| rs6596075 | Crohns_disease | Autoimmune_disease | 0.77 | RAD50 | 188 | N |
| rs212388 | Crohns_disease | Autoimmune_disease | 0.84 | RP3- | 458 | N |
| | | | | 393E18.1 | | |
| rs212388 | Crohns_disease_{—} | Autoimmune_disease | 0.84 | RP3- | 458 | N |
| | celiac_disease | | | 393E18.1 | | |
| rs9355610 | Graves_disease | Autoimmune_disease | 0.73 | RNASET2 | 12 | N |
| rs6604026 | Multiple_sclerosis | Autoimmune_disease | 0.89 | RP4- | 357 | N |
| | | | | 612C19.1 | | |
| rs12025416 | Multiple_sclerosis | Autoimmune_disease | 0.89 | RP4- | 62 | N |
| | | | | 655J12.5 | | |
| rs7090512 | Multiple_sclerosis | Autoimmune_disease | 0.86 | RP11- | 3 | N |
| | | | | 414H17.2 | | |
| rs4939490 | Multiple_sclerosis | Autoimmune_disease | 0.93 | ZP1 | 153 | N |
| rs2248359 | Multiple_sclerosis | Autoimmune_disease | 0.75 | CYP24A1 | 1 | N |
| rs9321490 | Multiple_sclerosis | Autoimmune_disease | 0.98 | AHI1 | 149 | N |
| rs7779014 | Multiple_sclerosis | Autoimmune_disease | 0.87 | POR | 439 | N |
| rs17149161 | Multiple_sclerosis | Autoimmune_disease | 0.80 | AC005077.14 | 274 | N |
| rs9303277 | Primary_biliary_{—} | Autoimmune_disease | 0.72 | IKZF3 | 44 | N |
| | cirrhosis | | | | | |
| rs842636 | Psoriasis | Autoimmune_disease | 0.90 | AC007381.2 | 481 | N |
| rs743777 | Rheumatoid_arthritis | Autoimmune_disease | 0.89 | C1QTNF6 | 42 | N |
| rs1600249 | Rheumatoid_arthritis | Autoimmune_disease | 0.94 | CTSB | 359 | N |
| rs7329174 | Systemic_lupus_{—} | Autoimmune_disease | 0.82 | ELF1 | 1 | N |
| | erythematosus | | | | | |
| rs1317209 | Ulcerative_colitis | Autoimmune_disease | 0.86 | TMCO4 | 75 | N |
| rs3024493 | Ulcerative_colitis | Autoimmune_disease | 0.81 | RP11- | 242 | N |
| | | | | 534L20.4 | | |
| rs8067378 | Ulcerative_colitis | Autoimmune_disease | 0.86 | IKZF3 | 31 | N |
| rs11676348 | Ulcerative_colitis | Autoimmune_disease | 0.81 | C2orf62 | 219 | N |
| rs6017342 | Ulcerative_colitis | Autoimmune_disease | 0.71 | WISP2 | 282 | N |
| rs11978267 | Acute_lymphoblastic_{—} | Cancer | 0.85 | IKZF1 | 99 | N |
| | leukemia_childhood | | | | | |
| rs2380205 | Breast_cancer | Cancer | 0.92 | GDI2 | 58 | N |
| rs2981579 | Breast_cancer | Cancer | 0.96 | TACC2 | 411 | N |
| rs1219648 | Breast_cancer | Cancer | 0.79 | FGFR2 | 7 | N |
| rs10937405 | Lung_adenocarcinoma | Cancer | 0.84 | TPRG1 | 451 | N |
| rs7521902 | Ovarian_cancer | Cancer | 0.93 | HSPG2 | 268 | N |
| rs9311171 | Prostate_cancer | Cancer | 0.80 | DLEC1 | 105 | N |
| rs10263935 | Aortic_root_size | Cardiovascular | 0.75 | RABGEF1 | 163 | N |
| rs17375901 | Atrial_fibrillation | Cardiovascular | 0.99 | NPPA | 55 | N |
| rs1320448 | Cardiac_hypertrophy | Cardiovascular | 0.98 | COL17A1 | 0 | N |
| rs216172 | Coronary_heart_disease | Cardiovascular | 0.78 | MNT | 178 | N |
| rs7651039 | Coronary_heart_disease | Cardiovascular | 0.84 | CAPN7 | 360 | N |
| rs17577085 | Coronary_heart_disease | Cardiovascular | 0.83 | ARHGAP26 | 423 | N |
| rs17609940 | Coronary_heart_disease | Cardiovascular | 0.83 | DEF6 | 241 | N |
| rs6601530 | Internal_carotid_{—} | Cardiovascular | 0.71 | SOX7 | 83 | N |
| | intimal_medial_{—} | | | | | |
| | thickness | | | | | |
| rs499818 | Major_CVD | Cardiovascular | 0.81 | GFOD1 | 78 | N |
| rs11748327 | Myocardial_{—} | Cardiovascular | 0.88 | CTD- | 16 | N |
| | infarction | | | 2287N17.1 | | |
| rs10757278 | Myocardial_{—} | Cardiovascular | 0.85 | CDKN2B- | 11 | N |
| | infarction | | | AS1 | | |
| rs3807989 | PR_interval | Cardiovascular | 0.82 | ST7 | 469 | N |
| rs17421627 | Retinal_vascular_{—} | Cardiovascular | 0.89 | CTC- | 127 | N |
| | caliber | | | 547D20.1 | | |
| rs225717 | Retinal_vascular_{—} | Cardiovascular | 0.90 | GPR126 | 75 | N |
| | caliber | | | | | |
| rs4975709 | Stroke | Cardiovascular | 0.77 | CTD- | 20 | N |
| | | | | 2194D22.2 | | |
| rs10829156 | Sudden_cardiac_{—} | Cardiovascular | 0.71 | RP11- | 390 | N |
| | arrest | | | 288D15.2 | | |
| rs16866933 | Sudden_cardiac_{—} | Cardiovascular | 0.85 | AC092642.1 | 111 | N |
| | arrest | | | | | |
| rs7042864 | Tonometry | Cardiovascular | 0.88 | RP11- | 143 | N |
| | | | | 272G11.1 | | |
| rs4948088 | Type_1_diabetes | Diabetes | 0.71 | RP4- | 93 | N |
| | | | | 724E13.2 | | |
| rs3788013 | Type_1_diabetes_{—} | Diabetes | 0.86 | AP001625.6 | 140 | N |
| | autoantibodies | | | | | |
| rs743777 | Type_1_diabetes_{—} | Diabetes | 0.89 | C1QTNF6 | 42 | N |
| | autoantibodies | | | | | |
| rs7901695 | Type_2_diabetes | Diabetes | 0.71 | TCF7L2 | 157 | N |
| rs2383208 | Type_2_diabetes | Diabetes | 0.77 | RP11- | 329 | N |
| | | | | 70L8.3 | | |
| rs2472297 | Coffee_consumption | Drug_metabolism | 1.00 | CYP11A1 | 395 | N |
| rs6588480 | Response_to_statin_{—} | Drug_metabolism | 0.76 | HSPB11 | 417 | N |
| | therapy-chol_sum | | | | | |
| rs9305406 | Response_to_statin_{—} | Drug_metabolism | 0.71 | KRTAP23-1 | 336 | N |
| | therapy-SM | | | | | |
| rs17135859 | F-cell_distribution | Hematological_{—} | 0.79 | YTHDC2 | 71 | N |
| | | parameters | | | | |
| rs17342717 | Mean_corpuscular_{—} | Hematological_{—} | 0.74 | RP3- | 140 | N |
| | hemoglobin | parameters | | 501N12.3 | | |
| rs131794 | Mean_corpuscular_{—} | Hematological_{—} | 0.80 | NCAPH2 | 17 | N |
| | volume | parameters | | | | |
| rs172629 | Mean_corpuscular_{—} | Hematological_{—} | 0.72 | RP11- | 321 | N |
| | volume | parameters | | 601I15.1 | | |
| rs12485738 | Mean_platelet_{—} | Hematological_{—} | 0.76 | C3orf63 | 163 | N |
| | volume | parameters | | | | |
| rs8022206 | Platelet_count | Hematological_{—} | 0.83 | RAD51L1 | 233 | N |
| | | parameters | | | | |
| rs441460 | Platelet_count | Hematological_{—} | 0.93 | RP3- | 285 | N |
| | | parameters | | 522P13.3 | | |
| rs11611647 | Red_blood_{—} | Hematological_{—} | 0.86 | DYRK4 | 342 | N |
| | cell_count | parameters | | | | |
| rs7805747 | Chronic_kidney_{—} | Kidney_lung_liver | 0.86 | RP13- | 96 | N |
| | disease | | | 452N2.1 | | |
| rs10786284 | ADHD | Neurological_{—} | 0.88 | BLNK | 147 | N |
| | | behavioral | | | | |
| rs1859156 | ADHD | Neurological_{—} | 0.93 | PDLIM5 | 329 | N |
| | | behavioral | | | | |
| rs12020569 | Alcohol_dependence | Neurological_{—} | 0.88 | RPS3AP44 | 437 | N |
| | | behavioral | | | | |
| rs12282742 | Bipolar_disorder_{—} | Neurological_{—} | 0.80 | RP11- | 70 | N |
| | and_schizophrenia | behavioral | | 113D6.8 | | |
| rs17197037 | Bipolar_disorder | Neurological_{—} | 0.82 | METTL3 | 248 | N |
| | | behavioral | | | | |
| rs6990255 | Bipolar_disorder | Neurological_{—} | 0.90 | RP1- | 256 | N |
| | | behavioral | | 273G13.3 | | |
| rs1574192 | Brain_imaging_in_{—} | Neurological_{—} | 0.95 | KIF1A | 429 | N |
| | schizophrenia_{—} | behavioral | | | | |
| | interaction | | | | | |
| rs9442235 | Cognitive_{—} | Neurological_{—} | 0.84 | RP11- | 315 | N |
| | performance-PC1 | behavioral | | 169K16.4 | | |
| rs16880441 | Conduct_disorder_{—} | Neurological_{—} | 0.95 | ACTBP8 | 31 | N |
| | interaction | behavioral | | | | |
| rs332034 | Conduct_disorder_{—} | Neurological_{—} | 0.92 | RP11- | 389 | N |
| | interaction | behavioral | | 115J16.1 | | |
| rs3827730 | Depression_and_{—} | Neurological_{—} | 0.76 | RP11- | 57 | N |
| | alcohol_dependence | behavioral | | 183G22.3 | | |
| rs12042938 | DISC1 | Neurological_{—} | 0.91 | C1orf131 | 455 | N |
| | | behavioral | | | | |
| rs1869901 | Schizophrenia | Neurological_{—} | 0.70 | IVD | 111 | N |
| | | behavioral | | | | |
| rs8005962 | Tuberculosis | Parasitic_{—} | 0.84 | TCL6 | 104 | N |
| | | bacterial_{—} | | | | |
| | | disease | | | | |
| rs6545883 | Tuberculosis | Parasitic_{—} | 0.71 | USP34 | 323 | N |
| | | bacterial_{—} | | | | |
| | | disease | | | | |
| rs9990343 | Brain_structure | Quantitative_{—} | 0.94 | CXCR6 | 357 | N |
| | | traits | | | | |
| rs17646946 | Hair_curl | Quantitative_{—} | 0.99 | TCHHL1 | 1 | N |
| | | traits | | | | |
| rs17318596 | Height | Quantitative_{—} | 0.71 | BCKDHA | 20 | N |
| | | traits | | | | |
| rs3791679 | Height | Quantitative_{—} | 0.81 | CCDC88A | 470 | N |
| | | traits | | | | |
| rs6724465 | Height | Quantitative_{—} | 0.94 | NHEJ1 | 46 | N |
| | | traits | | | | |
| rs12658202 | Height | Quantitative_{—} | 0.97 | FAM114A2 | 430 | N |
| | | traits | | | | |
| rs6569648 | Height | Quantitative_{—} | 0.74 | ARHGAP18 | 430 | N |
| | | traits | | | | |
| rs6570507 | Height | Quantitative_{—} | 0.79 | GPR126 | 58 | N |
| | | traits | | | | |
| rs6611365 | Optic_disc_size_disc | Quantitative_{—} | 0.70 | CTD- | 157 | N |
| | | traits | | 2522E6.4 | | |
| rs9386463 | Primary_tooth_{—} | Quantitative_{—} | 0.99 | PRDM1 | 453 | N |
| | development_time_to_{—} | traits | | | | |
| | first_tooth_eruption | | | | | |
| rs1572050 | Renal_sinus_fat | Quantitative_{—} | 0.80 | RP11- | 30 | N |
| | | traits | | 23P11.2 | | |
| rs9315632 | Waist-hip_ratio | Quantitative_{—} | 0.73 | C13orf23 | 70 | N |
| | | traits | | | | |
| rs1055144 | Waist-hip_ratio | Quantitative_{—} | 0.70 | CTA- | 141 | N |
| | | traits | | 242H14.1 | | |
| rs9594738 | Bone_mineral_{—} | Radiographic_{—} | 0.90 | FABP3P2 | 8 | N |
| | density-hip | parameters | | | | |
| rs9594738 | Bone_mineral_{—} | Radiographic_{—} | 0.90 | FABP3P2 | 8 | N |
| | density-spine | parameters | | | | |
| rs4729260 | Bone_mineral_{—} | Radiographic_{—} | 0.85 | SHFM1 | 209 | N |
| | density-spine | parameters | | | | |
| rs10492681 | Alanine_{—} | Serum_metabolites | 0.76 | RP11- | 52 | N |
| | aminotransferase | | | 518D7.1 | | |
| rs2280401 | Albumin | Serum_metabolites | 0.71 | AKT1S1 | 379 | N |
| rs16856332 | Alkaline_phosphatase | Serum_metabolites | 0.77 | AC007556.2 | 129 | N |
| rs6742078 | Bilirubin | Serum_metabolites | 0.94 | TRPM8 | 168 | N |
| rs7953249 | DG7_glycan | Serum_metabolites | 0.75 | HNF1A | 12 | N |
| rs17342717 | Ferritin | Serum_metabolites | 0.74 | RP3- | 140 | N |
| | | | | 501N12.3 | | |
| rs12029080 | Fibrin-D- | Serum_metabolites | 0.79 | CNN3 | 340 | N |
| | dimer_levels | | | | | |
| rs1490453 | Fibrinogen | Serum_metabolites | 0.75 | RP11- | 127 | N |
| | | | | 655B23.1 | | |
| rs7998202 | HbA1C | Serum_metabolites | 0.72 | MCF2L | 409 | N |
| rs7499892 | HDL_cholesterol | Serum_metabolites | 0.84 | NLRC5 | 100 | N |
| rs2083637 | HDL_cholesterol | Serum_metabolites | 0.77 | CSGALNACT1 | 404 | N |
| rs13702 | HDL_cholesterol_{—} | Serum_metabolites | 0.84 | CSGALNACT1 | 363 | N |
| | triglycerides | | | | | |
| rs9303029 | IGF1-free | Serum_metabolites | 0.85 | FOXK2 | 69 | N |
| rs7577642 | IL6R | Serum_metabolites | 0.81 | SH2D6 | 43 | N |
| rs591044 | Insulin_resistance | Serum_metabolites | 0.88 | RP11- | 45 | N |
| | | | | 259P1.1 | | |
| rs2280401 | Protein-total | Serum_metabolites | 0.71 | AKT1S1 | 379 | N |
| rs236918 | Transferrin_receptor | Serum_metabolites | 0.77 | PAFAH1B2 | 64 | N |

TABLE 11
Target genes of distal DHSs harboring GWAS variants. Examples of distal DHSs-to-promoter
connections that highlight candidate genes potentially underlying the association.

| Disease or trait | R | Target gene | Distance |
|---|---|---|---|
| Amyotrophic lateral | 1 | SYNGAP1* - Axon formation; component of NMDA | 411 kb |
| sclerosis | | complex | |
| Crohn's disease | 1 | TRIB1* - NFkB regulation | 95 kb |
| Time to first primary tooth | 0.99 | PRDM1* - Craniofacial development | 452 kb |
| C-reactive protein | 0.99 | NLRP3 - Response to bacterial pathogens | 20 kb |
| Multiple sclerosis | 0.98 | AHI1* - White matter abnormalities | 149 kb |
| QRS duration | 0.96 | SCN10A* - Sodium channel involved in cardiac | 181 kb |
| | | conduction | |
| Breast cancer | 0.96 | TACC2* - Tumor suppressor | 411 kb |
| Schizophrenia/brain | 0.95 | KIF1A* - Neuron-specific kinesin involved in axonal | 428 kb |
| imaging | | transport | |
| Brain structure | 0.94 | CXCR6* - Chemokine receptor involved in glial | 357 kb |
| | | migration | |
| Rheumatoid arthritis | 0.94 | CTSB* - Cysteine proteinase linked to articular | 359 kb |
| | | erosion | |
| Ovarian cancer | 0.93 | HSPG2* - Ovarian tumor supressor | 268 kb |
| Multiple sclerosis | 0.93 | ZP1* - Known autoantigen | 153 kb |
| ADHD | 0.93 | PDLIM5* - Neuronal calcium signaling | 328 kb |
| Breast cancer | 0.88 | MAP3K1* - Response to growth factors | 158 kb |
| Amyotrophic lateral | 0.88 | CNTN4 - Neuronal cell adhesion | 306 kb |
| sclerosis | | | |
| Schizophrenia | 0.81 | FXR1* - Cognitive function | 120 kb |
| Type 1 diabetes | 0.75 | ACAD10* - Mitochondrial oxidation of fatty acids | 343 kb |
| Lupus | 0.74 | STAT4 - Mediates IL12 immune response and Th1 | 113 kb |
| | | differentiation | |

*indicates that highest correlated gene is not the nearest gene.
R, Pearson's correlation coefficient.

Methods.

Disease- and Trait-Associated Variants from GWAS.

The GWAS SNP set was used for analysis as previously described in Example 21 herein.

Identification of Replicated GWAS Associations.

The identification of replicated GWAS associations was performed as previously described in Example 21 herein.

DNaseI Mapping.

DNaseI mapping was conducted as previously described in Example 21 herein.

Isolation of Nuclei from Cultured Cells.

The isolation of nucleic from cultured cells was performed as previously described in Example 21 herein.

Isolation of Nuclei from Hematopoietic Cells.

The isolation of nuclei from hematopoietic cells was performed as previously described in Example 21 herein.

Isolation of Nuclei from Fetal Tissues.

The isolation of nuclei from fetal tissues was performed as previously described in Example 21 herein.

DNaseI Mapping from Isolated Nuclei.

DNaseI mapping from isolated nuclei was performed as previously described in Example 21 herein.

Processing of DNaseI-Seq Data.

The processing of DNaseI-seq data was performed as previously described in Example 21 herein.

Data Availability.

The DNaseI data used are available as previously described in Example 21 herein.

DHS-to-Promoter Assignments Based on Cross-Cell-Type Hypersensitivity Correlations.

Previously, DHSs genome-wide across 79 diverse cell types were measured, and correlation analyses performed on the patterns of DNaseI occupancy across the cell types. Briefly, the 79 cell types were first collapsed into 32 categories, based on the similarities and differences of their DHS profiles genome-wide (Maurano et al., 2012). Then for each DHS, a 32-element vector of DNaseI tag counts was formed to represent the occupancy pattern within those cell types at that DHS. Then for each promoter DHS representing a GENCODE TSS, the correlation was computed between its occupancy pattern vector and the vector for each non-promoter DHS distal to it within a 500 kb radius. A distal/promoter DHS pair was defined to be “connected” if its Pearson correlation coefficient r was at least 0.7. 578,905 connected distal DHSs genome-wide were identified (mean separation=266 kb), 429,283 (74%) of which hop over an adjacent gene to find its highest correlation with a different gene farther away within a 500-kb radius.

Here this correlation map was used to obtain a set of 296 unique noncoding GWAS SNPs lying within distal DHSs achieving r>0.7 with a promoter DHS within 500 kb (Table 9). This analysis was also repeated using DHSs found in 46 cell types that were used for other analyses in this paper but not included among the 79 used for the above (Maurano et al., 2012). This correlation map identified an additional 123 unique noncoding GWAS SNPs lying within distal DHSs achieving r>0.7 with a promoter DHS within 500 kb (Table 10).

To establish the extent of LD between the distal and promoter DHSs, r² was computed between all pairs of 1000 Genomes SNPs fully phased in the CEU population and with minor allele frequency ≧5% lying within 2 kb of the DHS containing the GWAS SNP and lying within 2 kb of the promoter DHS. For a typical DHS pair, ˜127 r² values were computed, between ˜14 SNPs at one DHS and ˜9 SNPs at the other.

Two replicates of PolII ChIA-PET data in K562 cells were obtained from the UCSC Genome Browser (http://hgdownload-test.cse.ucsc.edu/goldenPath/hg19/encodeDCC/wgEncodeGisChiaPet/) and processed with awk.

### Example 24

### GWAS Variants in DHSs Frequently Alter Allelic Chromatin State

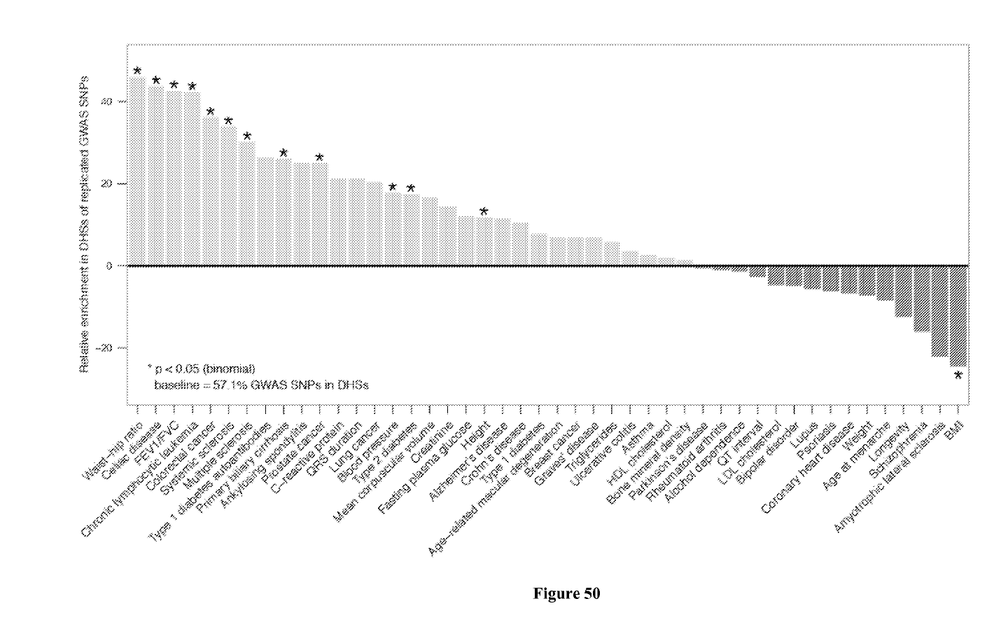

How GWAS variants in DHSs were distributed with respect to transcription factor recognition sequences, defined using a scan for known motif models at a stringency of P<10⁻⁴ was examined. Of GWAS SNPs in DHSs, 93.2% (2,874) overlap a transcription factor recognition sequence. GWAS variants were partitioned into 10 disease/trait classes, and then the frequency of GWAS variants associated with a particular disease/trait class that localized within sites for transcription factors independently partitioned into the same classes based on gene ontology annotations was determined (FIG. 50). FIG. 50 illustrates that GWAS variants in DHSs localize within physiologically relevant TF binding sites. FIG. 50A illustrates that GWAS variants in DHSs localize within physiologically relevant TF binding sites. FIG. 50A, columns, illustrates categorization of GWAS SNPs by disease area (Maurano et al., 2012). FIG. 50A, rows, illustrates ranscription factor categories from unbiased mapping into disease/pathophysiologic categories with GO. Each cell shows the proportion (grayscale bar) of all GWAS SNPs from a given disease category (column) that fall into the binding sites of TFs within each TF category (row). FIG. 50B illustrates a close-up of cancer and cardiovascular diseases showing the presence (red) or absence (black) of a recognition sequence for a particular recognition sequence (rows) at the location of a GWAS SNP in the indicated disease category (columns). FIG. 50C illustrates the significance of proportions in (A), with high significance (binomial test) along the diagonal indicating systematic localization of GWAS variants from a given disease category within binding sites of pathophysiologically-related TFs. This analysis revealed that common variants associated with specific diseases or trait classes were systematically enriched in the recognition sequences of transcription factors governing physiological processes relevant to the same classes.

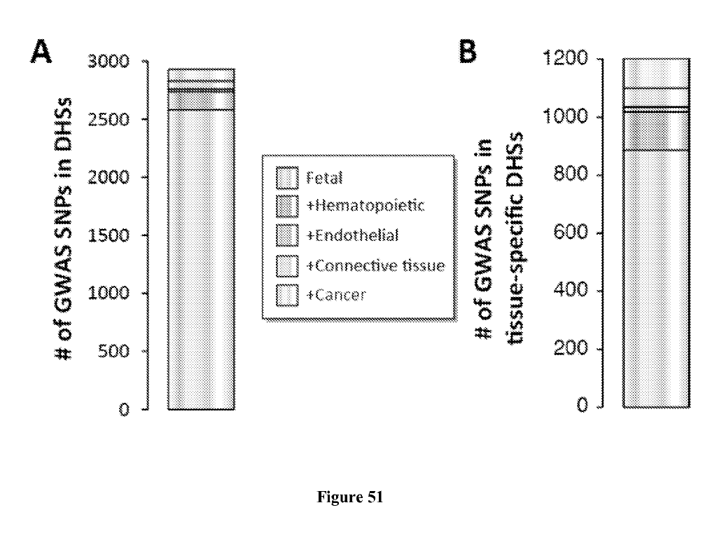

Functional variants that alter transcription factor recognition sequences frequently affect local chromatin structure. At heterozygous SNPs altering transcription factor recognition sequences, altered nuclease accessibility of the chromatin template manifests as an imbalance in the fraction of reads obtained from each allele. As the concentration of sequence reads and highly overlapping read coverage results in an effective re-sequencing of DHSs, cell types heterozygous for common SNPs could be detected and the relative proportions of reads from each allele across all cell types could be quantified. This imbalance is indicative of the functional effect of a particular allele on local chromatin state. 584 heterozygous GWAS SNPs with sufficient sequencing coverage were detected, of which 120 showed significant allelic imbalance in chromatin state (at FDR 5%). Sites where regulatory variants were associated with allelic chromatin states were identified, with the predicted higher-affinity allele exhibiting higher accessibility (FIG. 49C). FIG. 49 illustrates candidate regulatory roles for GWAS SNPs. FIG. 49C illustrates examples of allele-specific DNaseI sensitivity in cell types derived from heterozygous individuals for GWAS variants that alter TF recognition motifs within DHSs (also see Maurano et al., 2012). Each cell type track shows DNaseI cleavage density scaled by allelic imbalance at the GWAS variant and colored by variant nucleotide (blue=C, green=A, yellow=G, red=T). Total reads from each allele are also shown. In nearly 50% of cases, the magnitude of imbalance was >2:1 (FIG. 51). FIG. 51 illustrates the allelic imbalance distribution: the distribution of the proportion of reads from the less-frequent allele at DHSs with significant (FDR<5%) imbalance in DNaseI hypersensitivity. The GWAS SNPs were the sole local sequence difference between haplotypes, indicating that disease-associated variants are responsible for modulating local chromatin accessibility. Further, at sites with very high sequencing depth (>200×), 38.7% (53/137) show significant allelic imbalance (FDR<5%). As sensitivity to detect allelic imbalance is governed by sequencing depth, this suggests that nearly 40% of GWAS variants in similarly-sequenced DHSs would be expected to show allelic imbalance.

Methods.

Disease- and Trait-Associated Variants from GWAS.

The GWAS SNP set was used for analysis as previously described in Example 21 herein.

Identification of Replicated GWAS Associations.

The identification of replicated GWAS associations was performed as previously described in Example 21 herein.

DNaseI Mapping.

DNaseI mapping was conducted as previously described in Example 21 herein.

Isolation of Nuclei from Cultured Cells.

The isolation of nucleic from cultured cells was performed as previously described in Example 21 herein.

Isolation of Nuclei from Hematopoietic Cells.

The isolation of nuclei from hematopoietic cells was performed as previously described in Example 21 herein.

Isolation of Nuclei from Fetal Tissues.

The isolation of nuclei from fetal tissues was performed as previously described in Example 21 herein.

DNaseI Mapping from Isolated Nuclei.

DNaseI mapping from isolated nuclei was performed as previously described in Example 21 herein.

Processing of DNaseI-Seq Data.

The processing of DNaseI-seq data was performed as previously described in Example 21 herein.

Data Availability.

The DNaseI data used are available as previously described in Example 21 herein.

Transcription Factor Motif Data.

Potential sites of transcription factor binding were identified by scanning relevant regions utilizing position weight matrices from three major transcription factor binding motif remayories: TRANS-FAC, JASPAR, and UniPROBE. To avoid ascertainment bias for motifs better matching the reference allele of common polymorphisms, an alternate genome was created to complement the reference GRCh37/hg19 human genome. This alternate genome incorporates the non-reference allele at the location of each SNP identified in the CEU population of the 1000 Genomes Project.

Regions in the vicinity of GWAS or control SNPs were then scanned for motifs in both the reference and alternate genomes with a threshold P<10⁻⁴ using the program FIMO.

Mapping Transcription Factors to GWAS Disease/Trait Classes.

Information from the Gene Ontology (GO) was used to identify potentially relevant motif matches. All GO biological processes for 282 transcription factors were extracted from the Gene Ontology MySql database. For each disease/trait class, a collection of key terms which could identify factors potentially involved in the class was developed and used to search the list of GO biological processes associated with each transcription factor for which a position weight matrix was available (Maurano et al., 2012). Many transcription factors were found to be consistent with multiple disease/trait classes. The set of transcription factor motifs detected (P<10⁻⁴), with at least one Gene Ontology Biological Process matching search terms for the disease/trait class and which overlapped GWAS SNPs in a DHS was identified and used for subsequent pathway/interaction analyses.

For the measurements of GWAS SNP enrichment within transcription factor motif groups, a matrix of potential associations between transcription factor GO groups (e.g., aging) and disease classes (e.g., cancer) was formed. The relative frequency with which GWAS SNPs from a particular disease class localized within the recognition sequence of a transcription factor annotated with related physiological processes was computed, and a P-value was derived using the binomial distribution b(x; n, p), setting the first parameter to the number of GWAS SNPs present in the given factor group, and the second parameter to the proportion of GWAS SNPs belonging to the given disease class.

Allelic Imbalance in Chromatin Accessibility.

Heterozygous SNPs were first called directly from the DNaseI reads. At each of the 5,386 unique GWAS SNPs (coding and noncoding), reads were extracted from DNaseI alignments using SAMtools, and compared to the GRCh37/hg19 human reference sequence. To reduce the risk of false positives due to sequencing errors, only GWAS SNPs identified either in the 1000 Genomes Project's low-coverage CEU population data, or Complete Genomics' 54-individual sample were considered. To correct for mapping bias caused by the extra mismatch in reads containing the non-reference allele a less-stringent mismatch threshold was applied. Reads containing the reference allele were only counted if they contained zero or one base mismatches (over the entire read length) to the reference sequence; reads with the non-reference allele were counted if they had one or two base mismatches (one of which is the SNP). Any SNPs located within one read-length (36 bp) of another known SNP, represented by more than one chromosome in either sample from 1000 Genomes or Complete Genomics, were excluded from this analysis. Samples were called heterozygous at a SNP if each known allele was represented by reads aligned to at least three distinct positions (unique genomic coordinate and strand).

872 heterozygous SNPs were identified, and allele counts pooled from all heterozygous samples. Confirming the strategy for avoiding reference mapping bias, 412 SNPs with more reads from the reference allele, 416 SNPs with more reads containing the non-reference allele, and 44 SNPs with an equal amount of reads were observed. Sites with fewer than 21 reads were excluded for lack of power to test for allelic imbalance. The remaining 584 sites were then tested for imbalance using a two-tailed binomial test. A false discovery rate was calculated using the R package qvalue. To set an overall cutoff for significantly imbalanced sites, 200 random sets of read counts at 584 sites were simulated using the binomial distribution, with the ratios at imbalanced sites sampled from the actual data. The power of the method to correctly discover imbalanced sites was tested, and the actual false discovery rate was measured to be <5% for a cutoff of P<0.025.

### Example 25

### Disease-Associated Variants Cluster in Transcriptional Regulatory Pathways

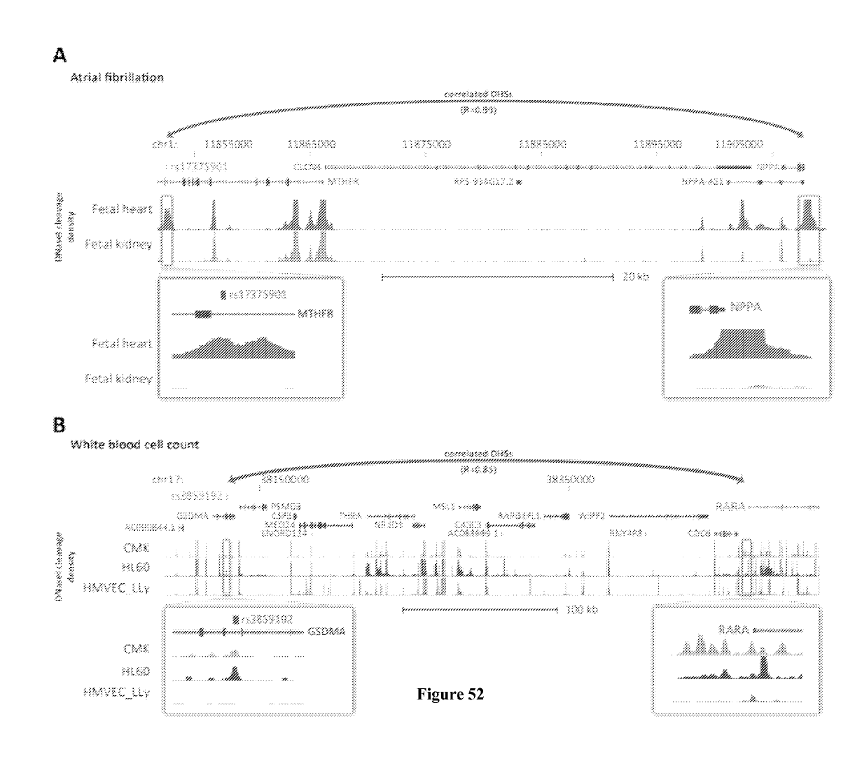

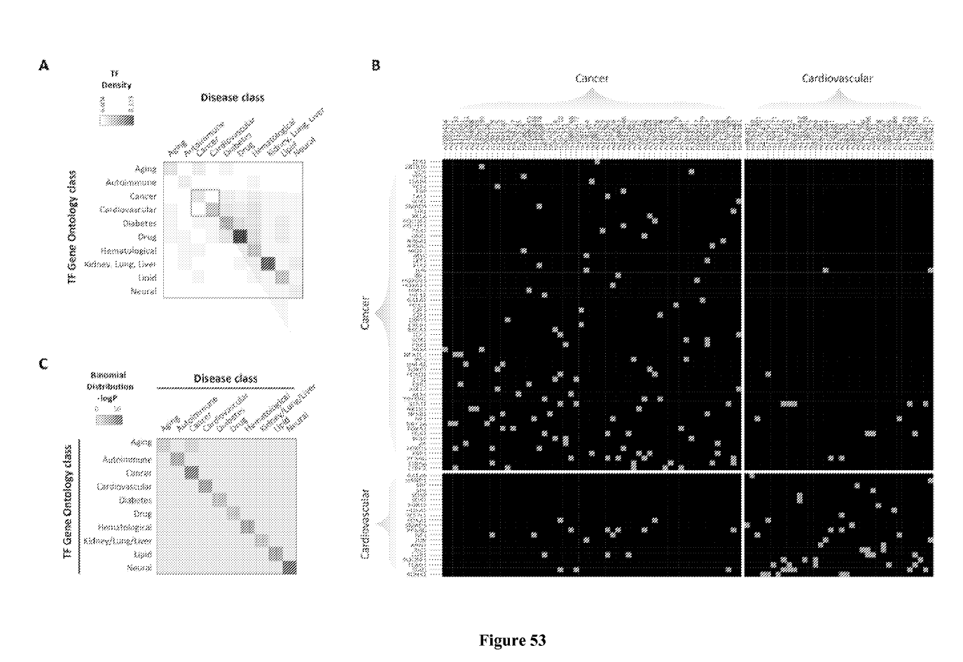

Transcriptional control of glucose homeostasis and beta cell genesis and function is mediated by a closely-knit transcriptional regulatory pathway defined by specific transcription factors. The Mendelian phenotypes of maturity-onset diabetes of the young (MODY) are caused by separate lesions disrupting the coding sequences of each of these transcription factors. Interestingly, clustering of common non-coding variants associated with abnormal glucose homeostasis, insulin and glycohemoglobin levels, and diabetic complications was observed within recognition sites for the same six transcription factors (P<0.029, binomial; 48% enrichment over random SNPs; FIG. 52A). FIG. 52 illustrates that common disease-associated variants cluster in regulatory pathways. FIG. 52A illustrates that SNPs in DHSs associated with diabetes (Type I and Type II), diabetic complications, and glucose homeostasis localize in recognition sites of transcriptional regulators (labeled ellipses) controlling glucose transport, glycolysis, and beta cell function that are structurally disrupted in the Mendelian phenotypes of maturity-onset diabetes of the young (MODY). Chromosome of each SNP associated with the indicated phenotype is listed (see Maurano et al., 2012). This suggests that non-coding variants that predispose to dysregulation of glucose homeostasis perturb peripheral nodes of the same regulatory network responsible for Mendelian forms of Type 2 diabetes.

Using known interacting sets of transcription factors related disease-associated variants were identified in the recognition sequences of a central target factor and its interacting partners (FIG. 52B, Maurano et al., 2012b) for factors involved in autoimmune disease, cancer and neurological development. FIG. 52B illustrates that 24.4% of SNPs associated with autoimmune disorders that fall within DHSs localize in recognition sequences of TFs that interact with IRF9. Arrows indicate directionality of relationship, dotted lines represent indirect interactions. The complete network is shown in Maurano et al., 2012. Exemplary factors for which no position weight matrices were available included MIXL1, NR2E3, TLX2, GSX1, EMX1, and TLX3. Exemplary factors for which no GWAS SNPs were in their binding sites included TLX2, HOXB8, STAT2, GFI1B, VENTX, and SOX6. SNPs in DHSs associated with autoimmune diseases repeatedly localize in recognition sequences for transcriptional regulators (labeled ellipses) that interact with IRF9. Another exemplary case (Maurano et al., 2012) demonstrated repeated involvement of the OTX1 pathway in neuropsychiatric diseases and traits. SNPs in DHSs associated with diverse neuropsychiatric diseases and traits repeatedly localized within recognition sequences of TFs that interact with the brain morphogenic factor OTX, significant at P<0.049 (binomial; 1.3× enrichment vs. proportion of random SNPs). Examples of such TFs include FOXG1, POU5F1, SMAD3, EN1, SOX2, NANOG, PAX2, and SMAD4. For SMAD2 and TBX1, position weight matrices were available, but no recognition sequences overlapped GWAS SNPs. A further exemplary case (Maurano et al., 2012) demonstrated that cancer-associated SNPs clustered in orphan nuclear receptor ESRRA network. SNPs in DHSs associated with cancer repeatedly localized in recognition sequences for transcriptional regulators that interact with ESRRA, significant at P<0.010 (binomial; 1.5× enrichment vs. proportion of random SNPs). Examples of such factors included ESR1, ARNT, AHR, SOX9, SP1, RXRA, PPARG, and PPARA. For THRA, ESRRB, EPAS1, and NR1H4, position weight matrices were available, but no recognition sequences overlapped GWAS SNPs. For NR1D1, ESRRG, PROX1, DPF2, HIF1A, and CREBZF, position weight matrices for these factors were unavailable. The 28 distinct SNPs in the ESRRA network represent 12.7% of 220 cancer GWAS SNPs overlapping DHSs.

IRF9 is a transcription factor associated with type I interferon induction. Of 26 transcription factors in the IRF9-centered interaction network, 15 represent transcription factors with recognition sequences in multiple distinct DHSs that contain GWAS variants associated with a wide variety of autoimmune disorders (P<1.6×10⁻¹³, binomial; 2.8-fold enrichment vs. random SNPs, FIG. 52B). Notably, 24.4% (64/262) of GWAS SNPs within DHSs of immune cells and associated with autoimmune disease alter one or more of the 15 transcription factor motifs from the IRF9-centered network. This example and those described herein for OTX and ESRRA, illustrated that disease-associated variants from the same or related disorders and traits repeatedly localize within the recognition sequences of transcription factors that form interacting regulatory networks.

Methods.

Disease- and Trait-Associated Variants from GWAS.

The GWAS SNP set was used for analysis as previously described in Example 21 herein.

Identification of Replicated GWAS Associations.

The identification of replicated GWAS associations was performed as previously described in Example 21 herein.

DNaseI Mapping.

DNaseI mapping was conducted as previously described in Example 21 herein.

Isolation of Nuclei from Cultured Cells.

The isolation of nucleic from cultured cells was performed as previously described in Example 21 herein.

Isolation of Nuclei from Hematopoietic Cells.

The isolation of nuclei from hematopoietic cells was performed as previously described in Example 21 herein.

Isolation of Nuclei from Fetal Tissues.

The isolation of nuclei from fetal tissues was performed as previously described in Example 21 herein.

DNaseI Mapping from Isolated Nuclei.

DNaseI mapping from isolated nuclei was performed as previously described in Example 21 herein.

Processing of DNaseI-Seq Data.

The processing of DNaseI-seq data was performed as previously described in Example 21 herein.

Data Availability.

The DNaseI data used are available as previously described in Example 21 herein.

Transcription Factor-Centered Networks.

Factors involved in maturity onset diabetes of the young were obtained (MODY, FIG. 52A), as well as those interacting with OTX1 (Maurano et al., 2012), IRF9 (FIG. 52B), and ESRRA (Maurano et al., 2012) using Ingenuity Pathways Analysis (Ingenuity Systems, www.ingenuity.com). The transcription factors in each network with known sequence specificities were examined for overlap with noncoding GWAS SNPs in DHSs in all cell types (the IRF9 network was restricted to cell types related to immune function: CD3+, CD3+_Cord_Blood, CD4+, CD8+, CD14+, CD19+, CD20+, CD34+, CD56+, fThymus, GM06990, GM12864, GM12865, GM12878, Th1, Th2, Th17, Jurkat). MODY factors were examined for GWAS SNPs associated with Type 1 or Type 2 diabetes or glucose metabolism-related traits. OTX1-interacting, IRF9-interacting, and ESRRA-interacting factors were examined for GWAS SNPs associated with neurological, autoimmune, and cancer classes, respectively. The significance of the enrichment of disease-relevant GWAS SNPs in the TFs in these networks was tested against the enrichment of random SNPs in the network. A binomial distribution with the parameter p set to the proportion of noncoding SNPs in the Affymetrix 500K genotyping array overlapping motifs of the same TFs in DHSs was used.

### Example 26

### Common Networks for Common Diseases

The observation that GWAS variants associated with multiple distinct diseases within the same broader disease class (e.g., inflammation, cancer) repeatedly localize within the recognition sites of interacting transcription factors suggested that cohorts of such transcription factors may form shared regulatory architectures. To explore whether non-coding GWAS SNPs from related diseases perturb different recognition sequences of a common set of transcription factors, all transcription factors for which at least 8 recognition sequences in DHSs were perturbed by GWAS SNPs associated with autoimmune diseases were tabulated (FIG. 53A). FIG. 53 illustrates common disease networks. GWAS SNPs from related diseases repeatedly perturb recognition sequences of common transcription factors. Shown are factors whose recognition sequences harbor 8 or 6 GWAS SNPs in inflammatory/autoimmune diseases (A) and cancer (B), respectively. Edge thickness represents number of associations between TF and disease in DHSs in relevant tissues. Both networks are significantly enriched for overlap with disease-relevant GWAS SNPs, and include many well-studied regulators. Among the 22 factors identified were canonical immune signaling regulators, such as STAT1 and STAT3, NF-xB, and PPARa and PPARy. These 22 transcription factors comprise a highly significant (P<9.8×10⁻⁵¹, simulation vs. number of factors for random SNPs), shared regulatory architecture that is repeatedly perturbed in a wide range of autoimmune disorders (FIG. 53A).

The same analysis in the context of 17 different malignancies exposed a very different network of transcription factors connecting seemingly disparate cancer types (P<7.1×10⁻¹¹, simulation) including neoplastic regulatory relationships, linking FoxA1 and breast cancer, Fox03 and colorectal cancer, and TP53 and melanoma, breast and prostate cancer (FIG. 53B). Six neuropsychiatric disorders were also analyzed, and 23 transcription factors whose recognition sequences were perturbed by at least 3 disease-associated variants were identified (Maurano et al., 2012). The exemplary neuropsychiatric disorders included ADHD, bipolar/schizophrenia, bipolar disorder, conduct disorder, depression, panic disorder, and schizophrenia. GWAS SNPs from related diseases repeatedly perturbed recognition sequences of common transcription factors. Collectively, these results supported the hypothesis that shared genetic liability may underlie many related categories of disease.

Methods.

Disease- and Trait-Associated Variants from GWAS.

The GWAS SNP set was used for analysis as previously described in Example 21 herein.

Identification of Replicated GWAS Associations.

The identification of replicated GWAS associations was performed as previously described in Example 21 herein.

DNaseI Mapping.

DNaseI mapping was conducted as previously described in Example 21 herein.

Isolation of Nuclei from Cultured Cells.

The isolation of nucleic from cultured cells was performed as previously described in Example 21 herein.

Isolation of Nuclei from Hematopoietic Cells.

The isolation of nuclei from hematopoietic cells was performed as previously described in Example 21 herein.

Isolation of Nuclei from Fetal Tissues.

The isolation of nuclei from fetal tissues was performed as previously described in Example 21 herein.

DNaseI Mapping from Isolated Nuclei.

DNaseI mapping from isolated nuclei was performed as previously described in Example 21 herein.

Processing of DNaseI-Seq Data.

The processing of DNaseI-seq data was performed as previously described in Example 21 herein.

Data Availability.

The DNaseI data used are available as previously described in Example 21 herein.

Disease Networks.

For the autoimmune network (FIG. 53A), SNPs of the autoimmune class plus SNPs associated with Type 1 diabetes were used (Maurano et al., 2012). Only GWAS SNPs in DHSs from cell types related to immune function were examined and the number of GWAS SNPs associated with autoimmune disease were tallied. Transcription factors overlapping 8 or more GWAS SNPs are shown.

For the cancer network (FIG. 53B), a set of GWAS SNPs associated with cancer in DHSs from all tissue types was used. Transcription factors overlapping 6 or more GWAS SNPs are shown.

For the psychiatric network (Maurano et al., 2012) a set of GWAS SNPs associated with psychiatric diseases which were present in DHSs of fetal brain was used. Transcription factors overlapping 3 or more GWAS SNPs are shown, except for FOXI1 and FOXP3, which were removed from the network due to lack of hypersensitivity at their promoter DHSs.

For each network, the significance of finding a set of TFs whose recognition sequences overlap such a high number of GWAS SNPs was computed by comparing to random equally-sized samples of noncoding SNPs from the Affymetrix 500K genotyping array (10,000 replicates). P-values were estimated using a fitted Poisson distribution.

### Example 27

### De Novo Identification of Pathogenic Cell Types

To provide insights into the cellular structure of disease and potentially highlight pathogenic cell types, the selective localization of GWAS SNPs within the regulatory DNA of individual cell types was explored. The enrichment of all tested variants was considered further, not just those with genome-wide significance, and serial determination of the cell/tissue-selective enrichment patterns of progressively more strongly associated variants was performed to expose collective localization within specific lineages or cell types. All SNPs tested in GWAS meta-analyses of two common auto-immune disorders, Crohn's disease and multiple sclerosis (MS), were used, and a common continuous physiological trait, cardiac conduction measured by the electrocardiogram QRS duration (n=938,703, 2,465,832, and ˜2.5M SNPs, respectively). For SNPs meeting increasingly significant P-value cutoffs, the proportion of SNPs in DHSs of each cell type were compared to the proportion of all SNPs in DHSs of the same cell type (FIG. 54). FIG. 54 illustrates identification of pathogenic cell types. GWAS SNPs are systematically enriched in the regulatory DNA of disease-specific cell types throughout the full range of significance. Shown are SNPs tested for association with the autoimmune disorders Crohn's disease (A), multiple sclerosis (B) and QRS duration (C). For all three studies, enrichment of more weakly associated variants was observed in regulatory DNA. This enrichment suggests that a large number of functional variants of small quantitative effect act through modulation of regulatory DNA. Additionally, it suggests that conditioning association analyses on regulatory DNA may ameliorate the stringent statistical correction for multiple testing required for genome-wide testing of unselected SNPs.

Furthermore, with progressively stringent P-value thresholds, increasingly selective enrichment of disease-associated variants within specific cell types was observed (FIG. 54). Strikingly, in the case of Crohn's disease, the Th17 (12.0-fold enriched) and Th1 (8.87-fold enriched) T-cell subtypes have a concentration of the most-significant GWAS variants in their DHSs (FIG. 54A). While Crohn's pathology has classically been associated with Th1 cytokine responses, an emerging consensus points to a defining role for IL17-producing Th17 cells. Notably, this analysis was accomplished without any prior knowledge about Crohn's disease pathology.

In the case of MS, sequential cell-selective enrichment analysis highlighted two cell types: CD3+ T-cells from cord blood, and CD19+/CD20+ B-cells (FIG. 54B). While MS has long been thought to be T-cell mediated, a critical role for B-cells has only recently been recognized and has major therapeutic implications. It is notable that cord blood CD3+ cells—essentially a naïve population—gamer the most highly selective enrichment, particularly in comparison with total adult CD3+ cells or other T-cell subsets, suggesting a role for variants influencing immune education. Also of note, DHSs active in brain tissue were moderately depleted (˜10%) for MS-associated variants, suggesting that neural regulatory elements do not play a substantial role in MS pathogenesis, as proposed. Analogously, analysis of variants associated with the continuously varying trait of QRS duration revealed similarly specific enrichment within fetal heart DHSs (FIG. 54C). Importantly, in all three cases, the results were obtained without any prior knowledge of physiological mechanisms. These data suggest a generally applicable approach, and highlight the value of extensive maps of regulatory DNA for gaining insights into disease physiology and pathogenesis.

Methods.

Disease- and Trait-Associated Variants from GWAS.

The GWAS SNP set was used for analysis as previously described in Example 21 herein.

Identification of Replicated GWAS Associations.

The identification of replicated GWAS associations was performed as previously described in Example 21 herein.

DNaseI Mapping.

DNaseI mapping was conducted as previously described in Example 21 herein.

Isolation of Nuclei from Cultured Cells.

The isolation of nucleic from cultured cells was performed as previously described in Example 21 herein.

Isolation of Nuclei from Hematopoietic Cells.

The isolation of nuclei from hematopoietic cells was performed as previously described in Example 21 herein.

Isolation of Nuclei from Fetal Tissues.

The isolation of nuclei from fetal tissues was performed as previously described in Example 21 herein.

DNaseI Mapping from Isolated Nuclei.

DNaseI mapping from isolated nuclei was performed as previously described in Example 21 herein.

Processing of DNaseI-Seq Data.

The processing of DNaseI-seq data was performed as previously described in Example 21 herein.

Data Availability.

The DNaseI data used are available as previously described in Example 21 herein.

Cell Type-Selective GWAS Variant-DHS Enrichment Analysis.

At a given P-value threshold, enrichment in a cell type's DHSs was calculated as the fraction of SNPs with a P-value below that threshold that overlap DHSs, divided by the fraction of all noncoding SNPs in the study that overlap DHSs. Malignancy-derived cell lines were excluded. Enrichments were tested at P-value thresholds from 1.0 to 10⁻⁷⁵. The thresholds were chosen as powers of ten which approximately halved the number of additional SNPs included at each successively-lower threshold. The smallest threshold was chosen to retain sufficient sample size (>100 SNPs). The statistical significance of each enrichment was measured with a one-sided Fisher's exact test, implemented in R's “fisher.test” function.

While preferred cases of the present invention have been shown and described herein, it will be obvious to those skilled in the art that such cases are provided by way of example only. Numerous variations, changes, and substitutions will now occur to those skilled in the art without departing from the invention. It should be understood that various alternatives to the cases of the invention described herein may be employed in practicing the invention. It is intended that the following claims define the scope of the invention and that methods and structures within the scope of these claims and their equivalents be covered thereby.

1-99. (canceled)

100. A method for generating a map of one or more variants of a set of nucleotides within one or more regulatory regions of a plurality of polynucleotide fragments, comprising:
a) determining a frequency of polynucleotide cleavage events throughout a length of the plurality of polynucleotide fragments, wherein the plurality of polynucleotide fragments are generated by digesting, with a polynucleotide cleaving agent, a first polynucleotide in the presence of the plurality of binding proteins;
b) detecting whether the determined frequency of polynucleotide cleavage events is relatively high;
c) if detected that the determined frequency of polynucleotide cleavage events is relatively high, identifying sequences of a set of nucleotides within the plurality of polynucleotide fragments;
d) identifying at least one regulatory region within the plurality of polynucleotide fragments;
e) identifying at least one variant of the set of nucleotides within the regulatory region of the plurality of polynucleotide fragments;
f) repeating steps (a)-(e) using a second polynucleotide that differs from the first polynucleotide;
g) using at least one polynucleotide information database, correlating the variants identified for the first polynucleotide with the variants identified for the second nucleotide so as to generate one or more patterns of variants; and
h) annotating the generated patterns using information from the polynucleotide information database to generate the map.

101. The method of claim 100, further comprising: analyzing the generated patterns to identify at least one polynucleotide target of the regulatory region of the first polynucleotide.

102. The method of claim 100, further comprising: correlating the variants identified for the first polynucleotide and the variants identified for the second polynucleotide so as to determine a relationship between a polynucleotide target of the first polynucleotide and a polynucleotide target of the second polynucleotide.

103. The method of claim 102, wherein the determined relationship confers association with a phenotype.

104. The method of claim 103, wherein the phenotype is selected from the group consisting of: a disease; a state of pathogenesis; a stage of development; a type of tissue; and a type of cell.

105. The method of claim 100, wherein the first and second polynucleotides are derived from genomic DNA of at least one human cell type.

106. The method of claim 100, wherein at least one of the identified regulatory regions is a DNA hypersensitivity site.

107. The method of claim 100, wherein at least one of the identified regulatory regions is a protein binding sequence.

108. The method of claim 100, wherein the map is generated using an algorithm selected from the group consisting of: a set of genome wide association study algorithms; a gene ontology algorithm; a clustering analysis algorithm; a linear regression analysis algorithm; and a uniform processing algorithm.

109. The method of claim 100, wherein the method is performed under the control of one or more processors or computers.

110. A method of determining whether an allele of a gene of a heterozygous subject is associated with a functional disease phenotype comprising:
a) obtaining a polynucleotide sample from the heterozygous subject, wherein the heterozygous subject has a risk allele and a non-risk allele;
b) cleaving the polynucleotide sample in order to generate a library of polynucleotide fragments;
c) obtaining sequence reads of the polynucleotide fragments;
d) using the sequences of step c, identifying the sequence reads within the region encompassing the risk allele and non-risk allele and counting the number of sequence reads for each allele;
e) using the numbers from step d, determining a ratio of the risk-allele sequence reads to the non-risk-allele sequence; and
f) identifying the risk allele as functional if the ratio of step e is greater than 1:1.

111. The method of claim 110, wherein the risk allele is a single nucleotide polymorphism.

112. The method of claim 110, wherein the disease is cancer, diabetes, aging-related disorders, autoimmune disorder, metabolic disorder, neurodegenerative disease, or an inflammatory disorder.

113. The method of claim 110, wherein the polynucleotide is a fetal polynucleotide.

114. The method of claim 110, further comprising distinguishing a homozygous allele from a heterozygous allele by comparing the polynucleotide fragment pattern to either: (a) known polynucleotide fragment patterns for homozygous alleles; or (b) known polynucleotide fragment patterns for heterozygous alleles.

115. (canceled)

116. A method of identifying a regulatory region of a gene comprising:
a) identifying a plurality of DNaseI hypersensitivity sites (DRS) within a gene wherein at least one of the DRS includes a promoter of the gene;
b) computing a pattern of DRS across greater than 10 cell types, wherein the pattern reflect the presence or absence of DRS;
c) computing the pattern of at least one non-promoter DRS within 500 kilobases of the promoter; and
d) correlating the patterns from step b and step c in order to identify DRS with synchronous patterns across greater than 10 cell types, thereby identifying a distal regulatory region of the gene.

117. The method of claim 110, wherein step d) comprises:
i) identifying a plurality of DNaseI hypersensitivity sites (DRS) within a gene wherein at least one of the DRS includes a promoter of the gene;
ii) computing a pattern of DRS across greater than 10 cell types, wherein the pattern reflect the presence or absence of DRS;
iii) computing the pattern of at least one non-promoter DRS within 500 kilobases of the promoter; and
iv) correlating the patterns from step b and step c in order to identify DRS with synchronous patterns across greater than 10 cell types, thereby identifying a distal regulatory region of the gene.


SEQUENCE LISTING (14 sequences)

SEQ ID NO: 1 - DNA, 16 bp, Artificial Sequence
  Description of Artificial Sequence Synthetic oligonucleotide
ancngntnannnncgt

SEQ ID NO: 2 - protein, 16 aa, Artificial Sequence
  Description of Artificial Sequence Synthetic peptide
CPDCDMAFVTSGELVR

SEQ ID NO: 3 - protein, 13 aa, Artificial Sequence
  Description of Artificial Sequence Synthetic peptide
TFQCELCSYTCPR

SEQ ID NO: 4 - protein, 14 aa, Artificial Sequence
  Description of Artificial Sequence Synthetic peptide
NSDLLTSPDVGLLK

SEQ ID NO: 5 - protein, 15 aa, Artificial Sequence
  Description of Artificial Sequence Synthetic peptide
NVTDEQEGFAEGFVR

SEQ ID NO: 6 - protein, 10 aa, Artificial Sequence
  Description of Artificial Sequence Synthetic peptide
QNALLEQQVR

SEQ ID NO: 7 - protein, 9 aa, Artificial Sequence
  Description of Artificial Sequence Synthetic peptide
ATEYIQYMR

SEQ ID NO: 8 - DNA, 18 bp, Artificial Sequence
  Description of Artificial Sequence Synthetic primer
gctagcctcgaggatatc

SEQ ID NO: 9 - DNA, 18 bp, Artificial Sequence
  Description of Artificial Sequence Synthetic primer
aggccagatcttgatatc

SEQ ID NO: 10 - DNA, 24 bp, Artificial Sequence
  Description of Artificial Sequence Synthetic oligonucleotide
actagtgcgcatgcgcaatgtaca

SEQ ID NO: 11 - DNA, 22 bp, Artificial Sequence
  Description of Artificial Sequence Synthetic oligonucleotide
ctgtcggcagagagacaacaga

SEQ ID NO: 12 - DNA, 22 bp, Artificial Sequence
  Description of Artificial Sequence Synthetic oligonucleotide
ctgttggcagagagacaacaga

SEQ ID NO: 13 - DNA, 12 bp, Artificial Sequence
  Description of Artificial Sequence Synthetic oligonucleotide
ccannagnnggc

SEQ ID NO: 14 - DNA, 14 bp, Artificial Sequence
  Description of Artificial Sequence Synthetic oligonucleotide
ctggnnnnnngcca